(19) United States
(12) Patent Application Publication
(10) Pub. No.: US 2023/0388871 A1
(43) Pub. Date: Nov. 30, 2023

(54) MOBILITY FEATURES FOR NEXT GENERATION CELLULAR NETWORKS

(71) Applicant: Intel Corporation, Santa Clara, CA (US)

(72) Inventors: Yi Guo, Shanghai (CN); Xun Tang, Beijing (CN); Sudeep Palat, Cheltenham (GB); Candy Yiu, Portland, OR (US); Seau Sian Lim, Swindon (GB); Jaemin Han, Portland, OR (US); Richard Burbidge, Shrivenham (GB); Youn Hyoung Heo, San Jose, CA (US); Bishwarup Mondal, San Ramon, CA (US)

(21) Appl. No.: 18/352,810

(22) Filed: Jul. 14, 2023

Related U.S. Application Data
(60) Provisional application No. 63/389,621, filed on Jul. 15, 2022.
(60) Provisional application No. 63/393,031, filed on Jul. 28, 2022.
(60) Provisional application No. 63/410,866, filed on Sep. 28, 2022.
(60) Provisional application No. 63/411,553, filed on Sep. 29, 2022.
(60) Provisional application No. 63/485,496, filed on Feb. 16, 2023.

(30) Foreign Application Priority Data
Jul. 18, 2022 (WO) PCT/CN2022/106201
Feb. 6, 2023 (WO) PCT/CN2023/074519

(51) Int. Cl. H04W 36/00

(52) U.S. Cl. CPC H04W 36/0069; H04W 36/00835; H04W 36/0061

(57) ABSTRACT

The present disclosure is related to layer 1 (L1)/layer 2 (L2) triggered mobility (LTM) aspects, including LTM inter-cell mobility, LTM in split architectures; dynamic cell group changes, activation, and deactivation, conditional primary SCG cell addition or change (CPAC) aspects; early timing advance acquisition for LTM; radio link monitoring (RLM) handling for LTM; LTM-related security mechanisms; conditional handover (CHO)/CPAC aspects related to secondary cell group (SCG) configurations and radio resource control (re)configuration; and reference configuration aspects. Additional or alternative aspects may be described and/or claimed.

### CROSS REFERENCE TO RELATED APPLICATIONS

The present application claims priority to U.S. Provisional App. No. 63/389,621 filed 15 Jul. 2023, Intl App. No. PCT/CN2022/106201 filed 18 Jul. 2023, U.S. Provisional App. No. 63/393,031 filed 28 Jul. 2023, U.S. Provisional App. No. 63/410,866 filed 28 Sep. 2023, U.S. Provisional App. No. 63/411,553 filed 29 Sep. 2023, Int'l App. No. PCT/CN2023/074519 filed 6 Feb. 2024, and U.S. Provisional App. No. 63/485,496 filed 16 Feb. 2024, the contents of each of which are hereby incorporated by reference in their entireties and for all purposes.

### FIELD

The present disclosure is generally related to wireless communications technologies, network topologies, network and information security technologies, communication hardware implementations, and in particular, to various aspects of layer 1 (L1) and/or layer 2 (L2) based inter-cell mobility.

### BACKGROUND

When a user equipment (UE) moves from a coverage area of one cell to another cell, at some point a serving cell change needs to be performed. Currently, a serving cell change is triggered by layer 3 (L3) measurements and is done by radio resource control (RRC) signaling triggered reconfiguration with synchronisation for change of primary cell (PCell) and primary secondary cell group (SCG) cell (PSCell), as well as release add for secondary cells (SCell) when applicable. All cases involve complete L2 and L1 resets, leading to longer latency, larger overhead and longer interruption time than beam switch mobility.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings in which:

FIG. 1 depicts an example legacy handover (HO) procedure;

FIG. 2 depicts an example conditional HO (CHO) procedure;

FIG. 3 depicts an example layer 2 structure for uplink (UL) with carrier aggregation (CA) configured;

FIG. 4a depicts an example NG-RAN architecture;

FIG. 4b depicts an example centralized unit (CU) user plane (UP)/control plane (CP) split architecture;

FIGS. 5, 6, 7, and 8 depicts example graphs related to thresholds of good beams;

FIG. 9 depicts an example intra-CU inter-DU handover;

FIG. 10 depicts an example intra-DU handover;

FIG. 11 depicts an example intra-DU handover to an additional physical cell identity (PCI);

FIG. 12 depicts an example intra-DU handover based on L1/L2 signaling;

FIG. 13 depicts an example intra-DU handover based on L1/L2 measurements;

FIG. 15 depicts an example of activating/deactivating PSCells;

FIG. 16 depicts example NR-DC scenarios;

FIG. 17 depicts an example of NR-DC with selective activation of SCGs via L3 enhancements;

FIG. 18 depicts an example procedure for SCG change with PCell change or HO;

FIG. 19 depicts an example SCG index;

FIG. 20 depicts an example scenarios of two UEs being served by multiple transmission reception points;

FIGS. 21 and 22 depict example TCI state activation/deactivation MAC CEs;

FIG. 24 depicts an example procedure for a network (NW) preparation phase during intra-DU L1/L2 mobility;

FIG. 25 depicts an example UE context modification procedure;

FIG. 26 depicts an example procedure for HO execution phase during intra-DU L1/L2 mobility;

FIG. 27 depicts an example access success procedure;

FIG. 28 depicts an example procedure for subsequent HO execution phase during intra-DU L1/L2 mobility;

FIG. 29 depicts an example procedure for a NW preparation phase during intra-CU L1/L2 mobility;

FIG. 30 depicts an example UE context setup request procedure;

FIG. 31 depicts an example gNB-DU initiated UE context release procedure;

FIG. 32 shows an example gNB-CU initiated UE context release procedure;

FIG. 33 shows an example DL RRC message transfer procedure;

FIG. 34 shows an example procedure for inter-DU HO execution during intra-CU inter-DU L1/L2 mobility;

FIGS. 35a and 35b show an example procedure for intra-DU or inter-DU subsequent HO execution during intra-CU inter-DU L1/L2 mobility;

FIG. 36 depicts an example signaling procedure for L1/L2 triggered mobility (LTM);

FIG. 37 depicts an example physical downlink control channel (PDCCH) order procedure;

FIG. 38 depicts an example of separate random access channel configuration for early timing advance (TA) acquisition;

FIG. 39 depicts an example configuration of preamble resources;

FIG. 40 depicts an example of a gap for both preamble transmission and random access response reception;

FIG. 41 depicts an example of a periodical gap for preamble transmission;

FIG. 42 depicts an example of TA estimation based on a preamble sent towards another candidate cell;

FIG. 43 depicts an example of source cell indication of TA of a candidate cell to a UE;

FIG. 44 depicts an example of synchronization of remaining validity time of a candidate cell's TA;

FIG. 45 depicts an example of a timing advance command medium access control (MAC) control element (CE) for a candidate cell;

FIGS. 49, 50, and 51 depict example procedures for enhancing HO request acknowledgement message signaling;

FIG. 52 depicts an example scenario of the issue when SRB3 was used for intra-source secondary node (S-SN) reconfiguration;

FIG. 53 depicts an example scenario of the issue when SRB1 has to be used for intra-S-SN reconfiguration;

FIGS. 54 and 55 depict example wireless networks;

FIG. 56 depicts example hardware resources;

FIG. 57 depicts split architecture examples; and

FIGS. 14, 23, 46, 47, and 48 depict example processes for practicing the various embodiments discussed herein.

### DETAILED DESCRIPTION

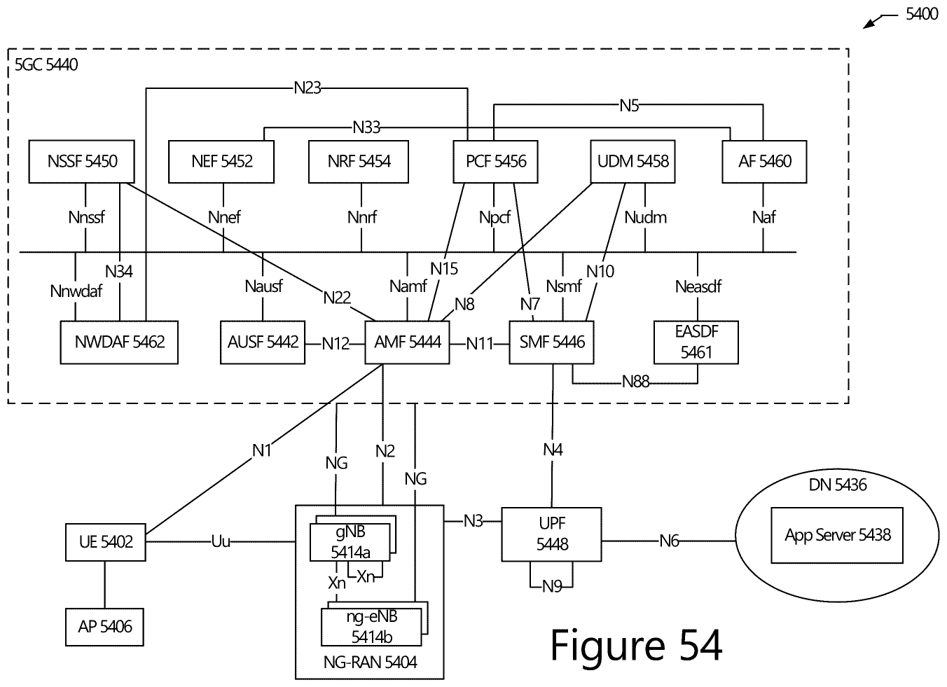

When a UE 5402 (see e.g., FIG. 54) moves from the coverage area of one cell to another cell, at some point a serving cell change needs to be performed. Currently serving cell change is triggered by layer 3 (L3) measurements and is done by RRC signalling triggered Reconfiguration with Synchronisation for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signalling, in order to reduce the latency, overhead and interruption time.

In Rel-17 Conditional PSCell change (CPC)/Conditional PSCell addition (CPA), a CPC/CPA-configured UE 5402 has to release the CPC/CPA configurations when completing random access towards the target PSCell. Hence the UE 5402 doesn't have a chance to perform subsequent CPC/CPA without prior CPC/CPA reconfiguration and re-initialization from the network. This will increase the delay for the cell change and increase the signaling overhead, especially in the case of frequent SCG changes when operating FR2. Therefore, MR-DC with selective activation of cell groups aims at enabling subsequent CPC/CPA after SCG change, without reconfiguration and re-initialization on the CPC/CPA preparation from the network. This results in a reduction of the signalling overhead and interrupting time for SCG change.

Currently, conditional handover (CHO) and MR-DC cannot be configured simultaneously. This limits the usefulness of these two features when MR-DC is configured. If it is not completed in release (Rel)-17, Rel-18 should specify mechanisms for CHO and MR-DC to be configured simultaneously. However, this alone may not be sufficient to optimise MR-DC mobility, as the radio link quality of the conditionally-configured PSCell may not be good enough or may not be the best candidate PSCell when the UE 5402 accesses the target PCell, and this may impact the UE 5402 throughput. To mitigate this throughput impact, Rel-18 CHO+MRDC can consider CHO including target MCG and multiple candidate SCGs for CPC/CPA.

3GPP document RP-221799 approved a revised work item description (WID) on further NR mobility enhancements for Rel-18. RP-221799 provides the following objectives to support L1/L2 based inter-cell mobility.

A first objective is to specify mechanism and procedures of L1/L2 based inter-cell mobility for mobility latency reduction, including: configuration and maintenance for multiple candidate cells to allow fast application of configurations for candidate cells; dynamic switch mechanism among candidate serving cells (including SpCell and SCell) for the potential applicable scenarios based on L1/L2 signalling; L1 enhancements for inter-cell beam management, including L1 measurement and reporting, and beam indication; Timing Advance management; CU-DU interface signaling to support L1/L2 mobility, if needed. Additionally, the procedure of L1/L2 based inter-cell mobility are applicable to the following scenarios: standalone, carrier aggregation (CA), and NR-NR dual connectivity (NR-DC) cases with serving cell change within one CG; intra-DU case and intra-CU inter-DU case (applicable for Standalone and CA: no new RAN interfaces are expected); both intra-frequency and inter-frequency; both frequency range one (FR1) and frequency range two (FR2); and/or source and target cells may be synchronized or non-synchronized.

A second objective is to specify mechanism and procedures of NR-DC with selective activation of the cell groups (at least for SCG) via L3 enhancements: to allow subsequent cell group change after changing CG without reconfiguration and re-initiation of CPC/CPA. A harmonized RRC modelling approach for objectives 1 and 2 could be considered to minimize the workload in RAN2. A third objective is to specify CHO including target MCG and target SCG. A fourth objective is to specify CHO including target MCG and candidate SCGs for CPC/CPA in NR-DC wherein CHO including target MCG and target SCG is used as the baseline. A fifth objective is to specify RRM core requirements for L1/L2-based inter-cell mobility and enhanced CHO configurations. A sixth objective is to specify RF requirements to cover inter-frequency L1/L2-based mobility, as necessary.

A seventh objective is to study the following, with completion targeted by RAN #98 meeting [RAN4], including: the impact of FR2 RRM mobility measurement acquisition and reporting on FR2 SCell/SCG setup/resume delay for a UE connecting from idle/inactive mode; the level of feasible improvement in FR2 SCell/SCG setup delay from defining new UE measurement procedures and RRM core requirements, and whether additional information from the network would help the UE to perform those measurements effectively. The following sequence of events should be assumed (the UE initiates and performs improved measurements when it requests RRC connection setup/resume; and/or after acquiring those improved measurements, the UE subsequently reports those measurements to the network to support SCell/SCG setup).

Based on the objectives of RP-221799, the present disclosure is related to layer 1 (L1)/layer 2 (L2) triggered mobility (LTM) aspects, including LTM inter-cell mobility, LTM in split NG-RAN architecture; dynamic cell group changes, activation, and deactivation aspects; conditional primary SCG cell (PSCell) addition or change (CPAC) aspects; early timing advance acquisition for LTM; LTM radio link monitoring (RLM) handling; LTM-related security mechanisms; CHO/CPAC aspects related to SCG configurations and RRC (re)configurations; and reference configuration aspects.

### 1. [AE6254] LAYER 1/LAYER 2 INTER-CELL MOBILITY ASPECTS

The present disclosure provides enhancements for standalone handover (HO) case wherein the L1/L2 based HO includes preconfigured candidate target Pcells and the HO is triggered by L1/L2 based signaling or L1/L2 measurement results. The present disclosure also provides enhancements for CA case, the L1/L2 based inter-cell mobility refers to the role change between PCell and SCell.

In particular, the standalone HO enhancements to support L1/L2 based HO include: an L2 measurement event/criterion is defined to identify a qualified candidate target cell; and the candidate target PCells are pre-configured, and the HO is triggered by L1/L2 signaling from network or based on L1/L2 measurement results at UE side. And the corresponding partial MAC reset is applied. The CA enhancements to support the role change between PCell and SCell include: a L2/L3 measurement event is defined, where the entering condition is related to the comparison of the radio link qualities of PCell and SCell; and the role change between PCell and SCell is triggered by a L1/L2/L3 signaling from network or based on L1/L2/L3 measurement results at UE side. And the corresponding partial MAC reset is applied. The solutions/enhancements disclosed herein can also be applicable to other cell change cases, for example, L1/L2 based PSCell change, or role change between PSCell and SCell. The solutions/enhancements disclosed herein support further mobility enhancements considering different deployment scenarios, such as intra-DU HO, and intra-CU inter-DU HO, and can reduce resource consumption and improve resource usage efficiency.

1.1. Handover (HO) Aspects

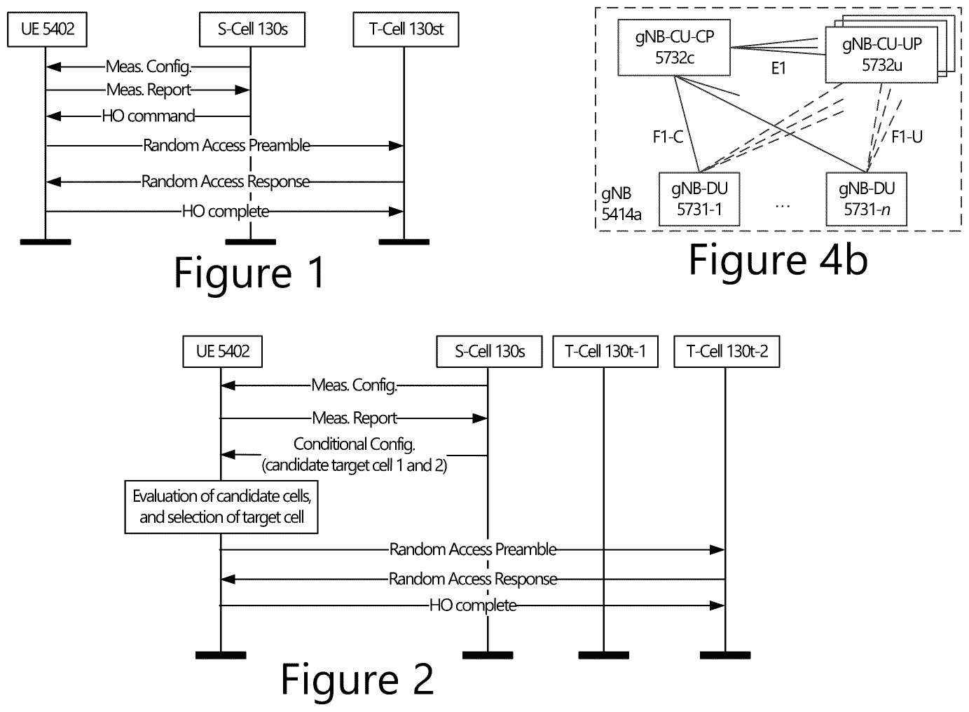

FIG. 1 shows an example HO procedure. Here, the UE 5402 receives a measurement (meas) configuration (config) from a source cell (S-Cell) 130s, performs neighbor cell measurements according to the measurement configuration, and sends a measurement report to the network (e.g., S-Cell 130s) when the entry condition of at least one measurement event is met. Then S-Cell 130s sends an HO command to the UE 5402, and UE 5402 performs random access channel (RACH) procedure to get access to target cell (T-Cell) 130t, which includes sending a random access (RA) preamble to the T-Cell 130t, and receiving an RA response from the T-Cell 130t. The UE 5402 then sends an HO complete message to T-Cell 130t. In NR, the HO command is a RRCReconfiguration message in which the masterCellGroup field includes the reconfigurationWithSync field, and the HO complete message is RRCReconfigurationComplete message. Since they are both Layer 3 messages, the legacy HO could also be called L3 signaling based HO.

FIG. 2 shows an example conditional HO (CHO) procedure. In CHO, to avoid late transmission (Tx) of an HO command, the candidate target cells (e.g., T-Cell 130t-1 and T-Cell 130t-2 in FIG. 2) and the corresponding execution conditions can be configured to UE 5402 in advance. And when an entry condition of at least one measurement event is met (e.g., the CHO execution condition is met), the UE 5402 initiates the execution of conditional reconfiguration for the T-Cell 130t (e.g., T-Cell 130t-2 in this example) by performing the RACH procedure and sending a RRCReconfigurationComplete message to T-Cell 130t. Meanwhile, multiple candidate target cells can be configured to the UE 5402, and the UE 5402 can select one target cell among them (e.g., more than one candidate target cells are configured) when the corresponding measurement event for this candidate cell is triggered.

1.2. Carrier Aggregation (CA) Aspects

In Carrier Aggregation (CA), two or more Component Carriers (CCs) are aggregated. A UE 5402 may simultaneously receive or transmit on one or multiple CCs depending on its capabilities. For example, a UE 5402 with single timing advance (TA) capability for CA can simultaneously receive and/or transmit on multiple CCs corresponding to multiple serving cells sharing the same TA (multiple serving cells grouped in one timing advance group (TAG)); a UE 5402 with multiple timing advance capability for CA can simultaneously receive and/or transmit on multiple CCs corresponding to multiple serving cells with different timing advances (multiple serving cells grouped in multiple TAGs). NG-RAN ensures that each TAG contains at least one serving cell; and a non-CA capable UE 5402 can receive on a single CC and transmit on a single CC corresponding to one serving cell only (one serving cell in one TAG).

CA is supported for both contiguous and non-contiguous CCs. When CA is deployed frame timing and SFN are aligned across cells that can be aggregated, or an offset in multiples of slots between the PCell/PSCell and an SCell is configured to the UE. The maximum number of configured CCs for a UE 5402 is 16 for DL and 16 for UL.

CA can also involve a primary cells (PCell), primary secondary cell group (SCG) cells (PSCell), serving cells, secondary cells, and special cells.

A PCell is a master cell group (MCG) cell, operating on the primary frequency, in which the UE 5402 either performs the initial connection establishment procedure or initiates the connection re-establishment procedure. A PSCell, for dual connectivity operation, the SCG cell in which the UE 5402 performs random access when performing the Reconfiguration with Sync procedure.

A serving cell, for a UE 5402 in RRC_CONNECTED not configured with CA/DC there is only one serving cell comprising of the primary cell. For a UE 5402 in RRC_CONNECTED configured with CA/DC the term ‘serving cells’ is used to denote the set of cells comprising of the Special Cell(s) and all secondary cells. A secondary cell, for a UE 5402 configured with CA, a cell providing additional radio resources on top of special cell. A special cell, for Dual Connectivity operation the term Special Cell refers to the PCell of the MCG or the PSCell of the SCG, otherwise the term Special Cell refers to the PCell.

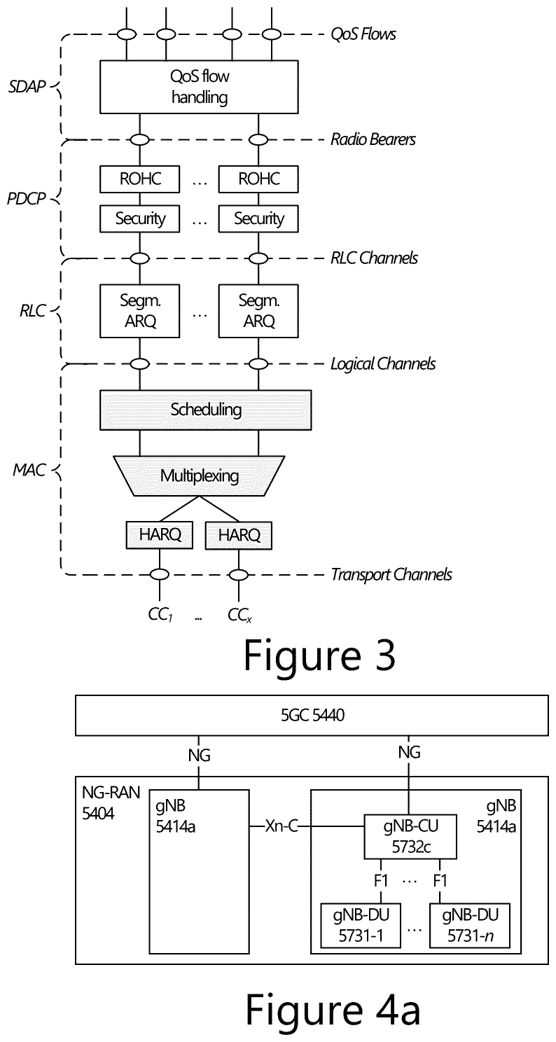

FIG. 3 shows an example L2 structure for UL with CA configured. In case of CA, the multi-carrier nature of the physical layer is only exposed to the MAC layer for which one HARQ entity is required per serving cell. In both uplink and downlink, there is one independent hybrid-ARQ entity per serving cell and one transport block is generated per assignment/grant per serving cell in the absence of spatial multiplexing. Each transport block and its potential HARQ retransmissions are mapped to a single serving cell. Additional aspects of each protocol layer in FIG. 3 (e.g., the SDAP layer, PDCP layer, RLC layer, and MAC layer) are discussed in [TS37324], [TS38323], [TS38322], and [TS38321].

1.3. CU-DU Split Architecture Aspects

An example NG-RAN architecture is depicted by FIG. 4a, and the overall architecture for separation of gNB-CU-control plane (CP) 5732c and gNB-CU-user plane (UP) 5732u is depicted by FIG. 4b. The NG-RAN 5404 includes a set of gNBs 5414a, each of which is connected to the 5GC 5440 through respective NG interfaces.

The 5G gNB can be divided into two physical entities, a centralized unit (CU) 5732 and a set of distributed units (DUs) 5731. A gNB 5414a can include a gNB-CU 5732 and one or more gNB-DU(s) 5731 (e.g., gNB-DU(s) 5731-1 to 5731-n, where n is a number). A gNB-CU 5732 is connected to an individual gNB-DU 5731 via an F1 interface. In some implementations, one gNB-DU 5731 is connected to only one gNB-CU 5732. In other implementations, for resiliency, a gNB-DU 5731 may be connected to multiple gNB-CUs 5732 by appropriate implementation. In case of network sharing with multiple cell identities (IDs) broadcast, each cell ID associated with a subset of PLMNs corresponds to a gNB-DU 5731 and the gNB-CU 5732 it is connected to (e.g., the corresponding gNB-DUs 5731 share the same physical layer cell resources).

As specified in 3GPP TS 38.300 v17.5.0 (2023 Jun. 30) (“[TS38300]”), the NG-RAN 5404 could also include a set of ng-eNBs 5414b, where each ng-eNB 5414b can include an ng-eNB-CU 5732 and one or more ng-eNB-DU(s) 5731. An ng-eNB-CU 5732 and an ng-eNB-DU 5731 are connected via W1 interface. The principles described herein with respect to (w.r.t) the gNB-CU 5732, gNB-DUs 5731, and F1 interface also apply to ng-eNB-CU 5732, ng-eNB-DU(s) 5731, and W1 interface, unless explicitly specified otherwise.

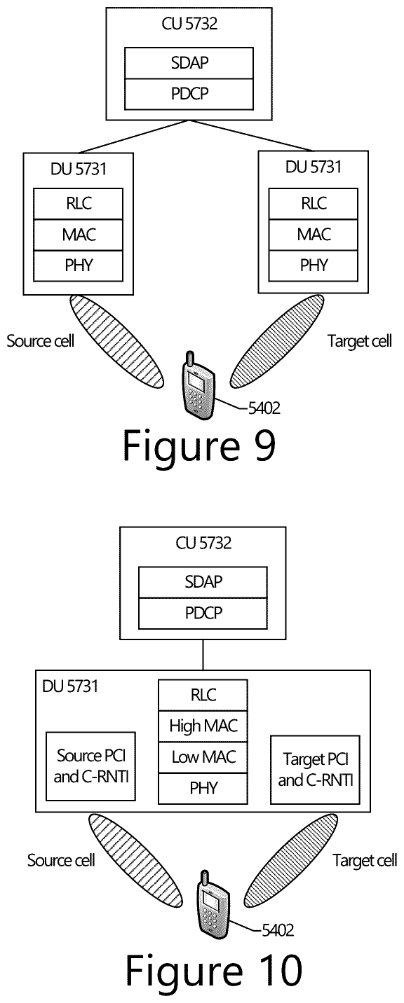

In some implementations, the CU 5732 provides support for the higher layers of the protocol stack (e.g., SDAP, PDCP, and RRC) while the DU 5731 provides support for the lower layers of the protocol stack (e.g., RLC, MAC, and PHY) (see e.g., FIGS. 9, 10, 11, and 57). An example deployment includes a single CU 5732 for each gNB 5414a, but one CU 5732 can control multiple DUs 5731, for example, two DUs 5731 can be connected to one CU 5732. Each DU 5731 is able to support one or more cells, so one gNB 5414a can control several cells. In some examples, a gNB 5414a can support FDD mode, TDD mode, or dual mode operation. Additionally, individual gNBs 5414a can be interconnected to one another through the Xn interface (e.g., the Xn control plane (Xn-C) interface in FIG. 4a).

The NG interface, Xn interface, and F1 interface are logical interfaces. For NG-RAN 5404, the NG and Xn-C interfaces for a gNB 5414a including a gNB-CU 5732 and gNB-DUs 5731, terminate in the gNB-CU 5732. For EN-DC, the S1-U and X2-C interfaces for a gNB 5414a including a gNB-CU 5732 and gNB-DUs 5731, terminate in the gNB-CU 5732. The gNB-CU 5732 and connected gNB-DUs 5731 are only visible to other gNBs 5414a and the 5GC 5440 as a gNB 5414a. A possible deployment scenario is described in Annex A of [TS38401].

The node hosting user plane part of NR PDCP (e.g., gNB-CU 5732, gNB-CU-UP 5732u, and for EN-DC, MeNB or SgNB depending on the bearer split) perform user inactivity monitoring and further informs its inactivity or (re)activation to the node having control plane (CP) connection towards the core network (e.g., over E1, X2 interfaces). The node hosting NR RLC (e.g., gNB-DU 5731) may perform user inactivity monitoring and further inform its inactivity or (re)activation to the node hosting control plane (e.g., gNB-CU 5732 or gNB-CU-CP 5732c). A UL PDCP configuration (e.g., how the UE 5402 uses the UL at the assisting node) is indicated via X2-C (for EN-DC), Xn-C (for NG-RAN) and F1-C. Radio Link Outage/Resume for DL and/or UL is indicated via X2-U (for EN-DC), Xn-U (for NG-RAN) and F1-U.

The NG-RAN 5404 is layered into a radio network layer (RNL) and a transport network layer (TNL). The NG-RAN architecture (e.g., the NG-RAN 5404 logical nodes and interfaces between them) is/are defined as part of the RNL.

For each NG-RAN interface (e.g., NG, Xn, F1) the related TNL protocol and the functionality are specified. The TNL provides services for user plane transport, signalling transport. In NG-Flex configurations, each NG-RAN node is connected to all AMFs of AMF Sets within an AMF Region supporting at least one slice also supported by the NG-RAN node. The AMF Set and the AMF Region are defined in [TS23501]. If security protection for control plane and user plane data on TNL of NG-RAN interfaces has to be supported, NDS/IP (see e.g., [TS33501]) is applied.

As shown by FIG. 4b, a gNB 5414a can include a gNB-CU-CP 5732c, multiple gNB-CU-UPs 5732u, and multiple gNB-DUs 5731; the gNB-CU-CP 5732c is connected to the gNB-DU through the F1-C interface; the gNB-CU-UP 5732u is connected to the gNB-DU 5731 through the F1-U interface; the gNB-CU-UP 5732u is connected to the gNB-CU-CP 5732c through the E1 interface; one gNB-DU 5731 is connected to only one gNB-CU-CP 5732c; and one gNB-CU-UP 5732u is connected to only one gNB-CU-CP 5732c. In some examples, one gNB-DU 5731 can be connected to multiple gNB-CU-UPs 5732u under the control of the same gNB-CU-CP 5732c. Additionally or alternatively, one gNB-CU-UP 5732u can be connected to multiple DUs 5731 under the control of the same gNB-CU-CP 5732c. Other configurations and arrangements of gNB-CU-CPs 5732c, gNB-CU-UPs 5732u, and gNB-DUs 5731 are possible in other implementations. For example, a gNB-DU 5731 and/or a gNB-CU-UP 5732u may be connected to multiple gNB-CU-CPs 5732c by appropriate implementation and/or for resiliency.

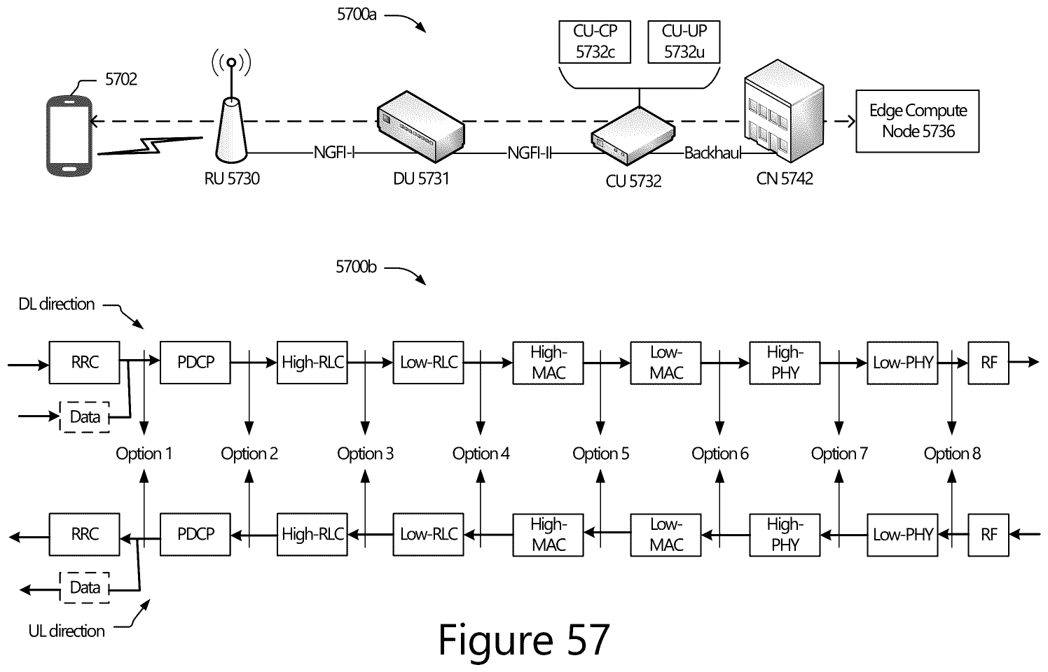

The connectivity between a gNB-CU-UP 5732u and a gNB-DU 5731 is established by the gNB-CU-CP using bearer context management functions. In some implementations, the gNB-CU-CP 5732c selects the appropriate gNB-CU-UP(s) 5732u for the requested services for the UE 5402. In case of multiple CU-UPs 5732u, they belong to same security domain as defined in 3GPP TS 33.210. Data forwarding between gNB-CU-UPs 5732u during intra-gNB-CU-CP 5732c HO within a gNB 5414a may be supported by Xn-user plane (Xn-U) (not shown by FIGS. 1.4a, 1.4b). In some examples, it is up to network implementation whether to split the gNB 5414a by CU-DU split or not. Additional aspects of CU-DU split architecture is shown by FIG. 57 and discussed in more detail infra.

1.4. Standalone Ho and Cell Change Enhancements

1.4.1. Enhancement 1

The first enhancement includes an L2 measurement event/criterion that is defined to identify a qualified candidate target cell. In legacy HO, the L3 measurement events are defined to compare the radio qualities of cells. For example, event A3 is triggered/reported when the Neighbor becomes offset better than SpCell, then a HO may be performed towards this neighbor cell. The cell radio quality is the derived by averaging the measurement results of cell beams, and L3 filtering is applied, which introduces some extra delay for HO.

At least for intra-DU HO cases, the DU 5731 may be responsible to manage this inter-cell mobility procedure. An L2 measurement event/criterion may be needed to accelerate the HO procedure. That is, the UE 5402 can provide measurement reporting or indication of switching to a certain target cell among configured candidate target cells based on L2 measurement event/criterion procedure. This measurement reporting or indication can be signaled over MAC CE (Control Element) or PHY layer signaling (e.g., uplink control information (UCI)).

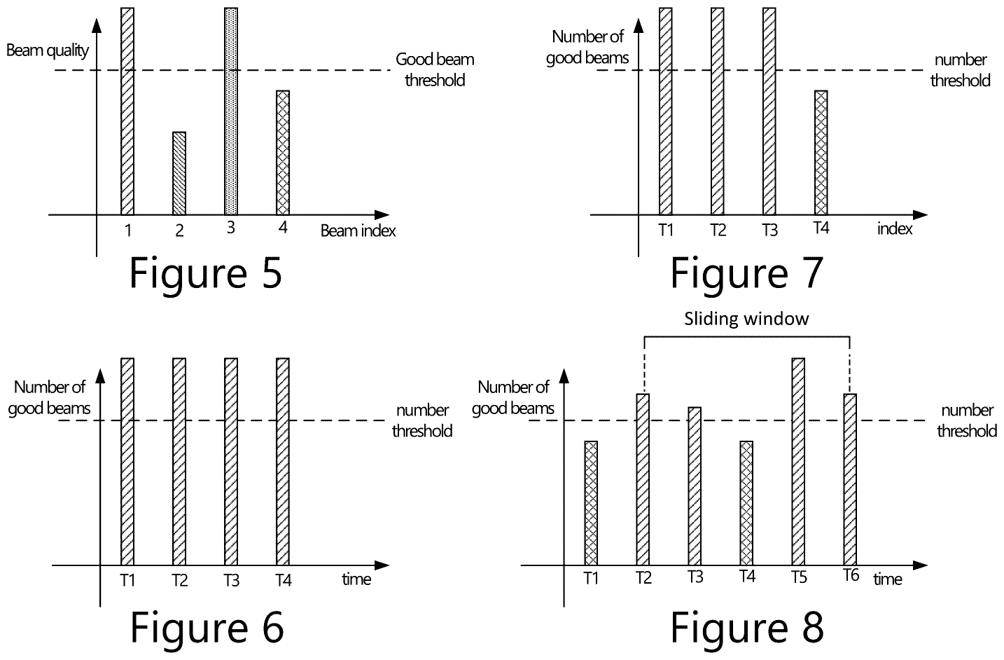

In a first option (Option 1), a UE 5402 counts the good beams of a candidate cell, for example, the number of good beams is better than a threshold X for consecutive N times, and/or for N times within a period of time (where X and N are numbers). Here, the physical layer (PHY) provides L1 beam measurement results, for example, based on the SSB measurement. The beam quality is derived in a periodical way, and the beam quality is also reported to MAC layer from physical layer periodically. A threshold Z1 can be configured by network (e.g., a RRC parameter or a MAC parameter), and the beams whose beam quality is better than this threshold Z1 is considered as a good/qualified beam. FIG. 5 shows an example graph of threshold(s) for good beams. As illustrated in FIG. 5, beam 1 and beam 3 are good beams as their qualities are above the threshold, and the number of good beams in this period is 2. When the PHY reports/updates the beam qualities, the MAC entity can count how many good beams there are for a candidate cell. There are several criteria for a UE 5402 to determine whether this candidate cell is qualified.
Criterion 1: the number of good beams is better than a threshold X in consecutive N times. The threshold X and N are configured by network. For example, MAC entity gets the beam qualities from physical layer in a periodical way, and N=4. FIG. 6 shows an example graph of when criterion 1 is met. As illustrated in FIG. 6, the number of good beams is above the threshold X for consecutive 4 times, so the criterion 1 is met. FIG. 7 shows an example graph of when criterion 1 is not met. As illustrated in FIG. 7, there is consecutive 3 times, but at T4 the number of good beams is lower than the threshold, so the criterion 1 is not met.
Criterion 2: the number of good beams is better than a threshold X for N times within a period of time. The threshold X and N, and time length are configured by network. This period of time can be managed by a timer, for example, when the number of good beams is better than a threshold X and the timer is not running, the timer is started. When the timer expires, if the number of good beams is better than a threshold X for N times, the candidate cell is qualified. It's also possible that every time the number of good beams is available, a UE 5402 checks during the time length whether there have been N times where the number of good beams is better than a threshold X. It's like a sliding window, when the L1 beam qualities are available the sliding window moves forward. For example, assume N=4 and the length of sliding window is 5 times of L1 reporting periodicity. FIG. 8 shows an example sliding window of criterion 2. As illustrated in FIG. 8, at T5 within this sliding window there are 3 times when the number of good beams is above the threshold. But at T6, the criterion 2 is met, and the corresponding candidate cell is qualified. An additional or alternative approach is the last N beams>X instead of a timer. They can be configured to produce the same result but easier to implement without a timer. A UE 5402 only tracks the last N beams in this case. An additional or alternative variation can be last M beams if at least N beams>X.

In a second option (Option 2), a UE 5402 compares the numbers of good beams of current serving cell and candidate cell. Besides of the number of good beams of candidate cells, the number of good beams of current serving cell can also be used for comparison. It's possible to configure a different threshold Z2 for serving cell, which means the criterion of good beam for serving cell is that the beam whose beam quality is better than this threshold Z2 is considered as a good/qualified beam. And it's up to network whether to set the same val UE 5402 for both threshold Z1 for candidate cells and threshold Z2 for serving cell.

When the numbers of good beams are available (e.g., based on L1 reporting) for both serving cell and candidate cells, the UE 5402 can compare them. The criterion can be whether a candidate cell's good beams are offset more than that of current serving cell. And a UE 5402 can check if this criterion has been met in consecutive N times, or for N times within a period of time. The detail is same as option 1.

In a third option (Option 3), a UE 5402 checks how many times that a candidate cell's quality is offset better than current serving cell. In legacy measurement, the cell quality is derived by averaging the beam qualities of a cell, and it's L3 filtered. In MAC layer, the cell quality can be used directly without L3 filtering. For example, A UE 5402 calculates the cell qualities of current serving cell and candidate cells upon the beam qualities are updated by physical layer, and the criterion is whether a candidate cell's quality is offset better than that of current serving cell. And a UE 5402 can check if this criterion has been met in consecutive N times, or for N times within a period of time. The details for this option are the same or similar as option 1.

According to the three aforementioned options, a candidate cell can be determined by UE 5402 as a qualified candidate cell, then a MAC CE can include the cell ID or cell index or config ID of it, and sent it to network by UE. After receiving this MAC CE, the subsequent HO can be triggered by network. Alternatively, the UE 5402 can switch to the target cell upon sending the MAC CE information if forward HO mechanism is supported e.g. without UE 5402 based HO rather than network controlled HO.

1.4.2. Enhancement 2

In this enhancement, the candidate target PCells are pre-configured, and the HO is triggered by L1/L2 signaling from network or based on L1/L2 measurement results at UE 5402 side.

1.4.2.1. Protocol Stack Related UE Behaviors

Similar to CHO, the candidate target cells for HO are configured to UE 5402 in advance. Depending on the different CU-DU split cases, some protocol stack related UE 5402 behaviors are also different.

1.4.2.1.1. Intra-CU Inter-DU Case

FIG. 9 shows an example intra-CU inter-DU case. In this case, the current serving cell (which may correspond to the S-Cell 130s discussed previously) and the candidate cells (which may correspond to the T-Cells 130t discussed previously) share the same CU yr32, which may implement, for example, shared SDAP and PDCP protocol stacks. If there is no change of the AS security algorithms associated to the master key, there is no need to update the master key (e.g., the Next Hop Chaining Counter parameter (NCC) value is not changed). Then PDCP re-establishment is also not needed, which could save some interruption time. But since it's an inter-DU HO, which means the RLC, MAC, PHY layer need to be handled by another DU 5731. This means the RLC layer should be reestablished, and the MAC layer should be reset. To align with RLC re-establishment, the PDCP layer also needs to perform PDCP data recovery. The PDCP recovery can be indicated by “recoverPDCP” in [TS38331] or the like, and the RLC re-establishment can be indicated by “reestablishRLC” in [TS38331] or the like. Currently, “reset MAC” is a default UE 5402 behavior upon HO. From a protocol stack point of view, current mechanism can work to support intra-CU inter-DU HO case. However, if a DCI and/or MAC CE is used as an HO command, then the UE 5402 may need to do PDCP/RLC/MAC related operations autonomously without explicit indications, which may require network to indicate the HO type (e.g., this HO is an intra-CU inter-DU HO).

1.4.2.1.2. Intra-DU Case

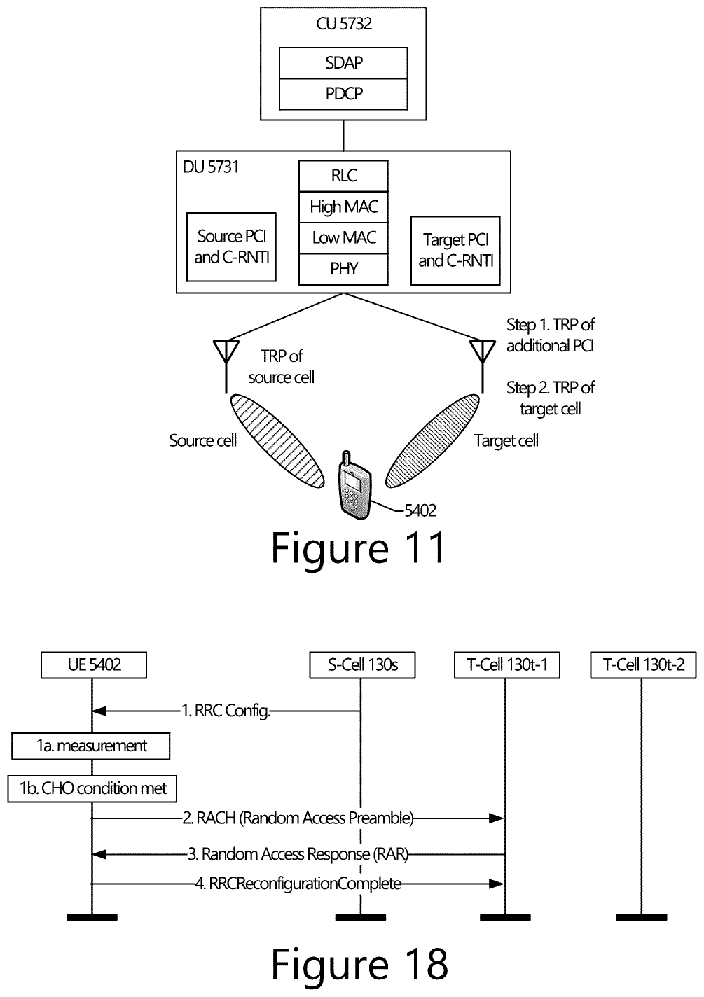

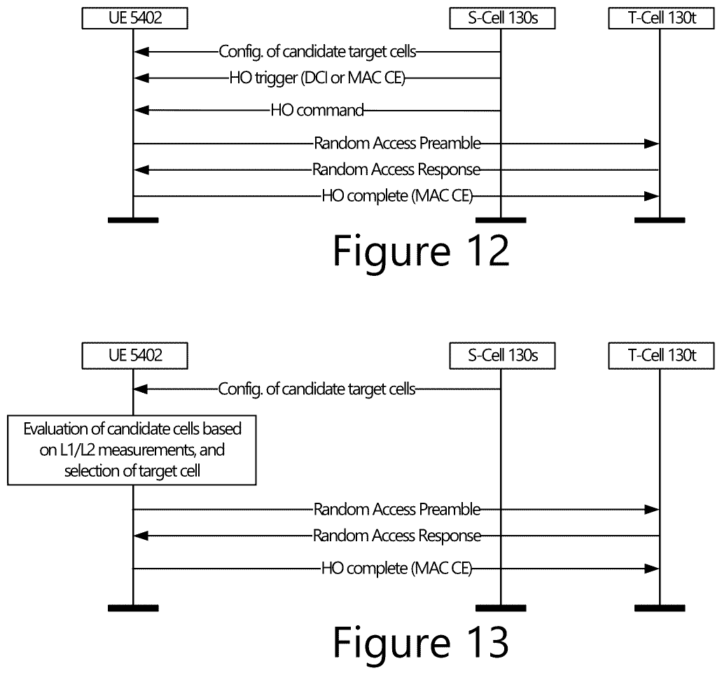

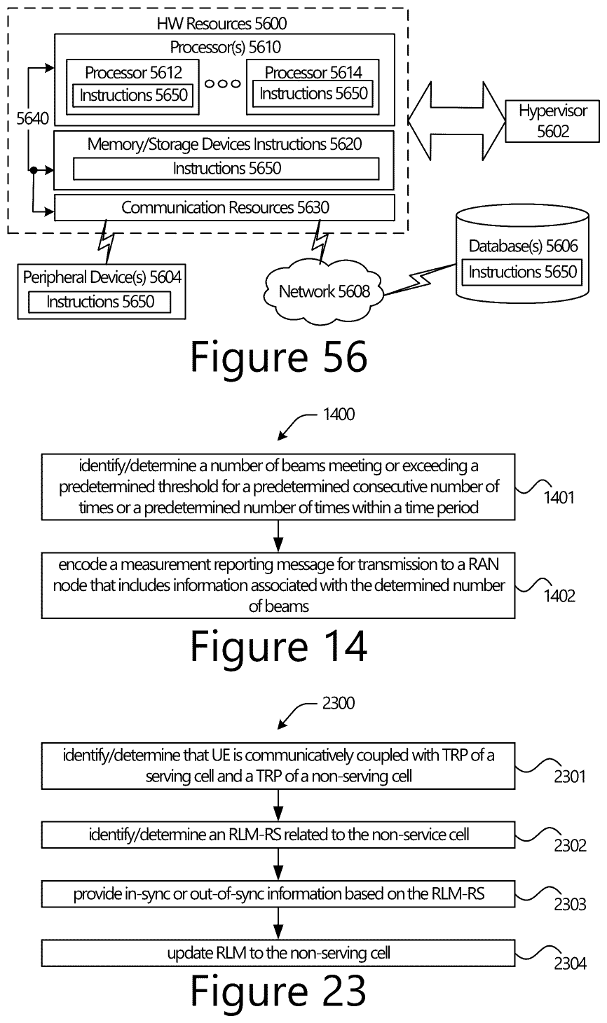

FIG. 10 shows an example intra-DU case. In this case, the current serving cell (which may correspond to the S-Cell 130s discussed previously) and the candidate cells cells (which may correspond to the T-Cells 130t discussed previously) share the same CU yr32 and DU 5731 (e.g., the same SDAP, PDCP, RLC, and MAC protocol stacks can be shared). For physical layers (e.g., physical channels), it is also possible to reuse the same configurations after HO, or reconfiguration is performed. Compared to legacy HO, the UE 5402 does not need to reset MAC and/or may only need to do a partial MAC reset. For example, in the example of FIG. 10, only the low MAC part needs to be reset, as it's related to physical layer. In some examples, a separate indication is used to indicate no MAC reset or a partial MAC reset.

Since during an HO, the UE 5402 needs to access a new cell, and the physical cell identity (PCI) and cell radio network temporary identifier (C-RNTI) are changed. At least some physical layer related (e.g., RACH, HARQ and physical layer measurements (e.g., beam failure detection, and power headroom reporting (PHR))) procedure/counter/timer need to be reset. And, logical channel Bⱼ value, triggered BSR in MAC layer (e.g., the high MAC part) can be maintained. For example, the UE 5402 behaviors of table 1.4.2.1.2-1 can be used for the partial MAC reset for intra-DU HO. See also sections 8.2.4.2, 8.4.18, and 8.4.19 infra.

TABLE 1.4.2.1.2-1
5.12b MAC Reset for intra-DU handover
If a reset of the MAC entity is requested by upper layers for intra-DU handover, the MAC
entity shall:
1> stop (if running) all timers;
1> consider all timeAlignmentTimers, inactivePosSRS-TimeAlignmentTimer, and cg-SDT-
TimeAlignmentTimer, if configured, as expired and perform the corresponding actions
in clause 5.2 of [TS38321];
1> set the NDIs for all uplink HARQ processes to the value 0;
1> stop, if any, ongoing Random Access procedure;
1> discard explicitly signalled contention-free Random Access Resources for 4-step RA
type and 2-step RA type, if any;
1> flush Msg3 buffer;
1> flush MSGA buffer;
1> cancel, if any, triggered Power Headroom Reporting procedure;
1> cancel, if any, triggered BFR;
1> cancel, if any, triggered Timing Advance Reporting procedure;
1> cancel, if any, triggered Configured uplink grant confirmation;
1> flush the soft buffers for all DL HARQ processes;
1> for each DL HARQ process, consider the next received transmission for a TB as the
very first transmission;
1> release, if any, Temporary C-RNTI;
1> reset all BFI_COUNTERS;

FIG. 11 shows an example intra-DU handover to an additional PCI. A special case of intra-DU handover is that the UE 5402 already receives PDSCH from a TRP associated to an additional PCI (different from current serving cell's PCI), as illustrated in FIG. 11. When the UE 5402 handovers to this target cell (with the additional PCI), even less MAC reset operations are needed. For example, the TA timer can be maintained as the UE 5402 doesn't need to re-perform uplink synchronization, and the NDIs of uplink HARQ processes and the DL HARQ buffers can also be maintained.

1.5. Triggering HO

Regarding the triggering HO, the trigger could be L1/L2 signaling from the network (e.g., RAN node or the like), which may take place, for example, after an L3 measurement report, an L2 measurement event is notified by UE 5402), and/or based on L1, L2, and/or L3 measurement results at the UE 5402. No matter how the HO is triggered, the protocol stack related operations of PDCP/RLC/MAC can be specified as UE behavior(s) or separate indications/configurations (e.g., for PDCP recovery/re-establishment, or for RLC re-establishment, or for (partial) MAC reset) can be included in the RRC configuration of the candidate cell(s).

1.5.1.1. Trigger Ho Based on L1/L2 Signaling from the Network

FIG. 12 shows an example procedure of intra-DU HO based on L1/L2 signaling. Here, the S-Cell 130s configures the UE 5402 with a set of candidate target cells, and then triggers the HO based on L1/L2 signaling from the NW, for example, by sending a downlink control information (DCI) in PHY layer and/or a MAC CE in MAC layer.

When DCI is used to trigger HO, there is no existing acknowledgement from UE 5402 about whether this DCI is received successfully. Here, the UE 5402 can send a MAC CE for this confirmation (e.g., HO complete MAC CE in FIG. 12). If the HO command is a MAC CE, the UE 5402 can send HARQ ACK to network to confirm successful reception. When only one candidate cell is configured as target candidate PCell, the HO command can be one bit DCI or a MAC CE with only a MAC header and/or without a MAC CE payload. When there are multiple candidate cells, the candidate cell ID is indicated in the DCI or MAC CE payload. Whether an HO is needed may depend on the measurement results the UE 5402 reports to source cell (e.g., according to the existing measurement event indicated by the measurement configuration). It is also possible to apply the new L2 measurement reporting as described in Enhancement 1 mentioned previously.

As a part of legacy HO execution, the UE 5402 can send an RRCReconfigurationComplete message to the T-Cell 130t. But in intra-DU case, it is possible that only the MAC layer needs to be partially reset and other layers can be maintained. A feasible way to indicate a successful intra-DU HO is to send a MAC CE to the T-Cell 130t. For intra-CU inter-DU handover, the legacy procedure can still apply.

Regarding how the UE 5402 can determine whether this is an intra-DU HO or an intra-CU inter-DU HO, there could be an indication for this partial MAC reset operation separately. When this field exists as part of the configuration of a candidate cell, a UE 5402 can determine partial MAC reset is needed as part of this handover. In some examples, another explicit indication (e.g., handover type) can be used to indicate this is an intra-DU handover or an intra-CU inter-DU handover. The intra-DU handover based on L1/L2 signaling is illustrated by FIG. 12.

1.5.1.2. Trigger HO Based on L1/L2/L3 Measurement Results at UE Side

FIG. 13 shows an example procedure for intra-DU HO based on L1/L2 measurements. Here, the HO is triggered based on L1, L2, and/or L3 measurement results from the UE 5402. In legacy CHO, an execution condition is configured for each candidate cell, and this execution condition is associated with L3 measurement event A3 and/or event A5. When the entering condition of event A3 and/or A5 are met, this means the execution condition of this candidate cell is met, then a CHO execution is triggered. Similarly, if the HO is triggered based on L1/L2 measurement results, the corresponding execution should also be configured for each candidate cell. If the execution condition is associated with L1 measurement, at least a threshold for measurement quantity should be configured. When the L1 measurement result is more than the threshold, an HO towards the corresponding candidate cell can be triggered. If the execution condition is associated with L2 measurement results (e.g., the criteria described in Enhancement 1), the corresponding parameters should be configured. An example procedure for intra-DU handover based on L1/L2 measurements is illustrated in FIG. 13.

1.6. CA and Role Change Between PCell and SCell Enhancements

1.6.1. Enhancement 1

In some examples, an L2/L3 measurement event is defined, where the entering condition is to compare the radio link qualities of PCell and SCell. In legacy L3 measurement event Ax, the entering conditions are normally comparison of radio link qualities between serving cell and neighbor cells, or to check if the serving cell or neighbor cell's quality is better than a threshold. To support role change between PCell and SCell, a new L3 measurement event could be defined, so that when the SCell's quality is offset better than the PCell's quality, a measurement report can be sent to network. Examples of this new L3 measurement event are shown by table 1.6.1-1 (e.g., event Ax and Ay).

TABLE 1.6.1-1
1. Event Ax (SCell becomes offset better than SpCell)
The UE shall:
1> consider the entering condition for this event to be satisfied when condition Ax-1,
as specified below, is fulfilled;
1> consider the leaving condition for this event to be satisfied when condition Ax-2, as
specified below, is fulfilled;
1> use the SpCell for Mp, Ofp and Ocp.
NOTE 1: The cell (s) that triggers the event has reference signals indicated in the
measObjectNR associated to this event which may be different from the NR SpCell
measObjectNR.
Inequality Ax-1 (Entering condition)
Mn + Ofn + Ocn − Hys > Mp + Ofp + Ocp + Off
Inequality Ax-2 (Leaving condition)
Mn + Ofn + Ocn + Hys < Mp + Ofp + Ocp + Off
The variables in the formula are defined as follows:
Mn is the measurement result of the SCell, not taking into account any offsets.
Ofn is the measurement object specific offset of the reference signal of the SCell
(e.g., offsetMO as defined within measObjectNR corresponding to the SCell).
Ocn is the cell specific offset of the SCell (e.g., cellIndividualOffset as defined
within measObjectNR corresponding to the frequency of the SCell), and set to zero if
not configured for the SCell.
Mp is the measurement result of the SpCell, not taking into account any offsets.
Ofp is the measurement object specific offset of the SpCell (e.g., offsetMO as defined
within measObjectNR corresponding to the SpCell).
Ocp is the cell specific offset of the SpCell (e.g., cellIndividualOffset as defined
within measObjectNR corresponding to the SpCell) , and is set to zero if not
configured for the SpCell.
Hys is the hysteresis parameter for this event (e.g., hysteresis as defined within
reportConfigNR for this event).
Off is the offset parameter for this event (e.g., ax-Offset as defined within
reportConfigNR for this event).
Mn, Mp are expressed in dBm in case of RSRP, or in dB in case of RSRQ and RS-SINR.
Ofn, Ocn, Ofp, Ocp, Hys, Off are expressed in dB.
2. Event Ay (SpCell becomes worse than threshold1 and SCell becomes better than
threshold2)
The UE shall:
1> consider the entering condition for this event to be satisfied when both condition
Ay-1 and condition Ay-2, as specified below, are fulfilled;
1> consider the leaving condition for this event to be satisfied when condition Ay-3 or
condition Ay-4, e.g. at least one of the two, as specified below, is fulfilled;
1> use the SpCell for Mp.
NOTE 1: The parameters of the reference signal (s) of the cell (s) that triggers the
event are indicated in the measObjectNR associated to the event which may be
different from the measObjectNR of the NR SpCell.
Inequality Ay-1 (Entering condition 1)
Mp + Hys < Thresh1
Inequality Ay-2 (Entering condition 2)
Mn + Ofn + Ocn − Hys > Thresh2
Inequality Ay-3 (Leaving condition 1)
Mp − Hys > Thresh1
Inequality Ay-4 (Leaving condition 2)
Mn + Ofn + Ocn + Hys < Thresh2
The variables in the formula are defined as follows:
Mp is the measurement result of the NR SpCell, not taking into account any offsets.
Mn is the measurement result of the SCell, not taking into account any offsets.
Ofn is the measurement object specific offset of the SCell (e.g., offsetMO as defined
within measObjectNR corresponding to the SCell).
Ocn is the cell specific offset of the SCcell (e.g., cellIndividualOffset as defined
within measObjectNR corresponding to the SCell), and set to zero if not configured
for the SCell.
Hys is the hysteresis parameter for this event (e.g., hysteresis as defined within
reportConfigNR for this event).
Thresh1 is the threshold parameter for this event (e.g., ay-Threshold as defined
within reportConfigNR for this event).
Thresh2 is the threshold parameter for this event (e.g., ay-Threshold2 as defined
within reportConfigNR for this event).
Mn, Mp are expressed in dBm in case of RSRP, or in dB in case of RSRQ and RS-SINR.
Ofn, Ocn, Hys are expressed in dB.
Thresh1is expressed in the same unit as Mp.
Thresh2 is expressed in the same unit as Mn.

For L2 measurement reporting, the enhancement 1 of embodiment 1 can be reused, for example, consider SCell is also a candidate cell for handover.

1.6.2. Enhancement 2

In some examples, a role change between PCell and SCell is triggered by a L1/L2/L3 signaling from network or based on L1/L2/L3 measurement results at the UE 5402. As legacy HO, the target cell is usually a neighbor cell, e.g., the target cell is not a serving cell of UE 5402 before the handover. But for role change between PCell and SCell, it means the target cell is a SCell which already serves UE. For the network perspective, the network will have to provide which SCell(s) to activate after the PCell handover. For the UE 5402 autonomous HO, the UE 5402 has to indicate which SCell(s) that it wants to activate after the PCell switch.

There are several differences between PCell and SCell: (1) a SCell can be deactivated, while PCell cannot; (2) the ServCellIndex is set to 0 for PCell, while it's used in cross carrier scheduling; (3) the PCell and SCell may belong to different TAG (e.g., PTAG and STAG, which correspond to different UE processing when the TA timer expires); and/or different BFR processing for PCell and SCell. Since they are mainly about physical layer configuration, the physical layer reconfiguration is necessary for role change between PCell and SCell. But from MAC perspective, the MAC reset processing can be reduced as shown by table 1.6.2-1 (e.g., RACH and BFR related reset are still needed while logical channel and HARQ buffers can be maintained). See also sections 8.2.4.2, 8.4.18, and 8.4.19 infra.

TABLE 1.6.2-1
5.12c MAC Reset for role change between PCell and SCell
If a reset of the MAC entity is requested by upper layers, the MAC entity
shall:
1> stop timeAlignmentTimers if PCell and SCell belong to different TAGs;
1> stop, if any, ongoing Random Access procedure;
1> discard explicitly signalled contention-free Random Access Resources
for 4-step RA type and 2-step RA type, if any;
1> flush Msg3 buffer;
1> flush MSGA buffer;
1> cancel, if any, triggered BFR;
1> release, if any, Temporary C-RNTI;
1> reset all BFI_COUNTERS;

The trigger of role change could be the same design as in enhancement 2 of embodiment 2. For example, if it's based on L1/L2/L3 signaling, a DCI or MAC CE or RRC message can be sent to UE 5402 from source cell (e.g., PCell in this case) to indicate a role change between PCell and SCell. Then the UE 5402 replies a MAC CE or RRC message to target cell (e.g., previous SCell) to indicate this role change is complete. If this trigger is based on the L2/L3 measurement results, the design could be the same as the way to trigger a handover in enhancement 2 of embodiment 2.

1.7. Example Implementations

FIG. 14 shows an example process 1400, which is performed by a UE 5402. However, it should be noted that process 1400 can be performed by any of the electronic device(s), network(s), system(s), chip(s) or component(s), or portions or implementations thereof, of FIGS. 54-57, or some other figure discussed herein. Process 1400 begins at operation 1401 where the UE 5402 identifies and/or determines a number of beams meeting or exceeding a predetermined threshold for a predetermined consecutive number of times or a predetermined number of times within a time period. At operation 1402, the UE 5402 encodes a measurement reporting message for Tx to a RAN node (e.g., gNB 5414a and/or the like) that includes information associated with the determined number of beams.

### 2. [AE6293] DYNAMIC CELL GROUP CHANGE, ACTIVATION, AND/OR DEACTIVATION ASPECTS

As mentioned previously, RP-221799 was approved to specify mechanisms and procedures of NR-DC with selective activation of cell groups (at least for SCG) via L3 enhancements including: to allow subsequent cell group change after changing CG without reconfiguration and re-initiation of CPC/CPA; and a harmonized RRC modelling approach for objectives 1 and 2 could be considered to minimize the workload in RAN2.

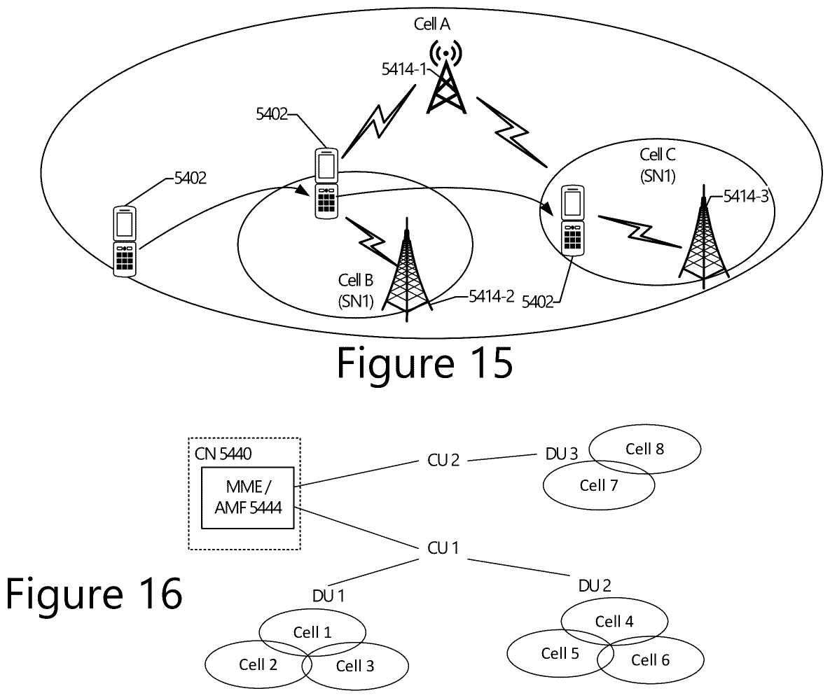

FIG. 15 shows an example of a UE 5402 moving from single connectivity to adding PSCell B and then PSCell C with potential activation/deactivation. In this example, at TO, the UE 5402 has single connectivity with cell A provided by RAN node 5414-1, with several candidate PSCells (e.g., cell B provided by RAN node 5414-2 and cell C provided by RAN node 5414-3). At T1, NR-DC, cell B is added as a PSCell. Meanwhile, the configuration of cell C is not released. At T2, NR-DC, cell C is activated as a PSCell. Meanwhile, the configuration of cell B is not released.

2.1. SCG Change without Pcell Change or Handover

In some examples, one or multiple SCG can be configured to the UE 5402 by the network (NW) in advance. The pre-configuration of SCG may contain one or more of the following: (i) CellGroupConfig (e.g., existing configuration for PHY/MAC/RLC); (ii) indicate the configuration is based on which cell (MN or SN or a cell ID) states (example: activate/deactivate/pre-configured) per SCell or per SCG; (iii) condition of the activation per SCell or per SCG, wherein (iii.a) it can be based on radio link condition such as A3 events or other existing/new events, (iii.b) if there is no activated SCG the event can be configured via A4 where SCG is compared to a threshold, and/or (iii.c) the condition can be CHO; (iv) condition of the deactivation, wherein (iv.a) it can be similar to activation using radio link condition such as A3 events or other existing/new events, (iv.b) condition can be CHO, and/or (iv.c) it can be an offset to the condition of the activation. (v) SCG or SCell state: this can be activated/deactivated or configured states, wherein (v.a) activated state: SCell is active and in use, (v.b) Deactivated state: UE may only perform RLM or monitor PDCCH on this cell but no data transmission and cell is not removed. UE kept all configuration, and/or (v.c) Configured state: in this state, the network has sent all pre-configuration information to the UE but UE may or may not sync to the SCell. The UE doesn't require to monitor this cell. (vi) SN key derivation in this case of selective activation of SCG. It may include the security key algorithm if key is required to be updated when activated. (vi.a) The MN shall set the SN Counter to ‘0’ when a new AS root key, K_{NG-RAN}, in the associated 5G AS security context is established. The MN shall set the SN Counter to ‘1’ after the first calculated SN security key (K_{SN}), and monotonically increment it for each additional calculated K_{SN}. The SN Counter value ‘0’ is used to calculate the first K_{SN}. The SN counter/SK counter is sent to the UE as part of the preconfiguration of the SCG and the UE derives the K_{SN} for an SCG based on the master key (MN key) and the SK counter. For Intra CU SCG change case, the same key is used since the same PDCP entity is maintained and only PDCP recovery is needed only for the case of inter-DU. Additional aspects of the SK counter are discussed infra w.r.t section 5. (vi.b) For Inter-CU SCG change case, assuming that the PDCP entity is retained for each inter-CU SCG, a different SK counter is provided in the pre-configuration of target SCG and thus a new SN key is derived for the PDCP entity of the target SCG. In this case the UE has to perform PDCP establishment (note that the PDCP entity of the old SCG is retained by the UE). (vi.c) In the case that the inter-CU SCG change is related to SCG that the PDCP entity is retained by UE and gNB:Inter-CU SCG change case, since the gNB and UE retain the PDCP entity, the SN key that is used before by the UE can be used. For the inter-DU case, PDCP data recovery has to be performed to allow for retransmission of all the PDCP PDUs that has not been acknowledged by the lower layers.

In the case that the inter-CU SCG change is performed without PDCP entity being retained by the UE 5402 and gNB 5414a, indication to UE 5402 of new SK counter (Option 1), support only intra-CU case (Option 2); and/or indicate to the UE 5402 intra or inter-CU case (Option 3). However, the last case may not fulfil the selective activation of SCG.

FIG. 16 shows example NR-DC scenarios. The depicted scenarios include scenario 1 which involves an intra-DU cell change/HO (e.g., cell 1 [symbol] cell 2); scenario 2 which involves an inter-DU and intra-CU cell change/HO (e.g., cell 3 [symbol] cell 5); and scenario 3 which involves an inter CU (e.g., cell 4 [symbol] cell 7).

2.2. UE Capability

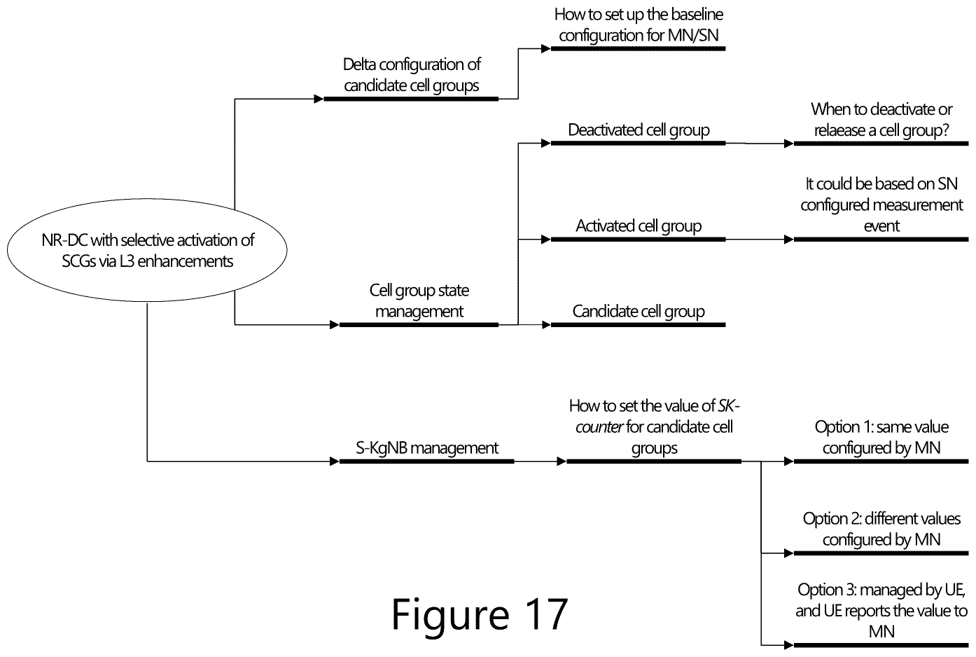

FIG. 17 depicts an example of NR-DC with selective activation of SCGs via L3 enhancements. In this example, the UE 5402 indicates support of SCG activation/deactivation feature, indicates support of SCG states, indicates the total number of SCG activation/deactivation/configured, and/or indicates the total number of activated SCG, (and/or) deactivated SCG (or indicates the number of activated/deactivated SCG per band combination supported by the UE 5402).

In the case where the UE 5402 reaches the maximum number of activated/deactivated SCGs, a new pre-configured SCG is triggered (a better cell) to be activated. In some examples, the UE 5402 releases, removes, or modifies an activated SCG to pre-configured SCG. For example, the UE 5402 has 2 deactivated and 1 activated SCG, 1 pre-configured SCG is measured to be better. In a first option (Option 1), the UE 5402 indicates preference to network. In a second option (Option 2), the UE 5402 selects the SCG to activate and release one SCG (still need to indicate to network). A third option (Option 3) is based on network pre-configured priority number per SCG (release lower priority SCG).

2.3. SCG Change with PCell Change/HO

FIG. 18 depicts an example procedure for SCG change with PCell change or HO.

2.3.1. Message 1

In the procedure of FIG. 18, the network (e.g., S-Cell 130s) sends an RRC configuration including multiple target cells configuration (e.g., T-cell 130t-1 and T-cell 130t-2) to the UE 5402 (step 1).

In release 16, one SCG can be added as part of RRC configuration. In some implementations, more than one SCG may be added as part of RRC configuration in each PCell and/or each SCG may have an unique ID/index. Each PCell has more than one SCG index. A separate SCG list with each SCG associated to the unique ID/index are configured to the UE 5402.

In legacy HO, secondary node (SN) configuration is based on the master node (MN), since SN may change when MN also change. Therefore, there could be multiple options when MN changes: network can indicate which MN is the baseline for a configured SN (Option 1); SN has its own configuration and/or not based on MN (Option 2); when PCell change, SN configuration is changed to new PCell (Option 3); and/or the UE 5402 indicates preference which cell is used as a baseline (Option 4). The UE 5402 then performs measurement (step 1a).

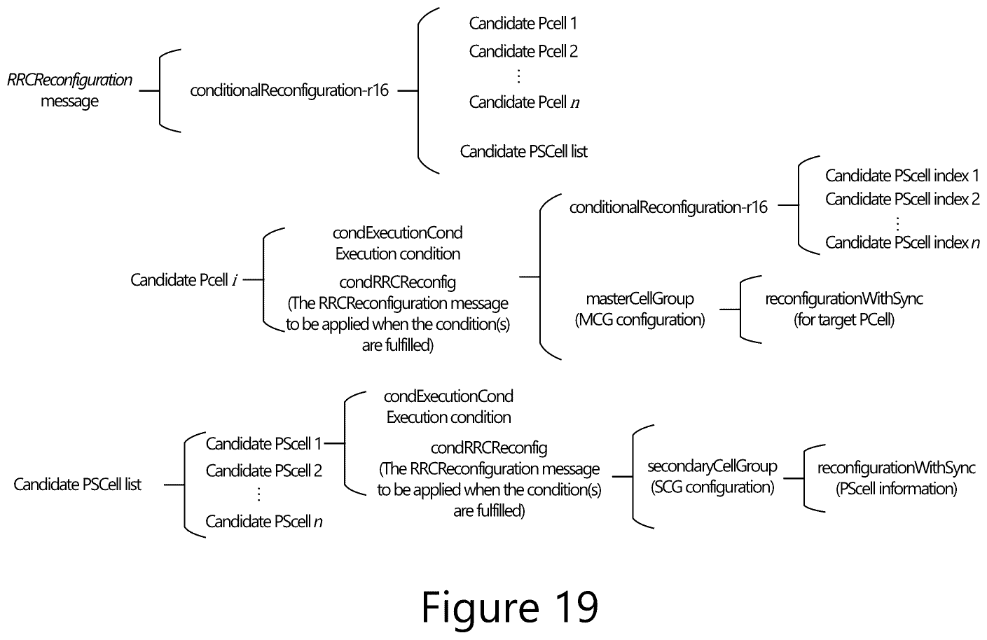

FIG. 19 depicts an example SCG index, which may be used as part of the procedure of FIG. 18 and/or any other procedure/process discussed herein.

2.3.2. Message 2

Continuing with the example of FIG. 18, the UE 5402 determines whether CHO condition has been met (step 1b) after performing/collecting measurements (step 1a). In case of any activation condition met, the UE 5402 will start RACH procedure (steps 2 and 3), which can include one or more of the following options.

Option 1: this can be triggered for HO. In this case, there can be two sub cases. In case 1a, the same SCG is associated with source PCell and target PCell. In this case, SCG will remain configured (activated) with the UE when CPC is executed. In case 1b, different SCG(s) are associated with source PCell and target PCell. In this case, SCG associated with source PCell will be deactivated and SCG associated with target SCG will be activated. In some implementations, for SCG selective activation, the CPC/CPA configurations of the UE 5402 are released after a PCell change, at least for inter-MN HO.

Option 2: this can be triggered for SCG change. Here, the source SCG is deactivated and target SCG is activated when target SCG is in the pre-configuration.

After the random access procedure is performed, the UE 5402 sends an RRCReconfiguration complete message to the T-Cell 130t-1 (step 4).

2.4. Subsequent SCG Change after CPA/CPC

When the UE 5402 does not connect to a SN (e.g., without a SCG), the network can configure multiple candidate SCGs for conditional PSCell Addition (CPA). For each candidate SCGs, an execution condition is also configured. When this execution condition is met, the UE 5402 performs the CPA execution. The execution condition may be associated with measurement event A4 (or other condition/event), and entering condition of event A4 is Neighbour becomes better than threshold. Then after the initial CPA, the other conditional configuration are not released, which means these candidate SCGs can be considered for subsequent conditional PSCell change (CPC). And, the execution conditions of CPC may be associated with measurement A3/A5 and/or other condition/event. The entering condition of event A3 is neighbor becomes offset better than SpCell. And, the entering condition of event A5 is SpCell becomes worse than threshold1 and neighbour becomes better than threshold2. So the cell qualities of current PSCell and candidate PSCells need to be compared to determine whether a CPC should be triggered.

In order to support subsequent CPC without reconfiguration, both execution conditions for CPA and CPC can be provided to the UE 5402, for example, one execution condition is for CPA and one execution condition is for subsequent CPC. An example RRC configuration is shown by table 2.4-1.

TABLE 2.4-1
CondReconfigToAddModList information element

```
-- ASN1START
-- TAG-CONDRECONFIGTOADDMODLIST-START
CondReconfigToAddModList-r16 : := SEQUENCE (SIZE (1 . . maxNrofCondCells-r16) ) OF
CondReconfigToAddMod-r16
CondReconfigToAddMod-r16 : := SEQUENCE {
  condReconfigId-r16 CondReconfigId-r16,
  condExecutionCond-r16 SEQUENCE (SIZE (1 . . 2) ) OF MeasId OPTIONAL, -- Need M
  condRRCReconfig-r16 OCTET STRING (CONTAINING RRCReconfiguration) OPTIONAL, -- Cond
condReconfigAdd
  . . . ,
  [ [
  condExecutionCondSCG-r17 OCTET STRING (CONTAINING CondReconfigExecCondSCG-r17) OPTIONAL --
Need M
    ] ],
    [ [
  condExecutionCondSubsequentCPC-r18 SEQUENCE (SIZE (1 . . 2) ) OF MeasId OPTIONAL, -- Need M
    ] ]
}
CondReconfigExecCondSCG-r17 : := SEQUENCE (SIZE (1 . . 2) ) OF MeasId
-- TAG-CONDRECONFIGTOADDMODLIST-STOP
-- ASN1STOP
```

Additionally or alternatively, in one execution condition two measurement IDs are associated, for example, one measurement ID associated to event A4 and/or other condition/event is for CPA, and the other measurement ID associated to event A3/A5 and/or other condition/event is for subsequent CPC. Since in current RRC specification, the condExecutionCond field can already associate with two measurement IDs, in this case a new indication for subsequent CPC should be used so that a UE can determine the two measurement IDs are for CPA and CPC respectively. An example of RRC configuration is shown by table 2.4-2.

TABLE 2.4-2
CondReconfigToAddModList information element

```
-- ASN1START
-- TAG-CONDRECONFIGTOADDMODLIST-START
CondReconfigToAddModList-r16 : := SEQUENCE (SIZE (1 . . maxNrofCondCells-r16) ) OF
CondReconfigToAddMod-r16
CondReconfigToAddMod-r16 : := SEQUENCE {
  condReconfigId-r16 CondReconfigId-r16,
  condExecutionCond-r16 SEQUENCE (SIZE (1 . . 2) ) OF MeasId OPTIONAL, -- Need M
  condRRCReconfig-r16 OCTET STRING (CONTAINING RRCReconfiguration) OPTIONAL, -- Cond
condReconfigAdd
  . . . ,
  [ [
  condExecutionCondSCG-r17 OCTET STRING (CONTAINING CondReconfigExecCondSCG-r17) OPTIONAL -- Need
M
    ] ],
    [ [
  SubsequentCPC-r18 ENUMERATED {true} OPTIONAL, -- Need M
    ] ]
}
CondReconfigExecCondSCG-r17 : := SEQUENCE (SIZE (1 . . 2) ) OF MeasId
-- TAG-CONDRECONFIGTOADDMODLIST-STOP
-- ASN1STOP
```

### 3. [AE6627] RADIO LINK MONITORING (RLM) HANDLING ASPECTS FOR LAYER 1 (L1)/LAYER 2 (L2) MOBILITY

Based on the objectives specified by RP-221799, the present disclosure provides mechanisms for actual switching of serving cell in RRC upon L1/L2 based cell switching. In this case, radio link monitoring (RLM) can be updated upon L1/L2 based cell switching.

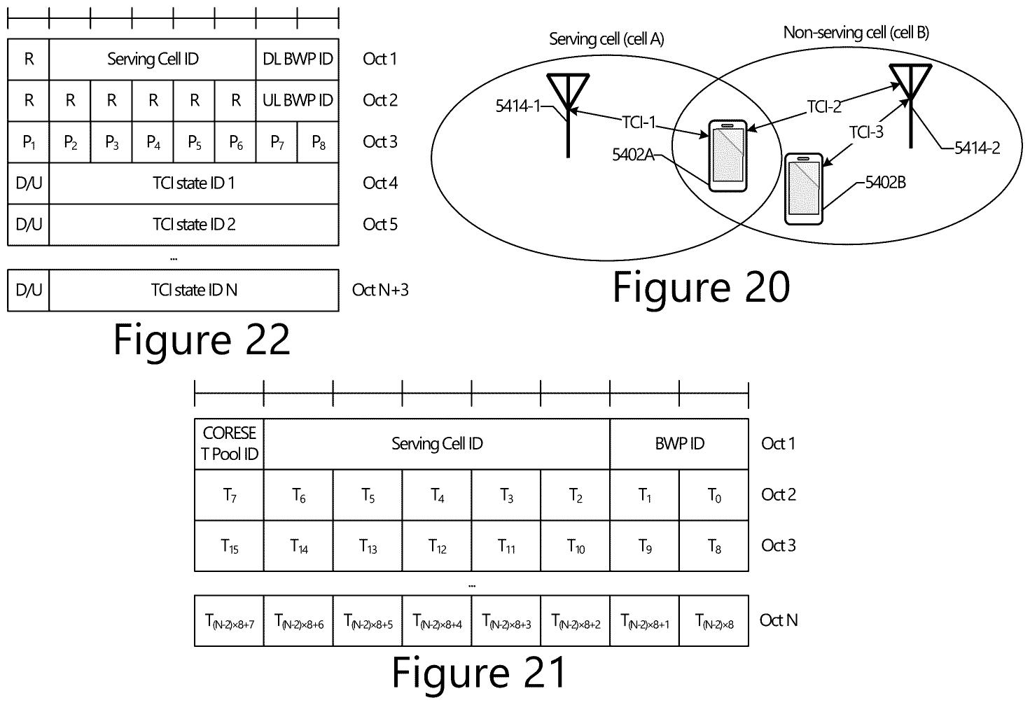

FIG. 20 depicts example scenarios where two UEs (e.g., UE 5402A and UE 5402B) are being served by multiple TRPs (e.g., TRP 5414-1 and UE 5414-2). FIG. 20 shows two scenarios.

A first scenario (scenario 1) is an inter-cell multi-TRP-like model (e.g., without serving cell change) where UE 5402A is served by cell A (serving cell) and cell B (non-serving cell). A transmission configuration indicator (TCI) can be switched from serving cell A to non-serving cell B via DCI and/or MAC (e.g., the MAC CEs shown by FIG. 21 or 22, and/or as discussed in [TS38321]). In this case, there is no serving cell change. This is supported in Rel-17 feMIMO.

A second scenario (scenario 2) is an inter-cell HO-like model (e.g., with serving cell change). Here, UE 5402B is moving out of serving cell A coverage and is in cell B coverage. Rel-18 feMob introduces L1/L2 HO, L1/L2 HO will be triggered in this case.
Case 1: if cell A and cell B are in the same CU (e.g., intra-CU cell change) (meaning at least they share the same RRC). Upon L1/L2 based switching/mobility if serving cell is kept as cell A, UE coverage would be within cell B but serving cell still remains in cell A. It means that RLM is performed based on cell A and at some point, out of sync from physical layer will trigger RLF. In order to avoid that, there are few approaches:
Option 1: upon L1/L2 based switching, PHY layer provide in-sync and out-sync information to RRC layer by using RLM-RS configured for cell B although the serving cell is still cell A. With this option, RLM can be autonomously updated to cell B and radio link failure (RLF) could be avoided.
Option 2: when L1/L2 mobility is triggered, it also indicates to higher layer (RRC) so RRC can reconfigure the following options: (A) reconfigure serving cell to cell B. Serving cell pre-configured RRC and PDCP is sent to the UE in advance. UE applies when serving cell change is triggered. (B) reconfigure RLM to include cell B, in this option, UE uses cell A and cell B for RLM purpose when L1/L2 signal the switch. Alternatively, the UE RLM procedure can be modified such that the UE use both cell for RLM purpose. For example, both cells will need to have out of sync for some time before RLF is triggered. If only one cell out of sync is detected, the UE doesn't trigger any RLF related timer. (C) UE performs hard HO to non-serving cell (cell B) when out of sync is detected without declaring RLF. (D) autonomous switching of MO: network configures TRP specific MO, the UE will switch the MO to corresponding TRP upon receiving L1/L2 switching indication from the lower layer. Option 1 and 2B,C,D should also apply to intra-DU case as well.
Case 2: if cell A and cell B are inter-CU (meaning they have different RRC). It may or may not be supported in Rel-18. Case 3: if cell A and cell B are intra-DU (meaning they share the same RRC, PDCP, RLC, MAC, and PHY).

When a UE 5402 is in location A, a list of candidate cells can be configured to UE. And, for each candidate cell, at least the following configurations can be provided: PCI, and frequency related information; Reference signals for radio link monitoring (RLM-RS); measObjectId of the MeasObjectNR in MeasConfig which is associated to the candidate cell (e.g., servingCellMO); dedicated channels configured as a part of unified TCI states; cell specific parameters of the candidate cell; and/or C-RNTI used by UE when the PHY is switched to this candidate cell.

As illustrated in FIG. 20, TCI state 1 (TCI-1) is associated to cell A, and TCI state 2 (TCI-2) and TCI state 3 (TCI-3) are both associated to cell B. When a UE 5402 is in location A, both TCI-1 and TCI-2 are activated. As the UE 5402 moves towards cell B, based on L1/L2 measurement results, TCI-1 can be deactivated when the beam quality of TCI-1 is not good enough, and only TCI-2 is activated at this time.

If no RLF for cell A is declared, the RLM and RRM measurements can keep unchanged, e.g., still based on RS of cell A. But after RLF is declared for cell A and TCI-2 is still used by the UE 5402 normally, then from the RLM and RRM measurement perspective, the RLM-RS should be based on cell B, and the serving cell quality should also be measured according to the measObjectId associated to cell B.

Before the RLF of cell A happens, the switch could be indicated by a L1/L2 signalling (e.g., a PHY switch or TRP switch indication). When a UE 5402 receives this indication from network, besides of the RLM and RRM measurements, optionally the UE 5402 also applies the new C-RNTI for scrambling and cell B specific parameters for physical channels. Since it's an intra-DU scenario, the PDCP and RLC entities of each radio bear can be still maintained, and MAC entity can also be maintained, only PHY layer needs to be switched to cell B. And the PHY related MAC reset operations are needed.

When the UE 5402 arrives at location B, TCI-3 is activated and TCI-2 is deactivated, the RLM and RRM measurements can keep unchanged (e.g., still based on RS of cell B).

Regardless of which option(s) is/are used, it may be desirable to know when it is triggered and what solution to use when triggered. In a first example, the trigger may happen after higher layer receive out-of-sync indicator. It can be in a form of a new timer similar to T310 or a new timer. At expiry of new timer, triggers new UE procedure. In a second example, the trigger may happen when L1/L2 mobility happen. In a third example, the trigger may be based on new event in L1/2 or L3.

In some implementations, the TCI states in FIG. 20 can be switched (activated/deactivated) using a suitable MAC CE. In some examples, the network may activate and deactivate the configured TCI states for PDSCH of a Serving Cell or a set of Serving Cells configured in simultaneousTCI-UpdateList1 or simultaneousTCI-UpdateList2 by sending the TCI States Activation/Deactivation for UE-specific PDSCH MAC CE of FIG. 21. The network may activate and deactivate the configured TCI states for a codepoint of the DCI Transmission configuration indication field as specified in [TS38212] for PDSCH of a Serving Cell by sending the Enhanced TCI States Activation/Deactivation for UE-specific PDSCH MAC CE described in clause 6.1.3.24 of [TS38321]. The configured TCI states for PDSCH are initially deactivated upon (re-)configuration by upper layers and after reconfiguration with sync.

If a MAC entity receives a TCI States Activation/Deactivation for UE-specific PDSCH MAC CE on a Serving Cell, the MAC entity indicates to lower layers the information regarding the TCI States Activation/Deactivation for UE-specific PDSCH MAC CE. If the MAC entity receives an Enhanced TCI States Activation/Deactivation for UE-specific PDSCH MAC CE on a Serving Cell, the MAC entity indicates to lower layers the information regarding the Enhanced TCI States Activation/Deactivation for UE-specific PDSCH MAC CE.

FIG. 21 shows an example TCI States Activation/Deactivation for UE-specific PDSCH MAC CE. The TCI States Activation/Deactivation for UE-specific PDSCH MAC CE is identified by a MAC subheader with LCID as specified in Table 6.2.1-1 of [TS38321] (e.g., value of 53). It has a variable size consisting of following fields.

The Serving Cell ID field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in [TS38331], this MAC CE applies to all the Serving Cells configured in the set simultaneousTCI-UpdateList1 or simultaneousTCI-UpdateList2, respectively.

The BWP ID field indicates a DL BWP for which the MAC CE applies as the codepoint of the DCI bandwidth part indicator field as specified in [TS38212]. The length of the BWP ID field is 2 bits. This field is ignored if this MAC CE applies to a set of Serving Cells.

If there is a TCI state with TCI-StateId i as specified in [TS38331], the Tᵢ field indicates the activation/deactivation status of the TCI state with TCI-StateId i, otherwise MAC entity shall ignore the Tᵢ field. The Tᵢ field is set to 1 to indicate that the TCI state with TCI-StateId i shall be activated and mapped to the codepoint of the DCI Transmission Configuration Indication field, as specified in [TS38214]. The Tᵢ field is set to 0 to indicate that the TCI state with TCI-StateId i shall be deactivated and is not mapped to the codepoint of the DCI Transmission Configuration Indication field. The codepoint to which the TCI State is mapped is determined by its ordinal position among all the TCI States with Tᵢ field set to 1, e.g., the first TCI State with Tᵢ field set to 1 is mapped to the codepoint value 0, second TCI State with Tᵢ field set to 1 is mapped to the codepoint value 1 and so on. The maximum number of activated TCI states is 8. The activated TCI states can be associated with at most one PCI different from the Serving Cell PCI at a time.

The CORESET Pool ID field indicates that mapping between the activated TCI states and the codepoint of the DCI Transmission Configuration Indication set by field T, is specific to the ControlResourceSetId configured with CORESET Pool ID as specified in [TS38331]. This field set to 1 indicates that this MAC CE is applied for the DL transmission (Tx) scheduled by CORESET with the CORESET pool ID equal to 1, otherwise, this MAC CE is applied for the DL Tx scheduled by CORESET pool ID equal to 0. If the coresetPoolIndex is not configured for any CORESET, MAC entity ignores the CORESET Pool ID field in this MAC CE when receiving the MAC CE. If the Serving Cell in the MAC CE is configured in a cell list that contains more than one Serving Cell, the CORSET Pool ID field is ignored when receiving the MAC CE.

In some examples, the network may activate and deactivate the configured unified TCI states of a Serving Cell or a set of Serving Cells configured in simultaneousU-TCI-UpdateList1, simultaneousU-TCI-UpdateList2, simultaneousU-TCI-UpdateList3 or simultaneousU-TCI-UpdateList4 by sending the Unified TCI States Activation/Deactivation MAC CE of FIG. 22. The configured unified TCI states are initially deactivated upon (re-)configuration by upper layers and after reconfiguration with sync. Here, if the MAC entity receives a Unified TCI States Activation/Deactivation MAC CE on a Serving Cell, the MAC entity indicates to lower layers the information regarding the Unified TCI States Activation/Deactivation MAC CE.

FIG. 22 shows an example unified TCI state activation/deactivation MAC CE. The Unified TCI States Activation/Deactivation MAC CE is identified by a MAC subheader with eLCID as specified in Table 6.2.1-1b of [TS38321] (e.g., codepoint value of 233 and index of 297). It has a variable size consisting of following fields.

The Serving Cell ID field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in [TS38331], this MAC CE applies to all the Serving Cells in the set simultaneousU-TCI-UpdateList1, simultaneousU-TCI-UpdateList2, simultaneousU-TCI-UpdateList3 or simultaneousU-TCI-UpdateList4, respectively.

The DL BWP ID field indicates a DL BWP for which the MAC CE applies as the codepoint of the DCI bandwidth part indicator field as specified in [TS38212]. The length of the BWP ID field is 2 bits.

The UL BWP ID field indicates a UL BWP for which the MAC CE applies as the codepoint of the DCI bandwidth part indicator field as specified in [TS38212]. If value of unifiedTCI-StateType in the Serving Cell indicated by Serving Cell ID is joint, this field is considered as the reserved bits. The length of the BWP ID field is 2 bits.

The P, field indicates whether each TCI codepoint has multiple TCI states or single TCI state. If P, field is set to 1, it indicates that i^{th} TCI codepoint includes the DL TCI state and the UL TCI state. If P, field is set to 0, it indicates that i^{th} TCI codepoint includes only the DL/joint TCI state or the UL TCI state. The codepoint to which a TCI state is mapped is determined by its ordinal position among all the TCI state ID fields.

The D/U field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink.

The TCI state ID field indicates the TCI state identified by TCI-StateId as specified in [TS38331]. If D/U is set to 1, 7-bits length TCI state ID e.g., TCI-StateId as specified in [TS38331] is used. If D/U is set to 0, the most significant bit of TCI state ID is considered as the reserved bit and remainder 6 bits indicate the TCI-UL-State-Id as specified in [TS38331]. The maximum number of activated TCI states is 16. The Reserved bit (R) is set to 0.

FIG. 23 shows an example process 2300, which is performed by a UE 5402. However, it should be noted that process 1400 can be performed by any of the electronic device(s), network(s), system(s), chip(s) or component(s), or portions or implementations thereof, of FIGS. 54-57, or some other figure discussed herein. Process 2300 begins at operation 2301 where the UE 5402 identifies and/or determines that the UE 5402 is communicatively coupled with a TRP of a serving cell and a TRP of a non-serving cell. At operation 2302, the UE 5402 identifies and/or determines a radio link monitoring reference signal (RLM-RS) related to the non-service cell. At operation 2303, the UE 5402 provides in-sync or out-of-sync information (e.g., to higher or lower layers) based on the RLM-RS. At operation 2304, the UE 5402 updates RLM to the non-serving cell.

### 4. [AE9456] SUPPORT FOR L1/L2-BASED INTRA-GNB INTER-CELL MOBILITY IN SPLIT NG-RAN ARCHITECTURES

As mentioned previously, one of the objectives of RP-221799 is to specify mechanism and procedures of L1/L2 based inter-cell mobility. A purpose of L1/L2 based inter-cell mobility is to reduce mobility latency by pre-configuring a list of cell configurations in advance to the UE 5402, for which based on L1/L2 measurements, NW triggers fast HO between cells. The concept is similar to CHO or primary secondary cell group (SCG) cell (PSCell) addition/change (CPAC) that has been specified from Rel-16 (e.g., multiple candidate cells pre-configuration), but here handover execution and to which cell to handover is fully controlled and explicitly decided by NW, rather than pre-configuring some conditions to evaluate for the UE to determine when and which cell to handover to.

According to RP-221799, the scope of L1/L2 based inter-cell mobility is within a single centralized unit (CU) where the intra-DU case and intra-CU inter-DU case will be supported. The present disclosure provides several enhancements to support both L1/L2 based intra-DU and intra-CU inter-DU mobility that achieves mobility latency reduction in a split NG-RAN architecture having CU-CP 5732c, CU-UP 5732u, and DU 5731.

In particular, the present disclosure provides procedures and information signalling to support L1/L2 based intra-DU mobility for latency reduction in a split NG-RAN architecture involving CU-CP 5732c, CU-UP 5732u, and DU 5731; and the procedures and information signalling to support L1/L2 based intra-CU inter-DU mobility for latency reduction in a split NG-RAN architecture involving CU-CP 5732c, CU-UP 5732u, and DUs 5731.

The signaling and information in this disclosure may enable a gNB in split NG-RAN architecture to support L1/L2 based mobility procedures toward the UE and achieve fast HO between candidate cells pre-configured. The various aspects discussed herein are relevant to, and may be specified in suitable 3GPP standards, such as F1AP standards (see e.g., [TS38473])), E1AP standards (see e.g., 3GPP TS 37.483 v17.5.0 (2023 Jun. 29) (“[TS37483]”)), F1-U standards (see e.g., 3GPP TS 38.425 v17.3.0 (2023 Apr. 3) (“[TS38425]”)), and/or CU-DU split NG-RAN architecture standards (see e.g., [TS38401]).

4.1. L1/L2 Based Intra-Du Mobility

The following discussion includes various procedures, data structures, and other technologies to support intra-DU mobility in a split NG-RAN architecture involving a CU-CP 5732c, a CU-UP 5732u, and a DU 5731. It should be noted that the following example implementations can be practiced by many more CU-CPs 5732c, a CU-UPs 5732u, and/or DUs 5731 than shown and/or described in the following description; and additional or alternative data structures and/or data elements can be used in the following procedures that the various data structures and/or data elements discussed infra.

4.1.1. NW Preparation for Multiple Candidate Cell Configurations

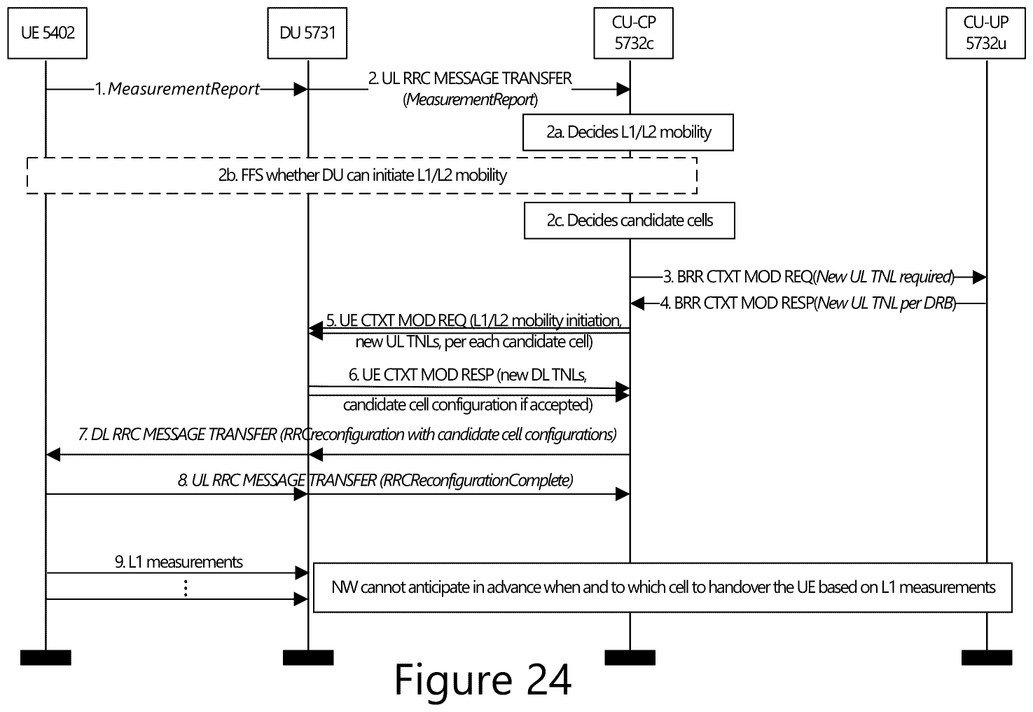

FIG. 24 shows an example procedure of a network (NW) preparation phase during intra-DU L1/L2 mobility and/or for multiple candidate cell configurations involving a DU 5731, CU-CP 5732c, and CU-UP 5732u. In the example of FIG. 24, the UE 5402 sends a measurement report (MeasurementReport) to the DU 5731 (step 1), and the DU 5731 sends an uplink (UL) message transfer to provide the measurement report to the CU-CP 5732c (step 2).

The CU-CP 5732c decides on L1/L2 mobility (step 2a). In some embodiments, the DU 5731 may or may not initiate L1/L2 mobility (step 2b). Additionally or alternatively, the final decision maker takes place at the CU-CP 5732c side (step 2c). In some examples, the DU 5731 suggests candidate cells based on L1 measurements, but the final decision whether to configure L1/L2 mobility to the UE and which candidate cells should be by CU-CP 5732c.

Once CU-CP 5732c decides intra-DU L1/L2 mobility (step 2a) and which candidate cells to configure (step 2c), following the legacy intra-DU HO principle, the CU-UP 5732u first retrieves new UL TNL per DRB from the CU-UP 5732u. One implementation includes reusing the legacy New UL TNL required IE in a bearer (BRR) context (CTXT) modification (MOD) request (REQ) message for the CU-CP 5732c (step 3) to retrieve a New UL TNL per DRB from the CU-UP 5732u (step 4). In this example, the CU-CP 5732c sends the New UL TNL required IE (or New UL TNL Information Required IE) in BRR CTXT MOD REQ message to the CU-UP 5732u (step 3), and the CU-CP 5732c receives a BRR CTXT MOD response (RESP) message from the CU-UP 5732u including the New UL TNL per DRB IE (step 4). In some implementations, when the New UL TNL Information Required IE is contained in the BRR CTXT MOD REQ message (step 3), the gNB-CU-UP 5732u includes the new UP Transport Layer Information IE in the BRR CTXT MOD RESP message (step 4). Details of the additional or alternative IEs included in the BRR CTXT MOD RESP message are discussed in [TS37483]. Additionally or alternatively, a new procedure and/or a dedicated IE(s) can be added to the E1AP specification (e.g., [TS37483]) for this purpose.

The CU-CP 5732c sends a UE CTXT MOD REQ to the DU 5731 (step 5). The UE CTXT MOD REQ includes, for example, L1/L2 mobility initiation, new UL TNLs, per each candidate cell, and/or other information/data. The CU-CP 5732c receives a UE CTXT MOD RESP from the DU 5731 (step 6). The UE CTXT MOD RESP includes, for example, new DL TNLs, candidate cell configuration if accepted. The contents of the UE CTXT MOD REQ and the UE CTXT MOD RESP are discussed infra and/or in [TS38473], respectively.

The UE sends a DL RRC MESSAGE TRANSFER to the CU-CP 5732c (step 7). The DL RRC MESSAGE TRANSFER message includes a RRCreconfiguration with candidate cell configurations. The CU-CP 5732c sends a UL RRC MESSAGE TRANSFER to the UE with a RRCReconfigurationComplete message (step 8). Then, the UE provides L1 measurement(s) to the DU 5731 (step 9). The NW cannot anticipate in advance when and to which cell to handover the UE 5402 (all based on L1 measurements).

An example implementation for special F1-U UL/DL tunnel endpoint identifier (TEID) handling for L1/L2-based intra-DU mobility is discussed infra. This example implementations could be used for stage-2 of [TS38401] for special F1-U UL/DL TEID handling for L1/L2-based intra-DU mobility.

4.1.1.1. Intra-NR Mobility

4.1.1.1.1. Intra-GNB-DU Handover

This procedure is used for the case that the UE moves from one cell to another cell within the same gNB-DU 5731 or for the case that intra-cell handover is performed during NR operation, and supported by the UE context modification (gNB-CU initiated) procedure as specified in [TS38473]. When the intra-gNB-DU 5731 handover is performed (either inter-cell or intra-cell) or the intra-gNB-DU 5731 L1/L2 based HO is prepared, the gNB-CU 5732 provides new UL GTP TEID to the gNB-DU 5731 and the gNB-DU 5731 provides new DL GTP TEID to the gNB-CU 5732. During HO, the gNB-DU 5731 continues sending UL PDCP PDUs to the gNB-CU 5732 using the previous UL GTP TEID until it re-establishes the RLC, and after then start sending using the new UL GTP TEID. The gNB-CU 5732 continues sending DL PDCP PDUs to the gNB-DU 5731 using the previous DL GTP TEID until it performs PDCP re-establishment or PDCP data recovery, and after then start sending using the new DL GTP TEID.

Having new UL TEID per each DRB, CU-CP 5732c now needs to establish candidate cell configurations with the DU 5731. From a NW point of view, this L1/L2-based mobility is similar to CHO/conditional PSCell addition/change (CPAC) in a sense that the NW needs to prepare multiple candidate cell configurations and configure them to the UE 5402. The difference lies on the HO execution part where CHO/CPAC is executed based on configured conditions in the UE side, while here in L1/L2-based mobility, HO is explicitly commanded by DU 5731 based on L1 measurements.

From this sense, in terms of preparing L1/L2 mobility with the DU 5731 over the F1 interface, it is beneficial to align F1 signalling design similar to what we already have for CHO/CPAC. During CHO/CPAC, we adopted parallel preparation each for each candidate cell (indicated by SpCell ID IE), where DU 5731 is able to accept/reject the request for each candidate cell basis and also able to provide lower-layer configuration separately for each candidate cell. On top of such parallel preparations over F1, CHO/CPAC initiation/replace/cancellation have been also worked out separately for intra-DU and intra-CU inter-DU cases. Therefore, it may be desirable to follow the described L1/L2 mobility design over F1 to that of CHO/CPAC that has been already optimized for multiple candidate cell configurations. For intra-DU case, the UE Context Modification procedure has been used for CHO/CPAC and has to be used for L1/L2-based mobility (as RAN3 already agreed). Therefore, embodiments may enhance the UE Context Modification procedure following similarly by “Conditional Intra-DU Mobility Information” IE.

Another reason why it is desirable to follow the CHO/CPAC approach over F1 is because we don't know when and to which cell the mobility would happen. Speaking of the legacy intra-DU HO, the single UE Context Modification procedure was used to indicate intra-cell or inter-cell HO (by SpCell ID IE) to the DU 5731 and also to provide the corresponding HO CMD (RRCReconfiguration) as well as to exchange new UL/DL TEIDs in one shot. Namely, HO preparation with DU 5731 and HO configuration to the UE 5402 was simultaneously performed and this was possible because NW expects the UE 5402 to execute HO right away when it receives HO CMD. However, during CHO/CPAC, NW cannot anticipate when the UE 5402 will execute HO and thus HO preparation with DU 5731 and HO configuration to the UE were separated out (and thus no need to tell the source DU 5731 to stop transmission). Similarly for L1/L2 mobility, NW cannot anticipate when and to which cell to switch the UE at the time when configuring L1/L2 mobility to the UE. It is all based on L1 measurements based on which DU 5731 decides. From this sense, for intra-DU case, it is a right direction to separate HO preparation with DU 5731 and HO configuration to the UE as in CHO/CPAC.

In terms of preparing multiple candidate cell configurations with DU 5731 over F1, parallel preparation signalling each for each candidate cell via the UE Context Modification procedure is used, where DU 5731 is able to accept/reject the request for each candidate cell basis and also able to provide lower-layer configuration separately for each candidate cell.

In some implementations, an IE is added in the F1AP UE CONTEXT MODIFICATION REQUEST message that handles L1/L2 mobility initiation/replace/cancellation triggered by CU-CP 5732c (e.g., CHO/CPAC). An example implementation for F1AP (see e.g., [TS37483]) is discussed infra.

4.1.1.2. UE Context Modification (GNB-CU Initiated)

4.1.1.2.1. Successful Operation

If the Estimated Arrival Probability IE is contained in the Conditional Intra-DU Mobility Information IE or contained in the L1L2 Intra-DU Mobility Information IE included in the UE CONTEXT MODIFICATION REQUEST message, then the gNB-DU may use the information to allocate necessary resources for the UE.

If the ul-GapFR2-Config IE is contained in the DU to CU RRC Information IE that is included in the UE CONTEXT MODIFICATION RESPONSE message, the gNB-CU shall, if supported, use it as described in [TS38331].

If the L1L2 Intra-DU Mobility Information IE is included in the UE CONTEXT MODIFICATION REQUEST message and the L1L2 Mobility Trigger is set to “L1L2HO-initiation”, the gNB-DU shall consider that the request concerns a intra-DU L1/L2 based handover for the included SpCell ID IE and shall include it as the Requested Target Cell ID IE in the UE CONTEXT MODIFICATION RESPONSE message.

If the L1L2 Intra-DU Mobility Information IE is included in the UE CONTEXT MODIFICATION REQUEST message and the L1L2 Mobility Trigger is set to “L1L2HO-replace”, the gNB-DU shall replace the existing prepared conditional mobility identified by the gNB-DU UE F1AP ID IE and the SpCell ID IE.

If the L1L2 Intra-DU Mobility Information IE is included in the UE CONTEXT MODIFICATION REQUEST message and the L1L2 Mobility Trigger is set to “L1L2HO-cancel”, the gNB-DU shall consider that the gNB-CU is about to remove any reference to, and release any resources previously reserved for the candidate cells associated to the UE-associated signalling identified by the gNB-CU UE F1AP ID IE and the gNB-DU UE F1AP ID IE. If the Candidate Cells To Be Cancelled List IE is also included in the UE CONTEXT MODIFICATION REQUEST message, the gNB-DU 5731 considers that only the resources reserved for the cells identified by the included NR CGIs are about to be released by the gNB-CU 5732.

4.1.1.2.2. Unsuccessful Operation

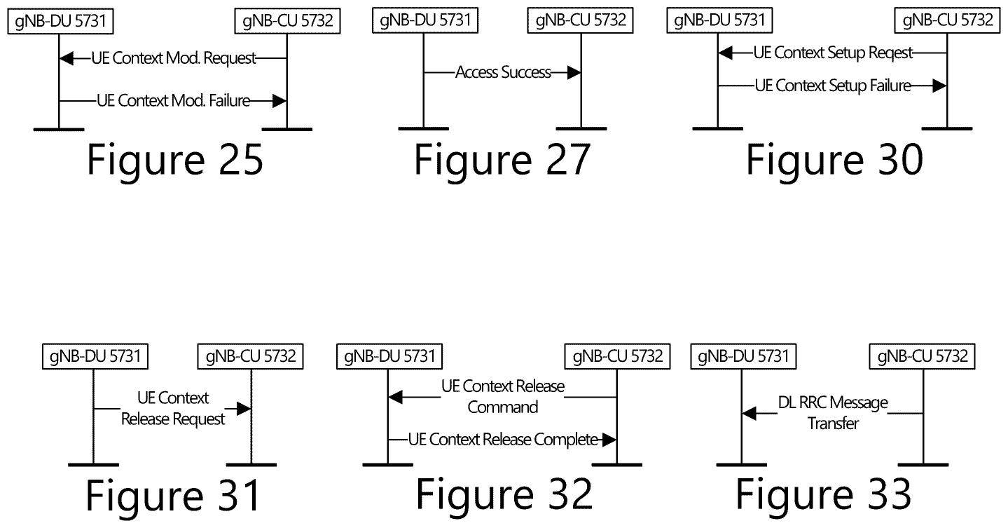

FIG. 25 shows an example UE Context Modification procedure for unsuccessful operation. In this example, the gNB-CU 5732 sends a UE Context Modification Request message to the gNB-DU 5731, and the gNB-DU 5731 sends a UE Context Modification Failure message in response to the UE Context Modification Request message.

In case none of the requested modifications of the UE context can be successfully performed, the gNB-DU shall respond with the UE CONTEXT MODIFICATION FAILURE message with an appropriate cause value. If the Conditional Intra-DU Mobility Information IE was included in the UE CONTEXT MODIFICATION REQUEST message and set to “CHO-initiation”, or the L1L2 Intra-DU Mobility Information IE was included in the UE CONTEXT MODIFICATION REQUEST message and set to “L1L2HO-initiation”, the gNB-DU shall include the received SpCell ID IE as the Requested Target Cell ID IE in the UE CONTEXT MODIFICATION FAILURE message.

If the gNB-DU is not able to accept the SpCell ID IE in UE CONTEXT MODIFICATION REQUEST message, it shall reply with the UE CONTEXT MODIFICATION FAILURE message.

If the Conditional Intra-DU Mobility Information IE was included and set to “CHO-initiation” or “CHO-replace” but the SpCell ID IE was not included in the UE CONTEXT MODIFICATION REQUEST message, or if the L1L2 Intra-DU Mobility Information IE was included and set to “L1L2HO-initiation” or “L1L2HO-replace” but the SpCell ID IE was not included in the UE CONTEXT MODIFICATION REQUEST message, the gNB-DU shall respond with the UE CONTEXT MODIFICATION FAILURE message with an appropriate cause value.

4.1.1.2.3. Abnormal Conditions

If the gNB-DU receives a UE CONTEXT MODIFICATION REQUEST message containing a E-UTRAN QoS IE for a GBR QoS DRB but where the GBR QoS Information IE is not present, the gNB-DU shall report the establishment of the corresponding DRB as failed in the DRB Failed to Setup List IE of the UE CONTEXT MODIFICATION RESPONSE message with an appropriate cause value.

If the gNB-DU receives a UE CONTEXT MODIFICATION REQUEST message containing a DRB QoS IE for a GBR QoS DRB but where the GBR QoS Flow Information IE is not present, the gNB-DU shall report the establishment of the corresponding DRBs as failed in the DRB Failed to Setup List IE of the UE CONTEXT MODIFICATION RESPONSE message with an appropriate cause value.

If the Delay Critical IE is included in the Dynamic 5QI Descriptor IE within the DRB QoS IE in the UE CONTEXT MODIFICATION REQUEST message and is set to the value “delay critical” but the Maximum Data Burst Volume IE is not present, the gNB-DU shall report the establishment of the corresponding DRB as failed in the DRB Failed to Setup List IE of the of the UE CONTEXT MODIFICATION RESPONSE message with an appropriate cause value.

If one or more candidate cells in the Candidate Cells To Be Cancelled List IE included in the UE CONTEXT MODIFICATION REQUEST message were not prepared using the same UE-associated signaling connection, the gNB-DU shall ignore those non-associated candidate cells.

In case of “CHO-replace” or “L1L2HO-replace” when the Target gNB-DU UE F1AP ID IE is included, if the candidate cell in the SpCell ID IE included in the UE CONTEXT MODIFICATION REQUEST message was not prepared using the same UE-associated signalling connection, the gNB-DU shall ignore this candidate cell.

4.1.1.2.4. UE Context Modification Request

The UE context modification request message is sent by the gNB-CU to provide UE context information changes to the gNB-DU 5731. Direction of communication for this message is: gNB-CU→gNB-DU. Example contents and other aspects of the UE context modification request message are shown by tables 4.1.1.2.4-1, 4.1.1.2.4-2, and 4.1.1.2.4-3. Additional or alternative content and/or other aspects of the UE context modification request message are described in [TS37483] (see e.g., [TS37483] § 9.2.2.4).

TABLE 4.1.1.2.4-1

| | | | IE type | | | |
|---|---|---|---|---|---|---|
| | | | and | | | |
| | | | reference | Semantics | | Assigned |
| IE/Group Name | Presence | Range | [TS37483] | description | Criticality | Criticality |
| Message Type | M | | 9.3.1.1 | | YES | reject |
| gNB-CU UE F1AP ID | M | | 9.3.1.4 | | YES | reject |
| gNB-DU UE F1AP ID | M | | 9.3.1.5 | | YES | reject |
| SpCell ID | O | | NR CGI | Special Cell as | YES | ignore |
| | | | 9.3.1.12 | defined in TS | | |
| | | | | 38.321 [16]. For | | |
| | | | | handover case, | | |
| | | | | this IE is | | |
| | | | | considered as | | |
| | | | | target cell. | | |

. . .

| | | | | | |
|---|---|---|---|---|---|
| Conditional Intra-DU | O | | | YES | reject |
| Mobility Information | | | | | |
| >CHO Trigger | M | | ENUMERATED | — | — |
| | | | (CHO- | | |
| | | | initiation, | | |
| | | | CHO- | | |
| | | | replace, | | |
| | | | CHO- | | |
| | | | cancel, . . . ) | | |
| >Candidate Cells To | C- | 0 . . . | | — | — |
| Be Cancelled List | ifCHOcancel | <maxnoof | | | |
| | | CellsinCHO> | | | |
| >>Target Cell ID | M | | NR CGI | — | — |
| | | | 9.3.1.12 | | |
| >Estimated Arrival | O | | INTEGER | YES | ignore |
| Probability | | | (1 . . . 100) | | |

. . .

| | | | | | |
|---|---|---|---|---|---|
| SDT Bearer | O | | ENUMERATED | YES | ignore |
| Configuration Query | | | (true, . . . ) | | |
| Indication | | | | | |
| L1L2 Intra-DU Mobility | O | | | YES | reject |
| Information | | | | | |
| >L1L2 Mobility Trigger | M | | ENUMERATED | — | — |
| | | | (L1L2HO- | | |
| | | | initiation, | | |
| | | | L1L2HO- | | |
| | | | replace, | | |
| | | | L1L2HO- | | |
| | | | cancel, . . . ) | | |
| >Candidate Cells To | C- | 0 . . . | | — | — |
| Be Cancelled List | ifL1L2HOcancel | <maxnoof | | | |
| | | CellsinL1L2 | | | |
| | | intraDU | | | |
| | | mobility> | | | |
| >>Target Cell ID | M | | NR CGI | — | — |
| | | | 9.3.1.12 | | |
| >Estimated Arrival | O | | INTEGER | YES | ignore |
| Probability | | | (1 . . . 100) | | |

TABLE 4.1.1.2.4-2

| Range bound | Explanation |
|---|---|
| maxnoofSCells | Maximum no. of SCells allowed towards one UE, the maximum |
| | value is 32. |
| maxnoofSRBs | Maximum no. of SRB allowed towards one UE, the maximum value |
| | is 8. |
| maxnoofDRBs | Maximum no. of DRB allowed towards one UE, the maximum value |
| | is 64. |
| maxnoofULUPTNLInformation | Maximum no. of UL UP TNL Information allowed towards one DRB, |
| | the maximum value is 2. |
| maxnoofQoSFlows | Maximum no. of flows allowed to be mapped to one DRB, the |
| | maximum value is 64. |
| maxnoofBHRLCChannels | Maximum no. of BH RLC channels allowed towards one IAB-node, |
| | the maximum value is 65536. |
| maxnoofSLDRBs | Maximum no. of SL DRB allowed for NR sidelink communication per |
| | UE, the maximum value is 512. |
| maxnoofPC5QoSFlows | Maximum no. of PC5 QoS flow allowed towards one UE for NR |
| | sidelink communication, the maximum value is 2048. |
| maxnoofAdditionalPDCPDuplicationTNL | Maximum no. of additional UP TNL Information allowed towards one |
| | DRB, the maximum value is 2. |
| maxnoofCellsinCHO | Maximum no. cells that can be prepared for a conditional mobility. |
| | Value is 8. |
| maxnoofUuRLCChannels | Maximum no. of Uu Relay RLC channels for L2 U2N relaying per |
| | Relay UE, the maximum value is 32. |
| maxnoofPC5RLCChannels | Maximum no. of PC5 Relay RLC channel allowed for L2 U2N |
| | relaying per Remote UE or Relay UE, the maximum value is 512. |
| maxnoofMRBsforUE | Maximum no. of multicast MRB allowed towards one UE, the |
| | maximum value is 64. |
| maxnoofSLdestinations | Maximum number of destination for NR sidelink communication, the |
| | maximum value is 32 |
| maxnoofCellsinL1L2intraDUmobility | Maximum no. cells that can be prepared for a L1/L2 intra-DU |
| | mobility. Value is 8. |

TABLE 4.1.1.2.4-3

| Condition | Explanation |
|---|---|
| ifCHOcancel | This IE may be present if the CHO Trigger IE |
| | is present and set to “CHO-cancel”. |
| ifL1L2HOcancel | This IE may be present if the L1L2 Mobility |
| | Trigger IE is present and set to “L1L2HO-cancel”. |

Additionally or alternatively, it may be up to implementation, a new procedure, and/or a dedicated IE could be added to F1AP specifications (e.g., [TS37483]) to achieve this purpose. Additionally or alternatively, new F1 UE-associated signalling can be created for some candidate cells configuration toward the DU 5731.

After preparing multiple candidate cell configurations with DU 5731 over the F1 interface, allow the DU 5731 to request cancellation of configured candidate cells toward CU. In some implementations, the Candidate Cells To Be Cancelled List IE is extend and/or added in the F1AP UE CONTEXT MODIFICATION REQUIRED message to handle cancellation request triggered by DU 5731 (e.g., the same or similar to CHO/CPAC). An example implementation for F1AP (see e.g., [TS37483]) are discussed infra.

4.1.1.3. UE Context Modification Required (GNB-DU Initiated)

4.1.1.3.1. General

The purpose of the UE Context Modification Required procedure is to modify the established UE Context, e.g., modifying and releasing radio bearer resources, or sidelink radio bearer resources or candidate cells in conditional handover or conditional PSCell addition or conditional PSCell change or intra-DU L1/L2 based mobility. The procedure uses UE-associated signalling.

4.1.1.3.2. Successful Operation

If the Candidate Cells To Be Cancelled List IE is included in the UE CONTEXT MODIFICATION REQUIRED message, the gNB-CU shall consider that only the resources reserved for the candidate cells identified by the included NR CGIs and associated to the UE-associated signaling identified by the gNB-CU UE F1AP ID IE and the gNB-CU UE F1AP ID IE are about to be released by the gNB-DU 5731.

If the PCS RLC Channel Required to be Modified List IE or the PCS RLC Channel Required to be Released List IE is included in the UE CONTEXT MODIFICATION REQUIRED message and the F1AP-IDs is associated with a U2N Relay UE, the PCS RLC Channel Required to be Modified List IE or the PCS RLC Channel Required to be Released List shall include the Remote UE Local ID and correspondingly, the PCS RLC Channel Modified Item IEs in the UE CONTEXT MODIFICATION CONFIRM message shall include the Remote UE Local ID IE.

If the UE Multicast MRB Required to Be Modified List IE is included in the UE CONTEXT MODIFICATION REQUIRED message containing for an MRB the MRB type reconfiguration IE set to “true” the gNB-CU shall take the MRB Reconfigured RLC mode IE into account to reconfigure the UE and to decide whether to request a PDCP status report as specified in TS 38.300 [6] and include the MBS PTP Retransmission Tunnel Required IE in the UE Multicast MRB Confirmed to Be Modified Item IEs IE.

If the L1L2 Candidate Cells To Be Cancelled List IE is included in the UE CONTEXT MODIFICATION REQUIRED message, the gNB-CU shall consider that only the resources reserved for the candidate cells identified by the included NR CGIs and associated to the UE-associated signaling identified by the gNB-CU UE F1AP ID IE and the gNB-CU UE F1AP ID IE are about to be released by the gNB-DU 5731.

4.1.1.3.3. Abnormal Conditions

If one or more candidate cells in the Candidate Cells To Be Cancelled List IE or in the L1L2 Candidate Cells To Be Cancelled List IE included in the UE CONTEXT MODIFICATION REQUIRED message were not prepared using the same UE-associated signaling connection, the gNB-CU shall ignore those non-associated candidate cells.

4.1.1.3.4. UE Context Modification Required

The UE context modification required message is sent by the gNB-DU to request the modification of a UE context. Direction of communication for this message is: gNB-CU gNB-DU. Example contents and other aspects of the UE context modification required message are shown by tables 4.1.1.3.4-1, 4.1.1.3.4-2, and 4.1.1.3.4-3. Additional or alternative content and/or other aspects of the UE context modification required message are described in [TS37483] (see e.g., [TS37483] § 9.2.2.7).

TABLE 4.1.1.3.4-1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | reject |
| gNB-CU UE F1AP ID | M | | 9.3.1.4 | | YES | reject |
| gNB-DU UE F1AP ID | M | | 9.3.1.5 | | YES | reject |

. . .

| | | | | | |
|---|---|---|---|---|---|
| Candidate Cells To Be | | 0 . . . | | YES | reject |
| Cancelled List | | <maxnoof | | | |
| | | CellsinCHO> | | | |
| >Target Cell ID | M | | NR CGI | — | — |
| | | | 9.3.1.12 | | |

. . .

| | | | | | | |
|---|---|---|---|---|---|---|
| UE Multicast MRB | | 0 . . . 1 | | | YES | reject |
| Required to Be | | | | | | |
| Released List | | | | | | |
| >UE Multicast MRB | | 1 . . . | | | EACH | reject |
| Required to Be | | <maxnoof | | | | |
| Released Item IEs | | MRBsforUE> | | | | |
| >>MRB ID | M | | 9.3.1.224 | MRB ID for the | — | |
| | | | | UE. | | |
| L1L2 Candidate Cells To | | 0 . . . | | | YES | reject |
| Be Cancelled List | | <maxnoof | | | | |
| | | CellsinL1L2 | | | | |
| | | intraDU | | | | |
| | | mobility> | | | | |
| >Target Cell ID | M | | NR CGI | | — | — |
| | | | 9.3.1.12 | | | |

TABLE 4.1.1.3.4-2

| Range bound | Explanation |
|---|---|
| maxnoofSRBs | Maximum no. of SRB allowed towards one UE, the maximum value |
| | is 8. |
| maxnoofDRBs | Maximum no. of DRB allowed towards one UE, the maximum value |
| | is 64. |
| maxnoofDLUPTNLInformation | Maximum no. of DL UP TNL Information allowed towards one DRB, |
| | the maximum value is 2. |
| maxnoofBHRLCChannels | Maximum no. of BH RLC channels allowed towards one IAB-node, |
| | the maximum value is 65536. |
| maxnoofSLDRBs | Maximum no. of SL DRB allowed for NR sidelink communication per |
| | UE, the maximum value is 512. |
| maxnoofAdditionalPDCPDuplicationTNL | Maximum no. of additional UP TNL Information allowed towards one |
| | DRB, the maximum value is 2. |
| maxnoofCellsinCHO | Maximum no. cells that can be prepared for a conditional mobility. |
| | Value is 8. |
| maxnoofUuRLCChannels | Maximum no. of Uu Relay RLC channels for L2 U2N relaying per |
| | Relay UE, the maximum value is 32. |
| maxnoofPC5RLCChannels | Maximum no. of PC5 Relay RLC channels allowed for L2 U2N |
| | relaying per Remote UE or Relay UE, the maximum value is 512. |
| maxnoofMRBsforUE | Maximum no. of multicast MRB allowed towards one UE, the |
| | maximum value is 32. |
| maxnoofCellsinL1L2intraDUmobility | Maximum no. cells that can be prepared for a L1/L2 intra-DU |
| | mobility. Value is 8. |

TABLE 4.1.1.3.4-3

| Condition | Explanation |
|---|---|
| ifMRBTypeReconf | This IE shall be present if the MRB |
| | Type Reconfiguration IE is present. |

Additionally or alternatively, it may be up to implementation, a new procedure, and/or a dedicated IE could be added onto F1AP specification (see e.g., [TS37483]) to achieve the aforementioned purpose(s). Additionally or alternatively, a new F1 UE-associated signalling can be used.

While doing so, new UL TEID per DRB (retrieved from CU-UP 5732u by CU-CP 5732c) has to be delivered to the DU 5731 as well so that DU 5731 can meet the legacy intra-DU HO principle and use it when “intra-DU” L1/L2 mobility is executed. This can be provided by DRB to Be Modified List in the UE CONTEXT MODIFICATION REQUEST message per DRB basis, where in, the UL UP TNL Information to be setup List IE is mandatorily included for each DRB to be modified. Only the first item on this list can be used to provide new UL TEID.

Once DU 5731 receives such UE CONTEXT MODIFICATION REQUEST message, from the current signalling design, DU 5731 also provides the corresponding new DL TEID for each DRB requested to be modified to the CU-CP 5732c as well (Note that the DL UP TNL Information to be setup List IE is also mandatory in DRB Modified List of the UE CONTEXT MODIFICATION RESPONSE message.) Then, thanks to parallel preparations for each candidate cell, CU-CP 5732c can obtain new DL TEID for each DRB for each candidate cell that has been successfully prepared with the DU 5731, which later can be delivered to CU-UP 5732u to meet the legacy intra-DU principle and use it when “intra-DU” L1/L2 mobility is executed.

When preparing multiple candidate cell configurations with DU 5731 over F1, CU-CP 5732c provides new UL TEID (retrieved from CU-UP 5732u by CU-CP) for each DRB, so that DU 5731 can meet the legacy intra-DU HO principle and use it when “intra-DU” L1/L2 mobility is executed.

In some implementations, the legacy UL UP TNL Information to be setup List IE is reused and/or added in the DRB to Be Modified List IE of the F1AP UE CONTEXT MODIFICATION REQUEST message to provide new UL TEID to the DU 5731.

Additionally or alternatively, it may be up to implementation, a new procedure or a dedicated IE could be added onto F1AP specification (see e.g., [TS37483]) to achieve this purpose. Additionally or alternatively, a new F1 UE-associated signalling can be used.

In return, DU 5731 provides the corresponding new DL TEID for each DRB, so that CU-CP 5732c can obtain new DL TEID for each DRB that has been successfully prepared with the DU 5731, which later can be delivered to CU-UP 5732u to meet the legacy intra-DU HO principle and use it when “intra-DU” L1/L2 mobility is executed.

In some implementations, the legacy DL UP TNL Information to be setup List IE is reused and/or added in the DRB Modified List IE of the F1AP UE CONTEXT MODIFICATION RESPONSE message to provide new DL TEID to the CU-CP 5732c.

Additionally or alternatively, it may be up to implementation, a new procedure, and/or a dedicated IE could be added onto F1AP specification (see e.g., [TS37483]) to achieve this purpose. Additionally or alternatively, a new F1 UE-associated signalling can be used.

4.1.2. HO Execution

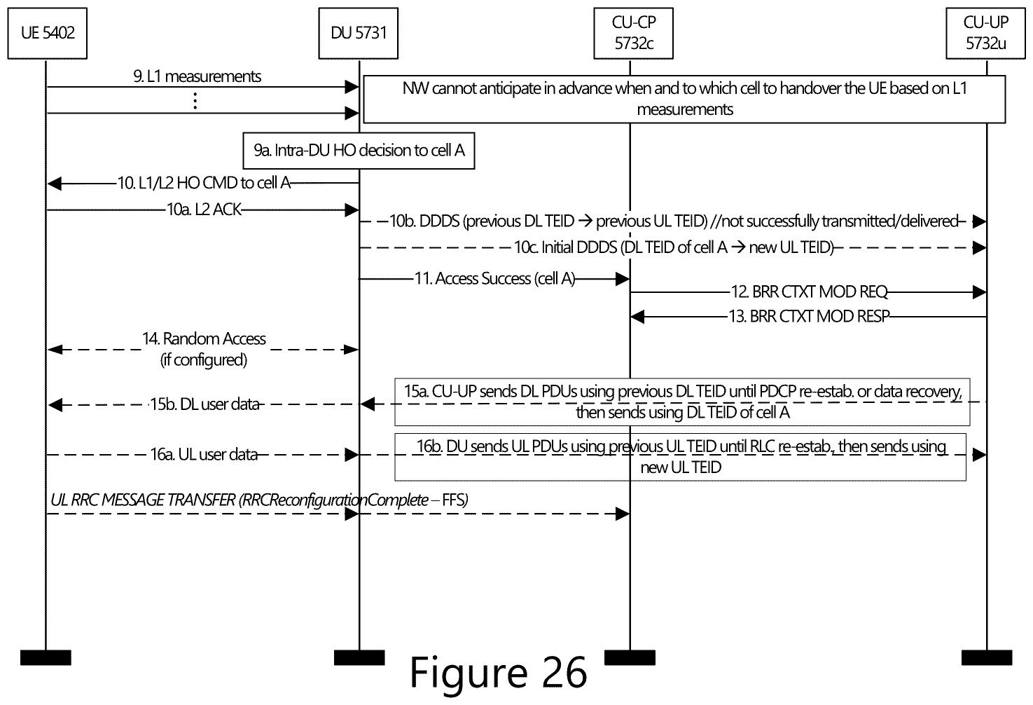

FIG. 26 shows an example procedure for HO execution phase during intra-DU L1/L2 mobility, involving DU 5731 and CU-UP 5732u. This example continues after step 9 of FIG. 24 discussed previously, where the DU 5731 determines/decides to perform an intra-DU HO to a cell A (step 9a). The DU 5731 sends an L1/L2 HO command (CMD) to the UE 5402 instructing the UE 5402 to HO to cell A (step 10), and receives an L2 acknowledgement (ACK) (step 10a). The DU 5731 sends a DL data delivery status (DDDS) message towards the CU-UP 5732u, which informs the CU-UP 5732u of unsuccessfully transmitted and/or delivered PDUs (step 10b). The DDDS message may include a previous DL TEID, a previous UL TEID, and/or other suitable information/data. Additionally or alternatively, the DU 5731 sends an initial DDDS message towards the CU-UP 5732u, which may include the DL TEID of cell A, a new UL TEID, and/or other suitable information/data (step 10c). The initial DDDS message may or may not be successfully transmitted and/or delivered to the CU-UP 5732u. The DU 5731 sends an access success for cell A to the CU-CP 5732c (step 11), and the CU-CP 5732c sends a BRR CTXT MOD REQ to the CU-UP 5732u (step 12), and receives a BRR CTXT MOD RESP from the CU-UP 5732u (step 13). In this example, the BRR CTXT MOD REQ can include the DL TEID of cell A, SDAP configuration update and/or PDCP configuration update if needed. Additionally or alternatively, the BRR CTXT MOD REQ can include a security key update if needed. The UE 5402 performs a random access procedure, if configured (step 14). The CU-UP 5732u sends DL PDUs using previous DL TEID until PDCP reestablishment or data recovery, then sends using DL TEID of cell A (step 15a) and the DU 5731 sends DL user data to the UE 5402 (step 15b). The UE 5402 sends UL user data to the DU 5731 (step 16a), and the DU 5731 sends UL PDUs using previous UL TEID until RLC reestablishment, then sends using new UL TEID (step 16b). A UL RRC MESSAGE TRANSFER (RRCReconfigurationComplete) message may be send from the UE 5402 and/or DU 5731 to the CU-UP 5732u.

Once configured to the UE 5402, based on L1 measurements, DU 5731 will decide HO to one of candidate cells and send L1/2 HO CMD to the UE to initiate mobility toward the selected cell. Then the next question is how to design signalling between DU 5731, CU-CP 5732c, and CU-UP 5732u so that we can minimize interruption as well as meet the legacy intra-DU HO principles as much as possible.

In the legacy intra-DU HO, two DDDS signalling from DU 5731 has been specified. Once DU 5731 stopped transmission before configuring HO CMD to the UE, the first DDDS was sent over the legacy TNL to inform not successfully transmitted/delivered PDUs. Once the UE accesses to the target cell, initial DDDS was sent over the new TNL (identified by new UL/DL TEIDs) to inform CU-UP 5732u that the UE has accessed the target cell and CU-UP 5732u can start delivering packets.

And when it comes to Rel-17 CHO/CPAC, we have additionally adopted “ACCESS SUCCESS” message for DU 5731 to indicate the cell accessed by the UE promptly to CU-CP 5732c before receiving RRC Reconfiguration Complete message. This was not needed for the legacy intra-CU HO because anyway CU-CP 5732c knows which cell the UE is handed over to. But in case of CHO/CPAC, this was necessary because CU-CP 5732c needs to know which cell (among candidate cells pre-configured) the UE has accessed as early as possible to continue subsequent mobility procedure and thus to reduce latency. Also, especially when there is only one bearer context maintained in the CU-UP 5732u (supported only for intra-CU CHO/CPAC case; for inter-CU CHO/CPAC, parallel bearer contexts over El for the same UE is also possible by implementation as captured in [TS38401]), there are mainly two reasons why CU-CP 5732c needs to know the accessed cell early.

A first reason is that there are multiple DL TEIDs provided by DU 5731 for each candidate cell during CHO/CPAC preparation phase, which cannot be pre-configured to the CU-UP 5732u until the UE accessed. ACCESS SUCCESS was necessary for CU-CP 5732c to provide the right DL TEIDs (and SDAP/PDCP configurations) to the CU-UP 5732u corresponding to the cell that the UE has accessed as early as possible.

A second reason is that when security key is not retained, key update depends on the chosen cells' PCI (see e.g., 3GPP TS 33.501 v18.2.0 (2023 Jun. 22) (“[TS33501]”)), which cannot be updated/pre-configured to CU-UP 5732u until CU-CP 5732c knows which cell the UE accessed to. ACCESS SUCCESS was necessary for CU-CP 5732c to provide the right security key and initiate DL delivery as early as possible.

Considering the above mechanisms that has been devised so far, to minimize latency, we think the right approach is to incorporate all the above DDDS+ACCESS SUCCESS mechanisms as soon as DU 5731 confirms which cell the UE is going to access.

This can be confirmed when DU 5731 who decided which cell to move the UE based on L1 measurements receives successful ACK for the L1/2 HO CMD sent to the UE. The candidate cells configuration has been successfully configured to the UE before, so the purpose of this L1/2 HO CMD would be nothing more than to simply command the UE to handover to which cell among pre-configured. The ACK may not even be necessary for DU 5731 to confirm. Moreover, once DU 5731 confirms, it would be very unlikely that the UE fails the subsequent procedures—RACH to the target cell (if configured) or sending RRC Reconfiguration Complete, where the former (RACH) could be skipped and the latter (RRC Reconfiguration Complete) may later be decided unnecessary pending RAN2 progress. Continuing the mobility procedure before the optional RACH or RRC Reconfiguration Complete would work fine for this L1/L2 mobility.

Once DU 5731 decides which cell to move the UE 5402 based on L1 measurements and receives successful ACK for L1/2 HO CMD sent to the UE, then to minimize latency, continue the mobility procedure before RACH (optional) or RRC Reconfiguration Complete.

In some implementations, the legacy DDDS signalling and/or ACCESS SUCCESS message are reused to continue the mobility procedure toward CU-UP 5732u and CU-CP 5732c, respectively. That is, the DU 5731 sends two DDDS to CU-UP 5732u and ACCESS SUCCESS message to CU-CP 5732c as soon as the DU 5731 confirms which cell the UE 5402 is going to access.

The first DDDS is sent to CU-UP 5732u to inform not successfully transmitted/delivered PDUs using the legacy F1-U. The second (which is initial DDDS) is sent to CU-UP 5732u to inform the UE's successful access using new F1-U with DL TEID corresponding to the chosen cell by the DU 5731 and new UL TEID provided by CU-CP 5732c.

ACCESS SUCCESS message includes the cell the UE is going to access, which may further trigger the E1AP Bearer Context Modification procedure to provide to CU-UP 5732u the right DN TEIDs for new F1-Us, updated SDAP/PDCP configurations (if needed), and updated security key (if needed). An example adaptation for ACCESS SUCCESS message in F1AP (see e.g., [TS37483]) is discussed infra.

4.1.2.1. Access Success

4.1.2.1.1. General

The purpose of the Access Success procedure is to enable the gNB-DU to inform the gNB-CU of which cell the UE has successfully accessed during conditional handover or conditional PSCell addition or conditional PSCell change or L1/L2 based mobility. The procedure uses UE-associated signalling.

FIG. 27 shows an example access success procedure for successful operation. In this example, the gNB-DU 5731 initiates the procedure by sending an ACCESS SUCCESS message to the gNB-CU 5732.

4.1.2.1.2. Conditional Handover or Conditional PSCell Addition or Conditional PSCell Change

Upon reception of the ACCESS SUCCESS message, the gNB-CU shall consider that the UE successfully accessed the cell indicated by the included NR CGI IE in this gNB-DU and consider all the other CHO preparations or conditional PSCell addition or conditional PSCell change preparations accepted for this UE under the same UE-associated signaling connection in this gNB-DU as cancelled.

4.1.2.1.3. L1/L2 Based Mobility

Upon reception of the ACCESS SUCCESS message, the gNB-CU shall consider that the UE is successfully configured to perform HO to the cell indicated by the included NR CGI IE in this gNB-DU and consider all the other L1/L2 based handover preparations accepted for this UE under the same UE-associated signaling connection in this gNB-DU as cancelled.

Interaction with other procedure: The gNB-CU may initiate UE Context Release procedure toward the other signalling connections or other candidate gNB-DUs for this UE, if any.

4.1.2.1.4. Access Success

The access success message is sent by the gNB-DU 5731 to inform the gNB-CU 5732 of which cell the UE 5402 has successfully accessed during CHO or conditional PSCell addition or conditional PSCell change. The access success message is also sent by the gNB-DU 5731 to inform the gNB-CU 5732 of which cell the UE 5402 has successfully been commanded to execute HO during the L1/L2 based mobility. Direction of communication for this message is: gNB-DU gNB-CU. Example contents and other aspects of the UE context modification required message are shown by table 4.1.2.1.4-1. Additional or alternative content and/or other aspects of the UE context modification required message are described in [TS37483].

TABLE 4.1.2.1.4-1

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| gNB-CU UE F1AP ID | M | | 9.3.1.4 | | YES | reject |
| gNB-DU UE F1AP ID | M | | 9.3.1.5 | | YES | reject |
| NR CGI | M | | 9.3.1.12 | | YES | reject |

Additionally or alternatively, it may be up to implementation, a new procedure, and/or a dedicated IE could be added onto F1AP specification (see e.g., [TS37483]) and/or F1-U specifications (see e.g., [TS38425]) to achieve the aforementioned purpose(s). Additionally or alternatively, a new F1 UE-associated signalling can be used.

In some examples CU-CP 5732c further triggers the E1AP Bearer Context Modification procedure to provide to CU-UP 5732u the right DN TEIDs for new F1-Us, updated SDAP/PDCP configurations (if needed), and updated security key (if needed). One example implementation includes reusing the legacy IEs in the E1AP BEARER CONTEXT MODIFICATION REQUEST message to provide the above information.

Or up to implementation, a new procedure or a dedicated IE could be added onto E1AP specification (e.g., [TS37483]) to achieve this purpose.

4.1.3. Subsequent HO Executions

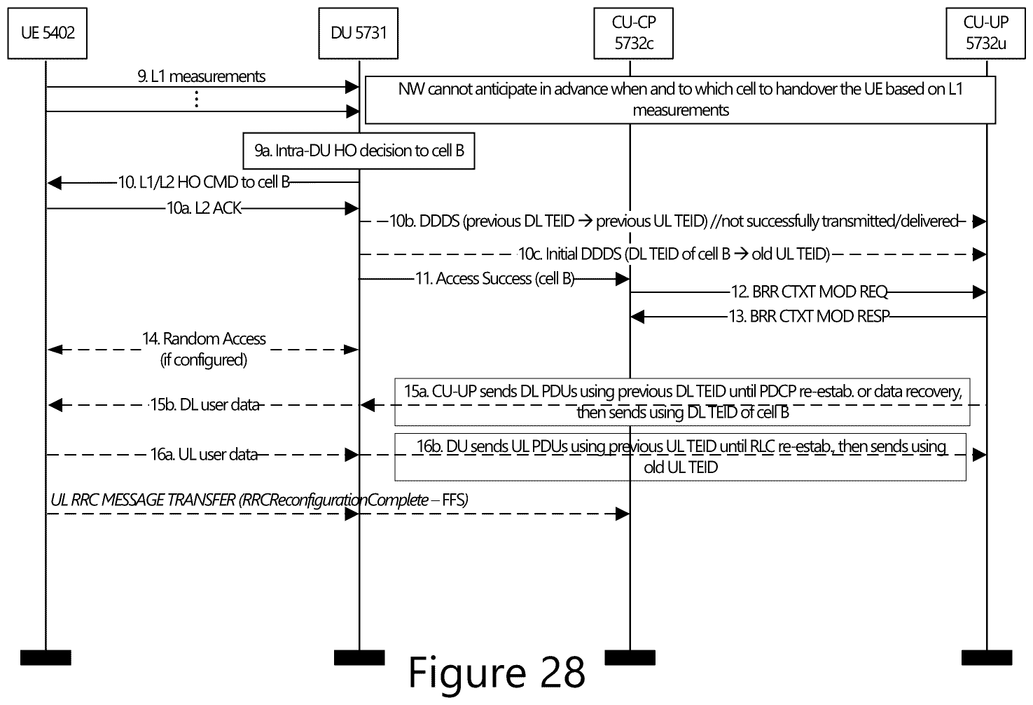

FIG. 28 shows an example procedure for subsequent HO execution phase during intra-DU L1/L2 mobility, involving DU 5731 and CU-UP 5732u. The procedure of FIG. 28 is similar to the procedure of FIG. 26 except that that the DU 5731 determines/decides to perform an intra-DU HO to a cell B (step 9a); the DU 5731 sends an initial DDDS message towards the CU-UP 5732u that includes the DL TEID of cell B, an old UL TEID, and/or other suitable information/data (step 10c); the CU-CP 5732c sends a BRR CTXT MOD REQ to the CU-UP 5732u, which includes the DL TEID of cell B, SDAP configuration update and/or PDCP configuration update if needed (step 12); the CU-UP 5732u sends DL PDUs using previous DL TEID until PDCP reestablishment or data recovery, then sends using DL TEID of cell B (step and the DU 5731 sends UL PDUs using previous UL TEID until RLC reestablishment, then sends using the old UL TEID (step 16b).

Once the initial HO is performed, DU 5731 can further trigger HO (based on pre-configured candidate cells and L1 measurements) to any of candidate cells. For example, once the UE is handed over to cell A, it can further be handed over to cell B or back to the original cell.

Network signalling design for HO execution should be aligned regardless of initial HO execution or subsequent HO executions. The only difference is on the usage of UL TEID for subsequent handovers.

To meet the legacy intra-DU principle, UL TEID used for new cell B HO should be different to what has been used for cell A HO before. Previously for cell A HO, “new” UL TEIDs (provided by CU-UP 5732u based on request from CU-CP) was used by DU 5731 for initial DDDS as well as by CU-UP 5732u for DL delivery. Given that the DU 5731 knows that another HO (to cell B) is being executed, all we need to do is simply to toggle between old UL TEIDs and new UL TEIDs at DU 5731 to use to meet the legacy intra-DU principle and let CU-UP 5732u use the UL TEID of the initial DDDS sent from DU 5731 for subsequent DL delivery.

For subsequent HO executions, the same network signalling design as for initial HO execution is used, with the difference that DU 5731 toggles between old UL TEIDs and new UL TEIDs for initial DDDS by DU 5731 to let CU-UP 5732u use the UL TEID of initial DDDS sent from DU 5731 for subsequent DL delivery, in order to meet the legacy intra-DU principle of the special F1-U UL/DL TEID handling (see e.g., [TS38401] § 8.2.1.2.)

Additionally or alternatively, a list of UL TEIDs per each candidate cell can be allocated by CU-UP 5732u in advance, for which the DU 5731 and the CU-UP 5732u uses the UL TEID and DL TEID corresponding to the cell that the UE is handed over for initial DDDS and subsequent UL/DL delivery over F1-U.

Additionally or alternatively, a list of UL TEIDs and DL TEIDs can be allocated by CU-UP 5732u and DU 5731 in advance, for which DU 5731 and CU-UP 5732u uses the UL TEID and DL TEID in the order of each list for UL/DL delivery over F1-U whenever the UE handover is executed.

4.2. L1/L2 Based Inter-Du Mobility

The following discussion includes various procedures, data structures, and other technologies to support inter-DU mobility in a split NG-RAN architecture involving a CU-CP 5732c, a CU-UP 5732u, and a DU 5731. It should be noted that the following example implementations can be practiced by many more CU-CPs 5732c, a CU-UPs 5732u, and/or DUs 5731 than shown and/or described in the following description; and additional or alternative data structures and/or data elements can be used in the following procedures that the various data structures and/or data elements discussed infra

4.2.1. NW Preparation for Multiple Candidate Cell Configurations

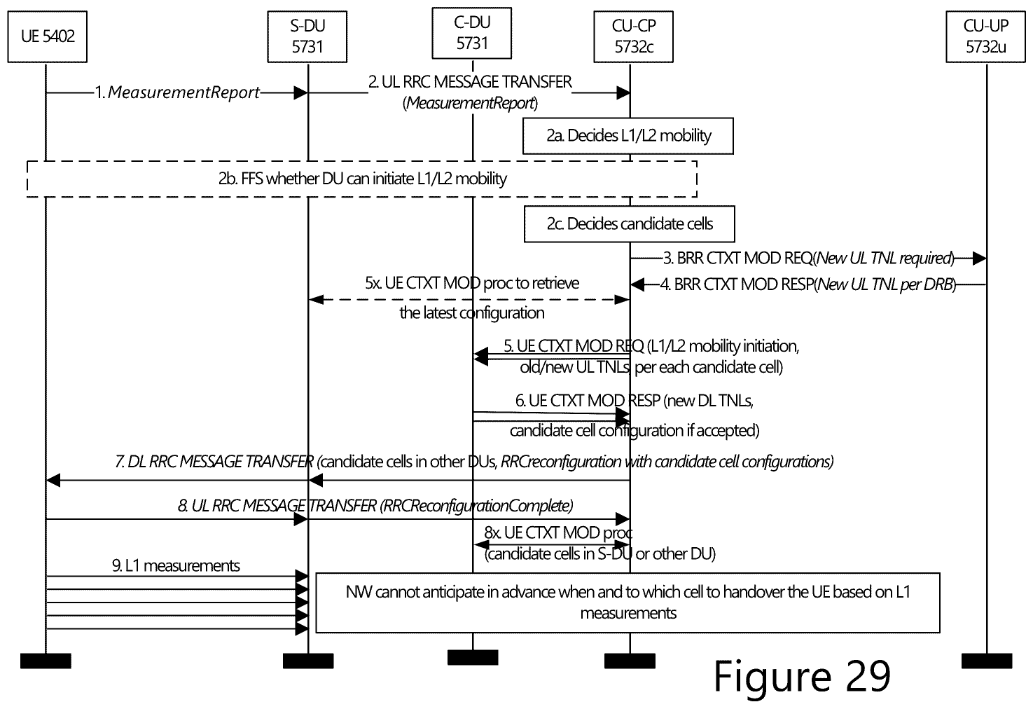

FIG. 29 shows an example NW preparation phase during intra-CU inter-DU L1/L2 mobility and/or for multiple candidate cell configurations, involving a a source DU (S-DU) 5731, candidate DU (C-DU) 5731, CU-CP 5732c, and CU-UP 5732u. The procedure of FIG. 29 is similar to the procedure of FIG. 24 with the following differences: a UE CTXT MOD procedure is performed between the S-DU 5731 and the CU-CP 5732c to retrieve a latest configuration (step the CU-CP 5732c sends a UE CTXT MOD REQ to the DU 5731, which includes old and/or new TNLs in addition to the information discussed previously (step 5); the UE 5402 sends a DL RRC MESSAGE TRANSFER to the CU-CP 5732c that includes candidate cells in one or more other DUs 5731 in addition to the RRCreconfiguration discussed previously (step 7); and a UE CTXT MOD procedure is performed between the C-DU 573 land the CU-CP 5732c to retrieve candidate cells in S-DU or other DU 5731 (step 8x).

Once CU-CP 5732c decides inter-DU L1/L2 mobility and which candidate cells to configure, following the legacy intra-DU HO principle, the CU-UP 5732u retrieves new UL TNL per DRB from CU-UP 5732u (same as discussed previously w.r.t procedure of FIG. 24).

In terms of preparing multiple candidate cell configurations with a candidate DU 5731 over F1, parallel preparation signalling each for each candidate cell via the UE Context Setup procedure is used, where DU 5731 is able to accept/reject the request for each candidate cell basis and also able to provide lower-layer configuration separately for each candidate cell.

In some implementations, an IE is added in/to the F1AP UE CONTEXT SETUP REQUEST message that handles L1/L2 mobility initiation/replace triggered by CU-CP 5732c (e.g., CHO/CPAC). An example implementation for F1AP (see e.g., [TS37483]) is discussed infra.

4.2.1.1. UE Context Setup

4.2.1.1.1. Successful Operation

If the Estimated Arrival Probability IE is contained in the Conditional Inter-DU Mobility Information IE or contained in the L1L2 Inter-DU Mobility Information IE included in the UE CONTEXT SETUP REQUEST message, then the gNB-DU may use the information to allocate necessary resources for the UE.

If the ul-GapFR2-Config IE is contained in the DU to CU RRC Information IE that is included in the UE CONTEXT SETUP RESPONSE message, the gNB-CU uses it as described in [TS 38331], if supported. The content and various other aspects of the UE CONTEXT SETUP RESPONSE message are described in [TS38473] § 9.2.2.2, and/or content discussed herein.

If the L1L2 Inter-DU Mobility Information IE is included in the UE CONTEXT SETUP REQUEST message, the gNB-DU shall consider that the request concerns an inter-DU L1/L2 based handover for the included SpCell ID IE and includes it as the Requested Target Cell ID IE in the UE CONTEXT SETUP RESPONSE message.

If the Target gNB-DU UE F1AP ID IE is contained in the L1L2 Inter-DU Mobility Information IE included in the UE CONTEXT SETUP REQUEST message, then the gNB-DU shall replace the existing prepared inter-DU L1/L2 based handover identified by the Target gNB-DU UE F1AP ID IE and the SpCell ID IE.

4.2.1.1.2. Unsuccessful Operation

FIG. 30 shows an example UE Context Setup Request procedure for unsuccessful operation. In this example, the gNB-CU 5732 sends a UE Context Setup Request message to the gNB-DU 5731, and the gNB-DU 5731 sends a UE Context Setup Failure message in response to the UE Context Modification Request message.

If the gNB-DU is not able to establish an F1 UE context, or cannot even establish one bearer it shall consider the procedure as failed and reply with the UE CONTEXT SETUP FAILURE message. If the Conditional Inter-DU Mobility Information IE was included in the UE CONTEXT SETUP REQUEST message or the L1L2 Inter-DU Mobility Information IE was included in the UE CONTEXT SETUP REQUEST message, the gNB-DU shall include the received SpCell ID IE as the Requested Target Cell ID IE in the UE CONTEXT SETUP FAILURE message.

If the gNB-DU is not able to accept the SpCell ID IE in UE CONTEXT SETUP REQUEST message, it shall reply with the UE CONTEXT SETUP FAILURE message with an appropriate cause value. Further, if the Candidate SpCell List IE is included in the UE CONTEXT SETUP REQUEST message and the gNB-DU is not able to accept the SpCell ID IE, the gNB-DU shall, if supported, include the Potential SpCell List IE in the UE CONTEXT SETUP FAILURE message and the gNB-CU should take this into account for selection of an opportune SpCell. The gNB-DU shall include the cells in the Potential SpCell List IE in a priority order, where the first cell in the list is the one most desired and the last one is the one least desired (e.g., based on load conditions). If the Potential SpCell List IE is present but no Potential SpCell Item IE is present, the gNB-CU should assume that none of the cells in the Candidate SpCell List IE are acceptable for the gNB-DU 5731.

4.2.1.1.3. Abnormal Conditions

If the gNB-DU receives a UE CONTEXT SETUP REQUEST message containing a E-UTRAN QoS IE for a GBR QoS DRB but where the GBR QoS Information IE is not present, the gNB-DU shall report the establishment of the corresponding DRB as failed in the DRB Failed to Setup List IE of the UE CONTEXT SETUP RESPONSE message with an appropriate cause value. If the gNB-DU receives a UE CONTEXT SETUP REQUEST message containing a DRB QoS IE for a GBR QoS DRB but where the GBR QoS Flow Information IE is not present, the gNB-DU shall report the establishment of the corresponding DRBs as failed in the DRB Failed to Setup List IE of the UE CONTEXT SETUP RESPONSE message with an appropriate cause value.

If the Delay Critical IE is included in the Dynamic 5QI Descriptor IE within the DRB QoS IE in the UE CONTEXT SETUP REQUEST message and is set to the value “delay critical” but the Maximum Data Burst Volume IE is not present, the gNB-DU shall report the establishment of the corresponding DRB as failed in the DRB Failed to Setup List IE of the of the UE CONTEXT SETUP RESPONSE message with an appropriate cause value.

In case of “CHO-replace” or “L1L2HO-replace” when the Target gNB-DU UE F1AP ID IE is included, if the candidate cell in the SpCell ID IE included in the UE CONTEXT SETUP REQUEST message was not prepared using the same UE-associated signaling connection, the gNB-DU shall ignore this candidate cell.

4.2.1.1.4. UE Context Management Messages

4.2.1.1.4.1. UE Context Setup Request

The UE context setup request message is sent by the gNB-CU 5732 to request the setup of a UE context. Direction of communication for this message is: gNB-CU 5732 gNB-DU 5731. Example contents and other aspects of the UE context setup request message are shown by tables 4.2.1.1.4.1-1, 4.2.1.1.4.1-2, and 4.2.1.1.4.1-3. Additional or alternative content and/or other aspects of the UE context modification request message are described in [TS38473] (see e.g., [TS38473] § 9.2.2.1).

TABLE 4.2.1.1.4.1-1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | reject |
| gNB-CU UE F1AP ID | M | | 9.3.1.4 | | YES | reject |
| gNB-DU UE F1AP ID | O | | 9.3.1.5 | | YES | ignore |
| SpCell ID | M | | NR CGI | Special Cell as | YES | reject |
| | | | 9.3.1.12 | defined in TS | | |
| | | | | 38.321 [16]. For | | |
| | | | | handover case, | | |
| | | | | this IE is | | |
| | | | | considered as | | |
| | | | | target cell. | | |

. . .

| | | | | | |
|---|---|---|---|---|---|
| Conditional Inter-DU | O | | | YES | reject |
| Mobility Information | | | | | |
| >CHO Trigger | M | ENUMERATED | | — | — |
| | | (CHO- | | | |
| | | initiation, | | | |
| | | CHO- | | | |
| | | replace, . . . ) | | | |
| >Target gNB-DU UE | C- | 9.3.1.5 | Allocated at the | — | — |
| F1AP ID | ifCHOmod | | target gNB-DU | | |
| >Estimated Arrival | O | INTEGER | | YES | ignore |
| Probability | | (1 . . . 100) | | | |

. . .

| | | | | | | |
|---|---|---|---|---|---|---|
| UE Multicast MRB to | | 0 . . . 1 | | | YES | reject |
| Be Setup List | | | | | | |
| >UE Multicast MRB to | | 1 .. | | | EACH | reject |
| Be Setup Item IEs | | <maxnoof | | | | |
| | | MRBsforUE> | | | | |
| >>MRB ID | M | | 9.3.1.224 | MRB ID for the | — | |
| | | | | UE. | | |
| >>MBS PTP | O | | 9.3.2.10 | | — | |
| Retransmission | | | | | | |
| Tunnel Required | | | | | | |
| >>MBS PTP | O | | MRB | | — | |
| Forwarding Tunnel | | | Progress | | | |
| Required Information | | | Information | | | |
| | | | 9.3.2.12 | | | |
| >>Source MRB ID | O | | 9.3.1.224 | In case of inter- | — | ignore |
| | | | MRB ID | DU handover, | | |
| | | | | indicates the | | |
| | | | | MRB ID | | |
| | | | | provided to the | | |
| | | | | UE in the source | | |
| | | | | cell. | | |
| L1L2 Inter-DU Mobility | O | | | | YES | reject |
| Information | | | | | | |
| >L1L2 Mobility Trigger | M | | ENUMERATED | | — | — |
| | | | (L1L2HO- | | | |
| | | | initiation, | | | |
| | | | L1L2HO- | | | |
| | | | replace, . . . ) | | | |
| >Target gNB-DU UE | C- | | 9.3.1.5 | Allocated at the | — | — |
| F1AP ID | ifL1L2HOmod | | | target gNB-DU | | |
| >Estimated Arrival | O | | INTEGER | | YES | ignore |
| Probability | | | (1 . . . 100) | | | |

TABLE 4.2.1.1.4.1-2

| Range bound | Explanation |
|---|---|
| maxnoofSCells | Maximum no. of SCells allowed towards one UE, the maximum |
| | value is 32. |
| maxnoofSRBs | Maximum no. of SRB allowed towards one UE, the maximum value |
| | is 8. |
| maxnoofDRBs | Maximum no. of DRB allowed towards one UE, the maximum value |
| | is 64. |
| maxnoofULUPTNLInformation | Maximum no. of ULUP TNL Information allowed towards one DRB, |
| | the maximum value is 2. |
| maxnoofCandidateSpCells | Maximum no. of SpCells allowed towards one UE, the maximum |
| | value is 64. |
| maxnoofQoSFlows | Maximum no. of flows allowed to be mapped to one DRB, the |
| | maximum value is 64. |
| maxnoofBHRLCChannels | Maximum no. of BH RLC channels allowed towards one IAB-node, |
| | the maximum value is 65536. |
| maxnoofSLDRBs | Maximum no. of SL DRB allowed for NR sidelink communication |
| | per UE, the maximum value is 512. |
| maxnoofPC5QoSFlows | Maximum no. of PC5 QoS flow allowed towards one UE for NR |
| | sidelink communication, the maximum value is 2048. |
| maxnoofAdditionalPDCPDuplicationTNL | Maximum no. of additional UP TNL Information allowed towards |
| | one DRB, the maximum value is 2. |
| maxnoofUuRLCChannels | Maximum no. of Uu Relay RLC channels for L2 U2N relaying per |
| | Relay UE, the maximum value is 32. |
| maxnoofPC5RLCChannels | Maximum no. of PC5 Relay RLC channels allowed for L2 U2N |
| | relaying per Remote UE or Relay UE, the maximum value is 512. |
| maxnoofMRBsforUE | Maximum no. of multicast MRB allowed towards one UE, the |
| | maximum value is 64. |

TABLE 4.2.1.1.4.1-3

| Condition | Explanation |
|---|---|
| ifDRBSetup | This IE shall be present only if the DRB |
| | to Be Setup List IE is present. |
| ifCHOmod | This IE shall be present if the CHO Trigger |
| | IE is present and set to “CHO-replace”. |
| ifL1L2HOmod | This IE shall be present if the L1L2 Mobility |
| | Trigger IE is present and set to “L1L2HO-replace”. |

Additionally or alternatively, it may be up to implementation, a new procedure, and/or a dedicated IE could be added onto F1AP specification (see e.g., [TS37483]) to achieve the aforementioned purpose(s). Additionally or alternatively, the same F1 UE-associated signalling can be maintained to configure multiple candidate cells.

After preparing multiple candidate cell configurations with a candidate DU 5731 over the F1 interface, allow DU 5731 and CU-CP 5732c to request cancellation of configured candidate cells. In some implementations, the Candidate Cells To Be Cancelled List IE is extended and/or included in the UE CONTEXT RELEASE REQUEST and the UE CONTEXT RELEASE COMMAND messages to handle cancellation request triggered by the DU 5731 and the CU-CP 5732c, respectively. Additionally or alternatively, new IE can be added for the UE CONTEXT RELEASE REQUEST and UE CONTEXT RELEASE COMMAND messages to handle cancellation request triggered by DU 5731 and CU-CP 5732c, respectively. An example implementation for F1AP (see e.g., [TS37483]) is discussed infra.

4.2.1.2. UE Context Release Request (GNB-DU Initiated)

4.2.1.2.1. General

The purpose of the UE Context Release Request procedure is to enable the gNB-DU to request the gNB-CU to release the UE-associated logical F1-connection or candidate cells in conditional handover or conditional PSCell addition or conditional PSCell change or L1/L2 based mobility. The procedure uses UE-associated signalling.

4.2.1.2.2. Successful Operation

FIG. 31 shows an example UE Context Release (gNB-DU initiated) procedure for successful operation. In this example, the gNB-DU 5731 sends a UE Context Release Request message to the gNB-CU 5732.

The gNB-DU controlling a UE-associated logical F1-connection initiates the procedure by generating a UE CONTEXT RELEASE REQUEST message towards the affected gNB-CU node. The UE CONTEXT RELEASE REQUEST message shall indicate the appropriate cause value.

If the Candidate Cells To Be Cancelled List IE or the L1L2 Candidate Cells To Be Cancelled List IE is included in the UE CONTEXT RELEASE REQUEST message, the gNB-CU shall consider that the only the resources reserved for the candidate cells identified by the included NR CGIs and associated to the UE-associated signaling identified by the gNB-CU UE F1AP ID IE and the gNB-DU UE F1AP ID IE are about to be released by the gNB-DU 5731.

Interactions with UE Context Release procedure: The UE Context Release procedure may be initiated upon reception of a UE CONTEXT RELEASE REQUEST message.

Interactions with UE Context Setup procedure: The UE Context Release Request procedure may be performed before the UE Context Setup procedure to request the release of an existing UE-associated logical F1-connection and related resources in the gNB-DU 5731.

4.2.1.2.3. Abnormal Conditions

If one or more candidate cells in the Candidate Cells To Be Cancelled List IE or the L1L2 Candidate Cells To Be Cancelled List IE included in the UE CONTEXT RELEASE REQUEST message were not prepared using the same UE-associated signaling connection, the gNB-CU shall ignore those non-associated candidate cells.

4.2.1.3. UE Context Release (GNB-CU Initiated)

4.2.1.3.1. General

The purpose of the UE Context Release procedure is to enable the gNB-CU to order the release of the UE-associated logical connection or candidate cells in conditional handover or conditional PSCell addition or conditional PSCell change or L1/L2 based mobility. The procedure uses UE-associated signalling.

4.2.1.3.2. Successful Operation

FIG. 32 shows an example UE Context Release (gNB-CU initiated) procedure for successful operation. In this example, the gNB-CU 5732 sends a UE Context Release Command message to the gNB-DU 5731, and the gNB-DU 5731 sends a UE Context Release Complete message in response to the UE Context Release Command message.

The gNB-CU initiates the procedure by sending the UE CONTEXT RELEASE COMMAND message to the gNB-DU 5731.

Upon reception of the UE CONTEXT RELEASE COMMAND message, the gNB-DU shall release all related signalling and user data transport resources and reply with the UE CONTEXT RELEASE COMPLETE message. If the CG-SDT Kept Indicator IE is contained in the UE CONTEXT RELEASE COMMAND message and set to “true”, the gNB-DU shall, if supported, consider that the UE is sent to RRC_INACTIVE state with CG-SDT configuration and store the configured CG-SDT resources, C-RNTI, CS-RNTI, the CG-SDT related RLC configurations and F1-U connections associated with the SDT bearers while releasing the UE context.

If the old gNB-DU UE F1AP ID IE is included in the UE CONTEXT RELEASE COMMAND message, the gNB-DU shall additionally release the UE context associated with the old gNB-DU UE F1AP ID.

If the UE CONTEXT RELEASE COMMAND message contains the RRC-Container IE, the gNB-DU shall send the RRC container to the UE via the SRB indicated by the SRB ID IE.

If the UE CONTEXT RELEASE COMMAND message includes the Execute Duplication IE, the gNB-DU shall perform CA based duplication, if configured, for the SRB for the included RRC-Container IE.

If the Candidate Cells To Be Cancelled List IE is included in the UE CONTEXT RELEASE COMMAND message, the gNB-DU shall consider that the gNB-CU is cancelling only the conditional handover or conditional PSCell addition or conditional PSCell change associated to the cells identified by the included NR CGIs and associated to the UE-associated signaling identified by the gNB-CU UE F1AP ID IE and the gNB-DU UE F1AP ID IE.

If the L1L2 Candidate Cells To Be Cancelled List IE is included in the UE CONTEXT RELEASE COMMAND message, the gNB-DU shall consider that the gNB-CU is cancelling only the L1/L2 based handover associated to the cells identified by the included NR CGIs and associated to the UE-associated signaling identified by the gNB-CU UE F1AP ID IE and the gNB-DU UE F1AP ID IE.

If the Positioning Context Reservation Indication IE is included in the UE CONTEXT RELEASE COMMAND message, the gNB-DU shall not release the positioning context including the SRS configuration for the UE.

Interactions with UE Context Setup procedure: The UE Context Release procedure may be performed before the UE Context Setup procedure to release an existing UE-associated logical F1-connection and related resources in the gNB-DU, e.g. when gNB-CU rejects UE access it shall trigger UE Context Release procedure with the cause value of UE rejection.

4.2.1.3.3. Abnormal Conditions

If one or more candidate cells in the Candidate Cells To Be Cancelled List IE or in the L1L2 Candidate Cells To Be Cancelled List IE included in the UE CONTEXT RELEASE COMMAND message were not prepared using the same UE-associated signalling connection, the gNB-DU shall ignore those non-associated candidate cells.

4.2.1.3.4. UE Context Release Request

The UE context release request message is sent by the gNB-DU 5731 to request the gNB-CU 5732 to release the UE-associated logical F1 connection or candidate cells in conditional handover or conditional PSCell addition or conditional PSCell change or L1/L2 based mobility. Direction of communication for this message is: gNB-DU 5731→gNB-CU 5732. Example contents and other aspects of the UE context release request message are shown by tables 4.2.1.3.4-1 and 4.2.1.3.4-2. Additional or alternative content and/or other aspects of the UE context modification request message are described in [TS38473] (see e.g., [TS38473] § 9.2.2.4).

TABLE 4.2.1.3.4-1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | ignore |
| gNB-CU UE F1AP ID | M | | 9.3.1.4 | | YES | reject |
| gNB-DU UE F1AP ID | M | | 9.3.1.5 | | YES | reject |
| Cause | M | | 9.3.1.2 | | YES | ignore |
| Candidate Cells To Be | | 0.. | | | YES | reject |
| Cancelled List | | <maxnoof | | | | |
| | | CellsinCHO> | | | | |
| >Target Cell ID | M | | NR CGI | | — | — |
| | | | 9.3.1.12 | | | |
| L1L2 Candidate Cells | | 0.. | | | YES | reject |
| To Be Cancelled List | | <maxnoof | | | | |
| | | CellsinL1- | | | | |
| | | L2mobility> | | | | |
| >Target Cell ID | M | | NR CGI | | — | — |
| | | | 9.3.1.12 | | | |

TABLE 4.2.1.3.4-2

| Range bound | Explanation |
|---|---|
| maxnoofCellsinCHO | Maximum no. cells that can be prepared for a conditional mobility. |
| | Value is 8. |
| maxnoofCellsinL1L2mobility | Maximum no. cells that can be prepared for a L1/L2 based mobility. |
| | Value is 8. |

4.2.1.3.5. UE Context Release Command

The UE context release command message is sent by the gNB-CU 5732 to request the gNB-DU 5731 to release the UE-associated logical F1 connection or candidate cells in conditional handover or conditional PSCell addition or conditional PSCell change or L1/L2 based mobility. Direction of communication for this message is: gNB-CU 5732 gNB-DU 5731. Example contents and other aspects of the UE context release command message are shown by tables 4.2.1.3.5-1, 4.2.1.3.5-2, and 4.2.1.3.5-3. Additional or alternative content and/or other aspects of the UE context modification request message are described in [TS38473] (see e.g., [TS38473] § 9.2.2.5).

TABLE 4.2.1.3.5-1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | reject |
| gNB-CU UE F1AP ID | M | | 9.3.1.4 | | YES | reject |
| gNB-DU UE F1AP ID | M | | 9.3.1.5 | | YES | reject |
| Cause | M | | 9.3.1.2 | | YES | ignore |
| RRC-Container | O | | 9.3.1.6 | Includes the DL- | YES | ignore |
| | | | | DCCH-Message | | |
| | | | | IE as defined in | | |
| | | | | subclause 6.2 of | | |
| | | | | TS 38.331 [8] | | |
| | | | | encapsulated in | | |
| | | | | a PDCP PDU, or | | |
| | | | | the DL-CCCH- | | |
| | | | | Message IE as | | |
| | | | | defined in | | |
| | | | | subclause 6.2 of | | |
| | | | | TS 38.331 [8]. | | |

. . .

| | | | | | |
|---|---|---|---|---|---|
| Candidate Cells To Be | | 0.. | | YES | reject |
| Cancelled List | | <maxnoof | | | |
| | | CellsinCHO> | | | |
| >Target Cell ID | M | | NR CGI | — | — |
| | | | 9.3.1.12 | | |
| Positioning Context | O | | ENUMER- | YES | ignore |
| Reservation Indication | | | ATED | | |
| | | | (True, . . .) | | |
| CG-SDT Kept Indicator | O | | ENUMER- | YES | ignore |
| | | | ATED | | |
| | | | (true, . . .) | | |
| L1L2 Candidate Cells | | 0.. | | YES | reject |
| To Be Cancelled List | | <maxnoof | | | |
| | | CellsinL1- | | | |
| | | L2mobility> | | | |
| >Target Cell ID | M | | NR CGI | — | — |
| | | | 9.3.1.12 | | |

TABLE 4.2.1.3.5-2

| Range bound | Explanation |
|---|---|
| maxnoofCellsinCHO | Maximum no. cells that can be |
| | prepared for a conditional mobility. Value is 8. |

TABLE 4.2.1.3.5-3

| Condition | Explanation |
|---|---|
| ifRRCContainer | This IE shall be present if the RRC container IE is present. |
| maxnoofCellsinL1L2mobility | Maximum no. cells that can be prepared for a L1/L2 based mobility. |
| | Value is 8. |

4.2.1.3.6. UE Context Release Complete

The UE context release complete message is sent by the gNB-DU 5731 to confirm the release of the UE-associated logical F1 connection or candidate cells in conditional handover or conditional PSCell addition or conditional PSCell change or L1/L2 based mobility. Direction of communication for this message is: gNB-DU 5731 gNB-CU 5732. Example contents and other aspects of the UE context release command message are shown by table 4.2.1.3.6-1. Additional or alternative content and/or other aspects of the UE context modification request message are described in [TS38473] (see e.g., [TS38473] § 9.2.2.6).

TABLE 4.2.1.3.6-1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | reject |
| gNB-CU UE F1AP ID | M | | 9.3.1.4 | | YES | reject |
| gNB-DU UE F1AP ID | M | | 9.3.1.5 | | YES | reject |
| Criticality Diagnostics | O | | 9.3.1.3 | | YES | ignore |

Additionally or alternatively, it is up to implementation, a new procedure or a dedicated IE could be added onto F1AP specification (see e.g., [TS37483]) to achieve this purpose.

In some implementations, when preparing multiple candidate cell configurations with a candidate DU 5731 over the F1 interface, the CU-CP 5732c configures two UL TNLs for each DRB (e.g., one is with old UL TEID that has been used with the source DU 5731, the other is with new UL TEID that is retrieved from CU-UP 5732u by CU-CP 5732c) in order to properly meet the legacy intra-DU principle of the special F1-U UL/DL TEID handling in case HO within a candidate DU 5731 (e.g., intra-DU 5731) may happen.

When preparing multiple candidate cell configurations with a candidate DU 5731 over F1, CU-CP 5732c provides two UL TNLs for each DRB (one is with old UL TEID that has been used with the source DU 5731, the other is with new UL TEID that is retrieved from CU-UP 5732u by CU-CP) for each DRB, so that DU 5731 can meet the legacy intra-DU HO principle and use it when “intra-DU” L1/L2 mobility is executed in case HO within a candidate DU 5731 (e.g., intra-DU) may happen.

In some implementations, the existing UL UP TNL Information is reused to be setup List IE in the DRB to Setup List IE of the F1AP UE CONTEXT SETUP REQUEST message to provide two new UL TEIDs to the DU 5731, with adapting the behavior as follows.

4.2.1.4. UE Context Setup

4.2.1.4.1. Successful Operation

If the ul-GapFR2-Config IE is contained in the DU to CU RRC Information IE that is included in the UE CONTEXT SETUP RESPONSE message, the gNB-CU shall, if supported, use it as described in [TS38331].

If the L1L2 Inter-DU Mobility Information IE is included in the UE CONTEXT SETUP REQUEST message, and if two UL UP TNL Information IEs are also included for a DRB, then gNB-DU shall include two DL UP TNL Information IEs in UE CONTEXT SETUP RESPONSE message. The gNB-CU and gNB-DU use the UL UP TNL Information IEs and DL UP TNL Information IEs to support change of F1-U UL/DL TEIDs during the intra-DU L1/L2 based HO as specified in [TS38401].

Additionally or alternatively, it is up to implementation, a new procedure, and/or a dedicated IE could be added onto F1AP specification (see e.g., [TS37483]) to achieve this purpose. Moreover, candidate cells within the source DU 5731 may also be decided to be configured to the UE together with the candidate cells in other candidate DU(s) 5731.

Those candidate cells under the source DU 5731 have to be configured to the candidate DU 5731 and vice versa, in order for the source DU 5731 or a candidate DU 5731 properly to execute inter-DU HO. DU 5731 is the one who executes HO and any DU 5731 (either a candidate or the source) should know the prepared candidate cells in other DU(s) 5731 that are also configured to the UE.

After preparing multiple candidate cell configurations with a candidate DU 5731 over F1, CU-CP 5732c provides the candidate cells to the DU 5731 that have been prepared with other DU(s) 5731.

One possible implementation would be to extend the F1AP UE CONTEXT MODIFICATION REQUEST message to provide the candidate cells to a candidate DU 5731 that have been prepared with other DU(s) 5731. An example implementation for F1AP (see e.g., [TS37483]) is as follows.

4.2.1.5. UE Context Modification (GNB-CU Initiated)

4.2.1.5.1. Successful Operation

If the ul-GapFR2-Config IE is contained in the DU to CU RRC Information IE that is included in the UE CONTEXT MODIFICATION RESPONSE message, the gNB-CU shall, if supported, use it as described in [TS38331].

If the L1L2 Inter-DU Mobility Information IE is included in the UE CONTEXT MODIFICATION REQUEST message and contains the Candidate Cells List IE, the gNB-DU shall consider that the L1/L2 based mobility has been prepared for the UE in other gNB-DU(s) for the target cell IDs included in the Candidate Cells List IE. If the Estimated Arrival Probability IE is also included for a target cell included in the Candidate Cells List IE, then the gNB-DU may use the information to decide L1/L2 based handover execution for the UE. If the Other UE-associated Logical F1-Connection List for Candidate Cells IE is also contained in the L1L2 Inter-DU Mobility Information IE, then the gNB-DU shall consider that each UE-associated signalling identified by each pair of the included gNB-CU UE F1AP ID IE and gNB-DU UE F1AP ID IE has been established for the same UE in the gNB-DU for L1/L2 inter-DU handover and shall consider their associated candidate cells stored in the gNB-DU have been also configured for the same UE 5402.

4.2.1.5.2. UE Context Modification Request

The UE context modification request message is sent by the gNB-CU 5732 to provide UE context information changes to the gNB-DU 5731. Direction of communication for this message is: gNB-CU 5732 gNB-DU 5731. Example contents and other aspects of the UE context release command message are shown by tables 4.2.1.5.2-1, 4.2.1.5.2-2, and 4.2.1.5.2-3. Additional or alternative content and/or other aspects of the UE context modification request message are described in [TS38473] (see e.g., [TS38473] § 9.2.2.7).

TABLE 4.2.1.5.2-1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | reject |
| gNB-CU UE F1AP ID | M | | 9.3.1.4 | | YES | reject |
| gNB-DU UE F1AP ID | M | | 9.3.1.5 | | YES | reject |
| SpCell ID | O | | NR CGI | Special Cell as | YES | ignore |
| | | | 9.3.1.12 | defined in TS | | |
| | | | | 38.321 [16]. For | | |
| | | | | handover case, | | |
| | | | | this IE is | | |
| | | | | considered as | | |
| | | | | target cell. | | |

. . .

| | | | | | |
|---|---|---|---|---|---|
| Conditional Intra-DU | O | | | YES | reject |
| Mobility Information | | | | | |
| >CHO Trigger | M | | ENUMER- | — | — |
| | | | ATED | | |
| | | | (CHO- | | |
| | | | initiation, | | |
| | | | CHO- | | |
| | | | replace, | | |
| | | | CHO- | | |
| | | | cancel, | | |
| >Candidate Cells To | C- | 0.. | | — | — |
| Be Cancelled List | ifCHO- | <maxnoof | | | |
| | cancel | Cellsin- | | | |
| | | CHO> | | | |
| >>Target Cell ID | M | | NR CGI | — | — |
| | | | 9.3.1.12 | | |
| >Estimated Arrival | O | | INTEGER | YES | ignore |
| Probability | | | (1..100) | | |

. . .

| | | | | | |
|---|---|---|---|---|---|
| SDT Bearer | O | | ENUMER- | YES | ignore |
| Configuration Query | | | ATED | | |
| Indication | | | (true, . . .) | | |
| L1L2 Inter-DU Mobility | O | | | YES | reject |
| Information | | | | | |
| >Candidate Cells | | 0.. | | — | — |
| List | | <maxnoof | | | |
| | | CellsinL1- | | | |
| | | L2mobility> | | | |
| >>Target Cell ID | M | | NR CGI | — | — |
| | | | 9.3.1.12 | | |
| >>Estimated Arrival | O | | INTEGER | YES | ignore |
| Probability | | | (1..100) | | |
| >Other UE- | | 0.. | | EACH | ignore |
| associated Logical | | <maxnoof | | | |
| F1-Connection List | | CellsinL1- | | | |
| for Candidate Cells | | L2mobility> | | | |
| >>gNB-CU UE F1AP | M | | 9.3.1.4 | — | — |
| ID | | | | | |
| >>gNB-DU UE F1AP | M | | 9.3.1.5 | — | — |
| ID | | | | | |

TABLE 4.2.1.5.2-2

| Range bound | Explanation |
|---|---|
| maxnoofSCells | Maximum no. of SCells allowed towards one UE, the maximum |
| | value is 32. |
| maxnoofSRBs | Maximum no. of SRB allowed towards one UE, the maximum |
| | value is 8. |
| maxnoofDRBs | Maximum no. of DRB allowed towards one UE, the maximum |
| | value is 64. |
| maxnoofULUPTNLInformation | Maximum no. of UL UP TNL Information allowed towards one |
| | DRB, the maximum value is 2. |
| maxnoofQoSFlows | Maximum no. of flows allowed to be mapped to one DRB, the |
| | maximum value is 64. |
| maxnoofBHRLCChannels | Maximum no. of BH RLC channels allowed towards one IAB- |
| | node, the maximum value is 65536. |
| maxnoofSLDRBs | Maximum no. of SL DRB allowed for NR sidelink communication |
| | per UE, the maximum value is 512. |
| maxnoofPC5QoSFlows | Maximum no. of PC5 QoS flow allowed towards one UE for NR |
| | sidelink communication, the maximum value is 2048. |
| maxnoofAdditionalPDCPDuplicationTNL | Maximum no. of additional UP TNL Information allowed towards |
| | one DRB, the maximum value is 2. |
| maxnoofCellsinCHO | Maximum no. cells that can be prepared for a conditional mobility. |
| | Value is 8. |
| maxnoofUuRLCChannels | Maximum no. of Uu Relay RLC channels for L2 U2N relaying per |
| | Relay UE, the maximum value is 32. |
| maxnoofPC5RLCChannels | Maximum no. of PC5 Relay RLC channel allowed for L2 U2N |
| | relaying per Remote UE or Relay UE, the maximum value is 512. |
| maxnoofMRBsforUE | Maximum no. of multicast MRB allowed towards one UE, the |
| | maximum value is 64. |
| maxnoofSLdestinations | Maximum number of destination for NR sidelink communication, |
| | the maximum value is 32 |
| maxnoofCellsinL1L2mobility | Maximum no. cells that can be prepared for a L1/L2 based |
| | mobility. Value is 8. |

TABLE 4.2.1.5.2-3

| Condition | Explanation |
|---|---|
| ifCHOcancel | This IE may be present if the CHO |
| | Trigger IE is present and set to “CHO-cancel”. |

Additionally or alternatively, it is up to implementation, a new procedure, and/or a dedicated IE could be added onto F1AP specification (see e.g., [TS37483]) to achieve this purpose. Additionally or alternatively, a new F1 UE-associated signalling can be used.

After preparing multiple candidate cell configurations with a candidate DU 5731 over the F1 interface, CU-CP 5732c provides the candidate cells to the source DU that have been prepared with other DU(s) 5731.

In some implementations, the F1AP DL RRC MESSAGE TRANSFER message is extended to provide the candidate cells to the source DU 5731 that have been prepared with other DU(s) 5731 when sending HO configuration to the UE. An example implementation for F1AP (see e.g., [TS37483]) is as follows.

4.2.1.6. 8.4.2 DL RRC Message Transfer

4.2.1.6.1. 8.4.2.1 General

The purpose of the DL RRC Message Transfer procedure is to transfer an RRC message The procedure uses UE-associated signalling.

4.2.1.6.2. 8.4.2.2 Successful Operation

FIG. 33 shows an example DL RRC Message Transfer procedure. The gNB-CU initiates the procedure by sending a DL RRC MESSAGE TRANSFER message. If a UE-associated logical F1-connection exists, the DL RRC MESSAGE TRANSFER message shall contain the gNB-DU UE F1AP ID IE, which should be used by gNB-DU to lookup the stored UE context. If no UE-associated logical F1-connection exists, the UE-associated logical F1-connection shall be established at reception of the DL RRC MESSAGE TRANSFER message.

If the Index to RAT/Frequency Selection Priority IE is included in the DL RRC MESSAGE TRANSFER, the gNB-DU may use it for RRM purposes. If the Additional RRM Policy Index IE is included in the DL RRC MESSAGE TRANSFER, the gNB-DU may use it for RRM purposes.

The DL RRC MESSAGE TRANSFER message shall include, if available, the old gNB-DU UE F1AP ID IE so that the gNB-DU can retrieve the existing UE context in RRC connection reestablishment procedure, as defined in [TS38401].

The DL RRC MESSAGE TRANSFER message shall include, if SRB duplication is activated, the Execute Duplication IE, so that the gNB-DU can perform CA based duplication for the SRB.

If the gNB-DU identifies the UE-associated logical F1-connection by the gNB-DU UE F1AP ID IE in the DL RRC MESSAGE TRANSFER message and the old gNB-DU UE F1AP ID IE is included, it shall release the old gNB-DU UE F1AP ID and the related configurations associated with the old gNB-DU UE F1AP ID.

If the UE Context not retrievable IE set to “true” is included in the DL RRC MESSAGE TRANSFER, the DL RRC MESSAGE TRANSFER may contain the Redirected RRC message IE and use it as specified in [TS38401].

If the UE Context not retrievable IE set to “true” is included in the DL RRC MESSAGE TRANSFER, the DL RRC MESSAGE TRANSFER may contain the PLMN Assistance Info for Network Sharing IE, if available at the gNB-CU and may use it as specified in [TS38401].

If the DL RRC MESSAGE TRANSFER message contains the New gNB-CU UE F1AP ID IE, the gNB-DU shall, if supported, replace the value received in the gNB-CU UE F1AP ID IE by the value of the New gNB-CU UE F1AP ID and use it for further signalling.

If the DL RRC MESSAGE TRANSFER message contains the L1L2 Inter-DU Mobility Information IE, the gNB-DU shall consider that the L1/L2 based mobility has been prepared for the UE in other gNB-DU(s) for the target cell IDs included in the Candidate Cells List IE. If the Estimated Arrival Probability IE is also included for a target cell included in the Candidate Cells List IE, then the gNB-DU may use the information to decide L1/L2 based handover execution for the UE.

Interactions with UE Context Release Request procedure: If the UE Context not retrievable IE set to “true” is included in the DL RRC MESSAGE TRANSFER, the gNB-DU may trigger the UE Context Release Request procedure, as specified in [TS38401].

4.2.1.7. RRC Message Transfer Messages

4.2.1.7.1. DL RRC Message Transfer

This message is sent by the gNB-CU to transfer the layer 3 message to the gNB-DU over the F1 interface. Direction of communication for this message is: gNB-CU 5732→gNB-DU 5731. Example contents and other aspects of the UE context release command message are shown by tables 4.2.1.7.1-1 and 4.2.1.7.1-2. Additional or alternative content and/or other aspects of the UE context modification request message are described in [TS38473] (see e.g., [TS38473] § 9.2.3.2).

TABLE 4.2.1.7.1-1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | ignore |
| gNB-CU UE F1AP ID | M | | 9.3.1.4 | | YES | reject |
| gNB-DU UE F1AP ID | M | | 9.3.1.5 | | YES | reject |
| old gNB-DU UE F1AP ID | O | | 9.3.1.5 | | YES | reject |
| SRB ID | M | | 9.3.1.7 | | YES | reject |
| Execute Duplication | O | | ENUMER- | | YES | ignore |
| | | | ATED | | | |
| | | | (true, . . .) | | | |
| RRC-Container | M | | 9.3.1.6 | Includes the DL- | YES | reject |
| | | | | DCCH-Message | | |
| | | | | IE as defined in | | |
| | | | | subclause 6.2 of | | |
| | | | | TS 38.331 [8] | | |
| | | | | encapsulated in a | | |
| | | | | PDCP PDU, or the | | |
| | | | | DL-CCCH- | | |
| | | | | Message IE as | | |
| | | | | defined in | | |
| | | | | subclause 6.2 of | | |
| | | | | TS 38.331 [8]. | | |
| RAT-Frequency Priority | O | | 9.3.1.34 | | YES | reject |
| Information | | | | | | |
| RRC Delivery Status | O | | ENUMER- | Indicates whether | YES | ignore |
| Request | | | ATED | RRC DELIVERY | | |
| | | | (true, . . .) | REPORT | | |
| | | | | procedure is | | |
| | | | | requested for the | | |
| | | | | RRC message. | | |
| UE Context not | O | | ENUMER- | | YES | reject |
| retrievable | | | ATED | | | |
| | | | (true, . . .) | | | |
| Redirected RRC | O | | RRC | Includes the UL- | YES | reject |
| message | | | Container | CCCH-Message | | |
| | | | 9.3.1.6 | IE as defined in | | |
| | | | | subclause 6.2 of | | |
| | | | | TS 38.331 [8]. | | |
| PLMN Assistance Info | O | | PLMN | | YES | ignore |
| for Network Sharing | | | Identity | | | |
| | | | 9.3.1.14 | | | |
| New gNB-CU UE F1AP | O | | gNB-CU UE | | YES | reject |
| ID | | | F1AP ID | | | |
| | | | 9.3.1.4 | | | |
| Additional RRM Policy | O | | 9.3.1.90 | | YES | ignore |
| Index | | | | | | |
| L1L2 Inter-DU Mobility | O | | | | YES | reject |
| Information | | | | | | |
| >Candidate Cells List | | 1 .. | | | — | — |
| | | <maxno- | | | | |
| | | ofCells- | | | | |
| | | inL1L2- | | | | |
| | | mobility> | | | | |
| >>Target Cell ID | M | | NR CGI | | — | — |
| | | | 9.3.1.12 | | | |
| >>Estimated Arrival | O | | INTEGER | | YES | ignore |
| Probability | | | (1..100) | | | |

TABLE 4.2.1.7.1-2

| Range bound | Explanation |
|---|---|
| maxnoofCellsinL1L2mobility | Maximum no. cells that can be prepared for a L1/L2 based mobility. |
| | Value is 8. |

4.2.2. HO Execution

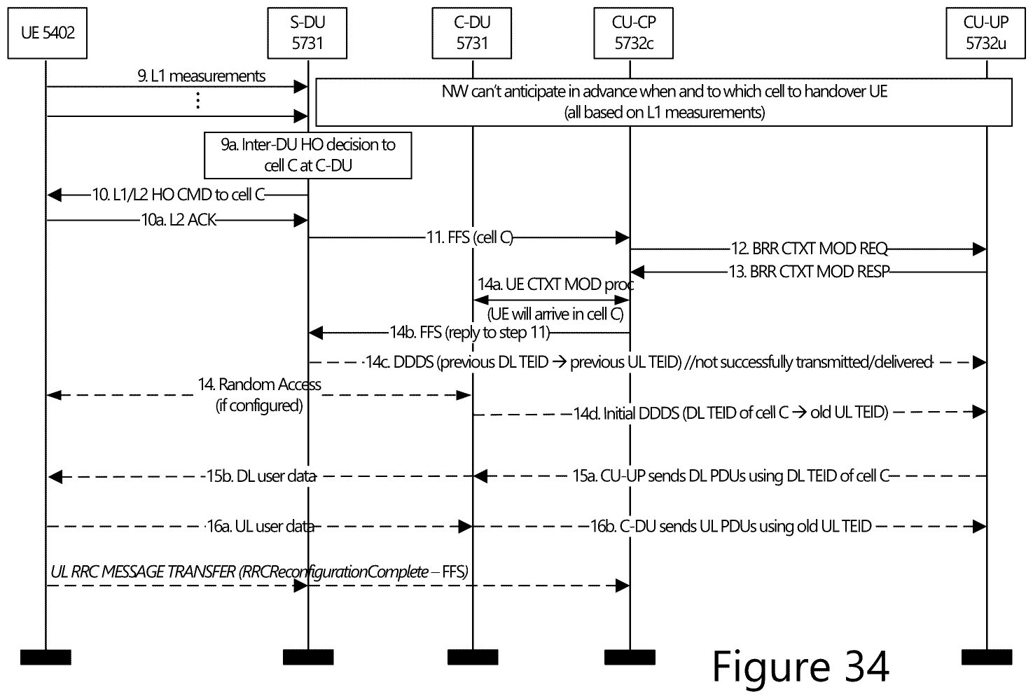

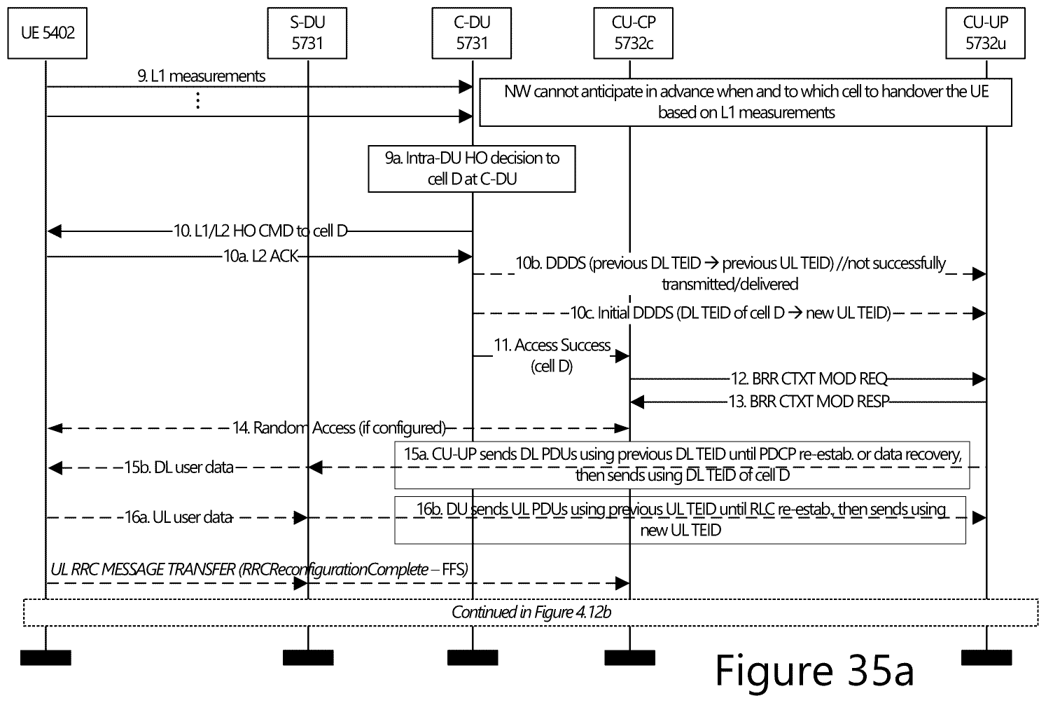

FIG. 34 shows an example procedure for inter-DU HO execution during intra-CU inter-DU L1/L2 mobility and/or for inter-DU HO execution (e.g., to cell C), involving a a source DU (S-DU) 5731, candidate DU (C-DU) 5731, CU-CP 5732c, and CU-UP 5732u. The procedure of FIG. 34 is similar to the procedure of FIG. 26 with the following differences: the S-DU 5731 determines/decides to perform an inter-DU HO to a cell C at the C-DU 5731 (step 9a); the S-DU 5731 sends an L1/L2 HO command (CMD) to the UE 5402 instructing the UE 5402 to HO to cell C (step 10); the S-DU 5731 sends a message (to be determined or FFS) for cell C to the CU-CP 5732c (step 11); the CU-CP 5732c sends a BRR CTXT MOD REQ to the CU-UP 5732u, which includes a DL TEID of cell C, SDAP/PDCP configuration update(s) if needed, and/or security key update if needed (step 12); the CU-CP 5732c performs a UE CTXT MOD procedure with the C-DU 5731 indicating that the UE will arrive in cell C (step 14a); the CU-CP 5732c sends a response to the message sent at step 11 (step 14b); the S-DU 5731 sends a DDDS message towards the CU-UP 5732u, which may not be successfully transmitted and/or delivered to the CU-UP 5732u, and the DDDS message may include a previous DL TEID, a previous UL TEID, and/or other suitable information/data (step 14c); the C-DU 5731 and the UE 54 perform a random access procedure, if configured (step 14); the C-DU 5731 sends an initial DDDS message towards the CU-UP 5732u, which may include the DL TEID of cell C, an old UL TEID, and/or other suitable information/data (step 14d); the CU-UP 5732u sends DL PDUs to the C-DU 5731 using DL TEID of cell C (step and the C-DU 5731 sends UL PDUs to the CU-UP 5732u using previous/old UL TEID (step 16b). In some implementations, the initial DDDS message is sent before, during, or after the UE 5402 performs the random access procedure with the C-DU 5731.

As in L1/L2 based intra-DU mobility case, it is beneficial to continue the mobility procedure once DU 5731 confirms successful delivery of L1/2 HO CMD without relying on RACH (optional) or RRC Reconfiguration Complete (pending RAN2). Then, inter-DU HO happens from a DU 5731 (called source DU 5731) that sent L1/2 HO CMD to a cell in another DU 5731 (called target DU 5731). In order to minimize latency, it would be good for the source DU 5731 to propagate HO execution to CU-CP 5732c and toward the target DU 5731 as soon as it confirms, so that CU-UP 5732u can be ready with the target DU 5731 and the target DU 5731 can be ready to trigger initial DDDS to the CU-UP 5732u as early as possible. Once these steps are successfully performed, an ack can be replied from CU-CP 5732c to let the source DU 5731 aware that the propagation was successful and trigger DDDS to inform not successfully transmitted/delivered PDUs to CU-UP.

Once DU 5731 decides which cell to move the UE based on L1 measurements and receives successful ACK for L1/2 HO CMD sent to the UE, then to minimize latency, continue the mobility procedure before RACH (optional) or RRC Reconfiguration Complete (which may be the same as the procedures of FIGS. 24-28)

The DU 5731 who executed HO and confirms further propagates HO execution to CU-UP 5732u and the target DU 5731 as soon as it confirms so that CU-UP 5732u can be ready with the target DU 5731 and the target DU 5731 can be ready to trigger initial DDDS to CU-UP 5732u as early as possible.

In some implementations, the DU-initiated class-1 procedure (e.g., steps 11 and 14b) is used to propagate HO execution to CU-CP 5732c and the target DU 5731 as soon as it confirms. Additionally or alternatively, the existing DU-initiated class-1 procedure could be re-used/extended, it can be up to implementation, a new dedicated procedure, and/or a dedicated IE could be added onto F1AP (see e.g., [TS37483]) or F1-U (see e.g., [TS38425]) specifications to achieve this purpose.

Additionally or alternatively, once the CU-CP 5732c receives such propagation of HO execution from DU 5731, the CU-CP 5732c can further propagate to the target DU 5731 (e.g., C-DU 5731). An example implementation that extends the F1AP UE Context Modification procedure is discussed infra.

4.2.2.1. 8.3.4 UE Context Modification (GNB-CU Initiated)

4.2.2.1.1. 8.3.4.2 Successful Operation

If the ul-GapFR2-Config IE is contained in the DU to CU RRC Information IE that is included in the UE CONTEXT MODIFICATION RESPONSE message, the gNB-CU shall, if supported, use it as described in [TS38331].

If the L1L2 Inter-DU Mobility Information IE is included in the UE CONTEXT MODIFICATION REQUEST message and contains the Access Target Cell ID IE, the gNB-DU shall consider that the UE has successfully been commanded to execute HO during the L1/L2 based mobility toward that target cell and act as specified in [TS38401].

4.2.2.1.2. UE Context Modification Request

The UE context modification request message is sent by the gNB-CU 5732 to provide UE context information changes to the gNB-DU 5731. Direction of communication for this message is: gNB-CU 5732 gNB-DU 5731. Example contents and other aspects of the UE context release request message are shown by table 4.2.2.1.2-1. Additional or alternative content and/or other aspects of the UE context modification request message are described in [TS38473] (see e.g., [TS38473] § 9.2.2.7).

TABLE 4.2.2.1.2-1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | reject |
| gNB-CU UE F1AP ID | M | | 9.3.1.4 | | YES | reject |
| gNB-DU UE F1AP ID | M | | 9.3.1.5 | | YES | reject |
| SpCell ID | O | | NR CGI | Special Cell | YES | ignore |
| | | | 9.3.1.12 | as defined in | | |
| | | | | TS 38.321 | | |
| | | | | [16]. For | | |
| | | | | handover | | |
| | | | | case, this IE is | | |
| | | | | considered as | | |
| | | | | target cell. | | |

. . .

| | | | | | |
|---|---|---|---|---|---|
| Conditional Intra-DU | O | | | YES | reject |
| Mobility Information | | | | | |
| >CHO Trigger | M | | ENUMER- | — | — |
| | | | ATED | | |
| | | | (CHO- | | |
| | | | initiation, | | |
| | | | CHO- | | |
| | | | replace, | | |
| | | | CHO- | | |
| | | | cancel, . . .) | | |
| >Candidate Cells To | C- | 0.. | | — | — |
| Be Cancelled List | ifCHO- | <maxnoof | | | |
| | cancel | CellsinCHO> | | | |
| >>Target Cell ID | M | | NR CGI | — | — |
| | | | 9.3.1.12 | | |
| >Estimated Arrival | O | | INTEGER | YES | ignore |
| Probability | | | (1..100) | | |
| SDT Bearer | O | | ENUMER- | YES | ignore |
| Configuration Query | | | ATED | | |
| Indication | | | (true, . . .) | | |
| L1L2 Inter-DU Mobility | O | | | YES | reject |
| Information | | | | | |
| >Access Target Cell ID | O | | NR CGI | — | — |
| | | | 9.3.1.12 | | |

Additionally or alternatively, it is up to implementation, the successful ACK replied from CU-CP 5732c (step 14b) could let the DU 5731 trigger DDDS to inform not successfully transmitted/delivered PDUs to CU-UP.

4.2.3. Subsequent HO Executions

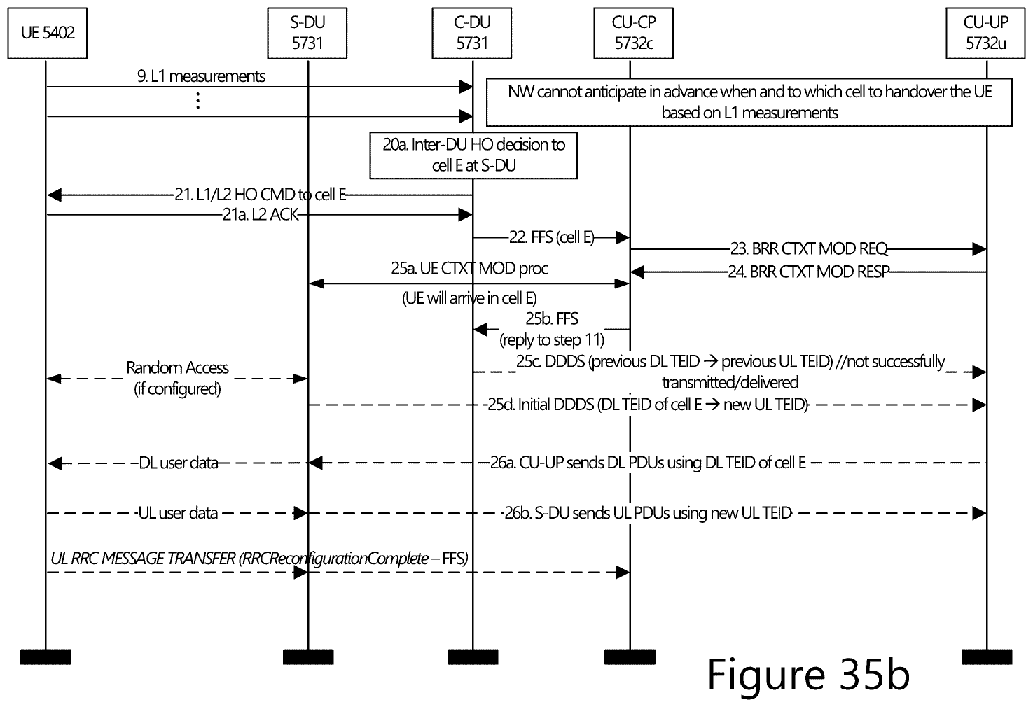

FIGS. 35a and 35b show an example procedure for intra-DU or inter-DU subsequent HO execution during intra-CU inter-DU L1/L2 mobility and/or for inter-DU subsequent HO execution (e.g., HO to cell D in the candidate DU 5731) or intra-DU subsequent HO execution (e.g., HO to cell E in the source DU 5731), involving a a source DU (S-DU) 5731, candidate DU (C-DU) 5731, CU-CP 5732c, and CU-UP 5732u. The procedure of FIGS. 35a and 35b is similar to the procedure of FIGS. 4.5 with the following differences:

Referring to FIG. 35a, the C-DU 5731 determines/decides to perform an intra-DU HO to a cell D at the C-DU 5731 (step 9a); the C-DU 5731 sends an L1/L2 HO CMD to the UE 5402 instructing the UE 5402 to HO to cell D (step 10); the C-DU 5731 sends a DDDS message towards the CU-UP 5732u, which informs the CU-UP 5732u of unsuccessfully transmitted and/or delivered PDUs (step 10b); the C-DU 5731 sends an initial DDDS message towards the CU-UP 5732u that includes the DL TEID of cell D and/or other suitable information/data (step 10c); the C-DU 5731 sends an access success for cell D to the CU-CP 5732c (step 11); the CU-CP 5732c sends a BRR CTXT MOD REQ to the CU-UP 5732u, which includes a DL TEID of cell D, SDAP/PDCP configuration update(s) if needed, and/or security key update if needed (step 12); the UE 5402 and CU-CP 5732c (or the C-DU 5731) perform a random access procedure, if configured (step 14); the CU-UP 5732u sends DL PDUs using previous DL TEID until PDCP reestablishment or data recovery, then sends using DL TEID of cell D (step 15a); and the S-DU 5731 sends UL PDUs using previous UL TEID until RLC reestablishment, then sends using the new UL TEID (step 16b).

Referring to FIG. 35b, the C-DU 5731 determines/decides to perform an inter-DU HO to a cell E at the S-DU 5731 (step 20a); the C-DU 5731 sends an L1/L2 HO CMD to the UE 5402 instructing the UE 5402 to HO to cell E (step 21); the C-DU 5731 sends a message (to be determined or FFS) for cell E to the CU-CP 5732c (step 22); the CU-CP 5732c sends a BRR CTXT MOD REQ to the CU-UP 5732u, which includes a DL TEID of cell E, SDAP/PDCP configuration update(s) if needed, and/or security key update if needed (step 23); the CU-CP 5732c performs a UE CTXT MOD procedure with the S-DU 5731 indicating that the UE 5402 will arrive in cell E (step 25a); the CU-CP 5732c sends a response to the message sent at step 22 (step 25b); the C-DU 5731 sends a DDDS message towards the CU-UP 5732u, which may not be successfully transmitted and/or delivered to the CU-UP 5732u, and the DDDS message may include a previous DL TEID and/or other suitable information/data (step 25c); the S-DU 5731 and the UE 5402 perform a random access procedure, if configured; the S-DU 5731 sends an initial DDDS message towards the CU-UP 5732u, which may include the DL TEID of cell E, a new UL TEID, and/or other suitable information/data (step 25d); the CU-UP 5732u sends DL PDUs to the S-DU 5731 using DL TEID of cell E (step 26a); and the C-DU 5731 sends UL PDUs to the CU-UP 5732u using the new UL TEID (step 26b).

For inter-DU L1/L2 handover execution, in case of intra-DU HO execution, the same network signalling is re-used as for intra-DU L1/L2 handover execution. Additionally or alternatively, different signalling can be defined for intra-DU HO execution in case of inter-DU L1/L2 handover execution.

### 5. [AE9553] SECURITY FOR L1/L2 MOBILITY

Based on the various objectives of RP-221799 discussed previously, the present disclosure provides mechanisms to help address security issues for L1 L2 mobility activate/deactivate SCG. In Rel-16, conditional handover (CHO) configurations (candidate PCells) cannot be maintained as horizontal key derivation can only be applied not more than 2 hops/handovers. However, such security issue does not apply to CPA/CPC. For CPA/CPC, the security key for the SCG is derived based on the Master key and SK counter which is generated by RAN. In order to maintain the CPA/CPC configuration (e.g., candidate SCG configurations) and allowing the UE 5402 to move back and fore between the candidate PSCells (e.g., PSCell A then PSCell B and back to PSCell A), one option is that network provides a new SK counter for the previous PSCell. However, this may defeat the purpose of maintaining the candidate PSCell configurations.

Another option is the Rel-18 UE needs to maintain the security key derived from the SK counter for each SCG configuration. By doing so, there is no limit on the reuse of SK counter for each of the candidate SCG configurations (until the PDCP SN wraparound). However, this will require confirmation from SA3 whether they are fine with reusing the SK counter. If SA3 think that SK counter cannot be reused when the UE moves back and fore candidate PSCells, another option is that network can provide UE with a list of sk-counter values for a candidate PSCell for sequential use whenever the UE moves back to the same candidate cell. When all sk-counters is used, MN key will need to be changed.

In both cases, PDCP SN wraparound happens, network will need to assign new sk-counter. Therefore, the following options for the sk-counter assignments can include a list of sk-counter values for sequential use when CPC happens (option 1) and one assigned sk-counter for each candidate PSCell (option2).
Option 1 includes a list of sk-counter values for sequential use when CPC happens. In this option, the network will provide the UE 5402 a list of sk-counters, this list can be incremental or not. UE will use the next available sk-counter for the next activated cell. When all the sk-counters are used in the list, the network sends a new list to the UE. Or no more SCG can be activated which require a new sk-counter. The UE will need to fall back to legacy procedure. In this case, sk-counters may or may not be reused. For reuse cases, a UE can remember which sk-counter is used for the deactivated cell. If a newly activated cell (never activated from pre-configuration), a UE will use a new sk-counter from the list.
Option 2 includes one assigned sk-counter for each candidate PSCell, wherein each candidate PSCell is associated with a pre-configured sk-counter, and the UE will use the associated sk-counter accordingly. Here, an sk-counter assigned to a candidate PSCell may be reused (this will be pending on SA confirm on security issue). If the sk-counter can be reused for deactivated PSCell, the UE will use the stored sk-counter. In the case where sk-counter is not allowed to be reused, the NW assigns new sk-counter to the deactivate cell. Additionally or alternatively, the UE may request sk-counter from network. Otherwise, the cell will need to be released.

In both options, the sk-counter and/or sk-counter list can be communicated using suitable signaling/messaging mechanisms (e.g., RRC message(s)/signaling, MAC CEs, and/or any other signaling mechanisms, such as any of those discussed herein). The various example implementations discussed herein can be specified in corresponding 3GPP specifications (e.g., [TS38331], and/or the like).

5.1. Access Stratum (AS) Security Aspects

Access stratum (AS) security comprises integrity protection and ciphering of RRC signalling (e.g., Signalling Radio Bearers (SRBs)) and user data (e.g., Data Radio Bearers (DRBs)). The RRC layer/entity handles the configuration of the AS security parameters which are part of the AS configuration: the integrity protection algorithm, the ciphering algorithm, if integrity protection and/or ciphering is enabled for a DRB and two parameters, namely the keySetChangeIndicator and the nextHopChainingCount, which are used by the UE to determine the AS security keys upon reconfiguration with sync (with key change), connection re-establishment and/or connection resume.

The integrity protection algorithm is common for SRB1, SRB2, SRB3 (if configured), SRB4 (if configured) and DRBs configured with integrity protection, with the same keyToUse value. The ciphering algorithm is common for SRB1, SRB2, SRB3 (if configured), SRB4 (if configured) and DRBs configured with the same keyToUse value. Neither integrity protection nor ciphering applies for SRB0. Some or all DRBs related to the same PDU session have the same enable/disable setting for ciphering and the same enable/disable setting for integrity protection, as specified in [TS33501].

RRC integrity protection and ciphering are always activated together, e.g. in one message/procedure. RRC integrity protection and ciphering for SRBs are never de-activated. However, it is possible to switch to a ‘NULL’ ciphering algorithm (nea0).

The ‘NULL’ integrity protection algorithm (nia0) is used only for SRBs and for the UE in limited service mode (see e.g., [TS33501]) and when used for SRBs, integrity protection is disabled for DRBs. In case the ‘NULL’ integrity protection algorithm is used, ‘NULL’ ciphering algorithm is also used. Lower layers discard RRC messages for which the integrity protection check has failed and indicate the integrity protection verification check failure to RRC.

The AS applies four different security keys: one for the integrity protection of RRC signalling (K_{RRCint}), one for the ciphering of RRC signalling (K_{RRCenc}), one for integrity protection of user data (K_{UPint}) and one for the ciphering of user data (K_{UPenc}). All four AS keys are derived from a gNB key (K_{gNB}). The K_{gNB} is based on an AMF key (K_{AMF}) (see e.g., [TS33501]), which is handled by upper layers. The integrity protection and ciphering algorithms can only be changed with reconfiguration with sync. The AS keys (e.g., K_{gNB}, K_{RRCint}, K_{RRCenc}, K_{UPint}, and K_{UPenc}) change upon reconfiguration with sync (if masterKeyUpdate is included), and upon connection re-establishment and connection resume.

For each radio bearer an independent counter (e.g., COUNT, as specified in [TS38323]) is maintained for each direction. For each radio bearer, the COUNT is used as input for ciphering and integrity protection. It is not allowed to use the same COUNT value more than once for a given security key. As specified in [TS33501] clause 6.9.4.1, the network is responsible for avoiding reuse of the COUNT with the same RB identity and with the same key, for example, due to the transfer of large volumes of data, release and establishment of new RBs, and multiple termination point changes for RLC-UM bearers and multiple termination point changes for RLC-AM bearer with SN terminated PDCP re-establishment (COUNT reset) due to SN only full configuration whilst the key stream inputs (e.g., bearer ID, security key) at MN have not been updated. In order to avoid such re-use, the network may e.g. use different RB identities for RB establishments, change the AS security key, or an RRC_CONNECTED to RRC_IDLE/RRC_INACTIVE and then to RRC_CONNECTED transition.

In order to limit the signalling overhead, individual messages/packets include a short sequence number (e.g., PDCP SN), as specified in [TS38323]. In addition, an overflow counter mechanism is used: the hyper frame number (HFN), as specified in [TS38323]. The HFN needs to be synchronized between the UE and the network.

For each SRB, the value provided by RRC to lower layers to derive the 5-bit BEARER parameter used as input for ciphering and for integrity protection is the value of the corresponding srb-Identity with the MSBs padded with zeroes.

For a UE 5402 provided with an sk-counter, keyToUse indicates whether the UE uses the master key (K_{gNB}) or the secondary key (S-K_{eNB} or S-K_{gNB}) for a particular DRB. The secondary key is derived from the master key and sk-Counter, as defined in [TS33501]. Whenever there is a need to refresh the secondary key, e.g. upon change of MN with K_{gNB} change or to avoid COUNT reuse, the security key update is used (see e.g., [TS38331] § 5.3.5.7). When the UE is in NR-DC, the network may provide a UE configured with an SCG with an sk-Counter even when no DRB is setup using the secondary key (S-K_{gNB}) in order to allow the configuration of SRB3. The network can also provide the UE with an sk-Counter, even if no SCG is configured, when using SN terminated MCG bearers.

5.2. SK Counter and/or SN Counter Aspects

For MR-DC with 5GC including NGEN-DC, NE-DC, and NR-DC, when an MN establishes a security context between an SN and the UE 5402 for the first time for a given AS security context shared between the MN and the UE 5402, the MN generates a security key of the SN (K_{SN}) for the SN and sends it to the SN over the Xn-C interface. To generate the K_{SN}, the MN associates a counter, called an SN counter (or SK counter), with the current AS security context. The SN counter is used as freshness input into K_{SN} derivations as described in the clause 6.10.3.2 of [TS33501] and/or as discussed herein. The MN sends the value of the SN Counter to the UE 5402 over an RRC signaling path when it is required to generate a new K_{SN}. The K_{SN} is used to derive further RRC and UP keys that are used between the UE 5402 and SN. The UE 5402 and MN derive the K_{SN} as defined in Annex A.16 of [TS33501]. The SN RRC and UP keys are derived from the K_{SN} both at the SN and the UE 5402 using the function given in Annex A.7 of 3GPP TS 33.401 if the SN is a ng-eNB or using the function given in Annex A.8 of [TS33501] if the SN is a gNB. Once all the SN RRC and UP keys have been derived from the K_{SN}, the SN and UE 5402 may delete the K_{SN}.

The SN counter (or SK counter) is a 16-bit counter, which is used when computing the K_{SN}. The MN maintains the SN counter (or SK counter) in its AS security context. The MN maintains the value of the SN counter for a duration of a current 5G AS security context between the UE 5402 and the MN. The UE 5402 does not need to maintain the SN counter after it has computed the K_{SN} since the MN provides the UE 5402 with the current SN counter value when the UE 5402 needs to compute a new K_{SN}.

The SN counter is a fresh input to K_{SN} derivation. That is, the UE 5402 assumes that the MN provides a fresh SN counter each time and does not need to verify the freshness of the SN counter. An attacker cannot, over the air modify the SN Counter and force re-use of the same SN Counter. The reason for this is that the SN Counter is delivered over the RRC connection between the MN and the UE, and this connection is both integrity protected and protected from replay.

The MN sets the SN counter to ‘0’ when a new AS root key (K_{NG-RAN}) in the associated AS security context is established. The MN sets the SN counter to ‘1’ after the first calculated K_{SN}, and monotonically increment it for each additional calculated K_{SN}. The SN counter value ‘0’ is used to calculate the first K_{SN}. If the MN decides to release the offloaded connections to the SN and later decides to re-start the offloading to the same SN, the SN counter value keeps increasing, which keeps the computed K_{SN} fresh.

The MN refreshes the root key of the 5G AS security context associated with the SN counter before the SN counter wraps around. Refreshing the root key is done using intra-cell HO as described in subclause 6.7.3.3 of [TS33501]. When the root key is refreshed, the SN counter is reset to ‘0’ as discussed previously.

Additionally or alternatively, the SN counter and/or SK counter (sk-Counter) is a counter used upon initial configuration of S-K_{gNB} or S-K_{eNB}, as well as upon refresh of S-K_{gNB} or S-K_{eNB}. The sk-Counter IE/field is included in an RRCReconfiguration message either upon initial configuration of an NR SCG or upon configuration of the first RB with keyToUse set to secondary, whichever happens first. The sk-Counter IE/field may be absent from the RRCReconfiguration message if there is neither any NR SCG nor any RB with keyToUse set to secondary. Additionally or alternatively, the SK counter is included in a sk-Counter IE/field of an RRCResume message, and is a counter used to derive S-K_{gNB} or S-K_{eNB} based on the newly derived K_{gNB} during RRC resume. The sk-Counter IE/field may only be included when there is one or more RB with keyToUse set to secondary or mrdc-SecondaryCellGroup is included.

The SK-Counter IE/field is a counter used upon initial configuration of SN security for NR-DC and NE-DC, as well as upon refresh of S-K_{gNB} or S-K_{eNB} based on the current or newly derived K_{gNB} during RRC Resume or RRC Reconfiguration (see e.g., [TS33501]). An example SK-Counter IE/field is shown by table 5.1-1.

TABLE 5.1-1

-- ASN1START
-- TAG-SKCOUNTER-START
SK-Counter ::= INTEGER (0..65535)
-- TAG-SKCOUNTER-STOP
-- ASN1STOP

5.3. Security Key Update Aspects

A UE 5402 performs the following actions upon reception of an RRCReconfiguration message, RRCResume message, and/or upon execution of a conditional reconfiguration (e.g., CHO, CPA, or CPC): if the RRCReconfiguration includes the masterKeyUpdate, the UE 5402 performs AS security key update procedure as discussed herein and/or as specified in [TS38331]§ 5.3.5.7; if the RRCReconfiguration includes the sk-Counter, the UE 5402 performs the security key update procedure as discussed herein and/or as specified in [TS38331]§ 5.3.5.7. Additional actions performed by the UE 5402 upon reception of an RRCReconfiguration message and/or upon execution of a conditional reconfiguration are discussed in [TS38331]§ 5.3.5.3. For the AS security key update, the UE 5402 performs the following:

If the UE 5402 is connected to E-UTRA/EPC or E-UTRA/SGC, upon reception of sk-Counter as specified in [TS36331], the UE 5402 updates the S-K g NB key based on the K_{eNB} key and using the received sk-Counter value, as specified in [TS33401] for EN-DC or [TS33501] for NGEN-DC; derives the K_{RRCenc} and K_{UPenc} keys as specified in [TS33401] for EN-DC or [TS33501] for NGEN-DC; and/or derives the K_{RRCint} and K_{UPint} keys as specified in [TS33401] for EN-DC or [TS33501] for NGEN-DC.

Else if this procedure was initiated due to reception of the masterKeyUpdate: if the nas-Container is included in the received masterKeyUpdate, the UE 5402 forwards the nas-Container to the upper layers; if the keySetChangeIndicator is set to true, the UE 5402 derives or update the K_{gNB} key based on the K_{AMF} key, as specified in [TS33501]; else, the UE 5402 derives or update the K_{gNB} key based on the current K_{gNB} key or the NH, using the nextHopChainingCount value indicated in the received masterKeyUpdate, as specified in [TS33501]. The UE 5402 stores the nextHopChainingCount value; and derives the keys associated with the K_{gNB} key as follows: if the securityAlgorithmConfig is included in SecurityConfig, the UE 5402 derives the K_{RRCenc} and K_{UPenc} keys associated with the cipheringAlgorithm indicated in the securityAlgorithmConfig, as specified in [TS33501], and/or the UE 5402 derives the K_{RRCint} and K_{UPint} keys associated with the integrityProtAlgorithm indicated in the securityAlgorithmConfig, as specified in [TS33501]; else, the UE 5402 derives the K_{RRCenc} and K_{UPenc} keys associated with the current cipheringAlgorithm, as specified in [TS33501], and/or the UE 5402 derives the K_{RRCint} and K_{UPint} keys associated with the current integrityProtAlgorithm, as specified in [TS33501]. In some examples, ciphering and integrity protection are optional to configure for the DRBs.

Else, if this procedure was initiated due to reception of the sk-Counter (e.g., the UE 5402 is in NE-DC, NR-DC, or is configured with SN terminated bearer(s)), the UE 5402 derives or update the secondary key (S-K_{gNB} or S-K_{eNB}) based on the K_{gNB} key and using the received sk-Counter value, as specified in [TS33501]; derives the K_{RRCenc} key and the K_{UPenc} key as specified in [TS33501] using the ciphering algorithms indicated in the RadioBearerConfig associated with the secondary key (S-K_{gNB} or S-K_{eNB}) as indicated by keyToUse; and/or derives the K_{RRCint} key and the K_{UPint} key as specified in [TS33501] using the integrity protection algorithms indicated in the RadioBearerConfig associated with the secondary key (S-K_{gNB} or S-K_{eNB}) as indicated by keyToUse. If the UE 5402 has no radio bearer configured with keyToUse set to secondary and receives the sk-Counter without any RadioBearerConfig with keyToUse set to secondary, the UE 5402 does not consider it as an invalid reconfiguration.

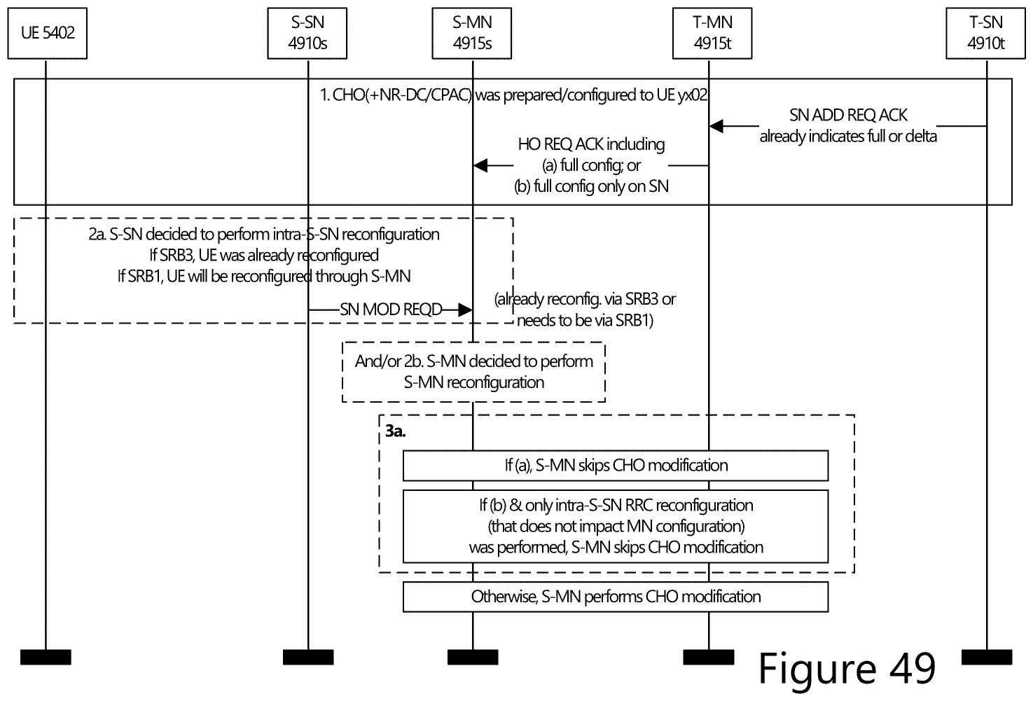

Additionally or alternatively to the above, when the UE 5402 and an MN (e.g., T-MN 4915t and/or S-MN 4915s in FIGS. 49-53) establish an RRC connection, the MN sends an SN Addition/Modification Request to an SN (e.g., T-SN 4910t and/or S-SN 4910s in FIGS. 49-53) over the Xn-C interface to negotiate the available resources, configuration, and algorithms at the SN. The MN computes and delivers the K_{SN} to the SN if a new key is needed. The UE security capabilities (see e.g., [TS33501] § 6.10.4) and the UP security policy received from the SMF 5446 is also sent to SN. In case of PDU split, UP integrity protection and ciphering activation decision from MN may be also included (see e.g., [TS33501] § 6.10.4). When the MN decides to configure CPA or CPC, if there are more than one candidate SNs, for each SN, the MN derives a different K_{SN} (or K_{SN}) and delivers the K_{SN} (or K_{SN}) to each SN seperately.

The SN allocates the necessary resources and chooses the ciphering algorithm and integrity algorithm that has the highest priority from its configured list and is also present in the UE security capability. If a new K_{SN} was delivered to the SN, then the SN calculates the needed RRC. The UP keys may be derived at the same time when RRC key derived. The SN activates the UP security policy as discussed in [TS33501] § 6.10.4. Then, the SN sends an SN Addition/Modification Acknowledge message to the MN indicating availability of requested resources and the identifiers for the selected algorithm(s) for the requested DRBs and/or SRB for the UE 5402. The UP integrity protection and encryption indications are sent to the MN.

Then, the MN sends an RRC Connection Reconfiguration Request message to the UE 5402 instructing it to configure the new DRBs and/or SRB for the SN. The MN includes the SN counter parameter to indicate a new K_{SN} is needed and the UE 5402 computes the K_{SN} for the SN. The MN forwards the UE configuration parameters (which contains the algorithm identifier(s) received from the SN), and UP integrity protection and encryption indications (received from the SN) to the UE 5402 (see e.g., [TS33501] § 6.10.3.3). If the SN sends more than one candidate PScell SCG configuration, the MN signals to the UE 5402 that all these configurations are associated with the same SN counter value. In some examples, since the message is sent over the RRC connection between the MN and the UE 5402, it is integrity protected using the K_{RRCint} of the MN making the SN counter tamper-resistant.

The UE 5402 accepts the RRC Connection Reconfiguration Request message after validating its integrity. The UE 5402 computes the K_{SN} for the SN if an SN counter parameter was included in the message. The UE 5402 also computes the needed RRC and UP keys and activate the RRC and UP protection as per the indications received for the associated SRB and/or DRBs, respectively. The UE 5402 sends an RRC Reconfiguration Complete message to the MN. The UE 5402 activates the chosen encryption/decryption and integrity protection keys with the SN at this point.

The MN sends an SN Reconfiguration Complete message to the SN over the Xn-C interface to inform the SN of the configuration result. On receipt of this message, the SN may activate the chosen encryption/decryption and integrity protection with UE 5402. If the SN does not activate encryption/decryption and integrity protection with the UE 5402 at this stage, the SN activates encryption/decryption and integrity protection upon receiving the Random Access request from the UE 5402.

### 6. [AF1768] EARLY TIMING ADVANCE ACQUISITION OF L1/L2 TRIGGERED INTER-CELL MOBILITY

As alluded to previously, one of the objectives of RP-221799 is to support L1/L2 triggered mobility (LTM), which may be L1/L2 triggered inter-cell mobility. To further reduce the latency of cell switch execution, the downlink (DL) synchronization and uplink (UL) synchronization towards a candidate target cell may be achieved by a user equipment (UE) before the reception of cell switch command.

Currently there are only some high-level descriptions of the early timing advance (TA) acquisition of LTM, including: DL synchronization for candidate cell(s) based on at least SSB before cell switch command is supported; TA acquisition of candidate cell(s) before cell switch command is received is supported; a PDCCH order is triggered by source cell, then the UE sends preamble to a candidate cell; the indication of candidate cell and/or RO of candidate cell are included in PDCCH order; the configuration of RACH resource for candidate cell(s) is provided prior to the PDCCH order; and TA updating (e.g., re-acquisition of TA) for candidate cell can be triggered by NW. The details of the whole procedure are not complete.

The present disclosure is related to early UL synchronization towards candidate cell, such as early TA acquisition of LTM. Specifically, an example signalling procedure of early TA acquisition is provided herein, such as the 7-element example which includes: (1) configure the configuration of RACH resource for candidate cell(s) for early TA acquisition; (2) Based on UE measurements, source cell sends a PDCCH order when it wants to trigger early RACH towards a candidate cell; (3) UE initiates RACH towards the candidate target cell; (4) candidate cell receives the preamble and evaluates the TA value accordingly; (5) source cell gets required TA value from target cell and sends it to the UE over source cell (this could also be an ack for the RACH instead of RAR), or UE receives RAR including TA from target cell directly; (6) UE and network maintain the TA value until it needs to be updated (timer or distance based solutions); and (7) if TA update is triggered, then reuse steps 2 to 5, and/or UE receives TA command MAC CE for the candidate cell. Details of these elements and/or other elements are further discussed herein. It should be noted that the aforementioned execution order is one example, and other implementations may vary by including more, fewer, combined, divided, or different elements. The achievement of LTM can further optimize the mobility performance of 3GPP NR/5G systems, for example, in terms of latency reduction and resource usage efficiency.

6.1. LTM Procedure

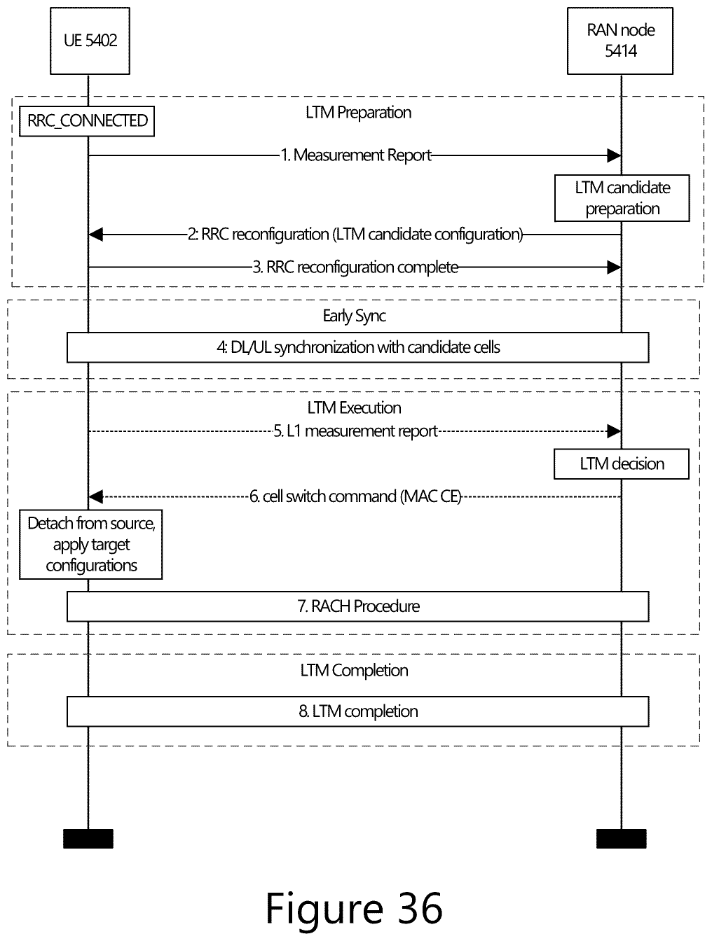

FIG. 36 shows an example LTM procedure, which includes an LTM preparation phase, an early synchronization (sync) phase, an LTM execution phase, and an LTM completion phase. The procedure of FIG. 36 may operate as follows.

LTM preparation: A UE 5402 in RRC_CONNECTED mode sends a MeasurementReport message to a RAN node 5414 (e.g., a gNB 5414a) (step 1), and the RAN node 5414 decides to use LTM and initiates LTM candidate preparation. The RAN node 5414 transmits an RRCReconfiguration message to the UE 5402, which includes the configuration of one or multiple LTM candidate target cells (step 2). The UE 5402 stores the configuration of LTM candidate target cell(s) and transmits a RRCReconfigurationComplete message to the RAN node 5414 (step 3).

Early sync: The UE 5402 may perform DL synchronization and TA acquisition with candidate target cell(s) before receiving the LTM cell switch command (step 4).

LTM execution: The UE 5402 performs L1 measurements on the configured LTM candidate target cell(s), and transmits lower-layer measurement reports to the source RAN node 5414 (step 5). The RAN node 5414 decides to execute LTM cell switch to a target cell, and transmits a cell switch command MAC CE triggering LTM cell switch by including the candidate configuration index of the target cell (step 6). The UE 5402 switches to the configuration of the LTM candidate target cell (e.g., the UE 5402 detaches from the source cell and applies target configurations). The UE 5402 performs random access (or RACH) procedure towards the target cell, if TA is not available (step 7).

LTM completion: The UE 5402 indicates successful completion of the LTM cell switch towards target cell (step 8).

6.2. PDCCH Ordered Random Access Channel (RACH)

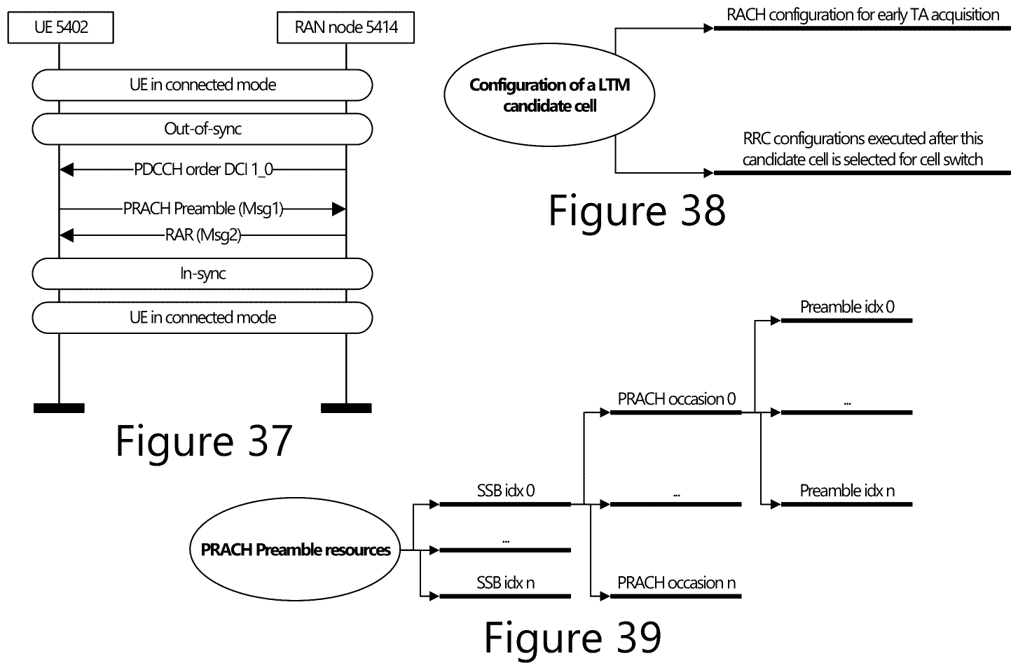

PDCCH order is a mechanism by which a RAN node (e.g., gNB 5414a and/or the like) may cause a UE 5402 to initiate PRACH. This procedure may occur when the network and a UE 5402 briefly lose synchronization while in connected states (e.g., due to the expiry of the Time Alignment timer) and user data is available to be sent out on network side. An example procedure is depicted in FIG. 37, and may be implemented as follows.

The RAN node 5414 (e.g., a gNB 5414a) transmits PDCCH order (e.g., DCI format 1_0) to trigger a PRACH Preamble (step 1). The UE 5402 transmits a PRACH preamble (Msg1) according to the configuration received in PDCCH order (step 2). The RAN node 5414 receives the preamble, calculates a TA value, and then transmits a random access response (RAR) to the UE 5402, which includes the TA value (step 3).

Table 6.2-1 shows example parameters/fields included in a PDCCH order message, which includes discussion related to various elements that may be included in the PDCCH order.

TABLE 6.2-1
DCI format 1_0 used for PDCCH order

| DCI Fields | Description |
|---|---|
| Identifier for DCI formats | The value of this bit field is always set to 1, indicating a DL DCI format |
| Frequency domain | If the CRC of the DCI format 1_0 is scrambled by C-RNTI and the “Frequency |
| resource assignment | domain resource assignment” field are of all ones, the DCI format 1_0 is for |
| | random access procedure initiated by a PDCCH order |
| Random Access | This field contains 6 bits. It indicates which Random access preamble to use in |
| Preamble index | case of Contention Free Random Access (CFRA) or the value 000000 in the case |
| | of Contention based Random Access (CBRA) procedure |
| UL/SUL indicator | ‘0’ for the non-supplementary uplink, and ‘1’ for the supplementary uplink |
| SS/PBCH index | If the value of the “Random Access Preamble index” is not all zeros, this field |
| | indicates the SS/PBCH that shall be used to determine the RACH occasion for the |
| | PRACH transmission; otherwise, this field is reserved. |
| PRACH Mask index | If the value of the “Random Access Preamble index” is not all zeros, this field |
| | indicates the RACH occasion associated with the SS/PBCH indicated by |
| | “SS/PBCH index” for the PRACH transmission; otherwise, this field is reserved |
| Reserved bits | 10 bits |

Each element of early TA acquisition is elaborated in the following sections.

6.3. Configuration of Early TA Acquisition

The configuration of early TA acquisition is provided to UE from source cell prior to the transmission of PDCCH order. As explained in table 6.2-1, the PDCCH order itself may include some configuration of preamble, such as preamble index, SSB index, and/or the RACH occasion index. In the early TA acquisition case, the PDCCH order may also include the indication of candidate cell (e.g., a candidate configuration index of a candidate cell and/or the like). However, the PDCCH order alone may not be sufficient, and other PRACH configurations may have to be provided by RRC messages/signaling (e.g., cell specific RACH parameters provided by RACH-ConfigCommon information element (IE)).

Two example implementations for providing RACH parameters of a candidate cell for early TA acquisition include (option 6.3.1) the RACH configuration is included in the candidate cell configuration, and (option 6.3.2) separate configuration (e.g., not a part of LTM candidate cell configuration (RRC model)).

6.3.1. RACH Configuration is Included in the Candidate Cell Configuration

In this option, the LTM candidate cell configuration is provided to the UE 5402 by a source cell (e.g., S-Cell 130s). In legacy designs, a RRCReconfiguration message and/or a CellGroupConfig IE can be used for a candidate cell. Based on the legacy ASN.1 structure, the common RACH configuration parameters may already be available within IE ReconfigurationWithSync. Furthermore, there is a field rach-ConfigDedicated within IE ReconfigurationWithSync to provide CFRA configuration. The detail could follow, for example, option 6.3.1.1 or option 6.3.1.2.
Option 6.3.1.1: reuse the common RACH configuration parameters within IE ReconfigurationWithSync+PDCCH order providing “the indication of candidate cell, preamble index, SSB index and the RACH occasion index”. In this situation, the rach-ConfigDedicated for CFRA may not be configured within IE ReconfigurationWithSync for a LTM candidate cell or overridden by PDCCH order, which means the common RACH configuration is provided by RRC, and dedicated preamble configuration for CFRA (and also the candidate cell triggered for early TA acquisition) may be provided by PDCCH order only.
Option 6.3.1.2: reuse the field rach-ConfigDedicated within IE ReconfigurationWithSync+PDCCH order providing the indication of candidate cell. In this situation, for each candidate cell, the CFRA configuration may be provided by RRC, and the PDCCH order only needs to indicate which candidate cell is triggered for early TA acquisition. The assumption is that if the preamble is to be reallocated, the network will send a reconfiguration for the CFRA resource again.

6.3.2. Separate Configuration that is not a Part of LTM Candidate Cell Configuration (RRC Model)

In option 6.3.1, the UE 5402 may have to decode the configuration of a candidate cell to obtain the RACH configuration for early TA acquisition, which is before a candidate cell is selected as LTM target cell. To avoid unnecessary decoding, and to increase flexibility (e.g., by allowing the preamble configuration to be generated/updated later separately), the RACH configuration for early TA acquisition of a candidate cell may be a separate configuration as illustrated in FIG. 38. FIG. 38 shows an example of a separate RACH configuration for early TA acquisition. Similar to option 6.3.1, this separate configuration may only include common RACH configuration parameters, then the PDCCH order provides the remaining preamble configuration. Additionally or alternatively, the separate configuration can include all CFRA configuration parameters, then the PDCCH order only contains the indication of candidate cell ID (e.g., candidate configuration index).

As an alternative, even if a separate RACH configuration is provided for early TA acquisition, CFRA resource can still be configured within IE ReconfigurationWithSync, as a fall-back RACH resource when early TA acquisition fails. It also means if early TA acquisition is successful, the configured CFRA resource within IE ReconfigurationWithSync will not be used.

6.4. Resource Allocation of Preamble

The preamble resource may be configured by the combination of SSB index, PRACH mask index and preamble index, as shown by the example PRACH preamble resource configuration shown by FIG. 39. Because one synchronization signal block (SSB) index could map to multiple PRACH occasions, for example, ssb-perRACH-Occasion is oneFourth and PRACH Mask Index is 0, this means all four (4) PRACH occasions may be used for preamble transmission. And, in each PRACH occasion, the preamble with the configured preamble index can be transmitted by the UE 5402. In total, there are four (4) preamble resources that can be used by the UE 5402.

Preamble resource for early TA acquisition towards a candidate cell may be allocated by this candidate cell. Sections 6.4.1 and 6.4.2 provide two example options of preamble resource allocation, although such allocation(s) may be performed differently in other implementations.

6.4.1. Preamble Resource is UE Specific
Option 6.4.1.1: preamble is determined by source cell. Based on measurement report (e.g., the UE 5402 measures SSB beams of candidate cells and reports L1/L3 measurement results to source cell), source cell selects a candidate cell, a PRACH occasion and a preamble according to a SSB index (e.g., this SSB is with the highest RSRP of this candidate cell). Then source cell indicates the preamble resource to UE by PDCCH order, and informs this assignment to this candidate cell too. In this case, candidate cell needs to reserve/allocate a preamble (or more than one preambles) for each PRACH occasion mapping to one SSB index in advance, and transfers the allocation outcome to source cell.
Option 6.4.1.2: preamble is determined by candidate cell. Based on measurement report, source cell informs candidate cell which SSB beam should be used for PRACH, then candidate cell allocates a preamble and informs source cell the preamble index. For the used PRACH occasion (the time and frequency resource a UE uses for preamble Tx), it could be determined by UE or indicated by source cell or candidate cell.

For both option 6.4.1.1 and 6.4.1.2, in a centralized unit (CU)-distributed unit (DU) split scenario, some complementary description is needed. If it's intra-DU cell switch case and the determination of preamble resource is based on L1 measurement report, the source cell/candidate cell above refer to the same DU 5731; if it's intra-CU inter-DU cell switch case and the determination of preamble resource is based on L1 measurement report, the source cell refers to the source DU 5731 and the candidate cell refers to the candidate DU 5731, the signalling between source DU 5731 and candidate DU 5731 needs to be transferred by CU; if it's intra-CU inter-DU cell switch case and the determination of preamble resource is based on L3 measurement report, the source cell refers to CU and the candidate cell refers to the candidate DU 5731.

6.4.2. Preamble Resource can be Shared by Multiple Ues

One preamble resource of a candidate cell is shared by multiple UEs 5402, and source cell only makes sure to trigger one UE 5402 at a time for early TA acquisition (e.g., only one UE 5402 uses this preamble resource). In this way, it can still save preamble resources by reusing preambles for each candidate cell. From the UE point of view, when the source cell triggers the PRACH via PDCCH order, the UE 5402 will use it for preamble Tx. Then the UE 5402 will release it (probably after a successful confirmation from network), e.g. the UE does not occupy this preamble resource all the time, and this preamble resource can be used by other UEs 5402 later.

Regarding whether a candidate cell knows which UE 5402 transmits this preamble, the following are two example sub-options, although other options may be used in other implementations: Option 6.4.2.1: When the source cells sends PDCCH order to trigger early TA acquisition, source sends UE ID indication to candidate cell (e.g., C-RNTI allocated by candidate cell), so this candidate cell can know which UE transmits this preamble and for which the early TA should be calculated. Option 6.4.2.2: when a candidate cell receives a preamble, it forwards the calculated TA to source cell (e.g., target cell doesn't need to know which UE it is).

6.5. Preamble Transmission

From a UE 5402 point of view, after the UE 5402 receives the PDCCH order, the UE 5402 transmits the PRACH preamble in the corresponding PRACH occasion. Depending on the UE capability, the UE 5402 may or may not be able to support simultaneous transmission (Tx) towards source cell and a candidate cell. Then there are two cases that can be used.

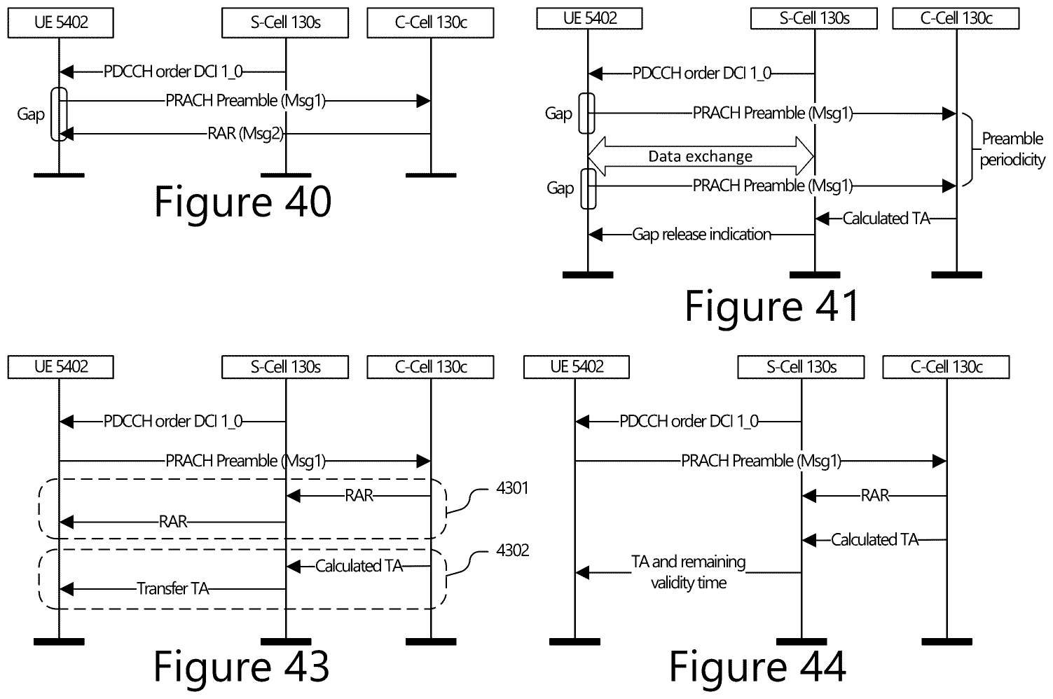

In some embodiments, a gap is used for preamble Tx towards a candidate cell. FIG. 40 shows an example procedure including a gap for both preamble Tx and random access response (RAR) reception. If the UE 5402 cannot support simultaneous UL Tx towards two cells, for example, due to a fact that only one RF chain is equipped at the UE 5402, a gap similar to measurement gap is needed while the data Tx and/or reception (Rx) is stopped in source cell.

The start time of this gap could be the time when UE 5402 receives PDCCH order, or some slots after the reception of PDCCH order (e.g., X slot used for processing PDCCH order, where X is a number). Additionally, a gap duration can be configured. In some examples, the gap is a short gap during which the UE 5402 transmits a PRACH preamble to a candidate cell (C-Cell) 130c. In some examples, the gap is a long gap during which the UE 5402 transmits the transmits PRACH preamble and also receives a RAR from the C-Cell 130c within this gap (e.g., a longer gap) as illustrated in FIG. 40. In some examples, the gap is used only for UL Tx. In other examples, the gap is used for both UL and DL Txs.

FIG. 41 shows an example procedure using a periodical gap for preamble Tx. Since the first preamble may not succeed, the UE 5402 may have to increase the Tx power and transmit the PRACH preamble for more times, the gap can take effect periodically along with the periodicity of the preamble resource. In these implementations, after the successful preamble Tx is confirmed by a target cell (e.g., C-Cell 130c), the gap can be released. In some examples, the gap release indication can be communicated in or using a RAR. It is also possible that a separate or alternative indication is used to release the gap by source cell. In some implementations, the gap configuration can be just the PRACH configuration of the C-Cell 130c if the S-Cell 130s and C-Cell 130c is/are SFN aligned. There is no need for explicit gap configuration.

In other embodiments, the UE 5402 monitors PDCCH of source cell while performing preamble Tx towards candidate cell. If the UE 5402 is able to support simultaneous UL Tx towards two cells (e.g., due to a fact that more than one antenna panels are equipped at UE side), the UE 5402 can report this capability to the S-Cell 130s, then there is no impact on source cell scheduling while the UE 5402 transmits the preamble to a candidate cell. Aspects related to preamble retransmission include (1) detection of failure of preamble Tx and (2) preamble re Tx.

For detection of failure of preamble Tx, on a pre-configured preamble resource, if a C-Cell 130c can not detect the preamble, the C-Cell 130c may identify that the preamble Tx fails. There are three potential examples of how an S-Cell 130s knows (or determines) that early preamble Tx fails, although other embodiments may use different options. In a first example, the candidate cell can inform the source cell the failure indication (e.g., by an inter-node message). In a second example, the UE 5402 can also inform the source cell the failure indication if it didn't receive the corresponding RAR within the RAR window (e.g., by a UL RRC message or MAC CE). In a third example, neither the UE 5402 nor the C-Cell 130c needs to inform the S-Cell 130s. Here, if the S-Cell 130s did not receive an acknowledgement within a certain amount/length of time, the S-Cell 130s assumes early preamble Tx has failed.

For preamble re-Tx, in a first example, the periodical preamble resource can be reused for preamble re-Tx if the failure of preamble Tx is detected by UE (see e.g., FIG. 41). In this case, this preamble resource needs to be reserved by source cell and/or candidate cell for a longer time. In a second example, the S-Cell 130s can also indicate the preamble re-Tx by sending PDCCH order again if the failure of preamble Tx is known by the S-Cell 130s. Additionally or alternatively, the PDCCH order may be able to differentiate initial and re-Tx of preamble (e.g., PDCCH order contains separate explicit indications for initial Tx and re-Tx of preamble) for power setting and controlling number of RACH re-Tx.

Additionally or alternatively, if preamble Tx fails or the failure number (e.g., as indicated by a suitable counter or other mechanism) reaches a preconfigured and/or pre-defined threshold, the following handling can be applied. Some examples include stopping early TA acquisition for this C-Cell 130c. If this C-Cell 130c is selected as target cell in a cell switch command, the RACH procedure is still needed to get UL synchronized. A separate explicit indication in cell switch command can indicate whether RACH is needed in the LTM execution phase. Additionally or alternatively, if there is no TA value included in cell switch command, the UE 5402 performs RACH towards target cell in LTM execution phase.

6.6. Preamble Reception

In a first example for preamble reception, a C-Cell 130c only receives a preamble that it allocates. This means the C-Cell 130c only needs to detect its own preamble, and calculate TA values based on this preamble.

In a second example for preamble reception, a C-Cell 130c can also receive a preamble allocated by other C-Cells 130c. In this case, these C-Cells 130c may share the same DU 5731 and they are sync-up in the DL. This may be an efficient way to derive TA values for multiple C-Cells 130c based on one preamble Tx.

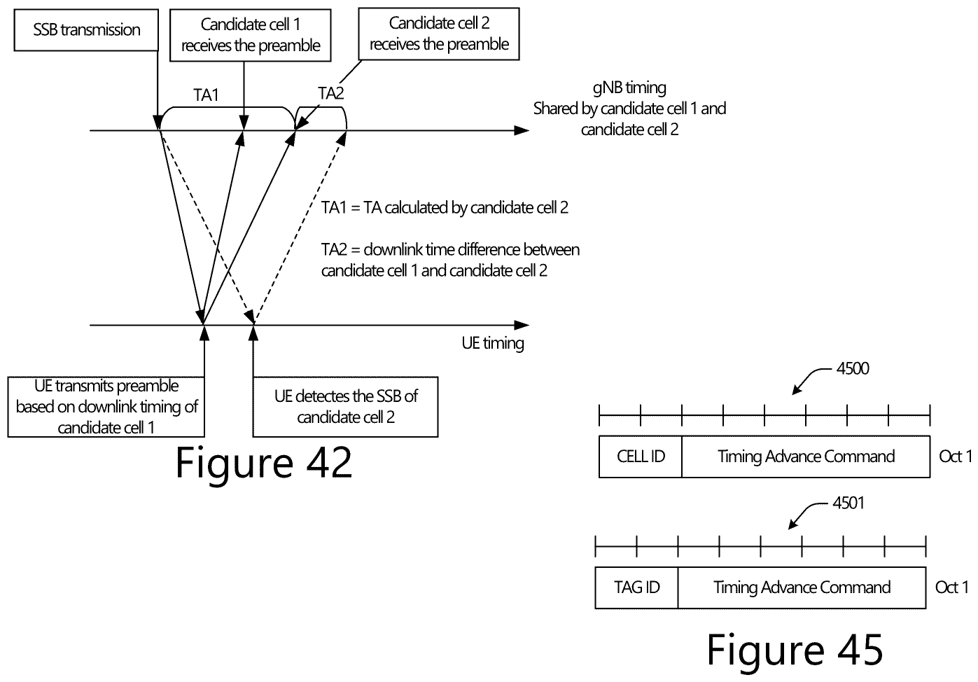

For example, a S-Cell 130s sends a PDCCH order to trigger a preamble Tx towards a first C-Cell 130c (e.g., C-Cell 130c-1), and a second C-Cell 130c (e.g., C-Cell 130c-2) also receives this preamble and calculates the TA value accordingly. In this case, the assistance information of the DL time difference between C-Cell 130c-1 and C-Cell 130c-2 needs to be reported to the S-Cell 130s by the UE 5402, then the S-Cell 130s transfers this assistance information to the C-Cell 130c-2. The real TA for C-Cell 130c-2 is equal to calculated TA (TA1) plus the DL time difference between C-Cell 130c-1 and C-Cell 130c-2 (TA2). An example estimation algorithm is illustrated in FIG. 42. FIG. 42 shows an example TA estimation based on a preamble sent towards another candidate cell.

6.7. Indicating TA to UE

In some implementations, a calculated TA is sent to a UE 5402 by an S-Cell 130s. An example of these implementations is shown by FIG. 43. FIG. 43 shows an example procedure where an S-Cell 130s indicates a TA of a C-Cell 130c to a UE 5402.

In a first example implementation 4301, the TA is indicated using a RAR in the S-Cell 130s similar to an unlicensed scenario. This option may require only minimal specification changes as it is already specified for unlicensed scenario (e.g., one additional spec change is that the candidate cell ID should be included in RAR). One limitation of this example is that the preamble used has to be unique across both the current and target cell, and also needs to be UE-specific; otherwise, there is risk of contention and RAR being interpreted by the wrong UE 5402.

In a second example implementation 4302, the TA is sent over dedicated RRC signaling or using MAC CE in the S-Cell 130s (see e.g., “transfer TA” in FIG. 43). In this case, it should be possible to uniquely identify the UE 5402, and hence, the preamble can be UE-specific. In some examples, the preamble can be a target-specific preamble (e.g., specific to the C-Cell 130c). That is, the same preamble can be used by source for some other UEs 5402. As a special case, the S-Cell 130s can send the TA in a cell switch command MAC CE (see e.g., [TS38321]).

In some implementations a calculated TA is sent to a UE 5402 by the C-Cell 130c. In some examples, the TA can be indicated using a RAR in the C-Cell 130c. As illustrated in FIG. 40 (and/or FIG. 43), the UE 5402 can receive the RAR form the same C-Cell 130c. In some examples, this element is not performed or is otherwise omitted, which means the calculated TA is not sent to the UE 5402 and is stored at network side only (e.g., at the C-Cell 130c and/or the S-Cell 130s). As discussed previously, the TA can be included in cell switch command when the target cell (e.g., C-Cell 130c) has been selected, but not in an early manner.

6.8. Ta Maintenance

If the TA value has been sent to the UE 5402 for a C-Cell 130c, before using it for access, the UE 5402 needs to verify if this TA value is still valid for this C-Cell 130c. Several example implementations are provided infra to address this issue.

6.8.1. Timer-Based Ta Maintenance

In these implementations, a TA timer at the UE 5402 is started/restarted when the UE 5402 receives a TA value. In some examples, the timer length or value is configured by the S-Cell 130s. When the timer expires, the UE 5402 cannot use this TA value for access to the corresponding C-Cell 130c. This means that the RACH procedure may still be needed to acquire UL synchronization towards the target cell (e.g., a C-Cell 130c).

FIG. 44 shows an example procedure for synchronization of remaining validity time of a C-Cell's 130c TA. In some examples, a TA timer is synchronized/aligned between the UE 5402 and the C-Cell 130c. If the RAR form the C-Cell 130c is used to transfer the TA value to the UE 5402, the TA timer at the C-Cell 130c is started itself. If the TA value is sent to the UE 5402 from the S-Cell 130s, one possible approach to keep the TA timer synchronized between the UE 5402 and the C-Cell 130c is that the C-Cell 130c indicates the expiry time (e.g., in UTC format and/or the format of another suitable timing standard, such as any of those discussed herein) of TA timer to the S-Cell 130s, then the S-Cell 130s indicates the remaining validity time to the UE 5402 considering the elapsed time. Then the TA timer length is configured as the remaining validity time (e.g., TA and remaining validity time (considering elapsed time)). An example is shown by FIG. 44.

These implementations can be applied alone in network side to assist the decision of TA updating. For example, the C-Cell 130c can indicate to the S-Cell 130s that current TA becomes invalid and needs to be updated, or the C-Cell 130c can indicate the expiry time (e.g., in UTC format and/or the format of another suitable timing standard, such as any of those discussed herein) of TA value to the S-Cell 130s. Then, a follow-up TA update can be triggered accordingly.

6.8.2. Distance-Based TA Maintenance

One drawback of the timer-based implementations is that, even if the UE 5402 does not move, the TA timer will expire anyway, which may lead to unnecessary TA update procedure. To address this issue, a distance-based TA maintenance mechanism can be applied. In these implementations, a distance threshold is configured to the UE 5402. After the UE 5402 receives the TA value towards a C-Cell 130c, the UE 5402 stores current UE location coordinates (e.g., using GPS/GNSS coordinates, LTE/NR positioning/location services, and/or some other coordinate system). Then, the UE 5402 checks the latest UE location periodically. If the distance between the stored UE location and a latest UE location is equal to or less than the distance threshold, the TA value can be considered valid.

Besides the distance threshold, a reference location can also be configured to the UE 5402. In this case, the criterion is changed to “if the distance between the reference UE location and the latest UE location is equal to or less than this threshold, the TA value can be considered valid”.

According to the distance-based implementations, only the UE 5402 knows if current TA is still valid. If current TA becomes invalid, the UE 5402 sends an indication to the S-Cell 130s, e.g., TA update request or TA invalidity indication. Then the S-Cell 130s can inform TA update request to the corresponding C-Cell 130c. Similar to the distance criterion, other criteria can also be applied, e.g., if the downlink timing difference between the S-Cell 130s and a C-Cell 130c is offset larger or smaller than the previous/stored value, the UE 5402 sends an indication to the S-Cell 130s.

It should be noted that the distance-based TA maintenance implementations may be used in combination with the timer-based TA maintenance implementations. In these implementations, the UE 5402 may operate according to the timer-based TA maintenance implementations, and checks its current location/coordinates according to the distance-based TA maintenance implementations when the TA timer expires.

6.9. TA Update

Some example implementations are discussed infra to perform a TA update, if a TA update is needed, although other embodiments may use different techniques.

6.9.1. Preamble-Based TA Update

In some examples, previous RACH resources (e.g., previously configured RACH resources) are reused for TA updates. If the preamble resource is UE-specific, or can be shared by multiple UEs 5402, the S-Cell 130s can send PDCCH order to trigger preamble Tx again for TA update.

Additionally or alternatively, another round of coordination of RACH resources between the S-Cell 130s and target cell (e.g., C-Cell 130c) can be used. Here, if previous preamble resource cannot be reused, the C-Cell 130c can initiate early TA acquisition again.

6.9.2. UL-Based TA Update

In some examples, a C-Cell 130c is able to listen to an uplink Tx (e.g., sounding reference signal (SRS) and/or the like) from a UE 5402 (while the UE 5402 is transmitting to the S-Cell 130s) and can maintain TA. In these examples, a TA command MAC CE for a C-Cell 130c can be used to adjust/update the TA value.

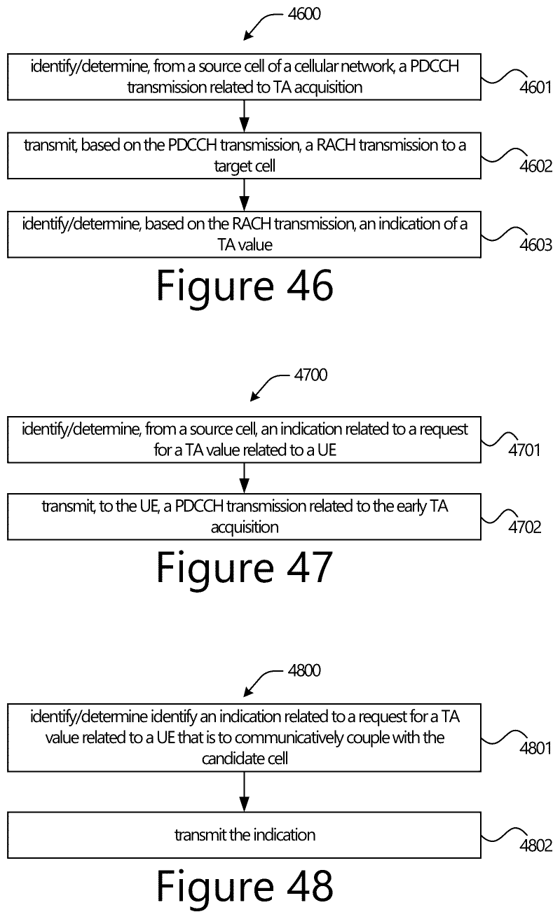

FIG. 45 shows an example TA command MAC CE 4500 for a candidate cell, which includes cell ID and TA (adjustment) value. In TA command MAC CE 4500, the CELL ID field has two bits and TA command has 6 bits. The CELL ID field contains a cell ID of the C-Cell 130c or a candidate configuration index. The Timing Advance Command field indicates the index value TA (e.g., 0, 1, 2 . . . 63) used to control the amount of timing adjustment that MAC entity has to apply (see e.g., [TS38213]).

FIG. 45 also shows another example TA command MAC CE 4501. The TA command MAC CE 4501 includes a 2 bit TAG Identity (TAG ID) field, which indicates the TAG Identity of the addressed Timing Advance Group (TAG). The TAG containing the SpCell has the TAG Identity 0. The TA command MAC CE 4501 includes also includes a 6 bit Timing Advance Command field, which indicates the index value TA (e.g., 0, 1, 2 . . . 63) used to control the amount of timing adjustment that MAC entity has to apply (see e.g., [TS38213]).

The Timing Advance Command MAC CEs 4500 and 4501 are identified by MAC subheader with LCID as specified in Table 6.2.1-1 of [TS38213] (e.g., LCID value of 61).

Additionally or alternatively, the TA command can be included in a MAC payload of a RAR (also referred to as a “MAC RAR”). The MAC RAR is of fixed size as depicted in FIG. 6.2.3-1 of [TS38213], and includes following fields: a reserved bit (R) set to 0; a 12 bit Timing Advance Command field that indicates the index value TA that is the same or similar as the Timing Advance Command field of MAC CEs 4500 and 4501; a 27 bit UL Grant field that indicates the resources to be used on the uplink in [TS38213]; a 16 bit Temporary C-RNTI field that indicates the temporary identity that is used by the MAC entity during Random Access.

6.10. Example Implementations

FIG. 46 shows an example process 4600, which is performed by a UE 5402. However, it should be noted that process 4600 can be performed by any of the electronic device(s), network(s), system(s), chip(s) or component(s), or portions or implementations thereof, of FIGS. 54-57, or some other figure discussed herein. Process 4600 begins at operation 4601 where the UE 5402 identifies and/or determines, from a S-Cell 130s of a cellular network, a physical downlink control channel (PDCCH) Tx related to timing advance (TA) acquisition. At operation 4602, the UE 5402 transmits, based on the PDCCH Tx, a random access channel (RACH) Tx to a target cell. At operation 4603, the UE 5402 identifies and/or determines, based on the RACH Tx, an indication of a TA value.

FIG. 47 shows an example process 4700, which is performed by a source cell (e.g., S-Cell 130s). However, it should be noted that process 4700 can be performed by any of the electronic device(s), network(s), system(s), chip(s) or component(s), or portions or implementations thereof, of FIGS. 54-57, or some other figure discussed herein. Process 4700 begins at operation 4701 where the S-Cell 130s identifies and/or determines that early timing advance (TA) acquisition of a C-Cell 130c by a UE 5402 is to occur. At operation 4702, the S-Cell 130s transmits, to the UE 5402, a physical downlink control channel (PDCCH) Tx related to the early TA acquisition.

FIG. 48 shows an example process 4800, which is performed by a candidate cell (e.g., C-Cell 130c). However, it should be noted that process 4800 can be performed by any of the electronic device(s), network(s), system(s), chip(s) or component(s), or portions or implementations thereof, of FIGS. 54-57, or some other figure discussed herein. Process 4800 begins at operation 4801 where the C-Cell 130c identifies and/or determines an indication related to a request for a timing advance (TA) value related to a UE 5402 that is to communicatively couple with the C-Cell 130c. At operation 4802, the C-Cell 130c transmits the indication to the UE 5402.

### 7. [AF2049] AVOIDING CHANGING PREPARE CONDITION HANDOVER (CHO) WITH OR WITHOUT SECONDARY CELL GROUP (SCG) CONFIGURATIONS DUE TO THE SOURCE RRC CONFIGURATION

As alluded to previously, one of the objectives of RP-221799 relates to finding a solution to avoid unnecessary signaling exchange between the source and the target to update the prepared CHO with or without SCG configurations due to the source RRC reconfiguration. For example, in addition to the objectives mentioned previously, RP-221799 also includes the following objectives:

In legacy HO, the HO command (CMD) prepared in the network (NW) and sent to a user equipment (UE) is executed right away, and thus there may be no need for RAN3 to consider “modification” of the prepared HO in NW side. However, when it comes to CHO, CHO preparation may happen in parallel for one or more candidate target primary cells (PCell(s)) and configured to the UE where the UE executes CHO to one of them for which a certain configured condition is met. Until executed, the UE is being served by the source and the source RRC configuration may change before CHO is executed by the UE. Therefore, it may be desirable to update the prepared CHO configurations (possibly together with new radio dual connectivity (NR-DC)/CPAC configurations if multiple secondary cell groups (SCGs) were also prepared in the target side by candidate secondary nodes), but so far this has resulted in the extensive signalling efforts and exchanges at the network (NW) side and with the UE for re-preparations and reconfigurations (note that it was agreed to reuse the existing HO signalling for CHO modification in NW side). As captured in 3GPP document RP-223520, it may be desirable for there to be mechanisms to avoid modification of such CHO(+NR-DC/CPAC) configurations that has been pre-configured in the UE due to the source RRC reconfiguration that may happen later (and before CHO(+NR-DC/CPAC) is executed).

3GPP document R3-226526 proposes a solution for the target to indicate to the source whether full configuration option was used when preparing CHO configuration, so that the source who knows this can skip CHO modification procedure with the target when its source RRC reconfiguration happens before CHO is executed by the UE. However, the solution in R3-226526 does not consider the aspect that master node (MN) and secondary node (SN) RRC configurations can be handled independently in the current RRC design of multi-radio access technology (RAT) dual-connectivity (MR-DC), for which could allow NW nodes to save even more modification efforts of the prepared CHO(+NR-DC/CPAC) configurations. Additionally, the solution in R3-226526 may also not allow NW nodes to save re-preparation signalling in the target side when CHO modification is triggered by the source.

The present disclosure provides techniques to avoid changing the prepared CHO with or without SCG configurations due to the source RRC reconfiguration. In some embodiments, a source secondary node (S-SN) (e.g., S-SN 4910s in FIGS. 49-53) who is aware of CHO) is made to inform a secondary master node (S-MN) (e.g., S-MN 4915s in FIGS. 49-53) of its intra-S-SN configuration update with the UE always, regardless of whether SRB3 was used and intra-S-SN reconfiguration was already performed, or SRB1 has to be used for intra-S-SN reconfiguration toward the UE. Additionally or alternatively, during CHO preparation phase with a target PCell in a target master node (T-MN) 4915t, the T-MN 4915t is made to provide full configuration status of its CHO(+NR-DC/CPAC) configuration by (a) full config vs (b) full config only on SN, so that based on (a) or (b) provided by T-MN 4915t, the S-MN 4915s can be made to save triggering CHO modification signallings toward the T-MN 4915t (see e.g., FIG. 49). FIG. 49 depicts an example procedure for enhancement of HO REQ ACK message signaling and how to save CHO modification signalling from the S-MN 4915s.

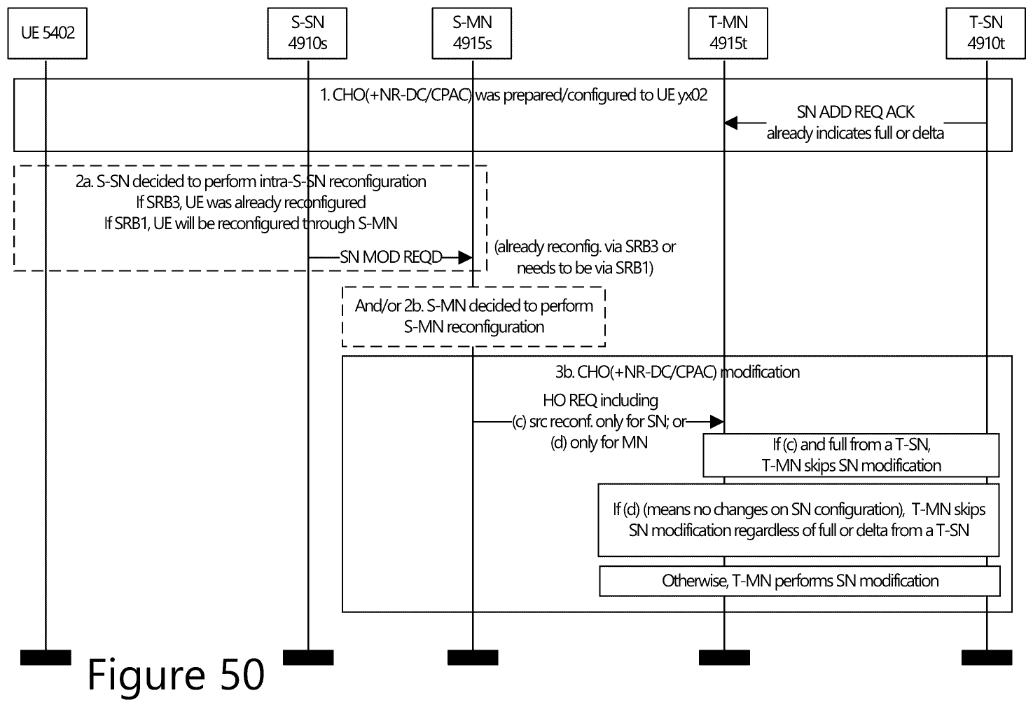

In some embodiments, in the case that the S-MN 4915s has to trigger subsequent CHO modification procedure, the S-MN 4915s is made provide information about whether the executed source RRC reconfiguration was for (c) SN only or (d) MN only, to help T-MN 4915t avoid unnecessary signalling in the target side further (see e.g., FIG. 50). FIG. 50 depicts an example procedure for enhancement HO REQ message and to save CHO modification signalling from T-MN 4915t.

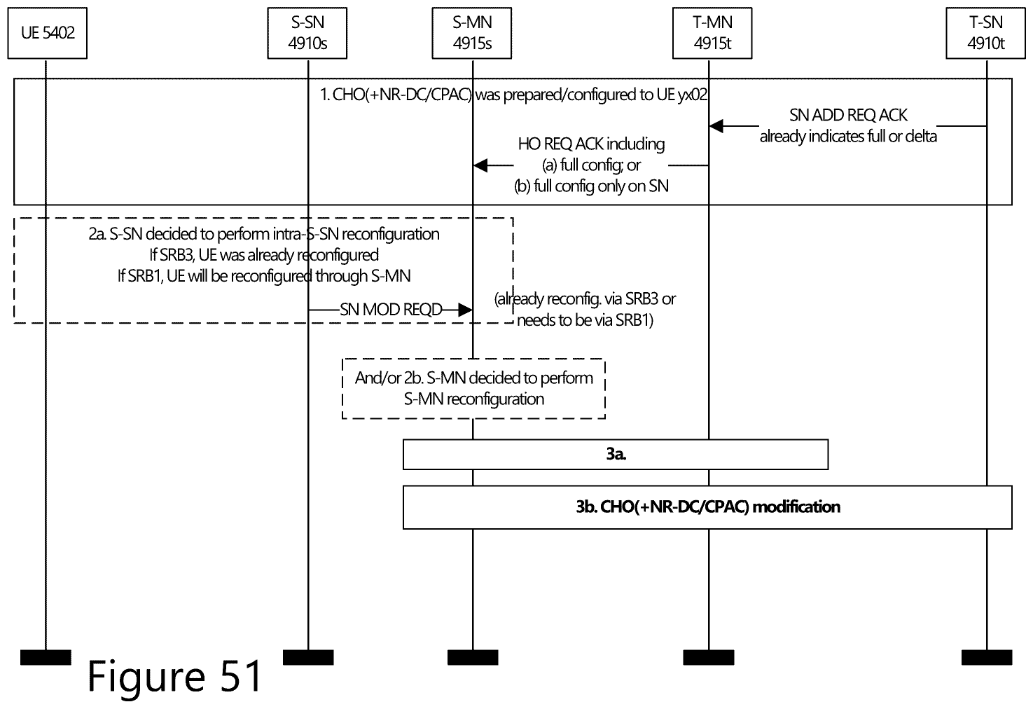

In some embodiments, a hybrid solution may achieve the best minimizations of unnecessary CHO modification signalling in the source and target side (see e.g., FIG. 51). FIG. 51 depicts an example hybrid of the procedures of FIGS. 49 and 50 to save CHO modification signalling from the S-MN 4915s and from T-MN 4915t.

The signaling and information in this disclosure may enable NW nodes to avoid changing the prepared CHO with or without SCG (Secondary Cell Group) configurations due to the source RRC reconfiguration and thus can reduce the waste of Xn interface resources, air interface and unnecessary processing burdens in the NW and the UE.

In legacy HO, the HO CMD prepared in NW and sent to the UE is executed right away, and thus there was no need to consider “modification” of the prepared HO in NW side.

However, when it comes to CHO, CHO preparation happens in parallel for one or more candidate target PCell(s) and configured to the UE where the UE executes CHO to one of them for which a certain configured condition is met. Until executed, the UE is being served by the source and the source RRC configuration may change before CHO is executed by the UE. There was a need to “update” the prepared CHO configurations and it was agreed to re-use the existing HO signalling for CHO modification.

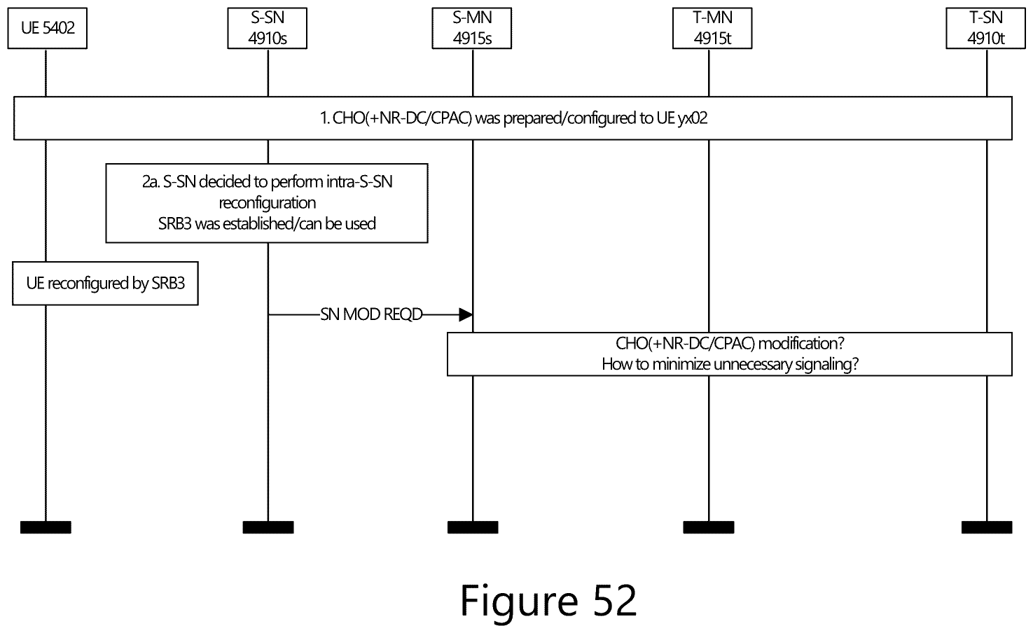

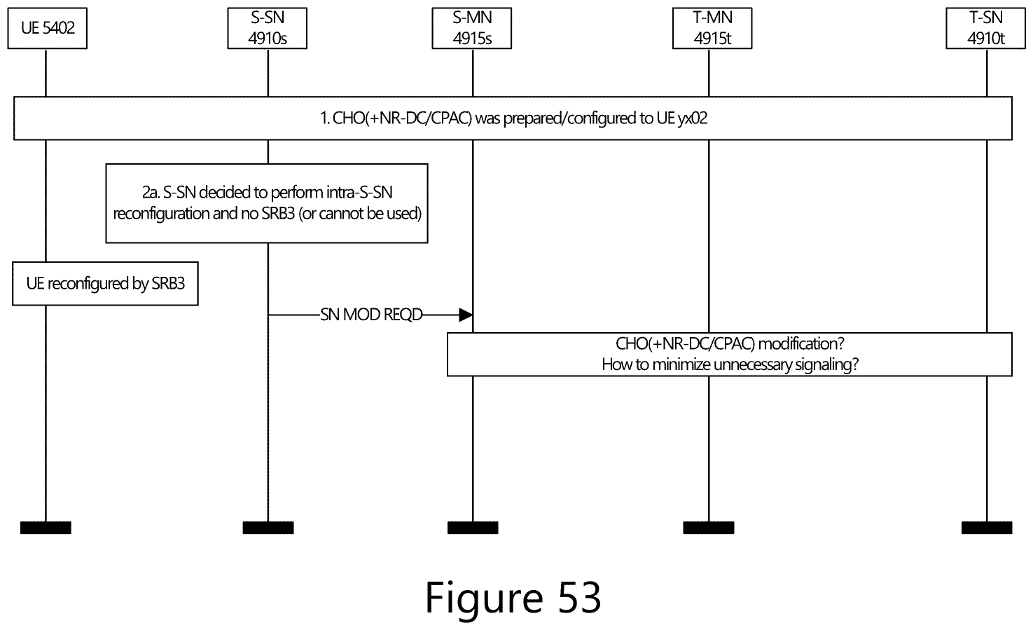

In the case that the source is in MR-DC, after CHO was prepared and configured to the UE, the UE's SN RRC configuration may get changed by an S-SN 4910s (e.g., via SRB3). So far, this has resulted in the modification of the prepared CHO between the S-MN 4915s and candidate target node(s), regardless of whether such change impacts CHO(+NR-DC/CPAC) configurations that has been configured in the UE or not. It was acknowledged that there is a need to avoid unnecessary modification of CHO(+NR-DC/CPAC) configurations when intra-S-SN reconfiguration incurs no change on them (see e.g., FIGS. 52 and 53). FIG. 52 depicts an example procedure of when SRB3 is used for intra-S-SN reconfiguration. FIG. 53 depicts an example procedure of when SRB1 has to be used for intra-S-SN reconfiguration.

Though the problem is shown and described based on intra-S-SN RRC reconfiguration in FIGS. 52 and 53, CHO modification is subject to any RRC reconfiguration in the source side, and thus, RRC reconfiguration by the S-MN 4915s also falls into the same problem of resulting in unnecessary necessary modification of CHO(+NR-DC/CPAC) configurations.

In 3GPP, “comprehension” of already applied UE RRC configuration from another node has been determined by that node itself and by a binary way—if comprehended, then delta signalling can be used for subsequent RRC reconfigurations; if not comprehended, then full configuration is used. With respect to RRC reconfigurations across nodes, this has been the principle of 3GPP from the very early days.

The “only exception” is when some CHO(+NR-DC/CPAC) configurations were built in a full configuration way. This is because the problem is about impacts on the RRC configurations generated by target (and configured to the UE but not applied yet) before the source RRC reconfiguration happens. If the source is able to know whether full config was used for some CHO(+NR-DC/CPAC) configurations already stored in the UE, then the source can have the privilege to skip subsequent modifications of those “full-configured” CHO(+NR-DC/CPAC) configurations.

However, in legacy specification, whether a target used full or delta RRC signaling is not informed to the source during HO preparation phase (also during CHO preparation phase which follows the legacy HO signalling). This is because in the legacy HO, the HO CMD is executed right away by the UE upon reception (e.g., RRC reconfiguration generated by the target is applied right away) and thus there was no need for the source to care about whether the target used full or delta RRC signalling.

On the other hand, during SN addition or modification in MR-DC, SN can inform MN whether it used full or delta via RRC Config Indication IE (see e.g., 3GPP TS 38.423 v17.5.0 (2023 Jun. 28) (“[TS38423]”), the contents of which are hereby incorporated by reference in its entirety). This is because there are some actions to be performed by MN from RRC point of view when SN used full configuration option for its SN RRC configuration (e.g., putting SN terminated DRBs into drb-ToReleaseList). Moreover, if the T-MN 4915t has to use full configuration option during HO or CHO, or if MN has to use full configuration during SN change, then (T-)MN T-SN 4915t implicitly forces full configuration to a target SN (T-SN) (e.g., T-SN 4910t in FIGS. 49-53) as well by omitting mcg-RB-Config, scg-RB-Config and sourceConfigSCG(-EUTRA) within CG-ConfigInfo (see e.g., [TS38331]).

But even though the T-MN 4915t can know whether the whole CHO(+NR-DC/CPAC) configurations was generated in a full configuration way, or only on SN part, such info is not informed to the source side as explained above. In legacy specifications, “only exception” cannot be leveraged by the source side that can potentially avoid unnecessary signalling.

Hence, in some examples, a S-SN 4910s (who is aware of CHO) could be made to inform the S-MN 4915s of its intra-S-SN configuration update with the UE always. Even if SRB3 was used and intra-S-SN reconfiguration was already performed with the UE (see e.g., FIG. 52), the S-SN 4910s could be made to trigger the SN-initiated SN modification procedure (including the updated CG-Config). As observed above, the S-SN 4910s does not make own judgements. Moreover, based on the updated CG-Config, the S-MN 4915s may have to perform RRC reconfiguration for MN part to the UE further. There should be no S-SN's 4910s own decision in doing so, even if the S-SN 4910s can be made aware that not only CHO but also (+NR-DC/CPAC) had been prepared for the UE 5402.

Then, with the aforementioned observations in mind, the following aspects are considered in designing possible solutions. One possible solution involves CHO modification being subject to any RRC reconfiguration in the source side and thus RRC reconfiguration by the S-MN 4915s (as well as by the S-SN 4910s) also falls into our optimization target. And, in case the S-SN 4910s performs intra-S-SN reconfiguration, the S-MN 4915s is informed.

In another possible solution, if the S-MN 4915s is able to know that full configuration was used for some CHO(+NR-DC/CPAC) configurations, then the S-MN 4915s can skip the subsequent CHO modification procedures toward those CHO(+NR-DC/CPAC) configurations, regardless of whether the source RRC reconfiguration was for MN part or for SN part.

In another possible solution, in MR-DC, in the current RRC design, if MN uses full config, then SN has to use full config. But the opposite is not true—That is, even if SN used full config for its SN RRC reconfiguration (e.g., when adding SN or SN change), MN can still do delta as long as MN can comprehend. And MN can know whether SN used full or delta during SN addition or modification procedures via the famous RRC Config Indication IE (see e.g., [TS38423]).

Combining these aspects gives room to avoid CHO modification signalings even more than just relying on full configuration indication from the target. Additionally or alternatively (see e.g., FIG. 49), during CHO preparation phase with a target PCell in a T-MN 4915t, the T-MN 4915t can be made to provide full configuration status of its CHO(+NR-DC/CPAC) configuration by (a) full config vs (b) full config only on SN, so that based on (a) or (b) provided by the T-MN 4915t, savings on CHO modification signalings from the S-MN 4915s can be optimized Like mentioned above, if (a) was indicated to the S-MN 4915s, which means that RRCReconfiguration message containing CHO(+NR-DC/CPAC) configuration from this target PCell was generated by full configuration and conveyed to the S-MN 4915s as CHO CMD via HO REQ ACK, then the S-MN 4915s doesn't have to trigger CHO modification procedure regardless of whether the source RRC reconfiguration was for MN or for SN or both. On the other hand, if (b) was indicated, then this means that only SN part of RRCReconfiguration message (e.g., radioBearerConfig2, secondaryCellGroup) to be applied when CHO(+NR-DC/CPAC) is executed was generated in a full configuration way. Then the S-MN 4915s can skip CHO modification signalling when the source RRC reconfiguration was only for intra-S-SN RRC reconfiguration that does not impact on MN configuration (for which the S-SN 4910s indicated so to the S-MN 4915s via SN MOD REQD already). As long as there is no change on the source MN RRC configuration, the S-MN 4915s who knows (b) doesn't have to bother this target PCell for modifying CHO(+NR-DC/CPAC) configuration previously configured in the UE. For these embodiments, example implementations for XnAP HANDOVER REQUEST ACKNOWLEDGE message are discussed in sections 7.1 and 7.2.

In another embodiment (see e.g., FIG. 50), in the case that the S-MN 4915s has to trigger subsequent CHO modification procedure toward a candidate PCell, the S-MN 4915s can be made provide information about the executed source RRC reconfiguration to help the T-MN 4915t avoid unnecessary signalling in the target side. That is, if the S-MN 4915s indicates that source RRC reconfiguration was for (c) SN only or (d) MN only in the CHO modification request signalling toward this candidate PCell (in a the T-MN 4915t), then the T-MN 4915t can further decide to skip the subsequent SN modification procedure with SN(s) associated with this candidate PCell for CHO(+NR-DC/CPAC) configurations: If (c) was indicated toward a candidate PCell but the T-MN 491St knows that a SN (associated with this candidate PCell for CHO(+NR-DC/CPAC) configurations) already used full configuration option beforehand (which is already supported by the existing RRC Config Indication IE (see e.g., [TS38423])), then the T-MN 491St can skip the SN modification procedure toward that SN. On the other hand, if (d) was indicated (which means that there was no change on SN configuration in the source side), then the T-MN 491St can skip SN modification with all the candidate SN(s) regardless of whether full or delta configuration was applied from those T-SN(s) 4910t when generating CHO(+NR-DC/CPAC) configurations, because the source RRC reconfiguration was only for MN part that does not impact SN configuration. In this case, there is no need to bother with those SN(s) to update the SN part of CHO(+NR-DC/CPAC) configurations. For these embodiments, example implementations for XnAP HANDOVER REQUEST message could be as discussed in sections 7.3 and 7.4.

In some embodiments (see e.g., FIG. 51), a hybrid of the aforementioned embodiments can be considered to achieve the best minimizations of unnecessary CHO modification signalling in the source and target side.

7.1. Handover Request Acknowledge

The handover request acknowledge message is sent by the target NG-RAN node to inform the source NG-RAN node about the prepared resources at the target. The direction of communication for this message is: target NG-RAN node source NG-RAN node. Example contents and other aspects of the handover request acknowledge message are shown by table 7.1-1. Additional or alternative content and/or other aspects of the handover request acknowledge message are described in [TS38423] (see e.g., [TS38423] § 9.1.1.2).

TABLE 7.1-1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.3.1 | | YES | reject |
| Source NG-RAN | M | | NG-RAN | Allocated at the | YES | ignore |
| node UE XnAP ID | | | node UE | source NG-RAN | | |
| | | | XnAP ID | node | | |
| | | | 9.2.3.16 | | | |
| Target NG-RAN | M | | NG-RAN | Allocated at the | YES | ignore |
| node UE XnAP ID | | | node UE | target NG-RAN | | |
| | | | XnAP ID | node | | |
| | | | 9.2.3.16 | | | |
| PDU Session | M | | 9.2.1.2 | | YES | ignore |
| Resources Admitted | | | | | | |
| List | | | | | | |
| PDU Session | O | | 9.2.1.3 | | YES | ignore |
| Resources Not | | | | | | |
| Admitted List | | | | | | |
| Target NG-RAN | M | | OCTET | Either includes the | YES | ignore |
| node To Source | | | STRING | HandoverCommand | | |
| NG-RAN node | | | | message as | | |
| Transparent | | | | defined in | | |
| Container | | | | subclause 10.2.2 of | | |
| | | | | [TS36331], if the | | |
| | | | | target NG-RAN | | |
| | | | | node is an ng-eNB, | | |
| | | | | or the | | |
| | | | | HandoverCommand | | |
| | | | | message as | | |
| | | | | defined in | | |
| | | | | subclause 11.2.2 of | | |
| | | | | [TS38331], if the | | |
| | | | | target NG-RAN | | |
| | | | | node is a gNB. | | |
| UE Context Kept | O | | 9.2.3.68 | | YES | ignore |
| Indicator | | | | | | |
| Criticality | O | | 9.2.3.3 | | YES | ignore |
| Diagnostics | | | | | | |
| DRBs transferred to | O | | DRB List | In case of DC, | YES | ignore |
| MN | | | 9.2.1.29 | indicates that SN | | |
| | | | | Status is needed | | |
| | | | | for the listed DRBs | | |
| | | | | from the S-NG- | | |
| | | | | RAN node. | | |
| DAPS Response | O | | 9.2.1.34 | | YES | reject |
| Information | | | | | | |
| Conditional | O | | | | YES | reject |
| Handover | | | | | | |
| Information | | | | | | |
| Acknowledge | | | | | | |
| >Requested | M | | Target Cell | Target cell | — | |
| Target Cell ID | | | Global ID | indicated in the | | |
| | | | 9.2.3.25 | corresponding | | |
| | | | | HANDOVER | | |
| | | | | REQUEST | | |
| | | | | message | | |
| >Maximum | O | | 9.2.3.101 | | — | |
| Number of CHO | | | | | | |
| Preparations | | | | | | |
| >Target RRC | O | | 9.2.3.X | | YES | Ignore |
| Config Indication | | | | | | |
| MBS Session | O | | 9.2.1.38 | | YES | ignore |
| Information | | | | | | |
| Response List | | | | | | |

7.2. Target RRC Config Indication

The target RRC configuration indication IE indicates the type of RRC configuration used at the target NG-RAN node. Aspects of this IE are described in table 7.2-1. Additional or alternative content and/or other aspects of this IE may be described in [TS38423].

TABLE 7.2-1

| | | | IE Type and | Semantics |
|---|---|---|---|---|
| IE/Group Name | Presence | Range | Reference | Description |
| Target RRC | M | | ENUMERATED (full | |
| Config Indication | | | config, full config | |
| | | | only on SN, . . .) | |

7.3. Handover Request

The handover request message is sent by the source NG-RAN node to the target NG-RAN node to request the preparation of resources for an HO. The direction of communication for this message is: source NG-RAN node target NG-RAN node. Example contents and other aspects of the handover request message are shown by tables 7.3-1 and 7.3-2. Additional or alternative content and/or other aspects of the handover request message are described in [TS38423] (see e.g., [TS38423] § 9.1.1.1).

TABLE 7.3-1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.3.1 | | YES | reject |
| Source NG-RAN node | M | | NG-RAN node | Allocated at the | YES | reject |
| UE XnAP ID reference | | | UE XnAP ID | source NG-RAN | | |
| | | | 9.2.3.16 | node | | |
| Cause | M | | 9.2.3.2 | | YES | reject |
| Target Cell Global ID | M | | 9.2.3.25 | Includes either an | YES | reject |
| | | | | E-UTRA CGI or an | | |
| | | | | NR CGI | | |
| GUAMI | M | | 9.2.3.24 | | YES | reject |

. . .

| | | | | | |
|---|---|---|---|---|---|
| Conditional Handover | O | | | YES | reject |
| Information Request | | | | | |
| >CHO Trigger | M | ENUMER- | | — | |
| | | ATED | | | |
| | | (CHO- | | | |
| | | initiation, | | | |
| | | CHO-replace, | | | |
| | | . . .) | | | |
| >Target NG-RAN | C- | NG-RAN node | Allocated at the | — | |
| node UE XnAP ID | ifCHOmod | UE XnAP ID | target NG-RAN | | |
| | | 9.2.3.16 | node | | |
| >Estimated Arrival | O | INTEGER | | | |
| Probability | | (1..100) | | | |
| >Source RRC Config | C- | 9.3.3.Y | | — | |
| Indication | ifCHOmod | | | | |
| NR V2X Services | O | 9.2.3.105 | | YES | ignore |
| Authorized | | | | | |

. . .

TABLE 7.3-1

| Condition | Explanation |
|---|---|
| ifCHOmod | This IE shall be present if the CHO Trigger |
| | IE is present and set to “CHO-replace”. |

7.4. Source RRC Config Indication

The source RRC configuration indication IE indicates the type of RRC configuration used at a source NG-RAN node. Aspects of this IE are described in table 7.4-1. Additional or alternative content and/or other aspects of this IE may be described in [TS38423].

TABLE 7.4-1

| | | | IE Type and | Semantics |
|---|---|---|---|---|
| IE/Group Name | Presence | Range | Reference | Description |
| Source RRC | M | | ENUMERATED | |
| Config Indication | | | (only on SN, only on | |
| | | | MN, . . .) | |

### 8. EXAMPLE CONFIGURATION ASPECTS

8.1. Protocol Data Units, Formats, and Parameters

The contents of each RRC message and IE are specified using Abstract Syntax Notation One (ASN.1) to specify the message syntax and using tables when needed to provide further detailed information about the fields specified in the message syntax.

Usage of the text “network always configures the UE with a value for this field” in the field description indicates that the network has to provide a value for the field in this or in a previous message based on a delta configuration (for an optional field with Need M). It does not imply a mandatory presence of the field.

8.1.1. Need Codes and Conditions for Optional Fields

The need for fields to be present in a message or an abstract type, for example, the ASN.1 fields that are specified as OPTIONAL in the abstract notation (ASN.1), is specified by means of comment text tags attached to the OPTIONAL statement in the abstract syntax. All comment text tags are available for use in the downlink direction for RRC message and in the sidelink for PC5 RRC message. The meaning of each tag is specified in table 8.1-1.

If conditions are used, a conditional presence table is provided for the message or information element specifying the need of the field for each condition case. The table also specifies whether UE maintains or releases the value in case the field is absent. The conditions clarify what the UE may expect regarding the setting of the message by the network for the RRC message or by the peer UE in the sidelink RRC message. Violation of conditions is regarded as invalid network behaviour when transmitting downlink RRC message or invalid UE behavior when transmitting PC5 RRC message, which the UE is not required to cope with. Hence the general error handling defined in 10.4 does not apply in case a field is absent although it is mandatory according to the CondC or CondM condition.

TABLE 8.1-1
Meaning of abbreviations used to specify the need for fields to be present

| Abbreviation | Meaning |
|---|---|
| Cond condition Tag | Conditionally present |
| | Presence of the field is specified in a tabular form following the ASN.1 segment. |
| CondC conditionTag | Configuration condition |
| | Presence of the field is conditional to other configuration settings. |
| CondM conditionTag | Message condition |
| | Presence of the field is conditional to other fields included in the message. |
| Need S | Specified |
| | Used for (configuration) fields, whose field description or procedure specifies the UE |
| | behavior performed upon receiving a message with the field absent (and not if field |
| | description or procedure specifies the UE behavior when field is not configured). |
| Need M | Maintain |
| | Used for (configuration) fields that are stored by the UE e.g., not one-shot. Upon |
| | receiving a message with the field absent, the UE maintains the current value. |
| Need N | No action (one-shot configuration that is not maintained) |
| | Used for (configuration) fields that are not stored and whose presence causes a one- |
| | time action by the UE. Upon receiving message with the field absent, the UE takes no |
| | action. |
| Need R | Release |
| | Used for (configuration) fields that are stored by the UE e.g., not one-shot. Upon |
| | receiving a message with the field absent, the UE releases the current value. |

In some examples, any field with Need M or Need N in system information may be interpreted as Need R. The need code used within a CondX definition only applies for the case (part of the condition) where it is defined: A condition may have different need codes for different parts of the condition.

In some examples, Need M (=Maintain) is used when the field needs to be stored by the UE 5402 (e.g., maintained) when absent; Need R (=Release) is used when the field needs to be released by the UE 5402 when absent; Need N(=None) is used when the UE 5402 is to take no action when the field is absent (e.g., UE does not even need to maintain any existing value of the field); Need S(=Specified) is used to specify the UE behavior upon absence of the field in the procedural text or in the field description table and/or UE behavior upon absence does not fit any of the above conditions. Additional aspects and guidelines on the use of need codes and conditions are provided in [TS38331] §§ 6.1.2, A.6, and A.7.

8.2. RRC Reconfiguration

8.2.1. General

The purpose of the RRC reconfiguration procedure is to modify an RRC connection, e.g. to establish/modify/release RBs/BH RLC channels/Uu Relay RLC channels/PC5 Relay RLC channels, to perform reconfiguration with sync, to setup/modify/release measurements, to add/modify/release SCells and cell groups, to add/modify/release conditional handover configuration, to add/modify/release conditional PSCell change or conditional PSCell addition configuration, to add/modify/release LTM candidate cells. As part of the procedure, non-access stratum (NAS) dedicated information may be transferred from the Network to the UE.

RRC reconfiguration to perform reconfiguration with sync includes, but is not limited to, the following cases: reconfiguration with sync and security key refresh, involving RA to the Pcell/PSCell, MAC reset, refresh of security and re-establishment of RLC and PDCP triggered by explicit L2 indicators; reconfiguration with sync but without security key refresh, involving RA to the Pcell/PSCell, MAC reset and RLC re-establishment and PDCP data recovery (for Acknowledged Mode (AM) DRB or AM Multicast/Broadcast Service (MBS) Radio Bearer (MRB)) triggered by explicit L2 indicators; reconfiguration with sync for Dual Active Protocol Stack (DAPS) and security key refresh, involving RA to the target Pcell, establishment of target MAC, and for non-DAPS bearer: refresh of security and re-establishment of RLC and PDCP triggered by explicit L2 indicators, for DAPS bearer: establishment of RLC for the target Pcell, refresh of security and reconfiguration of PDCP to add the ciphering function, the integrity protection function and ROHC function of the target Pcell, and for SRB: refresh of security and establishment of RLC and PDCP for the target Pcell; reconfiguration with sync for DAPS but without security key refresh, involving RA to the target Pcell, establishment of target MAC, and for non-DAPS bearer: RLC re-establishment and PDCP data recovery (for AM DRB or AM MRB) triggered by explicit L2 indicators, for DAPS bearer: establishment of RLC for target Pcell, reconfiguration of PDCP to add the ciphering function, the integrity protection function and ROHC function of the target Pcell, and for SRB: establishment of RLC and PDCP for the target Pcell; and/or reconfiguration with sync for direct-to-indirect path switch, not involving RA at target side, involving re-establishment of PDCP/PDCP data recovery (for AM DRB) triggered by explicit L2 indicators.

In (NG)EN-DC and NR-DC, SRB3 can be used for measurement configuration and reporting, for UE assistance (re-)configuration and reporting for power savings, for IP address (re-) configuration and reporting for IAB-nodes, to (re-)configure MAC, RLC, BAP, physical layer and RLF timers and constants of the SCG configuration, and to reconfigure PDCP for DRBs associated with the S-K g Ns or SRB3, and to reconfigure SDAP for DRBs associated with S-K_{gNB} in NGEN-DC and NR-DC, and to add/modify/release conditional PSCell change configuration, provided that the (re-)configuration does not require any MN involvement, and to transmit RRC messages between the MN and the UE during fast MCG link recovery. In (NG)EN-DC and NR-DC, only measConfig, radioBearerConfig, conditionalReconfiguration, bap-Config, iab-IP-AddressConfigurationList, otherConfig and/or secondaryCellGroup are included in RRCReconfiguration received via SRB3, except when RRCReconfiguration is received within DLInformationTransferMRDC.

8.2.2. Initiation

The network may initiate the RRC reconfiguration procedure to a UE 5402 in RRC_CONNECTED. The Network applies the procedure as follows: the establishment of RBs (other than SRB1, that is established during RRC connection establishment) is performed only when AS security has been activated; the establishment of BH RLC Channels for IAB is performed only when AS security has been activated; the establishment of Uu Relay RLC channels and PC5 Relay RLC channels (other than SL-RLC0 and SL-RLC1) for L2 U2N Relay UE is performed only when AS security has been activated, and the establishment of PC5 Relay RLC channels for L2 U2N Remote UE (other than SL-RLC0 and SL-RLC1) is performed only when AS security has been activated; the addition of Secondary Cell Group and SCells is performed only when AS security has been activated; the reconfigurationWithSync is included in secondaryCellGroup only when at least one RLC bearer or BH RLC channel is setup in SCG; the reconfigurationWithSync is included in masterCellGroup only when AS security has been activated, and SRB2 with at least one DRB or multicast MRB or, for JAB, SRB2, are setup and not suspended; the conditionalReconfiguration for CPC is included only when at least one RLC bearer is setup in SCG; the conditionalReconfiguration for CHO or CPA is included only when AS security has been activated, and SRB2 with at least one DRB or multicast MRB or, for JAB, SRB2, are setup and not suspended; the ltm-CandidateConfig for LTM on the MCG is included only when AS security has been activated, and SRB2 with at least one DRB are setup and not suspended; the ltm-CandidateConfig for LTM on the SCG is included only when at least one RLC bearer is setup in SCG. It is FFS on whether ltm-CandidateConfig applies also for the case of MBS or JAB.

8.2.3. Reception of an RRCReconfiguration by the UE

The UE 5402 performs the following actions upon reception of the RRCReconfiguration, or upon execution of the conditional reconfiguration (CHO, CPA, or CPC): If the RRCReconfiguration is applied due to a conditional reconfiguration execution upon cell selection performed while timer T311 was running, as defined in 5.3.7.3 of [TS38331], the UE 5402 removes all the entries within the MCG and the SCG VarConditionalReconfig except for the entries associated with Subsequent CPAC (SCPAC) candidates, if any. In SCG selective activation, the CPC/CPA configurations of the UE 5402 should be released after PCell change, at least for inter MN (e.g., by explicit indication from network, FFS other case). Removal of the SCPAC candidate configuration in case the UE 5402 performs intra-MN Pcell change is avoided. In the failure case, when CHO configuration has been used (attempted) for recovery, the UE 5402 may also select an intra-MN PCell to access, which should not result in SCPAC configuration removal. If the RRCReconfiguration includes the daps-SourceRelease, the UE 5402 resets the source MAC and release the source MAC configuration; for each DAPS bearer, the UE 5402 releases the RLC entity or entities as specified in clause 5.1.3 of [TS38322] and the associated logical channel for the source SpCell, and reconfigures the PDCP entity to release DAPS as specified in [TS38323]; for each SRB, the UE 5402 releases the PDCP entity for the source SpCell, and releases the RLC entity as specified in clause 5.1.3 [TS38322] and the associated logical channel for the source SpCell; the UE 5402 releases the physical channel configuration for the source SpCell; and discards the keys used in the source SpCell (the K_{gNB} key, the K_{RRCenc} key, the K_{RRCint} key, the K_{Upint} key and the K_{Upenc} key), if any. If the RRCReconfiguration is received via other RAT (e.g., inter-RAT handover to NR), if the RRCReconfiguration does not include the fullConfig and the UE 5402 is connected to 5GC (e.g., delta signalling during intra 5GC handover), the UE 5402 re-uses the source RAT SDAP and PDCP configurations if available (e.g., current SDAP/PDCP configurations for all RBs from source E-UTRA RAT prior to the reception of the inter-RAT HO RRCReconfiguration message). Else, if the RRCReconfiguration includes the fullConfig, the UE 5402 performs the full configuration procedure as specified in 5.3.5.11 of [TS38331]. If the RRCReconfiguration includes the masterCellGroup, the UE 5402 performs the cell group configuration for the received masterCellGroup according to 5.3.5.5 of [TS38331]. If the RRCReconfiguration includes the masterKeyUpdate, the UE 5402 performs AS security key update procedure as specified in 5.3.5.7 of [TS38331]. If the RRCReconfiguration includes the sk-Counter, the UE 5402 performs security key update procedure as specified in 5.3.5.7 of [TS38331]. If the RRCReconfiguration includes the secondaryCellGroup, the UE 5402 performs the cell group configuration for the SCG according to section 8.1 herein and/or 5.3.5.5 of [TS38331]. If the RRCReconfiguration includes the mrdc-SecondaryCellGroupConfig, if the mrdc-SecondaryCellGroupConfig is set to setup, if the mrdc-SecondaryCellGroupConfig includes mrdc-ReleaseAndAdd, the UE 5402 performs MR-DC release as specified in clause 5.3.5.10 of [TS38331]. If the received mrdc-SecondaryCellGroup is set to nr-SCG, the UE 5402 performs the RRC reconfiguration according to 5.3.5.3 of [TS38331] for the RRCReconfiguration message included in nr-SCG. If the received mrdc-SecondaryCellGroup is set to eutra-SCG, the UE 5402 performs the RRC connection reconfiguration as specified in [TS36331]clause 5.3.5.3 for the RRCConnectionReconfiguration message included in eutra-SCG. Else (mrdc-SecondaryCellGroupConfig is set to release), the UE 5402 performs MR-DC release as specified in clause 5.3.5.10 of [TS38331]. If the RRCReconfiguration message includes the radioBearerConfig, the UE 5402 performs the radio bearer configuration according to 5.3.5.6 of [TS38331]. If the RRCReconfiguration message includes the radioBearerConfig2, the UE 5402 performs the radio bearer configuration according to 5.3.5.6 of [TS38331]. If the RRCReconfiguration message includes the measConfig, the UE 5402 performs the measurement configuration procedure as specified in 5.5.2 of [TS38331]. If the RRCReconfiguration message includes the dedicatedNAS-MessageList, the UE 5402 forwards each element of the dedicatedNAS-MessageList to upper layers in the same order as listed. If the RRCReconfiguration message includes the dedicatedSIB1-Delivery, the UE 5402 performs the action upon reception of SIB1 as specified in 5.2.2.4.2 of [TS38331]. If this RRCReconfiguration is associated to the MCG and includes reconfigurationWithSync in spCellConfig and dedicatedSIB1-Delivery, the UE 5402 initiates (if needed) the request to acquire required SIBs, according to clause 5.2.2.3.5 of [TS38331], only after the random access procedure towards the target SpCell is completed. If the RRCReconfiguration message includes the dedicatedSystemInformationDelivery, the UE 5402 performs the action upon reception of System Information as specified in 5.2.2.4 of [TS38331]. If the RRCReconfiguration message includes the dedicatedPosSysInfoDelivery, the UE 5402 performs the action upon reception of the contained posSIB(s), as specified in clause 5.2.2.4.16 of [TS38331]. If the RRCReconfiguration message includes the otherConfig, the UE 5402 performs the other configuration procedure as specified in 5.3.5.9 of [TS38331]. If the RRCReconfiguration message includes the bap-Config, the UE 5402 performs the BAP configuration procedure as specified in 5.3.5.12 of [TS38331]. If the RRCReconfiguration message includes the iab-IP-AddressConfigurationList, if iab-IP-AddressToReleaseList is included, the UE 5402 performs release of IP address as specified in 5.3.5.12a.1.1 of [TS38331]; if iab-IP-AddressToAddModList is included, the UE 5402 performs IAB IP address addition/update as specified in 5.3.5.12a.1.2 of [TS38331].

If the RRCReconfiguration message includes the conditionalReconfiguration, the UE 5402 performs conditional reconfiguration as specified in section 8.2.5 herein and/or 5.3.5.13 of [TS38331]. If the RRCReconfiguration message includes the needForGapsConfigNR, if needForGapsConfigNR is set to setup, the UE 5402 considers itself to be configured to provide the measurement gap requirement information of NR target bands; else, the UE 5402 considers itself not to be configured to provide the measurement gap requirement information of NR target bands. If the RRCReconfiguration message includes the needForGapNCSG-ConfigNR, if needForGapNCSG-ConfigNR is set to setup, the UE 5402 considers itself to be configured to provide the measurement gap and NCSG requirement information of NR target bands; else, the UE 5402 considers itself not to be configured to provide the measurement gap and NCSG requirement information of NR target bands. If the RRCReconfiguration message includes the needForGapNCSG-ConfigEUTRA, if needForGapNCSG-ConfigEUTRA is set to setup, the UE 5402 considers itself to be configured to provide the measurement gap and NCSG requirement information of E-UTRA target bands; else, the UE 5402 considers itself not to be configured to provide the measurement gap and NCSG requirement information of E-UTRA target bands. If the RRCReconfiguration message includes the sl-ConfigDedicatedNR, the UE 5402 performs the sidelink dedicated configuration procedure as specified in 5.3.5.14 of [TS38331]. If the sl-ConfigDedicatedNR was received embedded within an E-UTRA RRCConnectionReconfiguration message, the UE does not build an NR RRCReconfigurationComplete message for the received sl-ConfigDedicatedNR. If the RRCReconfiguration message includes the sl-L2RelayUE-Config, the UE 5402 performs the L2 U2N Relay UE configuration procedure as specified in 5.3.5.15 of [TS38331]. If the RRCReconfiguration message includes the sl-L2RemoteUE-Config the UE 5402 performs the L2 U2N Remote UE configuration procedure as specified in 5.3.5.16 of [TS38331]. If the RRCReconfiguration message includes the dedicatedPagingDelivery the UE 5402 performs the Paging message reception procedure as specified in 5.3.2.3 of [TS38331]. If the RRCReconfiguration message includes the sl-ConfigDedicatedEUTRA-Info, the UE 5402 performs related procedures for V2X sidelink communication in accordance with [TS36331], clauses 5.3.10 and 5.5.2. If the RRCReconfiguration message includes the ul-GapFR2-Config, the UE 5402 performs the FR2 UL gap configuration procedure as specified in 5.3.5.13c of [TS38331]. If the RRCReconfiguration message includes the musim-GapConfig, the UE 5402 performs the MUSIM gap configuration procedure as specified in 5.3.5.9a of [TS38331]. If the RRCReconfiguration message includes the appLayerMeasConfig, the UE 5402 performs the application layer measurement configuration procedure as specified in 5.3.5.13d of [TS38331]. If the RRCReconfiguration message includes the ue-TxTEG-RequestUL-TDOA-Config, if ue-TxTEG-RequestUL-TDOA-Config is set to setup, the UE 5402 performs the UE positioning assistance information procedure as specified in 5.7.14 of [TS38331]; else, the UE 5402 releases the configuration of UE positioning assistance information.

If the RRCReconfiguration message includes the ltm-Config, the UE 5402 performs the LTM configuration procedure as specified in section 8.2.6 herein and/or 5.3.5.x of [TS38331].

If the RRCReconfiguration includes the scpac-Release, the UE 5402 removes all the entries associated with SCPAC candidates within the MCG and the SCG VarConditionalReconfig, if any; removes the entry associated with reference configuration within the MCG and the SCG VarConditionalReconfig, if any; removes all the entries within the VarConditionalReconfig-Complete, if any; for each measId of the MCG measConfig and for each measId of the SCG measConfig, if configured, if the associated reportConfig has a reportType set to condTriggerConfig and the measId is associated to SCPAC candidate execution condition: for the associated reportConfigId, the UE 5402 removes the entry with the matching reportConfigId from the reportConfigList within the VarMeasConfig; if the associated measObjectId is only associated to a reportConfig with reportType set to condTriggerConfig, the UE 5402 removes the entry with the matching measObjectId from the measObjectList within the VarMeasConfig; and the UE 5402 removes the entry with the matching measId from the measIdList within the VarMeasConfig.

Additionally, the UE 5402 sets the content of the RRCReconfigurationComplete message as follows: If the RRCReconfiguration includes the masterCellGroup containing the reportUplinkTxDirectCurrent, the UE 5402 includes the uplinkTxDirectCurrentList for each MCG serving cell with UL, and includes uplinkDirectCurrentBWP-SUL for each MCG serving cell configured with SUL carrier, if any, within the uplinkTxDirectCurrentList. If the RRCReconfiguration includes the masterCellGroup containing the report UplinkTxDirectCurrentTwoCarrier, the UE 5402 includes in the uplinkTxDirectCurrentTwoCarrierList the list of uplink Tx DC locations for the configured intra-band uplink carrier aggregation in the MCG. If the RRCReconfiguration includes the masterCellGroup containing the report UplinkTxDirectCurrentMoreCarrier, the UE 5402 includes in the uplinkTxDirectCurrentMoreCarrierList the list of uplink Tx DC locations for the configured intra-band uplink carrier aggregation in the MCG. If the RRCReconfiguration includes the secondaryCellGroup containing the reportUplinkTxDirectCurrent, the UE 5402 includes the uplinkTxDirectCurrentList for each SCG serving cell with UL, and includes uplinkDirectCurrentBWP-SUL for each SCG serving cell configured with SUL carrier, if any, within the uplinkTxDirectCurrentList. If the RRCReconfiguration includes the secondaryCellGroup containing the report UplinkTxDirectCurrentTwoCarrier, the UE 5402 includes in the uplinkTxDirectCurrentTwoCarrierList the list of uplink Tx DC locations for the configured intra-band uplink carrier aggregation in the SCG. If the RRCReconfiguration includes the secondaryCellGroup containing the report UplinkTxDirectCurrentMoreCarrier, the UE 5402 includes in the uplinkTxDirectCurrentMoreCarrierList the list of uplink Tx DC locations for the configured intra-band uplink carrier aggregation in the SCG. The UE 5402 does not expect that the report UplinkTxDirectCurrentTwoCarrier or reportUplinkTxDirectCurrentMoreCarrier is received in both masterCellGroup and in secondaryCellGroup. Network only configures at most one of report UplinkTxDirectCurrent, report UplinkTxDirectCurrentTwoCarrier or report UplinkTxDirectCurrentMoreCarrier in one RRC message. If the RRCReconfiguration message includes the mrdc-SecondaryCellGroupConfig with mrdc-SecondaryCellGroup set to eutra-SCG, the UE 5402 includes in the eutra-SCG-Response the E-UTRA RRCConnectionReconfigurationComplete message in accordance with [TS36331] clause 5.3.5.3 of [TS38331].

If the RRCReconfiguration message includes the mrdc-SecondaryCellGroupConfig with mrdc-SecondaryCellGroup set to nr-SCG, the UE 5402 includes in the nr-SCG-Response the SCG RRCReconfigurationComplete message; if the RRCReconfiguration message is applied due to conditional reconfiguration execution and the RRCReconfiguration message does not include the reconfigurationWithSync in the masterCellGroup, the UE 5402 includes in the selectedCondRRCReconfig the condReconfigId for the selected cell of conditional reconfiguration execution. If the RRCReconfiguration includes the reconfigurationWithSync in spCellConfig of an MCG, if the UE has logged measurements available for NR and if the RPLMN is included in plmn-IdentityList stored in VarLogMeasReport, the UE 5402 includes the logMeasAvailable in the RRCReconfigurationComplete message; if Bluetooth measurement results are included in the logged measurements the UE has available for NR, the UE 5402 includes the logMeasAvailableBT in the RRCReconfigurationComplete message; if WLAN measurement results are included in the logged measurements the UE has available for NR, the UE 5402 includes the logMeasAvailableWLAN in the RRCReconfigurationComplete message; if the sigLoggedMeasType in VarLogMeasReport is included, if T330 timer is running and the logged measurements configuration is for NR, the UE 5402 sets sigLogMeasConfigAvailable to true in the RRCReconfigurationComplete message; else, if the UE 5402 has logged measurements available for NR, the UE 5402 sets sigLogMeasConfigAvailable to false in the RRCReconfigurationComplete message; if the UE 5402 has connection establishment failure or connection resume failure information available in VarConnEstFailReport or VarConnEstFailReportList and if the RPLMN is equal to plmn-Identity stored in VarConnEstFailReport or in at least one of the entries of VarConnEstFailReportList, the UE 5402 includes connEstFailInfoAvailable in the RRCReconfigurationComplete message; if the UE 5402 has radio link failure or handover failure information available in VarRLF-Report and if the RPLMN is included in plmn-IdentityList stored in VarRLF-Report; or if the UE 5402 has radio link failure or handover failure information available in VarRLF-Report of [TS36331] and if the UE is capable of cross-RAT RLF reporting and if the RPLMN is included in plmn-IdentityList stored in VarRLF-Report of [TS36331], the UE 5402 includes rlf-InfoAvailable in the RRCReconfigurationComplete message; if the UE 5402 was configured with successHO-Config when connected to the source Pcell; and if the applied RRCReconfiguration is not due to a conditional reconfiguration execution upon cell selection performed while timer T311 was running, as defined in 5.3.7.3 of [TS38331], the UE 5402 performs the actions for the successful handover report determination as specified in clause 5.7.10.6 of [TS38331], upon successfully completing the Random Access procedure triggered for the reconfigurationWithSync in spCellConfig of the MCG; if the UE 5402 has successful handover information available in VarSuccessHO-Report and if the RPLMN is included in plmn-IdentityList stored in VarSuccessHO-Report, the UE 5402 includes successHO-InfoAvailable in the RRCReconfigurationComplete message.

If the RRCReconfiguration message was received via SRB1, but not within mrdc-SecondaryCellGroup or E-UTRA RRCConnectionReconfiguration or E-UTRA RRCConnectionResume: if the UE 5402 is configured to provide the measurement gap requirement information of NR target bands: if the RRCReconfiguration message includes the needForGapsConfigNR; or if the NeedForGapsInfoNR information is changed compared to last time the UE reported this information, the UE 5402 includes the NeedForGapsInfoNR and set the contents as follows: the UE 5402 includes intraFreq-needForGap and set the gap requirement information of intra-frequency measurement for each NR serving cell; if requestedTargetBandFilterNR is configured, for each supported NR band that is also included in requestedTargetBandFilterNR, the UE 5402 includes an entry in interFreq-needForGap and set the gap requirement information for that band; else, the UE 5402 includes an entry in interFreq-needForGap and set the corresponding gap requirement information for each supported NR band.

If the UE 5402 is configured to provide the measurement gap and NCSG requirement information of NR target bands: if the RRCReconfiguration message includes the needForGapNCSG-ConfigNR; or if the needForGapNCSG-InfoNR information is changed compared to last time the UE 5402 reported this information, the UE 5402 includes the NeedForGapNCSG-InfoNR and set the contents as follows, the UE 5402 includes intraFreq-needForNCSG and set the gap and NCSG requirement information of intra-frequency measurement for each NR serving cell; if requestedTargetBandFilterNCSG-NR is configured, for each supported NR band included in requestedTargetBandFilterNCSG-NR, the UE 5402 includes an entry in interFreq-needForNCSG and set the NCSG requirement information for that band; else, the UE 5402 includes an entry for each supported NR band in interFreq-needForNCSG and set the corresponding NCSG requirement information;

If the UE 5402 is configured to provide the measurement gap and NCSG requirement information of E-UTRA target bands: if the RRCReconfiguration message includes the needForGapNCSG-ConfigEUTRA, or if the needForGapNCSG-InfoEUTRA information is changed compared to last time the UE reported this information, the UE 5402 includes the NeedForGapNCSG-InfoEUTRA and set the contents as follows: if requestedTargetBandFilterNCSG-EUTRA is configured, for each supported E-UTRA band included in requestedTargetBandFilterNCSG-EUTRA, include an entry in needForNCSG-EUTRA and set the NCSG requirement information for that band; otherwise, include an entry for each supported E-UTRA band in needForNCSG-EUTRA and set the corresponding NCSG requirement information;

If this procedure is initiated due to the execution of an LTM cell switch, according to one or more of clause 5.3.4.x.5 of [TS38331], clause 5.3.5.x.4 of [TS38331] and/or section 8.2.6.4 herein, and/or clause 5.3.5.x.5 of [TS38331] and/or section 8.2.6.5 herein, the procedure ends.

If the UE 5402 is configured with E-UTRA nr-SecondaryCellGroupConfig (UE in (NG)EN-DC): if the RRCReconfiguration message was received via E-UTRA SRB1 as specified in [TS36331], or if the RRCReconfiguration message was received via E-UTRA RRC message RRCConnectionReconfiguration within MobilityFromNRCommand (handover from NR standalone to (NG)EN-DC), if the RRCReconfiguration is applied due to a conditional reconfiguration execution for CPC which is configured via conditionalReconfiguration contained in nr-SecondaryCellGroupConfig specified in [TS36331], the UE 5402 submits the RRCReconfigurationComplete message via the E-UTRA MCG embedded in E-UTRA RRC message ULInformationTransferMRDC as specified in [TS36331], clause 5.6.2a; else if the RRCReconfiguration message was included in E-UTRA RRCConnectionResume message, the UE 5402 submits the RRCReconfigurationComplete message via E-UTRA embedded in E-UTRA RRC message RRCConnectionResumeComplete as specified in [TS36331], clause 5.3.3.4a; else, the UE 5402 submits the RRCReconfigurationComplete via E-UTRA embedded in E-UTRA RRC message RRCConnectionReconfigurationComplete as specified in [TS36331], clause

If the scg-State is not included in the E-UTRA message (RRCConnectionReconfiguration or RRCConnectionResume) containing the RRCReconfiguration message, the UE 5402 performs SCG activation as specified in 5.3.5.13a of [TS38331]; if reconfigurationWithSync was included in spCellConfig of an SCG, the UE 5402 initiates the Random Access procedure on the PSCell, as specified in [TS38321]; else if the SCG was deactivated before the reception of the E-UTRA RRC message containing the RRCReconfiguration message: if bfd-and-RLM was not configured to true before the reception of the E-UTRA RRCConnectionReconfiguration or RRCConnectionResume message containing the RRCReconfiguration message or if lower layers indicate that a Random Access procedure is needed for SCG activation, the UE 5402 initiates the Random Access procedure on the SpCell, as specified in [TS38321]; else the procedure ends; else the procedure ends; else: the UE 5402 performs SCG deactivation as specified in 5.3.5.13b of [TS38331]; the procedure ends.

If the RRCReconfiguration message was received within nr-SecondaryCellGroupConfig in RRCConnectionReconfiguration message received via SRB3 within DLInformationTransferMRDC, the UE 5402 submits the RRCReconfigurationComplete via E-UTRA embedded in E-UTRA RRC message RRCConnectionReconfigurationComplete as specified in [TS36331], clause 5.3.5.3 and 5.3.5.4; if the scg-State is not included in the RRCConnectionReconfiguration, if reconfigurationWithSync was included in spCellConfig of an SCG, the UE 5402 initiates the Random Access procedure on the SpCell, as specified in [TS38321]; else the procedure ends; else, the UE 5402 performs SCG deactivation as specified in 5.3.5.13b of [TS38331], and the procedure ends. The order the UE 5402 sends the RRCConnectionReconfigurationComplete message and performs the Random Access procedure towards the SCG is left to UE implementation.

Else (RRCReconfiguration was received via SRB3) but not within DLInformationTransferMRDC, the UE 5402 submits the RRCReconfigurationComplete message via SRB3 to lower layers for transmission using the new configuration. In (NG)EN-DC and NR-DC, in the case RRCReconfiguration is received via SRB1 or within DLInformationTransferMRDC via SRB3, the random access is triggered by RRC layer itself as there is not necessarily other UL transmission. In the case RRCReconfiguration is received via SRB3 but not within DLInformationTransferMRDC, the random access is triggered by the MAC layer due to arrival of RRCReconfigurationComplete.

Else if the RRCReconfiguration message was received via SRB1 within the nr-SCG within mrdc-SecondaryCellGroup (UE in NR-DC, mrdc-SecondaryCellGroup was received in RRCReconfiguration or RRCResume via SRB1): if the RRCReconfiguration is applied due to a conditional reconfiguration execution for CPC which is configured via conditionalReconfiguration contained in nr-SCG within mrdc-SecondaryCellGroup, the UE 5402 submits the RRCReconfigurationComplete message via the NR MCG embedded in NR RRC message ULInformationTransferMRDC as specified in clause 5.7.2a.3 of [TS38331].

If the scg-State is not included in the RRCReconfiguration or RRCResume message containing the RRCReconfiguration message, the UE 5402 performs SCG activation as specified in 5.3.5.13a of [TS38331]; if reconfigurationWithSync was included in spCellConfig in nr-SCG, the UE 5402 initiates the Random Access procedure on the PSCell, as specified in [TS38321]; else if the SCG was deactivated before the reception of the NR RRC message containing the RRCReconfiguration message, if bfd-and-RLM was not configured to true before the reception of the RRCReconfiguration or RRCResume message containing the RRCReconfiguration message, or if lower layers indicate that a Random Access procedure is needed for SCG activation, the UE 5402 initiates the Random Access procedure on the PSCell, as specified in [TS38321]; else the procedure ends; else the procedure ends.

Else, the UE 5402 performs SCG deactivation as specified in 5.3.5.13b of [TS38331], and the procedure ends. The order in which the UE 5402 sends the RRCReconfigurationComplete message and performs the Random Access procedure towards the SCG is left to UE implementation.

Else if the RRCReconfiguration message was received via SRB3 (UE in NR-DC), if the RRCReconfiguration message was received within DLInformationTransferMRDC, if the RRCReconfiguration message was received within the nr-SCG within mrdc-SecondaryCellGroup (NR SCG RRC Reconfiguration), if the scg-State is not included in the RRCReconfiguration message containing the RRCReconfiguration message, if reconfigurationWithSync was included in spCellConfig in nr-SCG, the UE 5402 initiates the Random Access procedure on the PSCell, as specified in [TS38321]; else, the procedure ends. Else, the UE 5402 performs SCG deactivation as specified in 5.3.5.13b of [TS38331], and the procedure ends.

Else, if the RRCReconfiguration does not include the mrdc-SecondaryCellGroupConfig, if the RRCReconfiguration includes the scg-State, the UE 5402 performs SCG deactivation as specified in 5.3.5.13b of [TS38331], submits the RRCReconfigurationComplete message via SRB1 to lower layers for transmission using the new configuration; else, the UE 5402 submits the RRCReconfigurationComplete message via SRB3 to lower layers for transmission using the new configuration.

Else (RRCReconfiguration was received via SRB1), if the UE is in NR-DC, and if the RRCReconfiguration does not include the mrdc-SecondaryCellGroupConfig, if the RRCReconfiguration includes the scg-State, the UE 5402 performs SCG deactivation as specified in 5.3.5.13b of [TS38331]; else, the UE 5402 performs SCG activation without SN message as specified in 5.3.5.13b1 of [TS38331].

If the reconfigurationWithSync was included in spCellConfig of an MCG, if ta-Report is configured with value enabled and the UE supports TA reporting, the UE 5402 indicates TA report initiation to lower layers; and the UE 5402 submits the RRCReconfigurationComplete message via SRB1 to lower layers for transmission using the new configuration.

If this is the first RRCReconfiguration message after successful completion of the RRC re-establishment procedure, the UE 5402 resumes SRB2, SRB4, DRBs, multicast MRB, and BH RLC channels for IAB-MT, and Uu Relay RLC channels for L2 U2N Relay UE, that are suspended.

If reconfigurationWithSync was included in spCellConfig of an MCG or SCG and when MAC of an NR cell group successfully completes a Random Access procedure triggered above, or if sl-PathSwitchConfig was included in reconfigurationWithSync included in spCellConfig of an MCG, and when successfully sending RRCReconfigurationComplete message (e.g., PC5 RLC acknowledgement is received from target L2 U2N Relay UE), the UE 5402 stops timer T304 for that cell group if running; if sl-PathSwitchConfig was included in reconfigurationWithSync, the UE 5402 stops timer T420; releases all radio resources, including release of the RLC entities and the MAC configuration at the source side; and resets MAC used in the source cell. PDCP and SDAP configured by the source prior to the path switch that are reconfigured and re-used by target when delta signalling is used, are not released as part of this procedure.

Additionally, the the UE 5402 stops timer T310 for source SpCell if running; applies the parts of the CSI reporting configuration, the scheduling request configuration and the sounding RS configuration that do not require the UE to know the SFN of the respective target SpCell, if any; applies the parts of the measurement and the radio resource configuration that require the UE to know the SFN of the respective target SpCell (e.g., measurement gaps, periodic CQI reporting, scheduling request configuration, sounding RS configuration), if any, upon acquiring the SFN of that target SpCell; for each DRB configured as DAPS bearer, request uplink data switching to the PDCP entity, as specified in [TS38323], if the reconfigurationWithSync was included in spCellConfig of an MCG, if T390 is running, the UE 5402 stops timer T390 for all access categories and performs the actions as specified in 5.3.14.4 of [TS38331]; if T350 is running, the UE 5402 stops timer T350; if RRCReconfiguration does not include dedicatedSIB1-Delivery and if the active downlink BWP, which is indicated by the firstActiveDownlinkBWP-Id for the target SpCell of the MCG, has a common search space configured by searchSpaceSIB1, the UE 5402 acquires the SIB1, which is scheduled as specified in [TS38213], of the target SpCell of the MCG, and upon acquiring SIB1, perform the actions specified in clause 5.2.2.4.2 of [TS38331].

If the reconfigurationWithSync was included in spCellConfig of an MCG, or if the reconfigurationWithSync was included in spCellConfig of an SCG and the CPA or CPC was configured, the UE 5402 removes all the entries within the MCG and the SCG VarConditionalReconfig except for the entries associated with SCPAC candidates, if any, removes all the entries within VarConditionalReconfiguration as specified in [TS36331], clause 5.3.5.9.6, if any, and for each measId of the MCG measConfig, if configured, and for each measId of the SCG measConfig, if configured, if the associated reportConfig has a reportType set to condTriggerConfig and the measId is not associated to SCPAC candidate execution condition,
for the associated reportConfigId, the UE 5402 removes the entry with the matching reportConfigId from the reportConfigList within the VarMeasConfig; if the associated measObjectId is only associated to a reportConfig with reportType set to condTriggerConfig, the UE 5402 removes the entry with the matching measObjectId from the measObjectList within the VarMeasConfig; and the UE 5402 removes the entry with the matching measId from the measIdList within the VarMeasConfig.

If reconfigurationWithSync was included in masterCellGroup or secondaryCellGroup, if the UE 5402 initiated transmission of a UEAssistanceInformation message for the corresponding cell group during the last 1 second, and the UE is still configured to provide the concerned UE assistance information for the corresponding cell group, or if the RRCReconfiguration message is applied due to a conditional reconfiguration execution, and the UE is configured to provide UE assistance information for the corresponding cell group, and the UE has initiated transmission of a UEAssistanceInformation message for the corresponding cell group since it was configured to do so in accordance with 5.7.4.2 of [TS38331], the UE 5402 initiates transmission of a UEAssistanceInformation message for the corresponding cell group in accordance with clause of [TS38331] to provide the concerned UE assistance information, and the UE 5402 starts or restarts the prohibit timer (if exists) or the leave without response timer for the MUSIM associated with the concerned UE assistance information with the timer value set to the value in corresponding configuration; if SIB12 is provided by the target Pcell, and the UE initiated transmission of a SidelinkUEInformationNR message indicating a change of NR sidelink communication/discovery related parameters relevant in target Pcell (e.g., change of sl-RxInterestedFreqList or sl-TxResourceReqList) during the last 1 second preceding reception of the RRCReconfiguration message including reconfigurationWithSync in spCellConfig of an MCG, or if the RRCReconfiguration message is applied due to a conditional reconfiguration execution and the UE is capable of NR sidelink communication/discovery and SIB12 is provided by the target Pcell, and the UE has initiated transmission of a SidelinkUEInformationNR message since it was configured to do so in accordance with 5.8.3.2 of [TS38331], the UE 5402 initiates transmission of the SidelinkUEInformationNR message in accordance with 5.8.3.3 of [TS38331].

If reconfigurationWithSync was included in masterCellGroup, if configured with application layer measurements and if application layer measurement report container has been received from upper layers for which the successful transmission of the message or at least one segment of the message has not been confirmed by lower layers, the UE 5402 re-submits the MeasurementReportAppLayer message or all segments of the MeasurementReportAppLayer message to lower layers for transmission via SRB4.

If reconfigurationWithSync was included in masterCellGroup and the target cell provides SIB21, if the UE initiated transmission of an MBSInterestIndication message during the last 1 second preceding reception of this RRCReconfiguration message, or if the RRCReconfiguration message is applied due to a conditional reconfiguration execution, and the UE has initiated transmission of an MBSInterestIndication message after having received this RRCReconfiguration message, the UE 5402 initiates transmission of an MBSInterestIndication message in accordance with clause 5.9.4; and the procedure ends.

In some examples, the UE 5402 is only required to acquire broadcasted SIB1 if the UE can acquire it without disrupting unicast or MBS multicast data reception, e.g. the broadcast and unicast/MBS multicast beams are quasi co-located. Additionally or alternatively, the UE 5402 sets the content of UEAssistanceInformation according to latest configuration (e.g., the configuration after applying the RRCReconfiguration message) and latest UE preference. The UE may include more than the concerned UE assistance information within the UEAssistanceInformation according to 5.7.4.2 of [TS38331]. Therefore, the content of UEAssistanceInformation message might not be the same as the content of the previous UEAssistanceInformation message.

8.2.4. Cell Group Configuration

8.2.4.1. General

The network configures the UE 5402 with Master Cell Group (MCG), and zero or more Secondary Cell Groups (SCGs). In (NG)EN-DC, the MCG is configured as specified in [TS36331], and for NE-DC, the SCG is configured as specified in [TS36331] or [TS38331]. The network provides the configuration parameters for a cell group in the CellGroupConfig IE. The UE performs the following actions based on a received CellGroupConfig IE:

If the CellGroupConfig contains the spCellConfig with reconfigurationWithSync, the UE 5402 performs reconfiguration with sync according to 5.3.5.5.2 of [TS38331], and resumes all suspended radio bearers except the SRBs for the source cell group, and resume SCG transmission for all radio bearers, and resume BH RLC channels and resume SCG transmission for BH RLC channels for IAB-MT, if suspended. If the SCG is deactivated, resuming SCG transmission for all radio bearers does not imply that PDCP PDUs can be transmitted or received on SCG RLC bearers.

If the CellGroupConfig contains the rlc-BearerToReleaseList or rlc-BearerToReleaseListExt, the UE 5402 performs RLC bearer release as specified in 5.3.5.5.3 of [TS38331]. If the CellGroupConfig contains the rlc-BearerToAddModList, the UE 5402 performs the RLC bearer addition/modification as specified in 5.3.5.5.4 of [TS38331]. If the CellGroupConfig contains the mac-CellGroupConfig, the UE 5402 configures the MAC entity of this cell group as specified in 5.3.5.5.5 of [TS38331]. If the CellGroupConfig contains the sCellToReleaseList, the UE 5402 performs SCell release as specified in 5.3.5.5.8 of [TS38331]. If the CellGroupConfig contains the spCellConfig, the UE 5402 configures the SpCell as specified in 5.3.5.5.7 of [TS38331]. If the CellGroupConfig contains the sCellToAddModList, the UE 5402 performs SCell addition/modification as specified in 5.3.5.5.9 of [TS38331]. If the CellGroupConfig contains the bh-RLC-ChannelToReleaseList, the UE 5402 performs BH RLC channel release as specified in 5.3.5.5.10 of [TS38331]. If the CellGroupConfig contains the bh-RLC-ChannelToAddModList, the UE 5402 performs the BH RLC channel addition/modification as specified in 5.3.5.5.11 of [TS38331]. If the CellGroupConfig contains the uu-RelayRLC-ChannelToReleaseList, the UE 5402 performs Uu Relay RLC channel release as specified in of [TS38331]. If the CellGroupConfig contains the uu-RelayRLC-ChannelToAddModList, the UE 5402 performs the Uu Relay RLC channel addition/modification as specified in 5.3.5.5.13 of [TS38331].

If this procedure is initiated due to an LTM cell switch procedure, and if CellGroupConfig contains the ltm-CellSwitchInfo, the UE 5402 applies as the C-RNTI for this cell group the value included in newUE-Identity within the field ltm-CellSwitchInfo of the LTM candidate cell configuration indicated by lower layers, configures lower layers in accordance with the received spCellConfigCommon within the field ltm-CellSwitchInfo of the LTM candidate cell configuration indicated by lower layers, and configures lower layers in accordance with the received rach-ConfigDedicated within the field ltm-CellSwitchInfo of the LTM candidate cell configuration indicated by lower layers.

8.2.4.2. MAC Entity Configuration

If SCG MAC is not part of the current UE configuration (e.g., SCG establishment), the UE 5402 creates an SCG MAC entity. If any DAPS bearer is configured, the UE 5402 reconfigures the MAC main configuration for the target cell group in accordance with the received mac-CellGroupConfig excluding tag-ToReleaseList and tag-ToAddModList. Else, the UE 5402 reconfigures the MAC main configuration of the cell group in accordance with the received mac-CellGroupConfig excluding tag-ToReleaseList and tag-ToAddModList.

If the received mac-CellGroupConfig includes the tag-ToReleaseList, for each TAG-Id value included in the tag-ToReleaseList that is part of the current UE configuration, the UE 5402 releases the TAG indicated by TAG-Id.

If the received mac-CellGroupConfig includes the tag-ToAddModList, for each tag-Id value included in tag-ToAddModList that is not part of the current UE configuration (TAG addition), the UE 5402 adds the TAG, corresponding to the tag-Id, in accordance with the received timeAlignmentTimer; and for each tag-Id value included in tag-ToAddModList that is part of the current UE configuration (TAG modification), the UE 5402 reconfigures the TAG, corresponding to the tag-Id, in accordance with the received timeAlignmentTimer.

8.2.4.3. S Cell Release

If the release is triggered by reception of the sCellToReleaseList, for each sCellIndex value included in the sCellToReleaseList, if the current UE configuration includes an SCell with value sCellIndex, the UEs 5402 releases the SCell. It is FFS on whether the release of an SCell by an LTM candidate cell configuration is a valid case.

8.2.4.4. Inability to Comply with RRCReconfiguration

The UE behavior specified in this clause does not apply to the following, and the UE ignores, for example, does not take an action on and does not store, the fields that it does not support or does not comprehend the fields in ServingCellConfigCommon that are defined in Rel-16 and later and/or the fields of searchSpaceMCCH and searchSpaceMTCH in PDCCH-ConfigCommon that are defined in Rel-17 and later.

If the UE 5402 is in (NG)EN-DC, if the UE 5402 is unable to comply with (part of) the configuration included in the RRCReconfiguration message received over SRB3; if the RRCReconfiguration message was received as part of ConditionalReconfiguration, the UE 5402 continues using the configuration used prior to when the inability to comply with the RRCReconfiguration message was detected; else, the UE 5402 continues using the configuration used prior to the reception of RRCReconfiguration message; if MCG transmission is not suspended, the UE 5402 initiates the SCG failure information procedure as specified in clause to report SCG reconfiguration error, upon which the connection reconfiguration procedure ends; else, the UE 5402 initiates the connection re-establishment procedure as specified in [TS36331], clause 5.3.7, upon which the connection reconfiguration procedure ends; else, if the UE 5402 is unable to comply with (part of) the configuration included in the RRCReconfiguration message received over SRB1, if the RRCReconfiguration message was received as part of ConditionalReconfiguration, the UE 5402 continues using the configuration used prior to when the inability to comply with the RRCReconfiguration message was detected; else, the UE 5402 continues using the configuration used prior to the reception of RRCReconfiguration message; and the UE 5402 initiates the connection re-establishment procedure as specified in [TS36331], clause 5.3.7, upon which the connection reconfiguration procedure ends.

Else if RRCReconfiguration is received via NR (e.g., NR standalone, NE-DC, or NR-DC), if the UE 5402 is unable to comply with (part of) the configuration included in the RRCReconfiguration message received over SRB3 (in some examples, this case does not apply in NE-DC); if the RRCReconfiguration message was received as part of ConditionalReconfiguration, the UE 5402 continues using the configuration used prior to when the inability to comply with the RRCReconfiguration message was detected; else, the UE 5402 continues using the configuration used prior to the reception of RRCReconfiguration message; if MCG transmission is not suspended, the UE 5402 initiates the SCG failure information procedure as specified in clause of [TS38331] to report SCG reconfiguration error, upon which the connection reconfiguration procedure ends; else, the UE 5402 initiates the connection re-establishment procedure as specified in clause 5.3.7, upon which the connection reconfiguration procedure ends; else if the UE 5402 is unable to comply with (part of) the configuration included in the RRCReconfiguration message received over the SRB1 or if the upper layers indicate that the nas-Container is invalid. In some examples, the compliance also covers the SCG configuration carried within octet strings e.g. field mrdc-SecondaryCellGroupConfig. E.g. the failure behaviour defined also applies in case the UE cannot comply with the embedded SCG configuration or with the combination of (parts of) the MCG and SCG configurations. In some examples, compliance also covers the V2X sidelink configuration carried within an octet string, e.g. field sl-ConfigDedicatedEUTRA. E.g. the failure behaviour defined also applies in case the UE cannot comply with the embedded V2X sidelink configuration.

If the RRCReconfiguration message was received as part of ConditionalReconfiguration, the UE 5402 continues using the configuration used prior to when the inability to comply with the RRCReconfiguration message was detected; else, the UE 5402 continues using the configuration used prior to the reception of RRCReconfiguration message; if AS security has not been activated, the UE 5402 performs the actions upon going to RRC_IDLE as specified in 5.3.11, with release cause ‘other’; else if AS security has been activated but SRB2 and at least one DRB or multicast MRB or, for IAB, SRB2, have not been setup, the UE 5402 performs the actions upon going to RRC_IDLE as specified in 5.3.11 of [TS38331], with release cause ‘RRC connection failure’; else, the UE 5402 initiates the connection re-establishment procedure as specified in 5.3.7 of [TS38331], upon which the reconfiguration procedure ends.

Else if RRCReconfiguration is received via other RAT (Handover to NR failure), if the UE 5402 is unable to comply with any part of the configuration included in the RRCReconfiguration message or if the upper layers indicate that the nas-Container is invalid, the UE 5402 performs the actions defined for this failure case as defined in the specifications applicable for the other RAT. The UE 5402 may apply above failure handling also in case the RRCReconfiguration message causes a protocol error for which the generic error handling as defined in clause 10 specifies that the UE shall ignore the message. If the UE 5402 is unable to comply with part of the configuration, it does not apply any part of the configuration (e.g., there is no partial success/failure). In some examples, it is up to UE implementation whether the compliance check for an RRCReconfiguration received as part of ConditionalReconfiguration is performed upon the reception of the message or upon CHO, CPA and CPC execution (when the message is required to be applied). Additionally or alternatively, it is up to UE implementation whether the compliance check for an RRCReconfiguration message received as part of an LTM-Config IE is performed upon the reception of the message of upon an LTM cell switch procedure (when the message is required to be applied). It is FFS is further actions are needed from the UE 5402 when a reconfiguration failure is detected because of an early compliance check of an LTM candidate.

8.2.4.5. T3xx Expiry (LTM Cell Switch Failure)

If T3xx of MCG expires, the UE 5402 releases dedicated preambles provided in rach-ConfigDedicated if configured; releases dedicated msgA PUSCH resources provided in rach-ConfigDedicated if configured; reverts back to the UE configuration used in the source PCell; and initiates the connection re-establishment procedure as specified in clause 5.3.7 of [TS38331]; else if T3xx of SCG expires, if MCG transmission is not suspended, the UE 5402 releases dedicated preambles provided in rach-ConfigDedicated, if configured, releases dedicated msgA PUSCH resources provided in rach-ConfigDedicated, if configured, and initiates the SCG failure information procedure as specified in clause 5.7.3 to report SCG LTM cell switch failure, upon which the RRC reconfiguration procedure ends; else, the UE 5402 initiates the connection re-establishment procedure as specified in clause 5.3.7 of [TS38331].

8.2.5. Conditional Reconfiguration

8.2.5.1. General

The network configures the UE 5402 with one or more candidate target SpCells in the conditional reconfiguration. The UE 5402 evaluates the condition of each configured candidate target SpCell. The UE 5402 applies the conditional reconfiguration associated with one of the target SpCells which fulfils associated execution condition. The network provides the configuration parameters for the target SpCell in the ConditionalReconfiguration IE.

In NR-DC, the UE 5402 may receive two independent conditionalReconfiguration, including a conditionalReconfiguration associated with MCG, that is included in the RRCReconfiguration message received via SRB1; and a conditionalReconfiguration, associated with SCG, that is included in the RRCReconfiguration message received via SRB3, or, alternatively, included within a RRCReconfiguration message embedded in a RRCReconfiguration message received via SRB1. In this case, the UE 5402 maintains two independent VarConditionalReconfig, one associated with each conditionalReconfiguration; the UE 5402 independently performs all the procedures in section 8.2.5 herein and/or clause 5.3.5.13 of [TS38331] for each conditionalReconfiguration and the associated VarConditionalReconfig, unless explicitly stated otherwise; and/or the UE 5402 performs the procedures in clause 5.5 of [TS38331] for the VarConditionalReconfig associated with the same cell group like the measConfig. In EN-DC, the VarConditionalReconfig is associated with the SCG. In NE-DC and when no SCG is configured, the VarConditionalReconfig is associated with the MCG.

The UE 5402 performs the following actions based on a received ConditionalReconfiguration IE: if the ConditionalReconfiguration contains the condReconfigToRemoveList, the UE 5402 performs conditional reconfiguration removal procedure as specified in section 8.2.5.2 herein and/or 5.3.5.13.2 of [TS38331]; if the ConditionalReconfiguration contains the condReconfigToAddModList, the UE 5402 performs conditional reconfiguration addition/modification as specified in section 8.2.5.3 herein and/or of [TS38331]; if the ConditionalReconfiguration contains the scpac-Reference Configuration, the UE 5402 performs reference configuration addition/modification as specified in section 8.2.5.7 herein and/or 5.3.5.13.xl of [TS38331]; the UE 5402 performs the actions to generate a complete conditional configuration as specified in section 8.2.5.8 herein and/or 5.3.5.13.x2 of [TS38331]. In some examples, it is up to UE implementation to perform compliance check upon reception of the SCPAC configuration or upon CPA/CPC execution.

8.2.5.2. Conditional Reconfiguration Removal

For each condReconfigId value included in the condReconfigToRemoveList that is part of the current UE conditional reconfiguration in VarConditionalReconfig, the UE 5402 removes the entry with the matching condReconfigId from the VarConditionalReconfig.

For each condReconfigId value included in the condReconfigToRemoveList is part of the current UE conditional reconfiguration in VarConditionalReconfig-Complete, the UE 5402 removes the entry with the matching condReconfigId from the VarConditionalReconfig-Complete.

In some examples, the UE 5402 does not consider the message as erroneous if the condReconfigToRemoveList includes any condReconfigId value that is not part of the current UE configuration.

8.2.5.3. Conditional Reconfiguration Addition/Modification

For each condReconfigId received in the condReconfigToAddModList IE the UE 5402 performs the following actions: if an entry with the matching condReconfigId exists in the condReconfigToAddModList within the VarConditionalReconfig, if the entry in condReconfigToAddModList includes an condExecutionCond or condExecutionCondSCG, the UE 5402 replaces condExecutionCond or condExecutionCondSCG within the VarConditionalReconfig with the value received for this condReconfigId; if the entry in condReconfigToAddModList includes an condRRCReconfig, the UE 5402 replaces condRRCReconfig within the VarConditionalReconfig with the value received for this condReconfigId; else, the UE 5402 adds a new entry for this condReconfigId within the VarConditionalReconfig; and the UE 5402 performs conditional reconfiguration evaluation as specified in section 8.2.5.4 herein and/or clause 5.3.5.13.4 of [TS38331].

8.2.5.4. Conditional Reconfiguration Evaluation

The UE 5402 performs the following actions for each condReconfigId within the VarConditionalReconfig:
If the RRCReconfiguration within condRRCReconfig includes the masterCellGroup including the reconfigurationWithSync, the UE 5402 considers the cell which has a physical cell identity matching the value indicated in the ServingCellConfigCommon included in the reconfigurationWithSync within the masterCellGroup in the received condRRCReconfig to be applicable cell;
Else if the RRCReconfiguration within condRRCReconfig includes the secondaryCellGroup including the reconfigurationWithSync, the UE 5402 considers the cell which has a physical cell identity matching the value indicated in the ServingCellConfigCommon included in the reconfigurationWithSync within the secondaryCellGroup within the received condRRCReconfig and the physical cell identity does not match the value of the serving cell to be applicable cell;
If condExecutionCondSCG is configured, in the remainder of the procedure, the UE 5402 considers each measId indicated in the condExecutionCondSCG as a measId in the VarMeasConfig associated with the SCG measConfig;
If condExecutionCond is configured, if it is configured via SRB3 or configured within nr-SCG or within nr-SecondaryCellGroupConfig (specified in [TS36331]) via SRB1, in the remainder of the procedure, the UE 5402 considers each measId indicated in the condExecutionCond as a measId in the VarMeasConfig associated with the SCG measConfig; else, in the remainder of the procedure, the UE 5402 considers each measId indicated in the condExecutionCond as a measId in the VarMeasConfig associated with the MCG measConfig;
For each measId included in the measIdList within VarMeasConfig indicated in the condExecutionCond or condExecutionCondSCG associated to condReconfigId:
The UE 5402 considers the event associated to that measId to be fulfilled if the condEventId is associated with condEventT1, and if the entry condition applicable for this event associated with the condReconfigId (e.g., the event corresponding with the condEventId(s) of the corresponding condTriggerConfig within VarConditionalReconfig, is fulfilled for the applicable cell); and/or if the condEventId is associated with condEventD1, and if the entry conditions applicable for this event associated with the condReconfigId (e.g., the event corresponding with the condEventId(s) of the corresponding condTriggerConfig within VarConditionalReconfig) is fulfilled for the applicable cell during the corresponding timeToTrigger defined for this event within the VarConditionalReconfig; and/or if the condEventId is associated with condEventA3, condEventA4 or condEventA5, and if the entry condition(s) applicable for this event associated with the condReconfigId (e.g., the event corresponding with the condEventId(s) of the corresponding condTriggerConfig within VarConditionalReconfig) is fulfilled for the applicable cells for all measurements after layer 3 filtering taken during the corresponding timeToTrigger defined for this event within the VarConditionalReconfig;
The UE 5402 considers the event associated to that measId to be not fulfilled if the measId for this event associated with the condReconfigId has been modified; and/or if the condEventId is associated with condEventT1, and if the leaving condition applicable for this event associated with the condReconfigId (e.g., the event corresponding with the condEventId(s) of the corresponding condTriggerConfig within VarConditionalReconfig, is fulfilled for the applicable cell; and/or if the condEventId is associated with condEventD1, and if the leaving condition(s) applicable for this event associated with the condReconfigId (e.g., the event corresponding with the condEventId(s) of the corresponding condTriggerConfig within VarConditionalReconfig, is fulfilled for the applicable cell during the corresponding timeToTrigger defined for this event within the VarConditionalReconfig; and/or if the condEventId is associated with condEventA3, condEventA4 or condEventA5, and if the leaving condition(s) applicable for this event associated with the condReconfigId (e.g., the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig.
If event(s) associated to all measId(s) within condTriggerConfig for a target candidate cell within the stored condRRCReconfig are fulfilled, the UE 5402 considers the target candidate cell within the stored condRRCReconfig, associated to that condReconfigId, as a triggered cell, and initiates the conditional reconfiguration execution, as specified in section 8.2.5.6 herein and/or clause 5.3.5.13.5 of [TS38331].

In some examples, it is FFS on when to start condition evaluation for subsequent CPC. Additionally or alternatively, for MN-initiated case, if candidate SN provide the execution conditions for subsequent CPC procedure, FFS on whether and how to release the execution condition for initial CPC/CPA after initial CPA/CPC execution completion. Additionally or alternatively, up to two MeasId can be configured for each condReconfigId. In some examples, the conditional reconfiguration event of the two MeasId may have the same or different event conditions, triggering quantity, time to trigger, and triggering threshold.

8.2.5.5. Conditional Reconfiguration Evaluation of SN Initiated Inter-SN CPC for EN-DC

The UE 5402 performs the following actions for each condReconfigurationId within the VarConditionalReconfiguration specified in [TS36331]:
For each measId included in the measIdList within VarMeasConfig indicated in the CondReconfigExecCondSCG contained in the triggerConditionSN associated to the condReconfigurationId as specified in [TS36331], if the entry condition(s) applicable for the event associated with that measId, is fulfilled for the applicable cells for all measurements after layer 3 filtering taken during the corresponding timeToTrigger defined for this event associated with that measId, the UE 5402 considers this event to be fulfilled. If the measId for this event has been modified, and/or if the leaving condition(s) applicable for this event associated with that measId, is fulfilled for the applicable cells for all measurements after layer 3 filtering taken during the corresponding timeToTrigger defined for this event associated with that measId, the UE 5402 considers this event associated to that measId to be not fulfilled.

If trigger conditions for all events associated with the measId(s) indicated in the CondReconfigExecCondSCG contained in the triggerConditionSN as specified in [TS36331]), are fulfilled, the UE 5402 considers the target cell candidate within the RRCReconfiguration message contained in nr-SecondaryCellGroupConfig in the RRCConnectionReconfiguration message, as specified in [TS36331], contained in the stored condReconfigurationToApply, associated to that condReconfigurationId as specified in [TS36331]clause 5.3.5.9.4, as a triggered cell, the UE 5402 initiates the conditional reconfiguration execution, as specified in [TS36331]clause 5.3.5.9.5.

8.2.5.6. 5.3.5.13.5 Conditional Reconfiguration Execution

If more than one triggered cell exists, the UE 5402 selects one of the triggered cells as the selected cell for conditional reconfiguration execution; else, the UE 5402 considers the triggered cell as the selected cell for conditional reconfiguration execution. For the selected cell of conditional reconfiguration execution, the UE 5402 applies the stored condRRCReconfig of the selected cell and perform the actions as specified in 5.3.5.3 of [TS38331].

In some examples, it is FFS on whether to rely on the full configuration procedure as specified in 5.3.5.11 of [TS38331] or new complete configuration procedure when the UE applies a complete configuration. In some examples, it is FFS on UE behaviour to avoid redundant full configuration procedure or complete configuration procedure and full configuration procedure if the RRCreconfiguration of a candidate cell includes the Fullconfig flag. In some examples, if multiple NR cells are triggered in conditional reconfiguration execution, it is up to UE implementation which one to select (e.g., the UE considers beams and beam quality to select one of the triggered cells for execution).

8.2.5.7. Reference Configuration Addition/Modification

If scpac-Reference Configuration exists within the VarConditionalReconfig, the UE 5402 replaces the scpac-ReferenceConfiguration within the VarConditionalReconfig; else, the UE 5402 stores the scpac-Reference Configuration within the VarConditionalReconfig.

In some examples, it is FFS on whether to support reference configuration update based on delta config. 1n some examples, it is FFS on how to release reference configuration, e.g. based on NW explicit indication or UE autonomous release.

8.2.5.8. Complete Conditional Reconfiguration Generation

The purpose of this procedure is for the UE 5402 to generate a complete conditional configuration to be stored and applied for conditional reconfiguration execution. During the generation of a complete conditional reconfiguration, the current UE configuration shall not be modified. The UE 5402 performs the following actions for each condReconfig in condReconfigList within VarConditionalReconfig:

If an entry with the matching condReconfigId exists in the condReconfigCompleteList within the VarConditionalReconfig-Complete, if the RRCReconfiguraiton within condReconfig includes fullConfig, the UE 5402 replaces condReconfig-Complete within the VarConditionalReconfig-Complete with the value received for this condReconfigId; else, the UE 5402 generates a complete conditional configuration by applying condReconfig on top of scpac-ReferenceConfiguration and replace condReconfig-Complete within the VarConditionalReconfig-Complete with the complete conditional configuration;

Else, the UE 5402 stores the condReconfigId included in condReconfig within VarConditionalReconfig; stores fullConfig in condReconfig-Complete within VarConditionalReconfig-Complete if the RRCReconfiguraiton within condReconfig includes fullConfig; and generates a complete conditional configuration by applying condReconfig on top of scpac-ReferenceConfiguration and stores it in condReconfig-Complete within VarConditionalReconfig-Complete.

In some examples, it is FFS on whether to specify the details on generation of the complete configuration. In some examples, the UE 5402 will not perform RRC reconfiguration procedure as specified in 5.3.5 of [TS38331]during and upon generation of the complete configuration for SCPAC candidate until conditional reconfiguration execution.

8.2.6. LTM Configuration and Execution

8.2.6.1. General

The network configures the UE 5402 with one or more LTM candidate cell configurations within the LTM-Config IE.

In NR-DC, the UE 5402 may receive two independent ltm-Config, including: an ltm-Config associated with the MCG that is included within an RRCReconfiguration message received via SIB1; and/or an ltm-Config associated with the SCG that is included within an RRCReconfiguration message either received via SRB3, or, alternatively, embedded in a RRCReconfiguration message received via SRB1. In some examples, it is FFS how the UE receives the LTM MCG and the LTM SCG configurations and how to handle the SCG if LTM MCG is executed.

In this case: the UE 5402 maintains two independent VarLTM-Config, one associated with each ltm-Config; the UE 5402 maintains two independent VarLTM-UE-Config, one associated with each ltm-Config; and/or the UE 5402 independently performs all the procedures in section 8.2.6 herein and/or clause 5.3.5.x of [TS38331] for each ltm-Config and the associated VarLTM-Config and VarLTM-UE-Config, unless explicitly stated otherwise.

The UE 5402 performs the following actions based on the received LTM-Config IE:

If ltm-ReferenceConfiguration is present within VarLTM-Config, the UE 5402 replaces ltm-ReferenceConfiguration within VarLTM-Config with the received ltm-ReferenceConfiguration within the LTM-Config IE; and for each ltm-CandidateId in VarLTM-Config, the UE 5402 performs the actions to generate a complete LTM configuration as specified in section 8.2.6.4 herein and/or in clause 5.3.5.x.4 of [TS38331]; else, the UE 5402 stores the received ltm-ReferenceConfiguration in VarLTM-Config, if present.

If the LTM-Config includes the ltm-ServingCellNoResetID, the UE 5402 considers the received ltm-ServingCellNoResetID as the ltm-ServingCellNoResetID associated with current serving cell for this cell group.

If the LTM-Config includes the ltm-CandidateNoResetL2-List, the UE 5402 adds the received ltm-CandidateNoResetL2-List to VarLTM-Config.

If the LTM-Config includes the ltm-CandidateToAddModList, the UE 5402 performs the LTM candidate cell addition or reconfiguration as specified in section 8.2.6.3 herein and/or in clause 5.3.5.x.3 of [TS38311].

8.2.6.2. 5.3.5.x.2 LTM Candidate Cell Release

For each ltm-CandidateId in the ltm-CandidateToReleaseList: if the current VarLTM-Config includes an ltm-Candidate with the given ltm-CandidateId, the UE 5402 removes the entry related to ltm-Candidate from VarLTM-Config; if the current VarLTM-UE-Config includes a UE-LTM-Candidate with the given ltm-CandidateId, the UE 5402 removes the entry related to UE-LTM-Candidate from VarLTM-UE-Config.

8.2.6.3. LTM Candidate Cell Addition/Modification

For each ltm-CandidateId in the ltm-CandidateToAddModList: if the current VarLTM-Config includes an ltm-Candidate with the given ltm-CandidateId, the UE 5402 replaces the ltm-Candidate within VarLTM-Config in accordance with the received ltm-Candidate; else, the UE 5402 adds the received ltm-Candidate to VarLTM-Config; and the UE 5402 performs the actions to generate a complete LTM configuration as specified in section 8.2.6.4 herein and/or in clause 5.3.5.x.4 of [TS38331].

In some examples, it is up to the UE implementation to postpone the generation of a complete LTM configuration as specified in section 8.2.6.4 herein and/or in clause 5.3.5.x.4 of [TS38331] until the executing of an LTM cell switch. In some examples, it is FFS on whether the UE 5402 performs the compliance check of the reference and LTM candidate cell configuration upon their reception of upon the execution of the LTM cell switch. Additionally or alternatively, it is FFS on how and whether to indicate that no RACH is needed for an LTM candidate cell. Additionally or alternatively, it is FFS on how UE should establish the TA for a LTM candidate cell.

8.2.6.4. Generation of Ue Ltm Configuration

The purpose of this procedure is for the UE 5402 to generate a complete LTM candidate cell configuration to be stored and applied only when an indication of an LTM cell switch is received by lower layers. During the generation of a complete LTM candidate cell configuration, the current UE configuration shall not be modified.

If not present, the UE 5402 stores the ltm-CandidateId included in ltm-Candidate within VarLTM-UE-Config.

If ltm-Candidate includes ltm-ConfigComplete, the UE 5402 considers the received ltm-CandidateConfig within ltm-Candidate as a complete LTM candidate cell configuration; if ltm-Candidate is already present within VarLTM-UE-Config, the UE 5402 replaces the received ltm-CandidateConfig with the one already present in ue-LTM-Config within VarLTM-UE-Config; else, the UE 5402 stores the received ltm-CandidateConfig in ue-LTM-Config within VarLTM-UE-Config.

Else, the UE 5402 generates a complete LTM candidate cell configuration by applying ltm-CandidateConfig on top of ltm-referenceConfiguration, according to section 8.2.6.5 herein and/or clause 5.3.5.x.5 of [TS38331]; if ltm-Candidate is already present within VarLTM-UE-Config, the UE 5402 replaces the generated LTM candidate cell configuration with the one already present in ue-LTM-Config within VarLTM-UE-Config; else, the UE 5402 stores the generated LTM candidate cell configuration in ue-LTM-Config within VarLTM-UE-Config.

In some examples, it is FFS on the need of ltm-ConfigComplete to indicate to the UE 5402 that the LTM candidate cell configuration in ltm-Candidate is a complete configuration. Additionally or alternatively, it is FFS on whether we need to rely on the full configuration procedure or a new procedure for LTM is created when the UE 5402 generates a complete LTM candidate cell configuration.

8.2.6.5. Handling of Fields in Ltm Reference Configuration and Ltm Candidate Cell Configuration

Upon the generation of a complete LTM candidate cell configuration by applying an ltm-CandidateConfig on top of an ltm-referenceConfiguration, the UE 5402 performs the following actions:

The UE 5402 considers the configuration in ltm-referenceConfiguration as the complete LTM candidate cell configuration.

For each Need N field present in ltm-CandidateConfig that releases an element on a list (e.g., elementsToReleaseList according to [TS38331] § A.3.9), the UE 5402 deletes the corresponding element from the complete LTM candidate cell configuration, if present.

For each Need N field present in ltm-CandidateConfig that add or modify an element on a list (e.g., elementsToAddModList according to A.3.9): if the corresponding element is already present in the complete LTM candidate cell configuration, the UE 5402 modifies the corresponding element in the complete LTM candidate cell configuration with the one received in ltm-CandidateConfig; else, the UE 5402 adds the corresponding element in the complete LTM candidate cell configuration according to the one in ltm-CandidateConfig.

For each Need N field present in ltm-CandidateConfig (e.g., that do not release, add, or modify an element of a list): if the field is present in the complete LTM candidate cell configuration, the UE 5402 modifies the corresponding Need N field in the complete LTM candidate cell configuration with the one received in ltm-CandidateConfig; else, the UE 5402 adds the Need N field received in ltm-CandidateConfig in the complete LTM candidate cell configuration.

For each Need R field present in ltm-CandidateConfig: if the field is present in the complete LTM candidate cell configuration, the UE 5402 modifies the corresponding Need R field in the complete LTM candidate cell configuration with the one received in ltm-CandidateConfig; else, the UE 5402 adds the Need R field received in ltm-CandidateConfig in the complete LTM candidate cell configuration.

For each Need N field that is present in the LTM candidate cell configuration but does not have a corresponding Need N field in ltm-CandidateConfig (e.g., Need N fields that do not release, add, or modify an element of a list), the UE 5402 removes the corresponding Need N field from the complete LTM candidate cell configuration.

For each Need R field that is present in the LTM candidate cell configuration but does not have a corresponding Need R field in ltm-CandidateConfig, the UE 5402 removes the corresponding Need R field from the complete LTM candidate cell configuration.

In some examples, for the handling of all remaining ASN.1 structures, information elements, and fields that are not mentioned in this procedure the UE 5402 follows the general guidelines and principles according to Annex A of [TS38331].

8.2.6.6. LTM Cell Switch Execution

Upon the indication by lower layers that an LTM cell switch procedure is triggered, the UE 5402 performs the following actions (in some examples, it is FFS on whether it needs to be clarified that lower layers indicate an LTM candidate cell configuration ID, among other information):

The UE 5402 releases and/or clears all current dedicated radio configuration related to this cell group except for the following: if the LTM cell switch is triggered on the MCG: the MCG C-RNTI, and/or the AS security configurations associated with the master key; else, if the LTM cell switch is triggered on the SCG: the AS security configurations associated with the secondary key; the radioBearerConfig or radioBearerConfig2; the RLC entity configuration, which include one or more RLC-BearerConfig IEs; the UE variables VarLTM-Config and VarLTM-UE-Config. In some examples, it is FFS on whether the radio bearer needs to be kept when execution the LTM cell switch. Additionally or alternatively, it is FFS on whether some other configurations should be released or kept, e.g., the MeasConfig IE.

The UE 5402 releases and/or clears all current common radio configuration. In some examples, it is FFS on whether ServingCellConfigCommon is always provided in a LTM candidate cell configuration or whether can be optional.

The UE 5402 uses the default values specified in 9.2.3 of [TS38331] for timers T310, T311 and constants N310, N311. The UE 5402 stops timer T310 for the corresponding SpCell, if running.

If this procedure is executed for the MCG, and if timer T316 is running, the UE 5402 stops timer T316. In some examples, it is FFS on whether it is allowed to trigger an LTM cell switch (at the MCG or SCG) while timer T316 is running.

The UE 5402 stops timer T312 for the corresponding SpCell, if running. The UE 5402 resets the counters N310 and N311. The UE 5402 starts timer T3xx for this cell group with the timer value set to t3xx, as included within the field ltm-Timers. In some examples, it is FFS on whether to use a new timer or re-use timer T304.

The UE 5402 applies the default L1 parameter values as specified in corresponding physical layer specifications. The UE 5402 applies the specified BCCH configuration defined in 9.1.1.1 of [TS38331] for the target LTM candidate cell. The UE 5402 acquires the MIB of the target SpCell for the LTM candidate cell configuration indicated by lower layers, which is scheduled as specified in [TS38213], if applicable. The UE 5402 resets the MAC entity of this cell group.

If the value of field ltm-NoResetID contained within the LTM-Candidate IE related to the LTM candidate cell configuration identity as received by lower layers is equal to the value of ltm-ServingCellNoResetID in current serving cell for this cell group: the UE 5402 continues using the current RLC entity in the LTM candidate cell configuration indicated by lower layers, and replaces the value of ltm-ServingCellNoResetID for this cell group with the value received within ltm-NoResetID.

Else, for each RLC-BearerConfig within rlc-BearerToAddModList: the UE 5402 re-establishes the RLC entity as specified in [TS38322]; for each drb-Identity value included in the drb-ToAddModList that is part of the current UE configuration and not configured as DAPS bearer: the UE 5402 triggers the PDCP entity of this DRB to perform data recovery as specified in [TS38323]. In some examples, the handling of the MAC and RLC entity is still FFS as it depends on how the L2 reset is indicated by the network. In some examples, it is FFS on how to capture UE actions when the L2 reset is needed.

The UE 5402 continues using the current PDCP entity in the LTM candidate cell configuration indicated by lower layers; 1> apply the LTM configuration in ue-LTM-Config within VarLTM-UE-Config related to the LTM candidate cell configuration identity as received by lower layers according to clause 5.3.5.3 of [TS38331].

If the RRCReconfiguration message including the LTM-Candidate IE related to the LTM candidate cell configuration identity as received by lower layers was received via SRB1 within the nr-SCG within mrdc-SecondaryCellGroup (UE in NR-DC), the UE 5402 submits the RRCReconfigurationComplete message via the NR MCG embedded in NR RRC message ULInformationTransferMRDC as specified in clause 5.7.2a.3 of [TS38331]; else if RRCReconfiguration message including the LTM-Candidate IE related to the LTM candidate cell configuration identity as received by lower layers was received via SRB3 (UE in NR-DC): the UE 5402 submits the RRCReconfigurationComplete message via SRB3 to lower layers for transmission using the new configuration; else (RRCReconfiguration was received via SRB1): the UE 5402 submits the RRCReconfigurationComplete message to lower layers for transmission via SRB1 using the new configuration.

In some examples, it is FFS on whether the “apply” of the LTM configuration should explicitly refer to section 5.3.5.3 of [TS38331]. Additionally or alternatively, it is FFS on whether to reuse the reconfiguration with sync procedure and IE. Additionally or alternatively, it is FFS on whether the sending of the RRCReconfigurationComplete message should be triggered in this section or in section 5.3.5.3 of [TS38331] (e.g., Reception of an RRCReconfiguration by the UE 5402). Additionally or alternatively, it is FFS on whether further UE actions need to be specified, for example, subsequent LTM cell switch or interaction with lower layers. Additionally or alternatively, it is FFS on the UE actions (for no L2 reset) based on ltm-CandidateNoResetL2-List. Additionally or alternatively, it is FFS on how to handle the TA (and when the UE has no TA) in the source cell (in case no RACH is performed) upon an LTM cell switch and whether this should be specified in RRC or MAC. Additionally or alternatively, it is FFS on the supervision timer for the LTM cell switch. Additionally or alternatively, it is FFS on how to provide the UL grant to the UE in case no RACH is performed during the LTM cell switch.

8.3. RRC Messages: Message Definitions

8.3.1. RRCReconfiguration

The RRCReconfiguration message is the command to modify an RRC connection. It may convey information for measurement configuration, mobility control, radio resource configuration (e.g., including RBs, MAC main configuration and physical channel configuration) and AS security configuration. Signalling radio bearer: SRB1 or SRB3. RLC-SAP: AM. Logical channel: DCCH. Direction: Network to UE. An example RRCReconfiguration message is shown and described by tables 8.3.1-1, 8.3.1-2, and 8.3.1-3.

TABLE 8.3.1-1
RRCReconfiguration message

```
-- ASN1START
-- TAG-RRCRECONFIGURATION-START
RRCReconfiguration ::= SEQUENCE {
  rrc-TransactionIdentifier RRC-TransactionIdentifier,
  criticalExtensions CHOICE {
  rrcReconfiguration RRCReconfiguration-IEs,
  criticalExtensionsFuture SEQUENCE { }
  }
}
RRCReconfiguration-Ies ::= SEQUENCE {
  radioBearerConfig RadioBearerConfig OPTIONAL, -- Need M
  secondaryCellGroup OCTET STRING (CONTAINING CellGroupConfig) OPTIONAL, -- Cond SCG
  measConfig MeasConfig OPTIONAL, -- Need M
  lateNonCriticalExtension OCTET STRING OPTIONAL,
  nonCriticalExtension RRCReconfiguration-v1530-Ies OPTIONAL
}
RRCReconfiguration-v1530-Ies ::= SEQUENCE {
  masterCellGroup OCTET STRING (CONTAINING CellGroupConfig) OPTIONAL, -- Need M
  fullConfig ENUMERATED {true} OPTIONAL, -- Cond FullConfig
  dedicatedNAS-MessageList SEQUENCE (SIZE (1..maxDRB)) OF DedicatedNAS-Message OPTIONAL, -- Cond
nonHO
  masterKeyUpdate MasterKeyUpdate OPTIONAL, -- Cond MasterKeyChange
  dedicatedSIB1-Delivery OCTET STRING (CONTAINING SIB1) OPTIONAL, -- Need N
  dedicatedSystemInformationDelivery OCTET STRING (CONTAINING SystemInformation) OPTIONAL, -- Need
N
  otherConfig OtherConfig OPTIONAL, -- Need M
  nonCriticalExtension RRCReconfiguration-v1540-Ies OPTIONAL
}
RRCReconfiguration-v1540-Ies ::= SEQUENCE {
  otherConfig-v1540 OtherConfig-v1540 OPTIONAL, -- Need M
  nonCriticalExtension RRCReconfiguration-v1560-Ies OPTIONAL
}
RRCReconfiguration-v1560-Ies ::= SEQUENCE {
  mrdc-SecondaryCellGroupConfig SetupRelease { MRDC-SecondaryCellGroupConfig } OPTIONAL, -- Need M
  radioBearerConfig2 OCTET STRING (CONTAINING RadioBearerConfig) OPTIONAL, -- Need M
  sk-Counter SK-Counter OPTIONAL, -- Need N
  nonCriticalExtension RRCReconfiguration-v1610-Ies OPTIONAL
}
RRCReconfiguration-v1610-Ies ::= SEQUENCE {
  otherConfig-v1610 OtherConfig-v1610 OPTIONAL, -- Need M
  bap-Config-r16 SetupRelease { BAP-Config-r16 } OPTIONAL, -- Need M
  iab-IP-AddressConfigurationList-r16 IAB-IP-AddressConfigurationList-r16 OPTIONAL, -- Need M
  conditionalReconfiguration-r16 ConditionalReconfiguration-r16 OPTIONAL, -- Need M
  daps-SourceRelease-r16 ENUMERATED {true} OPTIONAL, -- Need N
  t316-r16 SetupRelease {T316-r16} OPTIONAL, -- Need M
  needForGapsConfigNR-r16 SetupRelease {NeedForGapsConfigNR-r16} OPTIONAL, -- Need M
  onDemandSIB-Request-r16 SetupRelease { OnDemandSIB-Request-r16 } OPTIONAL, -- Need M
  dedicatedPosSysInfoDelivery-r16 OCTET STRING (CONTAINING PosSystemInformation-r16-Ies) OPTIONAL,
-- Need N
  sl-ConfigDedicatedNR-r16 SetupRelease { SL-ConfigDedicatedNR-r16} OPTIONAL, -- Need M
  sl-ConfigDedicatedEUTRA-Info-r16 SetupRelease { SL-ConfigDedicatedEUTRA-Info-r16} OPTIONAL,
-- Need M
  targetCellSMTC-SCG-r16 SSB-MTC OPTIONAL, -- Need S
  nonCriticalExtension RRCReconfiguration-v1700-Ies OPTIONAL
}
RRCReconfiguration-v1700-Ies ::= SEQUENCE {
  otherConfig-v1700 OtherConfig-v1700 OPTIONAL, -- Need M
  sl-L2RelayUE-Config-r17 SetupRelease { SL-L2RelayUE-Config-r17 } OPTIONAL, -- Need M
  sl-L2RemoteUE-Config-r17 SetupRelease { SL-L2RemoteUE-Config-r17 } OPTIONAL, -- Need M
  dedicatedPagingDelivery-r17 OCTET STRING (CONTAINING Paging) OPTIONAL, -- Cond PagingRelay
  needForGapNCSG-ConfigNR-r17 SetupRelease { NeedForGapNCSG-ConfigNR-r17} OPTIONAL, -- Need M
  needForGapNCSG-ConfigEUTRA-r17 SetupRelease { NeedForGapNCSG-ConfigEUTRA-r17} OPTIONAL, -- Need M
  musim-GapConfig-r17 SetupRelease {MUSIM-GapConfig-r17} OPTIONAL, -- Need M
  ul-GapFR2-Config-r17 SetupRelease { UL-GapFR2-Config-r17 } OPTIONAL, -- Need M
  scg-State-r17 ENUMERATED { deactivated } OPTIONAL, -- Need N
  appLayerMeasConfig-r17 AppLayerMeasConfig-r17 OPTIONAL, -- Need M
  ue-TxTEG-RequestUL-TDOA-Config-r17 SetupRelease { UE-TxTEG-RequestUL-TDOA-Config-r17} OPTIONAL,
- Need M
  nonCriticalExtension RRCReconfiguration-v18xy OPTIONAL
  nonCriticalExtension RRCReconfiguration-v1800-Ies OPTIONAL
}
RRCReconfiguration-v18xy-Ies ::= SEQUENCE {
  ltm-Config-r18 SetupRelease {LTM-Config-r18} OPTIONAL, -- Need M
  nonCriticalExtension SEQUENCE { } OPTIONAL
}
RRCReconfiguration-v1800-IEs ::= SEQUENCE {
  scpac-Release-r18 ENUMERATED {true} OPTIONAL, -- Need N
  nonCriticalExtension SEQUENCE { } OPTIONAL
}
MRDC-SecondaryCellGroupConfig ::= SEQUENCE {
  mrdc-ReleaseAndAdd ENUMERATED {true} OPTIONAL, -- Need N
  mrdc-SecondaryCellGroup CHOICE {
  nr-SCG OCTET STRING (CONTAINING RRCReconfiguration),
  eutra-SCG OCTET STRING
  }
}
BAP-Config-r16 ::= SEQUENCE {
  bap-Address-r16 BIT STRING (SIZE (10)) OPTIONAL, -- Need M
  defaultUL-BAP-RoutingID-r16 BAP-RoutingID-r16 OPTIONAL, -- Need M
  defaultUL-BH-RLC-Channel-r16 BH-RLC-ChannelID-r16 OPTIONAL, -- Need M
  flowControlFeedbackType-r16 ENUMERATED {perBH-RLC-Channel, perRoutingID, both} OPTIONAL, -- Need
R
  ...
}
MasterKeyUpdate ::= SEQUENCE {
  keySetChangeIndicator BOOLEAN,
  nextHopChainingCount NextHopChainingCount,
  nas-Container OCTET STRING OPTIONAL, -- Cond securityNASC
  ...
}
OnDemandSIB-Request-r16 ::= SEQUENCE {
  onDemandSIB-RequestProhibitTimer-r16 ENUMERATED {s0, s0dot5, s1, s2, s5, s10, s20, s30}
}
T316-r16 ::= ENUMERATED {ms50, ms100, ms200, ms300, ms400, ms500, ms600, ms1000, ms1500, ms2000}
IAB-IP-AddressConfigurationList-r16 ::= SEQUENCE {
  iab-IP-AddressToAddModList-r16 SEQUENCE (SIZE (1..maxIAB-IP-Address-r16)) OF IAB-IP-
AddressConfiguration-r16 OPTIONAL, -- Need N
  iab-IP-AddressToReleaseList-r16 SEQUENCE (SIZE (1..maxIAB-IP-Address-r16)) OF IAB-IP-
AddressIndex-r16 OPTIONAL, -- Need N
  ...
}
IAB-IP-AddressConfiguration-r16 ::= SEQUENCE {
  iab-IP-AddressIndex-r16 IAB-IP-AddressIndex-r16,
  iab-IP-Address-r16 IAB-IP-Address-r16 OPTIONAL, -- Need M
  iab-IP-Usage-r16 IAB-IP-Usage-r16 OPTIONAL, -- Need M
  iab-donor-DU-BAP-Address-r16 BIT STRING (SIZE(10)) OPTIONAL, -- Need M
...
}
SL-ConfigDedicatedEUTRA-Info-r16 ::= SEQUENCE {
  sl-ConfigDedicatedEUTRA-r16 OCTET STRING OPTIONAL, -- Need M
  sl-TimeOffsetEUTRA-List-r16 SEQUENCE (SIZE (8)) OF SL-TimeOffsetEUTRA-r16 OPTIONAL -- Need M
}
SL-TimeOffsetEUTRA-r16 ::= ENUMERATED {ms0, ms0dot25, ms0dot5, ms0dot625, ms0dot75, ms1,
ms1dot25, msldot5, ms1dot 75,
  ms2, ms2dot5, ms3, ms4, ms5, ms6, ms8, ms10, ms20}
UE-TxTEG-RequestUL-TDOA-Config-r17 ::= CHOICE {
  oneShot-r17 NULL,
  periodicReporting-r17 ENUMERATED { ms160, ms320, ms1280, ms2560, ms61440, ms81920, ms368640,
ms 737280 }
}
-- TAG-RRCRECONFIGURATION-STOP
-- ASN1STOP
```

TABLE 8.3.1-2
RRCReconfiguration-IEs field descriptions
appLayerMeasConfig
This field is used to configure application layer measurements. This field is absent when the UE is configured to
operate with shared spectrum channel access.
Bap-Config
This field is used to configure the BAP entity for IAB nodes.
Bap-Address
Indicates the BAP address of an IAB-node. The BAP address of an IAB-node cannot be changed once configured
for the cell group to the BAP entity.
conditionalReconfiguration
Configuration of candidate target SpCell(s) and execution condition(s) for conditional handover, conditional PSCell
addition or conditional PSCell change. The field is absent if any DAPS bearer is configured or if the
masterCellGroup includes ReconfigurationWithSync or if the sl-L2RemoteUE-Config or sl-L2RelayUE-Config is
configured. For conditional PSCell change, the field is absent if the secondaryCellGroup includes
ReconfigurationWithSync. The RRCReconfiguration message contained in DLInformationTransferMRDC cannot
contain the field conditionalReconfiguration for conditional PSCell change or for conditional PSCell addition.
scpac-Release
Indicates to UE that the Subsequent CPAC configuration is to be released
Daps-SourceRelease
Indicates to UE that the source cell part of DAPS operation is to be stopped and the source cell part of DAPS
configuration is to be released.
dedicatedNAS-MessageList
This field is used to transfer UE specific NAS layer information between the network and the UE. The RRC layer is
transparent for each PDU in the list.
dedicatedPagingDelivery
This field is used to transfer Paging message for the associated L2 U2N Remote UE to the L2 U2N Relay UE in
RRC_CONNECTED.
dedicatedPosSysInfoDelivery
This field is used to transfer SIBPos to the UE in RRC_CONNECTED.
dedicatedSIB1-Delivery
This field is used to transfer SIB1 to the UE (including L2 U2N Remote UE). The field has the same values as the
corresponding configuration in servingCellConfigCommon.
dedicatedSystemInformationDelivery
This field is used to transfer SIB6, SIB7, SIB8, SIB19, SIB21 to the UE with an active BWP with no common
search space configured or the L2 U2N Remote UE in RRC_CONNECTED. For Ues in RRC_CONNECTED
(including L2 U2N Remote UE), this field is also used to transfer the SIBs requested on-demand.
defaultUL-BAP-RoutingID
This field is used for IAB-node to configure the default uplink Routing ID, which is used by IAB-node during IAB-
node bootstrapping, migration, IAB-MT RRC resume and IAB-MT RRC re-establishment for F1-C and non-F1
traffic. The defaultUL-BAP-RoutingID can be (re-)configured when IAB-node IP address for F1-C related traffic
changes. This field is mandatory only for IAB-node bootstrapping.
defaultUL-BH-RLC-Channel
This field is used for IAB-nodes to configure the default uplink BH RLC channel, which is used by IAB-node during
IAB-node bootstrapping, migration, IAB-MT RRC resume and IAB-MT RRC re-establishment for F1-C and non-F1
traffic. The defaultUL-BH-RLC-Channel can be (re-)configured when IAB-node IP address for F1-C related traffic
changes, and the new IP address is anchored at a different IAB-donor-DU. This field is mandatory for IAB-node
bootstrapping. If the IAB-MT is operating in EN-DC, the default uplink BH RLC channel is referring to an RLC
channel on the SCG; Otherwise, it is referring to an RLC channel either on the MCG or on the SCG depending on
whether the MN or the SN configures this field.
flowControlFeedbackType
This field is only used for IAB-node that support hop-by-hop flow control to configure the type of flow control
feedback. Value perBH-RLC-Channel indicates that the IAB-node shall provide flow control feedback per BH RLC
channel, value perRoutingID indicates that the IAB-node shall provide flow control feedback per routing ID, and
value both indicates that the IAB-node shall provide flow control feedback both per BH RLC channel and per
routing ID.
fullConfig
Indicates that the full configuration option is applicable for the RRCReconfiguration message for intra-system intra-
RAT HO. For inter-RAT HO from E-UTRA to NR, fullConfig indicates whether or not delta signalling of
SDAP/PDCP from source RAT is applicable. This field is absent if any DAPS bearer is configured or when the
RRCReconfiguration message is transmitted on SRB3, and in an RRCReconfiguration message for SCG
contained in another RRCReconfiguration message (or RRCConnectionReconfiguration message, see [TS36331])
transmitted on SRB1.
lab-IP-Address
This field is used to provide the IP address information for IAB-node.
lab-IP-AddressIndex
This field is used to identify a configuration of an IP address.
lab-IP-AddressToAddModList
List of IP addresses allocated for IAB-node to be added and modified.
lab-IP-Address ToReleaseList
List of IP address allocated for IAB-node to be released.
lab-IP-Usage
This field is used to indicate the usage of the assigned IP address. If this field is not configured, the assigned IP
address is used for all traffic.
lab-donor-DU-BAP-Address
This field is used to indicate the BAP address of the IAB-donor-DU where the IP address is anchored.
keySetChangeIndicator
Indicates whether UE shall derive a new K_{gNB}. If reconfigurationWithSync is included, value true indicates that a
K_{gNB} key is derived from a K_{AMF} key taken into use through the latest successful NAS SMC procedure, or N2
handover procedure with K_{AMF} change, as described in TS 33.501 [11] for K_{gNB} re-keying. Value false indicates
that the new K_{gNB} key is obtained from the current K_{gNB} key or from the NH as described in TS 33.501 [11].
ltm-Config
This field includes a set of configurations related to LTM candidate cell(s), reference configuration for LTM
candidate cell(s), and sets of LTM candidate cell(s) in which full L2 reset is applied upon an LTM cell switch.
masterCellGroup
Configuration of master cell group.
Mrdc-ReleaseAndAdd
This field indicates that the current SCG configuration is released and a new SCG is added at the same time.
Mrdc-SecondaryCellGroup
Includes an RRC message for SCG configuration in NR-DC or NE-DC.
For NR-DC (nr-SCG), mrdc-SecondaryCellGroup contains the RRCReconfiguration message as generated
(entirely) by SN gNB. In this version of the specification, the RRC message can only include fields
secondaryCellGroup, otherConfig, conditionalReconfiguration, measConfig, bap-Config and IAB-IP-
AddressConfigurationList.
For NE-DC (eutra-SCG), mrdc-SecondaryCellGroup includes the E-UTRA RRCConnectionReconfiguration
message as specified in [TS36331]. In this version of the specification, the E-UTRA RRC message can only
include the field scg-Configuration.
Musim-GapConfig
Indicates the MUSIM gap configuration and controls setup/release of MUSIM gaps. In this version of the
specification, the network does not configure MUSIM gap together with concurrent measurement gap or
preconfigured measurement gap for positioning.
Nas-Container
This field is used to transfer UE specific NAS layer information between the network and the UE. The RRC layer is
transparent for this field, although it affects activation of AS security after inter-system handover to NR. The
content is defined in TS 24.501 [23].
needForGapsConfigNR
Configuration for the UE to report measurement gap requirement information of NR target bands in the
RRCReconfigurationComplete and RRCResumeComplete message.
needForGapNCSG-ConfigEUTRA
Configuration for the UE to report measurement gap and NCSG requirement information of E-UTRA target bands
in the RRCReconfigurationComplete and RRCResumeComplete message.
needForGapNCSG-ConfigNR
Configuration for the UE to report measurement gap and NCSG requirement information of NR target bands in the
RRCReconfigurationComplete and RRCResumeComplete message.
nextHopChainingCount
Parameter NCC: see e.g., [TS33501]
onDemandSIB-Request
If the field is present, the UE is allowed to request SIB(s) on-demand while in RRC_CONNECTED according to
clause 5.2.2.3.5.
onDemandSIB-RequestProhibitTimer
Prohibit timer for requesting SIB(s) on-demand while in RRC_CONNECTED according to clause 5.2.2.3.5. Value
in seconds. Value s0 means prohibit timer is set to 0 seconds, value s0dot5 means prohibit timer is set to 0.5
seconds, value s1 means prohibit timer is set to 1 second and so on.
otherConfig
Contains configuration related to other configurations. When configured for the SCG, only fields drx-
PreferenceConfig, maxBW-PreferenceConfig, maxBW-PreferenceConfigFR2-2, maxCC-PreferenceConfig,
maxMIMO-LayerPreferenceConfig, maxMIMO-LayerPreferenceConfigFR2-2,
minSchedulingOffsetPreferenceConfig, minSchedulingOffsetPreferenceConfigExt, rlm-RelaxationReportingConfig,
bfd-RelaxationReportingConfig, btNameList, wlanNameList, sensorNameList and obtainCommonLocation can be
included.
radioBearerConfig
Configuration of Radio Bearers (DRBs, SRBs, multicast MRBs) including SDAP/PDCP. In (NG)EN-DC this field
may only be present if the RRCReconfiguration is transmitted over SRB3.
radioBearerConfig2
Configuration of Radio Bearers (DRBs, SRBs) including SDAP/PDCP. This field can only be used if the UE
supports NR-DC or NE-DC.
Scg-State
Indicates that the SCG is in deactivated state.
This field is not used
in an RRCReconfiguration message received:
within mrdc-SecondaryCellGroup, or
in an E-UTRA RRCConnectionReconfiguration message, or
in an E-UTRA RRCConnectionResume message or
in an RRCReconfiguration message received via SRB3, except if the RRCReconfiguration message is
included in DLInformationTransferMRDC.
The field is absent if CPA or CPC is configured for the UE, or if the RRCReconfiguration message is contained in
CondRRCReconfig.
Sl-L2RelayUE-Config
Contains L2 U2N relay operation related configurations used by a UE acting as or to be acting as a L2 U2N Relay
UE. The field is absent if conditionalReconfiguration is configured for CHO.
Sl-L2RemoteUE-Config
Contains L2 U2N relay operation related configurations used by a UE acting as or to be acting as a L2 U2N
Remote UE. The field is absent if conditionalReconfiguration is configured for CHO, or if appLayerMeasConfig or
SRB4 is configured/not released.
secondaryCellGroup
Configuration of secondary cell group ((NG)EN-DC or NR-DC).
Sk-Counter
A counter used upon initial configuration of S-K_{gNB} or S-K_{eNB}, as well as upon refresh of S-K_{gNB} or S-K_{eNB}. This field
is always included either upon initial configuration of an NR SCG or upon configuration of the first RB with
keyToUse set to secondary, whichever happens first. This field is absent if there is neither any NR SCG nor any
RB with keyToUse set to secondary.
Sl-ConfigDedicatedNR
This field is used to provide the dedicated configurations for NR sidelink communication/discovery.
Sl-ConfigDedicatedEUTRA-Info
This field includes the E-UTRA RRCConnectionReconfiguration as specified in [TS36331]. In this version of the
specification, the E-UTRA RRCConnectionReconfiguration can only includes sidelink related fields for V2X sidelink
communication, e.g. sl-V2X-ConfigDedicated, sl-V2X-SPS-Config, measConfig and/or otherConfig.
Sl-TimeOffsetEUTRA
This field indicates the possible time offset to (de)activation of V2X sidelink transmission after receiving DCI format
3_1 used for scheduling V2X sidelink communication. Value msOdpt75 corresponds to 0.75 ms, ms1 corresponds
to 1 ms and so on. The network includes this field only when sl-ConfigDedicatedEUTRA is configured.
targetCellSMTC-SCG
The SSB periodicity/offset/duration configuration of target cell for NR PSCell addition and SN change. When UE
receives this field, UE applies the configuration based on the timing reference of NR Pcell for PSCell addition and
PSCell change for the case of no reconfiguration with sync of MCG, and UE applies the configuration based on the
timing reference of target NR Pcell for the case of reconfiguration with sync of MCG. If both this field and the smtc
in secondaryCellGroup −> SpCellConfig −> reconfiguration WithSync are absent, the UE uses the SMTC in the
measObjectNR having the same SSB frequency and subcarrier spacing, as configured before the reception of the
RRC message.
T316
Indicates the value for timer T316 as described in clause 7.1. Value ms50 corresponds to 50 ms, value ms 100
corresponds to 100 ms and so on. This field can be configured only if the UE is configured with split SRB1 or
SRB3.
Ue-TxTEG-RequestUL-TDOA-Config
Configures the periodicity of UE reporting for the association between Tx TEG and SRS Positioning resources.
When configured with oneShot UE reports the association only one time. When configured with periodicReporting
UE reports the association periodically and the periodicReporting indicates the periodicity. Value ms160
corresponds to 160 ms, value ms320 corresponds to 320 ms and so on.
Ul-GapFR2-Config
Indicates the FR2 UL gap configuration to UE. In EN-DC and NGEN-DC, the SN decides and configures the FR2
UL gap pattern. In NE-DC, the MN decides and configures the FR2 UL gap pattern. In NR-DC without FR2-FR2
band combination, the network entity which is configured with FR2 serving cell(s) decides and configures the FR2
UL gap pattern.

TABLE 8.3.1-3

| Conditional Presence | Explanation |
|---|---|
| nonHO | The field is absent in case of reconfiguration with sync within NR or to NR; otherwise it |
| | is optionally present, need N. |
| securityNASC | This field is mandatory present in case of inter system handover. Otherwise the field is |
| | optionally present, need N. |
| MasterKeyChange | This field is mandatory present in case masterCellGroup includes |
| | Reconfiguration WithSync and RadioBearerConfig includes SecurityConfig with |
| | SecurityAlgorithmConfig, indicating a change of the AS security algorithms associated |
| | to the master key. If ReconfigurationWithSync is included for other cases, this field is |
| | optionally present, need N. Otherwise the field is absent. |
| FullConfig | The field is mandatory present in case of inter-system handover from E-UTRA/EPC to |
| | NR. It is optionally present, Need N, during reconfiguration with sync and also in first |
| | reconfiguration after reestablishment; or for intra-system handover from E-UTRA/5GC |
| | to NR. It is absent otherwise. |
| SCG | The field is mandatory present in: |
| | an RRCReconfiguration message contained in an RRCResume message (or in |
| | an RRCConnectionResume message, see [TS36331]), |
| | an RRCReconfiguration message contained in an |
| | RRCConnectionReconfiguration message, see [TS36331], which is contained in |
| | DLInformation TransferMRDC transmitted on SRB3 (as a response to |
| | ULInformation TransferMRDC including an MCGFailureInformation). |
| | The field is optional present, Need M, in: |
| | an RRCReconfiguration message transmitted on SRB3, |
| | an RRCReconfiguration message contained in another RRCReconfiguration |
| | message (or in an RRCConnectionReconfiguration message, see [TS36331]) |
| | transmitted on SRB1 |
| | an RRCReconfiguration message contained in another RRCReconfiguration |
| | message which is contained in DLInformation TransferMRDC transmitted on |
| | SRB3 (as a response to ULInformation TransferMRDC including an |
| | MCGFailureInformation) |
| | Otherwise, the field is absent |
| Paging Relay | For L2 U2N Relay UE, the field is optionally present, Need N. Otherwise, it is absent. |

8.4. RRC Information Elements

8.4.1. CellGroupConfig

The CellGroupConfig IE is used to configure an MCG and/or one or more SCGs. A cell group comprises a MAC entity, a set of logical channels with associated RLC entities and a primary cell (PCell and/or SpCell), and one or more SCells. An example CellGroupConfig IE is shown and described by tables 8.4.1-1, 8.4.1-2, and 8.4.1-3.

TABLE 8.4.1-1
CellGroupConfig information element

```
-- ASN1START
-- TAG-CELLGROUPCONFIG-START
-- Configuration of one Cell-Group:
CellGroupConfig ::= SEQUENCE {
  cellGroupId CellGroupId,
  rlc-BearerToAddModList SEQUENCE (SIZE (1..maxLC-ID)) OF RLC-BearerConfig OPTIONAL, -- Need N
  rlc-BearerToReleaseList SEQUENCE (SIZE (1..maxLC-ID)) OF LogicalChannelIdentity OPTIONAL, -- Need
N
  mac-CellGroupConfig MAC-CellGroupConfig OPTIONAL, -- Need M
  physicalCellGroupConfig PhysicalCellGroupConfig OPTIONAL, -- Need M
  spCellConfig SpCellConfig OPTIONAL, -- Need M
  sCellToAddModList SEQUENCE (SIZE (1..maxNrofSCells)) OF SCellConfig OPTIONAL, -- Need N
  sCellToReleaseList SEQUENCE (SIZE (1..maxNrofSCells)) OF SCellIndex OPTIONAL, -- Need N
  ...,
  [[
  reportUplinkTxDirectCurrent ENUMERATED {true} OPTIONAL -- Cond BWP-Reconfig
  ]],
  [[
  bap-Address-r16 BIT STRING (SIZE (10)) OPTIONAL, -- Need M
  bh-RLC-ChannelToAddModList-r16 SEQUENCE (SIZE (1..maxBH-RLC-ChannelID-r16)) OF BH-RLC-
ChannelConfig-r16 OPTIONAL, -- Need N
  bh-RLC-ChannelToReleaseList-r16 SEQUENCE (SIZE (1..maxBH-RLC-ChannelID-r16)) OF BH-RLC-ChannelID-
r16 OPTIONAL, -- Need N
  flc-TransferPath-r16 ENUMERATED {lte, nr, both} OPTIONAL, -- Need M
  simultaneousTCI-UpdateList1-r16 SEQUENCE (SIZE (1..maxNrofServingCellsTCI-r16)) OF ServCellIndex
OPTIONAL, -- Need R
  simultaneousTCI-UpdateList2-r16 SEQUENCE (SIZE (1..maxNrofServingCellsTCI-r16)) OF ServCellIndex
OPTIONAL, -- Need R
  simultaneousSpatial-UpdatedList1-r16 SEQUENCE (SIZE (1..maxNrofServingCellsTCI-r16)) OF
ServCellIndex OPTIONAL, Need R
  simultaneousSpatial-UpdatedList2-r16 SEQUENCE (SIZE (1..maxNrofServingCellsTCI-r16)) OF
ServCellIndex OPTIONAL, -- Need R
  uplinkTxSwitchingOption-r16 ENUMERATED { switchedUL, dualUL} OPTIONAL, -- Need R
  uplinkTxSwitchingPowerBoosting-r16 ENUMERATED { enabled} OPTIONAL -- Need R
  ]],
  [[
  reportUplinkTxDirectCurrentTwoCarrier-r16 ENUMERATED {true} OPTIONAL -- Need N
  ]],
  [[
  f1c-TransferPathNRDC-r17 ENUMERATED {mcg, scg, both} OPTIONAL, -- Need M
  uplinkTxSwitching-2T-Mode-r17 ENUMERATED { enabled} OPTIONAL, -- Cond 2Tx
  uplinkTxSwitching-DualUL-TxState-r17 ENUMERATED {oneT, twoT} OPTIONAL, -- Cond 2Tx
  uu-RelayRLC-ChannelToAddModList-r17 SEQUENCE (SIZE (1..maxUu-RelayRLC-ChannelID-r17)) OF Uu-
RelayRLC-ChannelConfig-r17
OPTIONAL, -- Need N
  uu-RelayRLC-ChannelToReleaseList-r17 SEQUENCE (SIZE (1..maxUu-RelayRLC-ChannelID-r17)) OF Uu-
RelayRLC-ChannelID-r17
OPTIONAL, -- Need N
  simultaneousU-TCI-UpdateList1-r17 SEQUENCE (SIZE (1..maxNrofServingCellsTCI-r16)) OF
ServCellIndex OPTIONAL, -- Need R
  simultaneousU-TCI-UpdateList2-r17 SEQUENCE (SIZE (1..maxNrofServingCellsTCI-r16)) OF
ServCellIndex OPTIONAL, -- Need R
  simultaneousU-TCI-UpdateList3-r17 SEQUENCE (SIZE (1..maxNrofServingCellsTCI-r16)) OF
ServCellIndex OPTIONAL, -- Need R
  simultaneousU-TCI-UpdateList4-r17 SEQUENCE (SIZE (1..maxNrofServingCellsTCI-r16)) OF
ServCellIndex OPTIONAL, -- Need R
  rlc-BearerToReleaseListExt-r17 SEQUENCE ( SIZE (1..maxLC-ID)) OF LogicalChannelIdentityExt-r17
OPTIONAL, -- Need N
  iab-ResourceConfigToAddModList-r17 SEQUENCE (SIZE (1..maxNrofIABResourceConfig-r17)) OF IAB-
ResourceConfig-r17 OPTIONAL, -- Need N
  iab-ResourceConfigToReleaseList-r17 SEQUENCE (SIZE (1..maxNrofIABResourceConfig-r17)) OF IAB-
ResourceConfigID-r17 OPTIONAL -- Need N
  ]],
  [[
  reportUplinkTxDirectCurrentMoreCarrier-r17 ReportUplinkTxDirectCurrentMoreCarrier-r17 OPTIONAL -
- Need N
}
-- Serving cell specific MAC and PHY parameters for a SpCell:
SpCellConfig ::= SEQUENCE {
  servCellIndex ServCellIndex OPTIONAL, -- Cond SCG
  reconfigurationWithSync ReconfigurationWithSync OPTIONAL, -- Cond ReconfWithSync
  rlf-TimersAndConstants SetupRelease { RLF-TimersAndConstants } OPTIONAL, -- Need M
  rlmInSyncOutOfSyncThreshold ENUMERATED {n1} OPTIONAL, -- Need S
  spCellConfigDedicated ServingCellConfig OPTIONAL, -- Need M
  ...,
  [[
  lowMobilityEvaluationConnected-r17 SEQUENCE {
  s-SearchDeltaP-Connected-r17 ENUMERATED {dB3, dB6, dB9, dB12, dB15, spare3, spare2, spare1},
  t-SearchDeltaP-Connected-r17 ENUMERATED {s5, s10, s20, s30, s60, s120, s180, s240, s300, spare7,
spare6, spare5,
  spare4, spare3, spare2, spare1 }
  } OPTIONAL, -- Need R
  goodServingCellEvaluationRLM-r17 GoodServingCellEvaluation-r17 OPTIONAL, -- Need R
  goodServingCellEvaluationBFD-r17 GoodServingCellEvaluation-r17 OPTIONAL, -- Need R
  deactivatedSCG-Config-r17 SetupRelease { DeactivatedSCG-Config-r17 } OPTIONAL -- Cond SCG-Opt
  ]],
  ltm-CellSwitchInfo-r18 SetupRelease { LTM-CellSwitchInfo-r18 } OPTIONAL -- Cond LTM-Candidate
  Itm-Timers-r18 SetupRelease { LTM-Timers-r18 } OPTIONAL -- Cond LTM-Config
  ]]
}
ReconfigurationWithSync ::= SEQUENCE {
  spCellConfigCommon ServingCellConfigCommon OPTIONAL, -- Need M
  newUE-Identity RNTI-Value,
  t304 ENUMERATED {ms50, ms100, ms150, ms200, ms500, ms1000, ms2000, ms10000 },
  rach-ConfigDedicated CHOICE {
  uplink RACH-ConfigDedicated,
  supplementaryUplink RACH-ConfigDedicated
  } OPTIONAL, -- Need N
  ...,
  [[
  smtc SSB-MTC OPTIONAL -- Need S
  ]],
  [[
  daps-UplinkPowerConfig-r16 DAPS-UplinkPowerConfig-r16 OPTIONAL -- Need N
  ]],
  [[
  sl-PathSwitchConfig-r17 SL-PathSwitchConfig-r17 OPTIONAL -- Cond DirectToIndirect-PathSwitch
  ]]
}
DAPS-UplinkPowerConfig-r16 ::= SEQUENCE {
  p-DAPS-Source-r16 P-Max,
  p-DAPS-Target-r16 P-Max,
  uplinkPowerSharingDAPS-Mode-r16 ENUMERATED { semi-static-model, semi-static-mode2, dynamic }
}
ScellConfig ::= SEQUENCE {
  sCellIndex ScellIndex,
  sCellConfigCommon ServingCellConfigCommon OPTIONAL, -- Cond ScellAdd
  sCellConfigDedicated ServingCellConfig OPTIONAL, -- Cond ScellAddMod
  ...,
  [[
  smtc SSB-MTC OPTIONAL -- Need S
  ]],
  [[
  sCellState-r16 ENUMERATED {activated} OPTIONAL, -- Cond ScellAddSync
  secondaryDRX-GroupConfig-r16 ENUMERATED {true} OPTIONAL -- Cond DRX-Config2
  ]],
  [[
  preConfGapStatus-r17 BIT STRING (SIZE (maxNrofGapId-r17)) OPTIONAL, -- Cond PreConfigMG
  goodServingCellEvaluationBFD-r17 GoodServingCellEvaluation-r17 OPTIONAL, -- Need R
  sCellSIB20-r17 SetupRelease { SCellSIB20-r17 } OPTIONAL -- Need M
  ]]
}
SCellSIB20-r17 ::= OCTET STRING (CONTAINING SystemInformation)
DeactivatedSCG-Config-r17 ::= SEQUENCE {
  bfd-and-RLM-r17 BOOLEAN,
  ...
}
GoodServingCellEvaluation-r17 ::= SEQUENCE {
  offset-r17 ENUMERATED {db2, db4, db6, db8} OPTIONAL -- Need S
}
SL-PathSwitchConfig-r17 ::= SEQUENCE {
  targetRelayUE-Identity-r17 SL-SourceIdentity-r17,
  t420-r17 ENUMERATED {ms50, ms100, ms150, ms200, ms500, ms1000, ms2000, ms10000},
  ...
}
IAB-ResourceConfig-r17 ::= SEQUENCE {
  iab-ResourceConfigID-r17 IAB-ResourceConfigID-r17,
  slotList-r17 SEQUENCE (SIZE (1..5120)) OF INTEGER (0.. 5119) OPTIONAL, -- Need M
  periodicitySlotList-r17 ENUMERATED {ms0p5, ms0p625, ms1, ms1p25, ms2, ms2p5, ms5, ms10, ms20,
ms40, ms80, ms160} OPTIONAL, -- Need M
  slotListSubcarrierSpacing-r17 SubcarrierSpacing OPTIONAL, -- Need M
  ...
}
IAB-ResourceConfigID-r17 ::= INTEGER (0..maxNrofIABResourceConfig-1-r17)
ReportUplinkTxDirectCurrentMoreCarrier-r17 ::= SEQUENCE (SIZE (1..maxSimultaneousBands)) OF
IntraBandCC-CombinationReqList-r17
IntraBandCC-CombinationReqList-r17::= SEQUENCE {
  servCellIndexList-r17 SEQUENCE (SIZE (1..maxNrofServingCells)) OF ServCellIndex,
  cc-CombinationList-r17 SEQUENCE (SIZE (1..maxNrofReqComDC-Location-r17)) OF IntraBandCC-
Combination-r17
}
IntraBandCC-Combination-r17::= SEQUENCE (SIZE (1..maxNrofServingCells)) OF CC-State-r17
CC-State-r17::= SEQUENCE {
  dlCarrier-r17 CarrierState-r17 OPTIONAL, -- Need N
  ulCarrier-r17 CarrierState-r17 OPTIONAL -- Need N
}
CarrierState-r17::= CHOICE {
  deActivated-r17 NULL,
  activeBWP-r17 INTEGER (0..maxNrofBWPs)
}
LTM-CellSwitchInfo-r18 ::= SEQUENCE {
  spCellConfigCommon-r18 ServingCellConfigCommon OPTIONAL, -- Need M
  newUE-Identity-r18 RNTI-Value,
  rach-ConfigDedicated-r18 CHOICE {
  uplink-r18 RACH-ConfigDedicated,
  supplementaryUplink-r18 RACH-ConfigDedicated
  } OPTIONAL, -- Need N}
LTM-Timers-r18 ::= SEQUENCE {
  t3xx ENUMERATED {ms50, ms100, ms150, ms200, ms500, ms1000, ms2000, ms10000} OPTIONAL, -- Need M
-- TAG-CELLGROUPCONFIG-STOP
-- ASN1STOP
```

TABLE 8.4.1-2
CellGroupConfig IE field descriptions
CC-State field descriptions
dlCarrier
Indicates DL carrier activation state for this carrier and the related active BWP Index, if activated.
ulCarrier
Indicates UL carrier activation state for this carrier and the related active BWP Index, if activated.
CellGroupConfig field descriptions
bap-Address
BAP address of the parent node in cell group.
Bh-RLC-ChannelToAddModList
Configuration of the backhaul RLC entities and the corresponding MAC Logical Channels to be added and
modified.
Bh-RLC-ChannelToReleaseList
List of the backhaul RLC entities and the corresponding MAC Logical Channels to be released.
F1c-TransferPath
The F1-C transfer path that an EN-DC IAB-MT should use for transferring F1-C packets to the IAB-donor-CU. If
IAB-MT is configured with lte, IAB-MT can only use LTE leg for F1-C transfer. If IAB-MT is configured with nr,
IAB-MT can only use NR leg for F1-C transfer. If IAB-MT is configured with both, it is up to IAB-MT to select an
LTE leg or a NR leg for F1-C transfer. If the field is not configured, the IAB node uses the NR leg as the default
one.
F1c-TransferPathNRDC
The F1-C transfer path that an NR-DC IAB-MT should use for transferring F1-C packets to the IAB-donor-CU. If
IAB-MT is configured with mcg, IAB-MT can only use the MCG for F1-C transfer. If IAB-MT is configured with scg,
IAB-MT can only use the SCG for F1-C transfer. If IAB-MT is configured with both, it is up to IAB-MT to select the
MCG or the SCG for F1-C transfer.
ltm-CellSwitchinfo
This field contains necessary information for the UE to execute an LTM cell switch procedure in case this cell is a
LTM candidate cell.
ltm-Timers
Indicates the timer value of T3xx to be used during and LTM cell switch procedure.
Mac-CellGroupConfig
MAC parameters applicable for the entire cell group.
Rlc-BearerToAddModList
Configuration of the MAC Logical Channel, the corresponding RLC entities and association with radio bearers.
reportUplinkTxDirectCurrent
Enables reporting of uplink and supplementary uplink Direct Current location information upon BWP configuration
and reconfiguration. This field is only present when the BWP configuration is modified or any serving cell is added
or removed. This field is absent in the IE CellGroupConfig when provided as part of RRCSetup message. If UE is
configured with SUL carrier, UE reports both UL and SUL Direct Current locations.
reportUplinkTxDirectCurrentMoreCarrier
Enables reporting of uplink Direct Current location information when the UE is configured with intra-band CA. This
field is absent in the IE CellGroupConfig when provided as part of RRCSetup message. The UE only reports the
uplink Direct Current location information that are related to the indicated cc-CombinationList. The network does
not include carriers which locate in DL only spectrum described in TS 38.101-2 [39], clause 5.3A.4 and defined by
Fsd according to Table 5.3A.4-3 in FR2 in the IntraBandCC-CombinationReqList. E.g. DL-only carrier in FR2
frequency spectrum is not used to calculate the default DC location.
reportUplinkTxDirectCurrentTwoCarrier
Enables reporting of uplink Direct Current location information when the UE is configured with uplink intra-band
CA with two carriers. This field is absent in the IE CellGroupConfig when provided as part of RRCSetup message.
Rlc-BearerToReleaseListExt
List of the RLC entities and the corresponding MAC Logical Channels to be released for multicast MRBs.
riminSyncOutOfSync Threshold
BLER threshold pair index for IS/OOS indication generation, see TS 38.133 [14], table 8.1.1-1. N1 corresponds to
the value 1. When the field is absent, the UE applies the value 0. Whenever this is reconfigured, UE resets N310
and N311, and stops T310, if running. Network does not include this field.
sCellSIB20
This field is used to transfer SIB20 of the SCell in order to allow the UE for MBS broadcast reception on SCell.
The network configures this field only for a single SCell at a time.
sCellState
Indicates whether the SCell shall be considered to be in activated state upon SCell configuration. If the field is
included for an SCell configured with TRS for fast activation of the SCell, such TRS is not used for the
corresponding SCell.
sCellToAddModList
List of secondary serving cells (SCells) to be added or modified.
sCellToReleaseList
List of secondary serving cells (SCells) to be released.
secondaryDRX-GroupConfig
The field is used to indicate whether the SCell belongs to the secondary DRX group. All serving cells in the
secondary DRX group shall belong to one Frequency Range and all serving cells in the legacy DRX group shall
belong to another Frequency Range.
simultaneousSpatial-UpdatedList1, simultaneousSpatial-UpdatedList2
List of serving cells which can be updated simultaneously for spatial relation with a MAC CE. The
simultaneousSpatial-UpdatedList1 and simultaneousSpatial-UpdatedList2 shall not contain same serving cells.
Network should not configure serving cells that are configured with a BWP with two different values for the
coresetPoolIndex in these lists.
simultaneousTCI-UpdateList1, simultaneousTCI-UpdateList2
List of serving cells which can be updated simultaneously for TCI relation with a MAC CE. The simultaneous TCI-
UpdateList1 and simultaneous TCI-UpdateList2 shall not contain same serving cells. Network should not configure
serving cells that are configured with a BWP with two different values for the coresetPoolIndex in these lists.
simultaneousU-TCI-UpdateList1, simultaneousU-TCI-UpdateList2, simultaneousU-TCI-UpdateList3,
simultaneousU-TCI-UpdateList4
List of serving cells for which the Unified TCI States Activation/Deactivation MAC CE applies simultaneously, as
specified in [TS38321] clause 6.1.3.47. The different lists shall not contain same serving cells. Network only
configures in these lists serving cells that are configured with unifiedTCI-State Type.
spCellConfig
Parameters for the SpCell of this cell group (Pcell of MCG or PSCell of SCG).
uplinkTxSwitchingOption
Indicates which option is configured for dynamic UL Tx switching for inter-band UL CA or (NG)EN-DC. The field is
set to switchedUL if network configures option 1 as specified in [TS38214], or dualUL if network configures option
2 as specified in [TS38214]. Network always configures UE with a value for this field in inter-band UL CA case
and (NG)EN-DC case where UE supports dynamic UL Tx switching.
uplinkTxSwitchingPowerBoosting
Indicates whether the UE is allowed to enable 3 dB boosting on the maximum output power for transmission on
carrier2 under the operation state in which 2-port transmission can be supported on carrier2 for inter-band UL CA
case with dynamic UL Tx switching as defined in TS 38.101-1 [15]. Network can only configure this field for
dynamic UL Tx switching in inter-band UL CA case with power Class 3 as defined in TS 38.101-1 [15].
uplinkTxSwitching-2T-Mode
Indicates 2Tx-2Tx switching mode is configured for inter-band UL CA or SUL, in which the switching gap duration
for a triggered uplink switching (as specified in [TS38214]) is equal to the switching time capability value reported
for the switching mode.
If this field is absent and uplinkTxSwitching is configured, it is interpreted that 1Tx-2Tx UL Tx switching is
configured as specified in [TS38214]. In this case, there is one uplink (or one uplink band in case of intra-band)
configured with uplinkTxSwitching, on which the maximum number of antenna ports among all configured P-
SRS/A-SRS and activated SP-SRS resources should be 1 and non-codebook based UL MIMO is not configured.
uplinkTxSwitching-DualUL-TxState
Indicates the state of Tx chains if the state of Tx chains after the UL Tx switching is not unique (as specified in
[TS38214]) in case of 2Tx-2Tx switching is configured and uplinkTxSwitchingOption is set to dualUL. Value oneT
indicates 1Tx is assumed to be supported on the carriers on each band, value twoT indicates 2Tx is assumed to
be supported on that carrier.
uu-RelayRLC-ChannelToAddModList
List of the Uu RLC entities and the corresponding MAC Logical Channels to be added or modified.
uu-RelayRLC-ChannelToReleaseList
List of the Uu RLC entities and the corresponding MAC Logical Channels to be released.
DeactivatedSCG-Config field descriptions
bfd-and-RLM
If the field is set to true, the UE shall perform RLM and BFD on the PSCell when the SCG is deactivated and the
network ensures that beamFailure-r17 is not configured in the radioLinkMonitoringConfig of the DL BWP of the
PSCell in which the UE performs BFD. If set to false, the UE is not required to perform RLM and BFD on the
PSCell when the SCG is deactivated.
DAPS-UplinkPowerConfig field descriptions
p-DAPS-Source
The maximum total transmit power to be used by the UE in the source cell group during DAPS handover.
p-DAPS-Target
The maximum total transmit power to be used by the UE in the target cell group during DAPS handover.
uplinkPowerSharingDAPS-Mode
Indicates the uplink power sharing mode that the UE uses in DAPS handover (see TS 38.213 [13]).
GoodServingCellEvaluation field descriptions
offset
The parameter “X” (dB) for the good serving cell quality criterion in RRC_CONNECTED, for a cell operating in
FR1 and FR2, respectively. If this field is absent, the UE applies the (default) value of 0 dB for “X”.
IAB-ResourceConfig field descriptions
iab-ResourceConfigID
This ID is used to indicate the specific resource configuration addressed by the MAC Ces specified in [TS38321].
periodicitySlotList
Indicates the periodicity in ms of the list of slot indexes indicated in slotList.
slotList
Indicates the list of slot indexes to which the information indicated in the specific MAC CE applies to, as specified
in [TS38321]. The values of the entries in the slotList are strictly less than the value of the periodicitySlotList.
slotListSubcarrierSpacing
Subcarrier spacing used as reference for the slotList configuration.
Only the following values are applicable depending on the used frequency:
FR1: 15 or 30 KHz
FR2-1: 60 or 120 KHz
FR2-2: 120 or 480 kHz
ReconfigurationWithSync field descriptions
rach-ConfigDedicated
Random access configuration to be used for the reconfiguration with sync (e.g., handover). The UE performs the
RA according to these parameters in the firstActiveUplinkBWP (see UplinkConfig).
Smtc
The SSB periodicity/offset/duration configuration of target cell for NR PSCell change and NR Pcell change. The
network sets the periodicityAndOffset to indicate the same periodicity as ssb-periodicityServingCell in
spCellConfigCommon or sets to the same periodicity as ssb-Periodicity-r17 in nonCellDefiningSSB-r17 if the first
active DL BWP included in this RRC message is configured with nonCellDefiningSSB-r17 for RedCap.
For case of NR Pcell change, the smtc is based on the timing reference of (source) Pcell. For case of NR PSCell
change, it is based on the timing reference of source PSCell.
If both this field and targetCellSMTC-SCG are absent, the UE uses the SMTC in the measObjectNR having the
same SSB frequency and subcarrier spacing, as configured before the reception of the RRC message. For a
RedCap UE, if the first active DL BWP included in this RRC message is configured with nonCellDefiningSSB-r17,
this field corresponds to the NCD-SSB indicated by nonCellDefiningSSB-r17, otherwise, this field corresponds to
the CD-SSB indicated by absoluteFrequencySSB in frequencyInfoDL.
ReportUplinkTxDirectCurrentMoreCarrier field descriptions
IntraBandCC-Combination
Indicates the state of the carriers and BWPs indexes of the carriers in a CC combination, each carrier in this
combination corresponds to an entry in servCellIndexList with same order. This IE shall have the same size as
servCellIndexList.
IntraBandCC-CombinationReqList
Indicates the list of the requested carriers/BWPs combinations for an intra-band CA component.
servCellIndexList
indicates the list of cell index for an intra-band CA component.
ScellConfig field descriptions
goodServingCellEvaluationBFD
Indicates the criterion for a UE to detect the good serving cell quality for BFD relaxation in an SCell in
RRC_CONNECTED. This field is always configured when the network enables BFD relaxation for the UE in this
SCell. This field is absent if failureDetectionSetN is present for the SCell.
preConfGapStatus
Indicates whether the pre-configured measurement gaps (e.g., the gaps configured with preConfigInd) are
activated or deactivated while this SCell is deactivated. If this field is configured, the UE shall apply network-
controlled mechanism for activation and deactivation of the pre-configured measurement gaps, otherwise the UE
shall apply the autonomous activation/deactivation mechanism, as specified in TS 38.133 [14]. The first/leftmost
bit corresponds to the measurement gap with gap ID 1, the second bit corresponds to measurement gap with gap
ID 2, and so on. Value 0 indicates that the corresponding pre-configured measurement gap is deactivated while
value 1 indicates that the corresponding pre-configured measurement gap is activated. The UE shall ignore the
bit if the corresponding measurement gap is not a pre-configured measurement gap.
Smtc
The SSB periodicity/offset/duration configuration of target cell for NR SCell addition. The network sets the
periodicityAndOffset to indicate the same periodicity as ssb-periodicityServingCell in sCellConfigCommon. The
smtc is based on the timing of the SpCell of associated cell group. In case of inter-RAT handover to NR, the
timing reference is the NR Pcell. In case of intra-NR Pcell change (standalone NR) or NR PSCell change (EN-
DC), the timing reference is the target SpCell. If the field is absent, the UE uses the SMTC in the measObjectNR
having the same SSB frequency and subcarrier spacing, as configured before the reception of the RRC message.
SpCellConfig field descriptions
deactivatedSCG-Config
Configuration applicable when the SCG is deactivated. The network always configures this field before or when
indicating that the SCG is deactivated in an RRCReconfiguration, RRCResume, E-UTRA
RRCConnectionReconfiguration or E-UTRA RRCConnectionResume message.
goodServingCellEvaluationBFD
Indicates the criterion for a UE to detect the good serving cell quality for BFD relaxation in the SpCell in
RRC_CONNECTED. The field is always configured when the network enables BFD relaxation for the UE in this
SpCell. This field is absent if failureDetectionSetN is present for the SpCell.
goodServingCellEvaluationRLM
Indicates the criterion for a UE to detect the good serving cell quality for RLM relaxation in the SpCell in
RRC_CONNECTED. The field is always configured when the network enables RLM relaxation for the UE in this
SpCell.
lowMobilityEvaluationConnected
Indicates the criterion for a UE to detect low mobility in RRC_CONNECTED in an SpCell. The s-SearchDeltaP-
Connected is the parameter “S_{SearchDeltaP-connected}”. Value dB3 corresponds to 3 dB, dB6 corresponds to 6 dB and
so on. The t-SearchDeltaP-Connected is the parameter “T_{SearchDeltaP-Connected}”. Value s5 means 5 seconds, value
s10 means 10 seconds and so on. Low mobility criterion is configured in NR Pcell for the case of NR SA/NR CA/
NE-DC/NR-DC, and in the NR PSCell for the case of EN-DC.
reconfigurationWithSync
Parameters for the synchronous reconfiguration to the target SpCell.
Rlf-TimersAndConstants
Timers and constants for detecting and triggering cell-level radio link failure. For the SCG, rlf-
TimersAndConstants can only be set to setup and is always included at SCG addition.
servCellIndex
Serving cell ID of a PSCell. The Pcell of the Master Cell Group uses ID = 0.
SL-PathSwitchConfig field descriptions
targetRelayUE-Identity
Indicates the L2 source ID of the target L2 U2N Relay UE during path switch.
T420
Indicates the timer value of T420 to be used during path switch.

TABLE 8.4.1-3

| Conditional Presence | Explanation |
|---|---|
| 2Tx | The field is optionally present, Need R, if uplinkTxSwitching is configured; |
| | otherwise it is absent, Need R. |
| BWP-Reconfig | The field is optionally present, Need N, if the BWPs are reconfigured or if serving |
| | cells are added or removed. Otherwise it is absent. |
| DirectToIndirect-PathSwitch | The field is mandatory present for the L2 U2N remote UE at path switch to the |
| | target L2 U2N Relay UE. It is absent otherwise. |
| DRX-Config2 | The field is optionally present, Need N, if drx-ConfigSecondaryGroup is |
| | configured. It is absent otherwise. |
| LTM-Candidate | The field is mandatory present, Need M, if the CellGroupConfig IE is part of ltm- |
| | CandidateConfig within ltm-Config. It is absent otherwise. |
| LTM-Config | This field is mandatory present, Need M, if ltm-Config is included with the |
| | RRCReconfiguration message. It is absent otherwise. |
| PreConfigMG | The field is optionally present, Need R, if there is at least one per UE gap |
| | configured with preConfigInd or there is at least one per FR gap of the same FR |
| | which the SCell belongs to and configured with preConfigInd. It is absent, Need |
| | R, otherwise. |
| ReconfWithSync | The field is mandatory present in the RRCReconfiguration message: |
| | in each configured CellGroupConfig for which the SpCell changes, |
| | in the masterCellGroup: |
| | at change of AS security key derived from K_{gNB}, |
| | in an RRCReconfiguration message contained in a |
| | DLInformation TransferMRDC message, |
| | path switch of L2 U2N remote UE to the target PCell, |
| | path switch of L2 U2N remote UE to the target L2 U2N Relay UE, |
| | in the secondaryCellGroup at: |
| | PSCell addition, |
| | SCG resume with NR-DC or (NG)EN-DC, |
| | update of required SI for PSCell, |
| | change of AS security key derived from S-K_{gNB} in NR-DC while the |
| | UE is configured with at least one radio bearer with keyToUse set |
| | to secondary and that is not released by this RRCReconfiguration |
| | message, |
| | MN handover in (NG)EN-DC. |
| | Otherwise, it is optionally present, need M. The field is absent in the |
| | masterCellGroup in RRCResume and RRCSetup messages and is absent in the |
| | masterCellGroup in RRCReconfiguration messages if source configuration is not |
| | released during DAPS handover. The field is also absent in the masterCellGroup |
| | and secondaryCellGroup if the CellGroupConfig IE is included within ltm-Config. |
| ScellAdd | The field is mandatory present upon SCell addition; otherwise it is absent, Need |
| | M. |
| ScellAddMod | The field is mandatory present upon SCell addition; otherwise it is optionally |
| | present, need M. |
| ScellAddSync | The field is optionally present, Need N: |
| | in the masterCellGroup at |
| | SCell addition, |
| | reconfiguration with sync, |
| | resume of an RRC connection. |
| | in the secondaryCellGroup, when the SCG is not indicated as deactivated |
| | at: |
| | SCG activation while the SCG was previously deactivated, |
| | SCell addition, |
| | reconfiguration with sync. |
| | It is absent otherwise. |
| SCG | The field is mandatory present in an SpCellConfig for the PSCell. It is absent |
| | otherwise. |
| SCG-Opt | The field is optionally present, Need M, in an SpCellConfig for the PSCell. It is |
| | absent otherwise. |

In case of change of AS security key derived from S-K_{gNB}/S-K_{eNB}, if reconfigurationWithSync is not included in the masterCellGroup, the network releases all existing MCG RLC bearers associated with a radio bearer with keyToUse set to secondary. In case of change of AS security key derived from K_{gNB}/K_{eNB}, if reconfigurationWithSync is not included in the secondaryCellGroup, the network releases all existing SCG RLC bearers associated with a radio bearer with keyToUse set to primary.

8.4.2. CondReconfigId

The IE CondReconfigId is used to identify a CHO, CPA or CPC configuration. An example CondReconfigId IE is shown and described by table 8.4.2-1.

TABLE 8.4.2-1
CondReconfigId information element

-- ASN1START
-- TAG-CONDRECONFIGID-START
-- CondReconfigId-r16 ::= INTEGER (1..maxNrofCondCells-r16)
-- TAG-CONDRECONFIGID-STOP
-- ASN1STOP

8.4.3. CondReconfigToAddModList

The IE CondReconfigToAddModList concerns a list of conditional reconfigurations to add or modify, with for each entry the condReconfigId and the associated condExecutionCond/condExecutionCondSCG and condRRCReconfig. An example CondReconfigToAddModList IE is shown and described by tables 8.4.3-1, 8.4.3-2, and 8.4.3-3.

TABLE 8.4.3-1
CondReconfigToAddModList information element

```
-- ASN1 START
-- TAG-CONDRECONFIGTOADDMODLIST-START
CondReconfigToAddModList-r16 ::= SEQUENCE (SIZE (1..maxNrofCondCells-r16)) OF
CondReconfigToAddMod-r16
CondReconfigToAddMod-r16 ::= SEQUENCE {
  condReconfigId-r16 CondReconfigId-r16,
  condExecutionCond-r16 SEQUENCE (SIZE (1..2)) OF MeasId OPTIONAL, -- Need M
  condRRCReconfig-r16 OCTET STRING (CONTAINING RRCReconfiguration) OPTIONAL, -- Cond
condReconfigAdd
  ...,
  [[
  condExecutionCondSCG-r17 OCTET STRING (CONTAINING CondReconfigExecCondSCG-r17) OPTIONAL -- Need
M
  ]]
}
CondReconfigExecCondSCG-r17 ::= SEQUENCE (SIZE (1..2)) OF MeasId
-- TAG-CONDRECONFIGTOADDMODLIST-STOP
-- ASN1STOP
```

In some examples, it is FFS on whether candidate SN can generate the execution condition for subsequent CPC for MN initiated case. Additionally or alternatively, it is FFS on whether A3/A5 event are supported for MN-initiated case. If not, whether different triggering conditions (e.g., two A4 events) are needed for a candidate for initial and subsequent CPC. Additionally or alternatively, it is FFS on how to differentiate the execution conditions for CPA and CPC if two trigger conditions of a candidate are provided to the UE 5402. Additionally or alternatively, it is FFS on whether CPA configuration can be used for CPC by default. If not, whether to introduce an additional indication to indicate that the CPA candidate configuration can be used for subsequent CPC or not.

TABLE 8.4.3-2
field descriptions
CondReconfigToAddMod field descriptions
condExecutionCond
The execution condition that needs to be fulfilled in order to trigger the execution of a conditional reconfiguration
for CHO, CPA, intra-SN CPC without MN involvement, MN initiated inter-SN CPC or SNthe network only indicates
MeasId(s) associated with condEventA3 or condEventA5.
CondReconfig ToAddMod field descriptions
condExecutionCondSCG
Contains execution condition that needs to be fulfilled in order to trigger the execution of a conditional
reconfiguration for SN initiated inter-SN CPC or SN initiated Subsequent CPAC. The Meas Ids refer to the
measConfig associated with the SCG. When configuring 2 triggering events (Meas Ids) for a candidate cell,
network ensures that both refer to the same measObject. For each condReconfigld, the network always configures
either condExecutionCond or condExecutionCondSCG (not both). The network only indicates Measld(s)
associated with condEventA3 or condEventA5.
condRRCReconfig
The RRCReconfiguration message to be applied when the condition(s) are fulfilled. The RRCReconfiguration
message contained in condRRCReconfig cannot contain the field conditionalReconfiguration containing
condRRCReconfig or the field daps-Config.

TABLE 8.4.3-3

| Conditional Presence | Explanation |
|---|---|
| condReconfigAdd | The field is mandatory present when a condReconfigId is being added. |
| | Otherwise the field is optional, need M. |

In some examples, for SN-initiated SCG selective activation, a candidate SN generates execution conditions for subsequent CPC. To allow candidate SN to generate the execution condition for subsequent CPC, the RRCReconfiguration message contained in condRRCReconfig may include the conditionalReconfiguration IE containing the execution conditions used for subsequent CPC. In some examples, nested configuration for candidate cell configuration may or may not be supported. In some examples, nested conditional reconfigurations may be prohibit while including execution condition in each candidate cell config for subsequent CPC is allowed. Additionally or alternatively, the conditionalReconfiguration contains the execution conditions for other candidate cells, which are generated by candidate SN for SCPAC procedure.

8.4.4. ConditionalReconfiguration

The IE ConditionalReconfiguration is used to add, modify and release the configuration of conditional reconfiguration. An example ConditionalReconfiguration IE is shown and described by tables [0518]-1, [0518]-2, and [0518]-3.

TABLE [0518]-1
ConditionalReconfiguration information element

```
-- ASN1 START
-- TAG-CONDITIONALRECONFIGURATION-START
ConditionalReconfiguration-r16 ::= SEQUENCE {
  attemptCondReconfig-r16 ENUMERATED {true} OPTIONAL, -- Cond CHO
  condReconfigToRemoveList-r16 CondReconfigToRemoveList-r16 OPTIONAL, -- Need N
  condReconfigToAddModList-r16 CondReconfigToAddModList-r16 OPTIONAL, -- Need N
    ...,
    [[
    scpac-ReferenceConfiguration-r18 OCTET STRING (CONTAINING RRCReconfiguration) OPTIONAL, --
Need FFS
    ]]
}
CondReconfigToRemoveList-r16 ::= SEQUENCE (SIZE (1..maxNrofCondCells-r16)) OF CondReconfigId-r16
-- TAG-CONDITIONALRECONFIGURATION-STOP
-- ASN1STOP
```

In some examples, it is FFS on whether MCG configuration is included in reference configuration. Additionally or alternatively, it is FFS on the RRC model of reference configuration. Additionally or alternatively, it is FFS on whether to introduce an indication to differentiate SCPAC and R16/17 CPA/CPC candidates. FFS on the granularity of the indication, e.g., per candidate or per conditional reconfiguration. Additionally or alternatively, it is FFS FFS on how to provide the SN counter values associated with each candidate SN.

TABLE [0518]-2
ConditionalReconfiguration field descriptions

attemptCondReconfig
If present, the UE shall perform conditional reconfiguration if selected cell is a target candidate cell and
it is the first cell selection after failure as described in clause 5.3.7.3 of [TS38331].
condReconfigToAddModList
List of the configuration of candidate SpCells to be added or modified for CHO, CPA or CPC.
condReconfigToRemoveList
List of the configuration of candidate SpCells to be removed.
scpac-ReferenceConfiguration
Includes the reference configuration for Subsequent CPAC candidates.

TABLE [0518]-3

| Conditional Presence | Explanation |
|---|---|
| CHO | The field is optional present, Need R, if the UE is configured with at least a |
| | candidate SpCell for CHO. Otherwise the field is not present. |

8.4.5. CSI-MeasConfig

The IE CSI-MeasConfig is used to configure CSI-RS (reference signals) belonging to the serving cell in which CSI-MeasConfig is included, channel state information reports to be transmitted on PUCCH on the serving cell in which CSI-MeasConfig is included and channel state information reports on PUSCH triggered by DCI received on the serving cell in which CSI-MeasConfig is included. See also [TS38214], clause 5.2. An example CSI-MeasConfig IE is shown and described by tables 8.4.5-1 and 8.4.5-2.

TABLE 8.4.5-1
CSI-MeasConfig information element

```
-- ASN1START
TAG-CSI-MEASCONFIG-START
CSI-MeasConfig ::= SEQUENCE {
  nzp-CSI-RS-ResourceToAddModList SEQUENCE (SIZE (1..maxNrofNZP-CSI-RS-Resources)) OF NZP-CSI-RS-
Resource OPTIONAL, -- Need N
  nzp-CSI-RS-ResourceToReleaseList SEQUENCE (SIZE (1..maxNrofNZP-CSI-RS-Resources)) OF NZP-CSI-RS-
ResourceId OPTIONAL, -- Need N
  nzp-CSI-RS-ResourceSetToAddModList SEQUENCE (SIZE (1..maxNrofNZP-CSI-RS-ResourceSets)) OF NZP-
CSI-RS-ResourceSet
  OPTIONAL, -- Need N
  nzp-CSI-RS-ResourceSetToReleaseList SEQUENCE (SIZE (1..maxNrofNZP-CSI-RS-ResourceSets)) OF NZP-
CSI-RS-ResourceSetId
  OPTIONAL, -- Need N
  csi-IM-ResourceToAddModList SEQUENCE (SIZE (1..maxNrofCSI-IM-Resources)) OF CSI-IM-Resource
OPTIONAL, -- Need N
  csi-IM-ResourceToReleaseList SEQUENCE (SIZE (1..maxNrofCSI-IM-Resources)) OF CSI-IM-ResourceId
OPTIONAL, -- Need N
  csi-IM-ResourceSetToAddModList SEQUENCE (SIZE (1..maxNrofCSI-IM-ResourceSets)) OF CSI-IM-
ResourceSet OPTIONAL, -- Need N
  csi-IM-ResourceSetToReleaseList SEQUENCE (SIZE (1..maxNrofCSI-IM-ResourceSets)) OF CSI-IM-
ResourceSetId OPTIONAL, -- Need N
  csi-SSB-ResourceSetToAddModList SEQUENCE (SIZE (1..maxNrofCSI-SSB-ResourceSets)) OF CSI-SSB-
ResourceSet OPTIONAL, -- Need N
  csi-SSB-ResourceSetToReleaseList SEQUENCE (SIZE (1..maxNrofCSI-SSB-ResourceSets)) OF CSI-SSB-
ResourceSetId OPTIONAL, -- Need N
  csi-ResourceConfigToAddModList SEQUENCE (SIZE (1..maxNrofCSI-ResourceConfigurations)) OF CSI-
ResourceConfig
  OPTIONAL, -- Need N
  csi-ResourceConfigToReleaseList SEQUENCE (SIZE (1..maxNrofCSI-ResourceConfigurations)) OF CSI-
ResourceConfigId
  OPTIONAL, -- Need N
  csi-ReportConfigToAddModList SEQUENCE (SIZE (1..maxNrofCSI-ReportConfigurations)) OF CSI-
ReportConfig OPTIONAL, -- Need N
  csi-ReportConfigToReleaseList SEQUENCE (SIZE (1..maxNrofCSI-ReportConfigurations)) OF CSI-
ReportConfigId
  OPTIONAL, -- Need N
  reportTriggerSize INTEGER (0..6) OPTIONAL, -- Need M
  aperiodicTriggerStateList SetupRelease { CSI-AperiodicTriggerStateList } OPTIONAL, -- Need M
  semiPersistentOnPUSCH-TriggerStateList SetupRelease { CSI-SemiPersistentOnPUSCH-
TriggerStateList } OPTIONAL, -- Need M
  ...,
  [[
  reportTriggerSizeDCI-0-2-r16 INTEGER (0..6) OPTIONAL -- Need R
  ]],
  [[
  sCellActivationRS-ConfigToAddModList-r17 SEQUENCE (SIZE (1..maxNrofSCellActRS-r17)) OF
SCellActivationRS-Config-r17 OPTIONAL, -- Need N
  sCellActivationRS-ConfigToReleaseList-r17 SEQUENCE (SIZE (1..maxNrofSCellActRS-r17)) OF
SCellActivationRS-ConfigId-r17 OPTIONAL -- Need N
  ]],
  [[
  ltm-CSI-ReportConfigToAddModList SEQUENCE (SIZE (1..maxNrofCSI-ReportConfigurations)) OF LTM-
CSI-ReportConfig OPTIONAL, -- Need N
  ltm-CSI-ReportConfigToReleaseList SEQUENCE (SIZE (1..maxNrofCSI-ReportConfigurations)) OF LTM-
CSI-ReportConfigId
  OPTIONAL, Need N
  ]]
}
-- TAG-CSI-MEASCONFIG-STOP
-- ASN1STOP
```

TABLE 8.4.5-2
CSI-MeasConfig field descriptions

aperiodicTriggerStateList
Contains trigger states for dynamically selecting one or more aperiodic and semi-persistent reporting
configurations and/or triggering one or more aperiodic CSI-RS resource sets for channel and/or interference
measurement (see [TS38214], clause 5.2.1).
csi-IM-ResourceSetToAddModList
Pool of CSI-IM-ResourceSet which can be referred to from CSI-ResourceConfig or from MAC CEs.
csi-IM-ResourceToAddModList
Pool of CSI-IM-Resource which can be referred to from CSI-IM-ResourceSet.
csi-ReportConfigToAddModList
Configured CSI report settings as specified in [TS38214] clause 5.2.1.1.
csi-ResourceConfigToAddModList
Configured CSI resource settings as specified in [TS38214] clause 5.2.1.2.
csi-SSB-ResourceSetToAddModList
Pool of CSI-SSB-ResourceSet which can be referred to from CSI-ResourceConfig.
ltm-CSI-ReportConfigToAddModList
Configured CSI report settings for LTM as specified in TS 38.xxx [XX].
nzp-CSI-RS-ResourceSetToAddModList
Pool of NZP-CSI-RS-ResourceSet which can be referred to from CSI-ResourceConfig or from MAC CEs.
nzp-CSI-RS-ResourceToAddModList
Pool of NZP-CSI-RS-Resource which can be referred to from NZP-CSI-RS-ResourceSet.
reportTriggerSize, reportTriggerSizeDCI-0-2
Size of CSI request field in DCI (bits) (see [TS38214], clause 5.2.1.5.1). The field reportTriggerSize applies to
DCI format 0_1 and the field reportTriggerSizeDCI-0-2 applies to DCI format 0_2 (see [TS38214], clause
5.2.1.5.1).
scellActivationRS-ConfigToAddModList
Configured RS for fast SCell activation as specified in [TS38214] clause x.y.z.

8.4.6. RadioBearerConfig

The IE RadioBearerConfig is used to add, modify and release signalling, multicast MRBs and/or data radio bearers. Specifically, this IE carries the parameters for PDCP and, if applicable, SDAP entities for the radio bearers. An example RadioBearerConfig IE is shown and described by tables 8.4.6-1, 8.4.6-2, and 8.4.6-3.

TABLE 8.4.6-1
RadioBearerConfig information element

```
-- ASN1START
-- TAG-RADIOBEARERCONFIG-START
RadioBearerConfig ::= SEQUENCE {
  srb-ToAddModList SRB-ToAddModList OPTIONAL, -- Cond HO-Conn
  srb3-ToRelease ENUMERATED{true} OPTIONAL, -- Need N
  drb-ToAddModList DRB-ToAddModList OPTIONAL, -- Cond HO-toNR
  drb-ToReleaseList DRB-ToReleaseList OPTIONAL, -- Need N
  securityConfig SecurityConfig OPTIONAL, -- Need M
  ...,
  [[
  mrb-ToAddModList-r17 MRB-ToAddModList-r17 OPTIONAL, -- Need N
  mrb-ToReleaseList-r17 MRB-ToReleaseList-r17 OPTIONAL, -- Need N
  srb4-ToAddMod-r17 SRB-ToAddMod OPTIONAL, -- Need N
  srb4-ToRelease-r17 ENUMERATED{true} OPTIONAL -- Need N
  ]]
}
SRB-ToAddModList ::= SEQUENCE (SIZE (1..2)) OF SRB-ToAddMod
SRB-ToAddMod ::= SEQUENCE {
  srb-Identity SRB-Identity,
  reestablishPDCP ENUMERATED{true} OPTIONAL, -- Need N
  discardOnPDCP ENUMERATED{true} OPTIONAL, -- Need N
  pdcp-Config PDCP-Config OPTIONAL, -- Cond PDCP
  ...,
  [[
  srb-Identity-v1700 SRB-Identity-v1700 OPTIONAL -- Need M
  ]]
}
DRB-ToAddModList ::= SEQUENCE (SIZE (1..maxDRB)) OF DRB-ToAddMod
DRB-ToAddMod ::= SEQUENCE {
  cnAssociation CHOICE {
  eps-BearerIdentity INTEGER (0..15),
  sdap-Config SDAP-Config
  } OPTIONAL, -- Cond DRBSetup
  drb-Identity DRB-Identity,
  reestablishPDCP ENUMERATED{true} OPTIONAL, -- Need N
  recoverPDCP ENUMERATED{true} OPTIONAL, -- Need N
  pdcp-Config PDCP-Config OPTIONAL, -- Cond PDCP
  ...,
  [[
  daps-Config-r16 ENUMERATED{true} OPTIONAL -- Cond DAPS
  ]]
}
DRB-ToReleaseList ::= SEQUENCE (SIZE (1..maxDRB)) OF DRB-Identity
SecurityConfig ::= SEQUENCE {
  securityAlgorithmConfig SecurityAlgorithmConfig OPTIONAL, -- Cond RBTermChange1
  keyToUse ENUMERATED{master, secondary} OPTIONAL, -- Cond RBTermChange
  ...
}
MRB-ToAddModList-r17 ::= SEQUENCE (SIZE (1..maxMRB-r17)) OF MRB-ToAddMod-r17
MRB-ToAddMod-r17 ::= SEQUENCE {
  mbs-SessionId-r17 TMGI-r17 OPTIONAL, -- Cond MRBSetup
  mrb-Identity-r17 MRB-Identity-r17,
  mrb-IdentityNew-r17 MRB-Identity-r17 OPTIONAL, -- Need N
  reestablishPDCP-r17 ENUMERATED{true} OPTIONAL, -- Need N
  recoverPDCP-r17 ENUMERATED{true} OPTIONAL, -- Need N
  pdcp-Config-r17 PDCP-Config OPTIONAL, -- Cond PDCP
  ...
}
MRB-ToReleaseList-r17 ::= SEQUENCE (SIZE (1..maxMRB-r17)) OF MRB-Identity-r17
-- TAG-RADIOBEARERCONFIG-STOP
-- ASN1STOP
```

TABLE 8.4.6-2
RadioBearerConfig IE field descriptions
DRB-ToAddMod and MRB-ToAddMod field descriptions
cnAssociation
Indicates if the bearer is associated with the eps-bearerIdentity (when connected to EPC) or sdap-Config (when
connected to 5GC).
daps-Config
Indicates that the bearer is configured as DAPS bearer.
drb-Identity
In case of DC, the DRB identity is unique within the scope of the UE, e.g. an MCG DRB cannot use the same
value as a split DRB. For a split DRB the same identity is used for the MCG and SCG parts of the configuration.
eps-BearerIdentity
The EPS bearer ID determines the EPS bearer.
mbs-SessionId
Indicates which multicast MBS session the bearer is associated with.
mrb-Identity
Identification of the multicast MRB.
mrb-IdentityNew
New identity of the multicast MRB when mrb-Identity needs to be changed, e.g. as a result of a handover.
reestablishPDCP
Indicates that PDCP should be re-established. Network sets this to true whenever the security key used for this
radio bearer changes. Key change could for example be due to termination point change for the bearer,
reconfiguration with sync, resuming an RRC connection, or the first reconfiguration after reestablishment. It is
also applicable for LTE procedures when NR PDCP is configured. Network doesn't include this field for DRB if the
bearer is configured as DAPS bearer.
recoverPDCP
Indicates that PDCP should perform recovery according to [TS38323]. Network doesn't include this field if the
bearer is configured as DAPS bearer or if the RadioBearerConfig IE is part of an RRCReconfiguration message
within the LTM-Config IE.
sdap-Config
The SDAP configuration determines how to map QoS flows to DRBs when NR or E-UTRA connects to the 5GC
and presence/absence of UL/DL SDAP headers.
RadioBearerConfig field descriptions
securityConfig
Indicates the security algorithm and key to use for the signalling and data radio bearers configured with the list in
this IE RadioBearerConfig. When the field is not included after AS security has been activated, the UE shall
continue to use the currently configured keyToUse and security algorithm for the radio bearers reconfigured with
the lists in this IE RadioBearerConfig. The field is not included when configuring SRB1 before AS security is
activated.
srb3-ToRelease
Release SRB3. SRB3 release can only be done over SRB1 and only at SCG release and reconfiguration with
sync.
SecurityConfig field descriptions
keyToUse
Indicates if the bearers configured with the list in this IE RadioBearerConfig are using the master key or the
secondary key for deriving ciphering and/or integrity protection keys. For MR-DC, network should not configure
SRB1 and SRB2 with secondary key and SRB3 with the master key. When the field is not included, the UE shall
continue to use the currently configured keyToUse for the radio bearers reconfigured with the lists in this IE
RadioBearerConfig.
securityAlgorithmConfig
Indicates the security algorithm for the signalling and data radio bearers configured with the list in this IE
RadioBearerConfig. When the field is not included, the UE shall continue to use the currently configured security
algorithm for the radio bearers reconfigured with the lists in this IE RadioBearerConfig.
SRB-ToAddMod field descriptions
discardOnPDCP
Indicates that PDCP should discard stored SDU and PDU according to [TS38323].
reestablishPDCP
Indicates that PDCP should be re-established. Network sets this to true whenever the security key used for this
radio bearer changes. Key change could for example be due to reconfiguration with sync, for SRB2 when
resuming an RRC connection, or at the first reconfiguration after RRC connection reestablishment in NR. For
SRB1, when resuming an RRC connection, or at the first reconfiguration after RRC connection reestablishment in
NR, the network does not set this field to true. For LTE SRBs using NR PDCP, it could be for handover, RRC
connection reestablishment or resume. Network doesn't include this field if any DAPS bearer is configured.
srb-Identity, srb-Identity-v1700
Value 1 is applicable for SRB1 only. Value 2 is applicable for SRB2 only. Value 3 is applicable for SRB3 only.
Value 4 is applicable for SRB4 only. If srb-Identity-v1700 is received for an SRB, the UE shall ignore srb-Identity
(e.g., without suffix) for this SRB.

TABLE 8.4.6-3

| Conditional Presence | Explanation |
|---|---|
| RBTermChange | The field is mandatory present in case of: |
| | set up of signalling and data radio bearer, |
| | change of termination point for the radio bearer between MN and SN. |
| | It is optionally present otherwise, Need S. |
| RBTermChange1 | The field is mandatory present in case of: |
| | set up of signalling and data radio bearer, |
| | change of termination point for the radio bearer between MN and SN, |
| | handover from E-UTRA/EPC or E-UTRA/5GC to NR, |
| | handover from NR or E-UTRA/EPC to E-UTRA/5GC if the UE supports |
| | NGEN-DC. |
| | It is optionally present otherwise, Need S. |
| PDCP | The field is mandatory present if the corresponding DRB/multicast MRB is being |
| | setup or corresponding DRB/multicast MRB is reconfigured with NR PDCP or |
| | corresponding SRB associated with two RLC entities is being setup or if the number |
| | of RLC bearers associated with the DRB/multicast MRB or SRB is changed. The |
| | field is optionally present, Need S, if the corresponding SRB associated with one |
| | RLC entity is being setup or corresponding SRB is reconfigured with NR PDCP; |
| | otherwise the field is optionally present, need M. |
| DRBSetup | The field is mandatory present if the corresponding DRB is being setup; otherwise |
| | the field is optionally present, need M. |
| HO-Conn | The field is mandatory present |
| | in case of inter-system handover from E-UTRA/EPC to E-UTRA/5GC or NR, |
| | or when the fullConfig is included in the RRCReconfiguration message and |
| | NE-DC/NR-DC is not configured, |
| | or in case of RRCSetup. |
| | Otherwise the field is optionally present, need N. |
| | Upon RRCSetup, only SRB1 can be present. |
| HO-toNR | If mrb-ToAddModList is not included, the field is mandatory present |
| | in case of inter-system handover from E-UTRA/EPC to E-UTRA/5GC or NR, |
| | or when the fullConfig is included in the RRCReconfiguration message and |
| | NE-DC/NR-DC is not configured. |
| | In case of RRCSetup, the field is absent; otherwise the field is optionally present, |
| | need N. |
| DAPS | The field is optionally present, need N, in case masterCellGroup includes |
| | ReconfigurationWithSync, SCell(s) and SCG are not configured, multi-DCI/single- |
| | DCI based multi-TRP are not configured in any DL BWP, supplementaryUplink is not |
| | configured, ethernetHeaderCompression is not configured for the DRB, |
| | conditionalReconfiguration is not configured, and NR sidelink and V2X sidelink are |
| | not configured. Otherwise the field is absent. |
| MRBSetup | The field is mandatory present if the corresponding multicast MRB is being setup; |
| | otherwise the field is optionally present, need M. |

8.4.7. RLC-BearerConfig

The IE RLC-BearerConfig is used to configure an RLC entity, a corresponding logical channel in MAC and the linking to a PDCP entity (served radio bearer). An example RLC-BearerConfig IE is shown and described by tables 8.4.7-1, 8.4.7-2, and 8.4.7-3.

TABLE 8.4.7-1
RLC-BearerConfig information element

```
-- ASN1START
-- TAG-RLC-BEARERCONFIG-START
RLC-BearerConfig ::= SEQUENCE {
  logicalChannelIdentity LogicalChannelIdentity,
  servedRadioBearer CHOICE {
  srb-Identity SRB-Identity,
  drb-Identity DRB-Identity
  } OPTIONAL, -- Cond LCH-SetupOnly
  reestablishRLC ENUMERATED {true} OPTIONAL, -- Need N
  rlc-Config RLC-Config OPTIONAL, -- Cond LCH-Setup
  mac-LogicalChannelConfig LogicalChannelConfig OPTIONAL, -- Cond LCH-Setup
  ...,
  [[
  rlc-Config-v1610 RLC-Config-v1610 OPTIONAL -- Need R
  ]],
  rlc-Config-v1700 RLC-Config-v1700 OPTIONAL, -- Need R
  logicalChannelIdentityExt-r17 LogicalChannelIdentityExt-r17 OPTIONAL, -- Cond LCH-SetupModMRB
  multicastRLC-BearerConfig-r17 MulticastRLC-BearerConfig-r17 OPTIONAL, --Cond LCH-SetupOnlyMRB
  servedRadioBearerSRB4-r17 SRB-Identity-v1700 OPTIONAL -- Need N
  ]]
}
MulticastRLC-BearerConfig-r17 ::= SEQUENCE {
  servedMBS-RadioBearer-r17 MRB-Identity-r17,
  isPTM-Entity-r17 ENUMERATED {true} OPTIONAL -- Need S
}
LogicalChannelIdentityExt-r17 ::= INTEGER (320..65855)
-- TAG-RLC-BEARERCONFIG-STOP
-- ASN1STOP
```

TABLE 8.4.7-2
RLC-BearerConfig field descriptions

isPTM-Entity
If configured, indicates that the RLC entity is used for PTM reception. When the field is absent the RLC entity is
used for PTP transmission/reception.
logicalChannelIdentity
ID used commonly for the MAC logical channel and for the RLC bearer. Value 4 is not configured for DRBs if
SRB4 is configured.
logicalChannelIdentityExt
Extended logical channel ID used commonly for the MAC logical channel and for the RLC bearer for PTM
reception. If this field is configured, the UE shall ignore logicalChannelIdentity.
reestablishRLC
Indicates that RLC should be re-established. Network sets this to true at least whenever the security key used for
the radio bearer associated with this RLC entity changes. For SRB2, multicast MRBs and DRBs, unless full
configuration is used, it is also set to true during the resumption of the RRC connection or the first reconfiguration
after reestablishment. For SRB1, when resuming an RRC connection, or at the first reconfiguration after RRC
connection reestablishment, the network does not set this field to true. The network does not include this field if
the RLC-BearerConfig IE is part of an RRCReconfiguration message within the LTM-Config IE
rlc-Config
Determines the RLC mode (UM, AM) and provides corresponding parameters. RLC mode reconfiguration can
only be performed by DRB/multicast MRB release/addition or full configuration. The network may configure rlc-
Config-v1610 only when rlc-Config (without suffix) is set to am.
servedMBS-RadioBearer
Associates the RLC Bearer with a multicast MRB. The UE shall deliver DL RLC SDUs received via the RLC entity
of this RLC bearer to the PDCP entity of the servedMBS-RadioBearer.
servedRadioBearer, servedRadioBearerSRB4
Associates the RLC Bearer with an SRB or a DRB. The UE shall deliver DL RLC SDUs received via the RLC
entity of this RLC bearer to the PDCP entity of the servedRadioBearer. Furthermore, the UE shall advertise and
deliver uplink PDCP PDUs of the uplink PDCP entity of the servedRadioBearer to the uplink RLC entity of this
RLC bearer unless the uplink scheduling restrictions (more ThanOneRLC in PDCP-Config and the restrictions in
LogicalChannelConfig) forbid it to do so.

TABLE 8.4.7-3

| Conditional Presence | Explanation |
|---|---|
| LCH-Setup | This field is mandatory present upon creation of a new logical channel for a DRB or a |
| | multicast MRB or SRB4. This field is optionally present, Need S, upon creation of a |
| | new logical channel for an SRB except SRB4. It is optionally present, Need M, |
| | otherwise. |
| LCH-SetupModMRB | This field is optionally present upon creation of a new logical channel for PTM |
| | reception for a multicast MRB. If this field is included upon creation of a new logical |
| | channel for PTM reception for a multicast MRB, it shall be present when modifying this |
| | logical channel. The field is absent for logical channels configured for an SRB and a |
| | DRB. |
| LCH-SetupOnly | This field is mandatory present upon creation of a new logical channel for a DRB or an |
| | SRB (servedRadioBearer). It is absent, Need M otherwise. |
| LCH-SetupOnlyMRB | This field is mandatory present upon creation of a new logical channel for a multicast |
| | MRB and upon modification of MRB-Identity of the served MRB. It is absent, Need M |
| | otherwise. |

8.4.8. LTM-Config

The IE LTM-Config is used to provide LTM candidate cell configuration. An example LTM-Config IE is shown and described by tables 8.4.8-1, 8.4.8-2, and 8.4.8-3.

TABLE 8.4.8-1
LTM-Config information element

```
-- ASN1START
-- TAG-LTM-CONFIG-START
LTM-Config-r18 ::= SEQUENCE {
  ltm-ReferenceConfiguration-r18 OCTET STRING (CONTAINING RRCReconfiguration), OPTIONAL, -- Cond
FirstLTM-Candidate
  ltm-CandidateToReleaseList-r18 LTM-CandidateToReleaseList-r18 OPTIONAL, -- Need N
  ltm-CandidateToAddModList-r18 LTM-CandidateToAddModList-r18 OPTIONAL, -- Need N
  ltm-ServingCellNoResetID-r18 INTEGER (1..maxNrofCellsLTM-r18) OPTIONAL, -- Cond FirstLTM-Only
  ltm-CSI-ResourceConfigToAddModList-r18 SEQUENCE (SIZE (1..maxNrofCSI-ResourceConfigurations)) OF
LTM-CSI-ResourceConfig
  OPTIONAL, -- Need N
  ltm-CSI-ResourceConfigToReleaseList-r18 SEQUENCE (SIZE (1..maxNrofCSI-ResourceConfigurations))
OF LTM-CSI-ResourceConfigId
  OPTIONAL, -- Need N
  ...
}
Editor's Note: FFS on whether the LTM-CandidateNoResetL2-List field should include separate reset
flags for RLC, and PDCP recovery.
LTM-CandidateToReleaseList-r18 ::= SEQUENCE (SIZE (1..maxNrofCellsLTM-r18)) OF LTM-CandidateId-
r18 OPTIONAL -- Need N
-- TAG-LTM-CONFIG-STOP
-- ASN1STOP
```

TABLE 8.4.8-2
LTM-CandidateConfig field descriptions

ltm-CandidateToAddModList
List of LTM candidate cell configurations to add and/or modify.
ltm-CandidateToReleaseList
List of LTM candidate cell configurations to remove.
ltm-CandidateNoResetL2-List
FFS
ltm-ServingCellNoResetID
This field is used by the UE to understand on whether no L2 reset should be performed for an LTM candidate cell
upon an LTM cell switch procedure. If the value of ltm-NoResetID in an LTM candidate cell is the same as the
value of ltm-ServingCellNoResetID in the serving cell of a cell group, then the UE shall not perform any L2 reset
during the LTM cell switch procedure.
ltm-ReferenceConfiguration
This field includes an RRCReconfiguration message used to configure a reference configuration for LTM.

TABLE 8.4.8-3

| Conditional Presence | Explanation |
|---|---|
| FirstLTM-Candidate | This field is mandatory present upon the first configuration of LTM-Config which |
| | includes at least one LTM candidate cell configuration where ltm-ConfigComplete is |
| | not present. Otherwise, the field is optionally present, Need M. |
| FirstLTM-Only | This field is mandatory present upon the first configuration of LTM-Config which |
| | includes at least one LTM candidate cell configuration. Otherwise, the field is absent, |
| | Need N. |

8.4.9. LTM-CandidateId

The IE LTM-CandidateId is used to identify an LTM candidate cell configuration. An example LTM-CandidateId IE is shown and described by table 8.4.9-1.

TABLE 8.4.9-1
LTM-Candidateld information element

-- ASN1START
-- TAG-LTM-CANDIDATEID-START
LTM-CandidateId-r18 ::= INTEGER (1..maxNrofCellsLTM-r18)
-- TAG-LTM-CANDIDATEID-STOP
-- ASN1STOP

8.4.10. LTM-CandidateToAddModList

The IE LTM-CandidateToAddModList concerns a list of LTM candidate cell configurations to add or modify. An example LTM-CandidateId IE is shown and described by tables 8.4.10-1 and 8.4.10-2.

TABLE 8.4.10-1
LTM-CandidateToAddModList information element

```
-- ASN1START
-- TAG-LTM-CANDIDATETOADDMODLIST-START
LTM-CandidateToAddModList-r18 ::= SEQUENCE (SIZE (1..maxNrofCellsLTM-r18)) OF LTM-Candidate-r18
LTM-Candidate-r18 ::= SEQUENCE {
  ltm-CandidateId-r18 LTM-CandidateId-r18,
  ltm-CandidateConfig-r18 OCTET STRING (CONTAINING RRCReconfiguration),
  ltm-ConfigComplete-r18 ENUMERATED {true} OPTIONAL, -- Need R
  ltm-EarlyUlSyncConfig-r18 SetupRelease { EarlyUlSyncConfig-r18 } OPTIONAL, -- Need M
  ltm-NoResetID-r18 INTEGER (1..maxNrofCellsLTM-r18) OPTIONAL, -- Need M
  ltm-Candidate-Tci-States-ToAddModList-r18 Candidate-Tci-States-r18 OPTIONAL, -- Need N
  ltm-Candidate-Tci-States-ToReleaseList-r18 Candidate-Tci-StatesId-r18 OPTIONAL, -- Need N
}
Editors's Note: FFS how to indicate to the UE that RACH should be skipped when doing an LTM cell
switch.
-- TAG-LTM-CANDIDATETOADDMODLIST-STOP
-- ASN1STOP
```

TABLE 8.4.10-2
LTM-CandidateToAddModList field descriptions

ltm-CandidateId
This field indicates an LTM candidate cell configuration.
ltm-CandidateConfig
This field includes an RRCReconfiguration message used to configure an LTM candidate cell.
ltm-ConfigComplete
This field indicates whether the LTM candidate cell configuration within ltm-Config is a complete configuration and
thus the UE shall not use the LTM reference configuration within the field ltm-ReferenceConfiguration.
ltm-NoResetID
This field indicate whether the UE should perform no L2 reset for an LTM candidate cell upon an LTM cell switch
procedure. If the value of ltm-NoResetID in the LTM candidate cell is the same as the value of ltm-
ServingCellNoResetID in the serving cell of a cell group, then the UE shall not perform any L2 reset during an LTM
cell switch procedure.

8.4.11. Candidate-Tci-States

The IE Candidate-Tci-States defines a group of one or more TCI states for the early DL synchronization procedure. An example Candidate-Tci-States IE is shown and described by table 8.4.11-1.

TABLE 8.4.11-1
Candidate-Tci-States information element

```
-- ASN1START
-- TAG-CANDIDATE-TCI-STATES-START
Candidate-Tci-States ::= SEQUENCE {
  tci-state FFS OPTIONAL, -- Need M
  ...
}
Editor's Note: This is a placeholder for the advance TCI state pool
configuration for LTM and what this IE should exactly include is FFS
-- TAG-CANDIDATE-TCI-STATES-STOP
-- ASN1STOP
```

8.4.12. Candidate-Tci-StatesId

The IE Candidate-Tci-StatesId is used to identify a Candidate-Tci-States. An example Candidate-Tci-StatesId IE is shown and described by table 8.4.12-1.

TABLE 8.4.12-1
Candidate-Tci-StatesId information element

-- ASN1START
-- TAG-CANDIDATE-TCI-STATESID-START
Candidate-Tci-StatesId ::= INTEGER (0..FFS-1)
-- TAG-LTM-CANDIDATE-TCI-STATESID-STOP
-- ASN1STOP

8.4.13. LTM-CSI-ReportConfig

The IE LTM-CSI-ReportConfig is used to configure report on the cell in which the LTM-CSI-ReportConfig is included. FFS on the details. An example LTM-CSI-ReportConfig IE is shown and described by table 8.4.13-1.

TABLE 8.4.13-1
LTM-CSI-ReportConfig information element

```
-- ASN1START
-- TAG-LTM-CSI-REPORTCONFIG-START
LTM-CSI-ReportConfig ::= SEQUENCE {
  FFS FFS OPTIONAL, -- Need M
  ...
}
Editor's Note: This is a placeholder for the CSI report configuration
for LTM and what this IE should exactly include is FFS
-- TAG-LTM-CSI-REPORTCONFIG-STOP
-- ASN1STOP
```

8.4.14. LTM-CSI-ResourceConfigId

The IE LTM-CSI-ReportConfigId is used to identify an LTM-CSI-ReportConfig. An example LTM-CSI-ReportConfigId IE is shown and described by table 8.4.14-1.

TABLE 8.4.14-1
LTM-CSI-ReportConfigId information element

-- ASN1START
-- TAG-LTM-CSI-REPORTCONFIGID-START
LTM-CSI-ReportConfigId : := INTEGER
(0..maxNrofCSI-ReportConfigurations−1)
-- TAG-LTM-CSI-REPORTCONFIGID-STOP
-- ASN1STOP

8.4.15. LTM-CSI-ResourceConfig

The IE LTM-CSI-ResourceConfig defines a group of one or more CSI resources for an LTM candidate cell configuration. An example LTM-CSI-ResourceConfig IE is shown and described by table 8.4.15-1.

TABLE 8.4.15-1
LTM-CSI-ResourceConfig information element

```
-- ASN1START
-- TAG-LTM-CSI-RESOURCECONFIG-START
LTM-CSI-ResourceConfig : := SEQUENCE {
  FFS FFS OPTIONAL, -- Need M
  ...
}
Editor's Note: This is a placeholder the CSI resource configuration
for LTM and what this IE should exactly include is FFS
-- TAG-LTM-CSI-RESOURCECONFIG-STOP
-- ASN1STOP
```

8.4.16. LTM-CSI-ResourceConfigid

The IE LTM-CSI-ResourceConfigId is used to identify an LTM-CSI-ResourceConfig. An example LTM-CSI-ResourceConfigId IE is shown and described by table 8.4.16-1.

TABLE 8.4.16-1
LTM-CSI-ResourceConfigId information element

-- ASN1START
-- TAG-LTM-CSI-RESOURCECONFIGID-START
LTM-CSI-ResourceConfigId : := INTEGER
(0..maxNrofCSI-ResourceConfigurations−1)
-- TAG-LTM-CSI-RESOURCECONFIGID-STOP
-- ASN1STOP

8.4.17. EarlyUlSync-CONFIG

The IE EarlyUlSync-Config is used to configure random access resources for the early UL synchronization procedure. An example EarlyUlSync-Config IE is shown and described by tables 8.4.17-1 and 8.4.17-2.

TABLE 8.4.17-1
EarlyULSync-Config information element

```
-- ASN1START
-- TAG-EARLYULSYNC-CONFIG-START
EarlySync-Config : := SEQUENCE {
  ra-Config FFS OPTIONAL, -- Need M
  ...
}
Editor's Note: FFS on what the configuration of EarlyUlSync-Config
actually is (e.g., RACH-Dedicated, CFRA, or something else). Wait
for more RAN1 progresses.
-- TAG-EARLYULSYNC-CONFIG-STOP
-- ASN1STOP
```

TABLE 8.4.17-2
EarlyULSync-Config field descriptions

ra-Config
Configuration used by the UE to perform the early UL synchronization
procedure.

8.4.18. TAG-Config

The IE TAG-Config is used to configure parameters for a time-alignment group. An example TAG-Config IE is shown and described by tables 8.4.18-1 and 8.4.18-2.

TABLE 8.4.18-1
TAG-Config information element

```
-- ASN1START
-- TAG-TAG-CONFIG-START
TAG-Config : := SEQUENCE {
  tag-ToReleaseList SEQUENCE (SIZE (1..maxNrofTAGs)) OF
  TAG-Id OPTIONAL, -- Need N
  tag-ToAddModList SEQUENCE (SIZE (1..maxNrofTAGs)) OF
  TAG OPTIONAL -- Need N
}
TAG : := SEQUENCE {
  tag-Id TAG-Id,
  timeAlignmentTimer TimeAlignmentTimer,
  ...
}
TAG-Id : := INTEGER (0..maxNrofTAGs−1)
-- TAG-TAG-CONFIG-STOP
-- ASN1STOP
```

TABLE 8.4.18-2
TAG field descriptions

tag-Id
Indicates the TAG of the SpCell or an Scell (see e.g., [TS38321]).
Uniquely identifies the TAG within the scope of a Cell Group
(e.g., MCG or SCG).
timeAlignmentTimer
The timeAlignmentTimer for TAG with ID tag-Id, as specified in
[TS38321].

8.4.19. TimeAlignmentTimer

The IE TimeAlignmentTimer is used to configure the time alignment timer as specified in [TS38321]. The values are in milliseconds (ms). An example TimeAlignmentTimer IE is shown and described by table 8.4.19-1.

TABLE 8.4.19-1
TimeAlignmentTimer information element

-- ASN1START
-- TAG-TIMEALIGNMENTTIMER-START
TimeAlignmentTimer ::= ENUMERATED {ms500, ms750, ms1280,
ms1920, ms2560, ms5120, ms10240, infinity}
-- TAG-TIMEALIGNMENTTIMER-STOP
-- ASN1STOP

8.5. RRC Multiplicity and Type Constraint Values

TABLE 8.5-1
MULTIPLICITY AND TYPE CONSTRAINT DEFINITIONS

```
-- ASN1START
-- TAG-MULTIPLICITY-AND-TYPE-CONSTRAINT-DEFINITIONS-START
maxAdditionalRACH-r17 INTEGER : := 256 -- Maximum number of additional RACH configurations.
maxAI-DCI-PayloadSize-r16 INTEGER : := 128 --Maximum size of the DCI payload scrambled with ai-
RNTI
maxAI-DCI-PayloadSize-1-r16 INTEGER : := 127 --Maximum size of the DCI payload scrambled with ai-
RNTI minus 1
maxBandComb INTEGER : := 65536 -- Maximum number of DL band combinations
maxBandsUTRA-FDD-r16 INTEGER : := 64 -- Maximum number of bands listed in UTRA-FDD UE caps
maxBH-RLC-ChannelID-r16 INTEGER ::= 65536 -- Maximum value of BH RLC Channel ID
maxBT-IdReport-r16 INTEGER : := 32 -- Maximum number of Bluetooth IDs to report
maxBT-Name-r16 INTEGER : := 4 -- Maximum number of Bluetooth name
maxCAG-Cell-r16 INTEGER : := 16 -- Maximum number of NR CAG cell ranges in SIB3, SIB4
maxTwoPUCCH-Grp-ConfigList-r16 INTEGER : : = 32 -- Maximum number of supported configuration (s) of
{primary PUCCH group
  -- config, secondary PUCCH group config}
maxTwoPUCCH-Grp-ConfigList-r17 INTEGER : := 16 -- Maximum number of supported configuration (s) of
{primary PUCCH group
  -- config, secondary PUCCH group config} for PUCCH cell switching
maxCBR-Config-r16 INTEGER : := 8 -- Maximum number of CBR range configurations for sidelink
communication
  -- congestion control
maxCBR-Config-1-r16 INTEGER : := 7 -- Maximum number of CBR range configurations for sidelink
communication
  -- congestion control minus 1
maxCBR-Level-r16 INTEGER : := 16 -- Maximum number of CBR levels
maxCBR-Level-1-r16 INTEGER : := 15 -- Maximum number of CBR levels minus 1
maxCellExcluded INTEGER : : = 16 -- Maximum number of NR exclude-listed cell ranges in SIB3, SIB4
maxCellGroupings-r16 INTEGER : := 32 -- Maximum number of cell groupings for NR-DC
maxCellHistory-r16 INTEGER : := 16 -- Maximum number of visited PCells reported
maxPSCellHistory-r17 INTEGER : := 16 -- Maximum number of visited PSCells across all reported
PCells
maxCellInter INTEGER : := 16 -- Maximum number of inter-Freq cells listed in SIB4
maxCellIntra INTEGER : := 16 -- Maximum number of intra-Freq cells listed in SIB3
maxCellMeasEUTRA INTEGER : := 32 -- Maximum number of cells in E-UTRAN
maxCellMeasIdle-r16 INTEGER : : = 8 -- Maximum number of cells per carrier for idle/inactive
measurements
maxCellMeasUTRA-FDD-r16 INTEGER : := 32 -- Maximum number of cells in FDD UTRAN
maxCellNTN-r17 INTEGER : := 4 -- Maximum number of NTN neighbour cells for which assistance
information is
  -- provided
maxCarrierTypePairList-r16 INTEGER : := 16 -- Maximum number of supported carrier type pair of
(carrier type on which
  -- CSI measurement is performed, carrier type on which CSI reporting is
  -- performed) for CSI reporting cross PUCCH group
maxCellAllowed INTEGER : := 16 -- Maximum number of NR allow-listed cell ranges in SIB3, SIB4
maxEARFCN INTEGER : := 262143 -- Maximum value of E-UTRA carrier frequency
maxEUTRA-CellExcluded INTEGER : := 16 -- Maximum number of E-UTRA exclude-listed physical cell
identity ranges
  -- in SIB5
maxEUTRA-NS-Pmax INTEGER : := 8 -- Maximum number of NS and P-Max values per band
maxFeatureCombPreamblesPerRACHResource-r17 INTEGER : := 256 -- Maximum number of feature
combination preambles.
maxLogMeasReport-r16 INTEGER : := 520 -- Maximum number of entries for logged measurements
maxMultiBands INTEGER : := 8 -- Maximum number of additional frequency bands that a cell belongs
to
maxNARFCN INTEGER : := 3279165 -- Maximum value of NR carrier frequency
maxNR-NS-Pmax INTEGER : : = 8 -- Maximum number of NS and P-Max values per band
maxFreqIdle-r16 INTEGER : := 8 -- Maximum number of carrier frequencies for idle/inactive
measurements
maxNrofServingCells INTEGER : := 32 -- Max number of serving cells (SpCells + SCells)
maxNrofServingCells-1 INTEGER : := 31 -- Max number of serving cells (SpCells + SCells) minus 1
maxNrofAggregatedCellsPerCellGroup INTEGER : : = 16
maxNrofAggregatedCellsPerCellGroupMinus4-r16 INTEGER : := 12
maxNrofDUCells-r16 INTEGER : := 512 -- Max number of cells configured on the collocated IAB-DU
maxNrofAppLayerMeas-r17 INTEGER : := 16 -- Max number of simultaneous application layer
measurements
maxNrofAppLayerMeas-1-r17 INTEGER : : = 15 -- Max number of simultaneous application layer
measurements minus 1
maxNrofAvailabilityCombinationsPerSet-r16 INTEGER : := 512 -- Max number of
AvailabilityCombinationId used in the DCI format 2_5
maxNrofAvailabilityCombinationsPerSet-1-r16 INTEGER : := 511 -- Max number of
AvailabilityCombinationId used in the DCI format 2_5 minus 1
maxNrofIABResourceConfig-r17 INTEGER : := 65536 -- Max number of IAB-ResourceConfigID used in MAC
CE
maxNrofIABResourceConfig-1-r17 INTEGER : : = 65535 -- Max number of IAB-ResourceConfigID used in
MAC CE minus 1
maxNrofSCellActRS-r17 INTEGER : := 255 -- Max number of RS configurations per SCell for SCell
activation
maxNrofSCells INTEGER : := 31 -- Max number of secondary serving cells per cell group
maxNrofCellMeas INTEGER : := 32 -- Maximum number of entries in each of the cell lists in a
measurement object
maxNrofCRS-IM-InterfCell-r17 INTEGER : := 8 -- Maximum number of LTE interference cells for CRS-IM
per UE
maxNrofRelayMeas-r17 INTEGER : := 32 -- Maximum number of L2 U2N Relay UEs to measure for each
measurement object
  -- on sidelink frequency
maxNrofCG-SL-r16 INTEGER : := 8 -- Max number of sidelink configured grant
maxNrofCG-SL-1-r16 INTEGER : := 7 -- Max number of sidelink configured grant minus 1
maxSL-GC-BC-DRX-QoS-r17 INTEGER : := 16 -- Max number of sidelink DRX configurations for NR
  -- sidelink groupcast/broadcast communication
maxNrofSL-RxInfoSet-r17 INTEGER : := 4 -- Max number of sidelink DRX configuration sets in
sidelink DRX assistant
  -- information
maxNrofSS-BlocksToAverage INTEGER : := 16 -- Max number for the (max) number of SS blocks to
average to determine cell measurement
maxNrofCondCells-r16 INTEGER : := 8 -- Max number of conditional candidate SpCells
maxNrofCondCells-1-r17 INTEGER : := 7 -- Max number of conditional candidate SpCells minus 1
maxNrofCSI-RS-ResourcesToAverage INTEGER : := 16 -- Max number for the (max) number of CSI-RS to
average to determine cell measurement
maxNrofDL-Allocations INTEGER : : = 16 -- Maximum number of PDSCH time domain resource allocations
maxNrofDL-AllocationsExt-r17 INTEGER : := 64 -- Maximum number of PDSCH time domain resource
allocations for multi-PDSCH
  -- scheduling
maxNrofPDU-Sessions-r17 INTEGER : := 256 -- Maximum number of PDU Sessions
maxNrofSR-ConfigPerCellGroup INTEGER : := 8 -- Maximum number of SR configurations per cell group
maxLCG-ID INTEGER : := 7 -- Maximum value of LCG ID
maxLCG-ID-IAB-r17 INTEGER : := 255 -- Maximum value of LCG ID for IAB-MT
maxLC-ID INTEGER : := 32 -- Maximum value of Logical Channel ID
maxLC-ID-Iab-r16 INTEGER ::= 65855 -- Maximum value of BH Logical Channel ID extension
maxLTE-CRS-Patterns-r16 INTEGER : := 3 -- Maximum number of additional LTE CRS rate matching
patterns
maxNrofTAGs INTEGER : := 4 -- Maximum number of Timing Advance Groups
maxNrofTAGs-1 INTEGER : := 3 -- Maximum number of Timing Advance Groups minus 1
maxNrofBWPs INTEGER : := 4 -- Maximum number of BWPs per serving cell
maxNrofCombIDC INTEGER : := 128 -- Maximum number of reported MR-DC combinations for IDC
maxNrofSymbols-1 INTEGER : : = 13 -- Maximum index identifying a symbol within a slot (14 symbols,
indexed from 0..13)
maxNrofSlots INTEGER : := 320 -- Maximum number of slots in a 10 ms period
maxNrofSlots-1 INTEGER : := 319 -- Maximum number of slots in a 10 ms period minus 1
maxNrofPhysicalResourceBlocks INTEGER : : = 275 -- Maximum number of PRBs
maxNrofPhysicalResourceBlocks-1 INTEGER : := 274 -- Maximum number of PRBs minus 1
maxNrofPhysicalResourceBlocksPlus1 INTEGER : := 276 -- Maximum number of PRBs plus 1
maxNrofControlResourceSets INTEGER : := 12 -- Max number of CoReSets configurable on a serving
cell
maxNrofControlResourceSets-1 INTEGER : := 11 -- Max number of CoReSets configurable on a serving
cell minus 1
maxNrofControlResourceSets-1-r16 INTEGER : := 15 -- Max number of CoReSets configurable on a
serving cell extended in minus 1
maxNrofCoresetPools-r16 INTEGER : := 2 -- Maximum number of CORESET pools
maxCoReSetDuration INTEGER ::= 3 -- Max number of OFDM symbols in a control resource set
maxNrofSearchSpaces-1 INTEGER : := 39 -- Max number of Search Spaces minus 1
maxNrofSearchSpacesLinks-1-r17 INTEGER : := 39 -- Max number of Search Space links minus 1
maxNrofBFDResourcePerSet-r17 INTEGER : : = 64 -- Max number of reference signal in one BFD set
maxSFI-DCI-PayloadSize INTEGER : := 128 -- Max number payload of a DCI scrambled with SFI-RNTI
maxSFI-DCI-PayloadSize-1 INTEGER : := 127 -- Max number payload of a DCI scrambled with SFI-RNTI
minus 1
maxIAB-IP-Address-r16 INTEGER : := 32 -- Max number of assigned IP addresses
maxINT-DCI-PayloadSize INTEGER : := 126 -- Max number payload of a DCI scrambled with INT-RNTI
maxINT-DCI-PayloadSize-1 INTEGER : := 125 -- Max number payload of a DCI scrambled with INT-RNTI
minus 1
maxNrofRateMatchPatterns INTEGER : := 4 -- Max number of rate matching patterns that may be
configured
maxNrofRateMatchPatterns-1 INTEGER : := 3 -- Max number of rate matching patterns that may be
configured minus 1
maxNrofRateMatchPatternsPerGroup INTEGER : : = 8 -- Max number of rate matching patterns that may
be configured in one group
maxNrofCSI-ReportConfigurations INTEGER : := 48 -- Maximum number of report configurations
maxNrofCSI-ReportConfigurations-1 INTEGER : := 47 -- Maximum number of report configurations minus
1
maxNrofCSI-ResourceConfigurations INTEGER : := 112 -- Maximum number of resource configurations
maxNrofCSI-ResourceConfigurations-1 INTEGER : := 111 -- Maximum number of resource configurations
minus 1
maxNrofAP-CSI-RS-ResourcesPerSet INTEGER : : = 16
maxNrOfCSI-AperiodicTriggers INTEGER : : = 128 -- Maximum number of triggers for aperiodic CSI
reporting
maxNrofReportConfigPerAperiodicTrigger INTEGER : := 16 -- Maximum number of report configurations
per trigger state for aperiodic reporting
maxNrofNZP-CSI-RS-Resources INTEGER : := 192 -- Maximum number of Non-Zero-Power (NZP) CSI-RS
resources
maxNrofNZP-CSI-RS-Resources-1 INTEGER : := 191 -- Maximum number of Non-Zero-Power (NZP) CSI-RS
resources minus 1
maxNrofNZP-CSI-RS-ResourcesPerSet INTEGER : := 64 -- Maximum number of NZP CSI-RS resources per
resource set
maxNrofNZP-CSI-RS-ResourceSets INTEGER : : = 64 -- Maximum number of NZP CSI-RS resource sets per
cell
maxNrofNZP-CSI-RS-ResourceSets-1 INTEGER : : = 63 -- Maximum number of NZP CSI-RS resource sets per
cell minus 1
maxNrofNZP-CSI-RS-ResourceSetsPerConfig INTEGER : : = 16 -- Maximum number of resource sets per
resource configuration
maxNrofNZP-CSI-RS-ResourcesPerConfig INTEGER : := 128 -- Maximum number of resources per resource
configuration
maxNrofZP-CSI-RS-Resources INTEGER : := 32 -- Maximum number of Zero-Power (ZP) CSI-RS resources
maxNrofZP-CSI-RS-Resources-1 INTEGER : := 31 -- Maximum number of Zero-Power (ZP) CSI-RS resources
minus 1
maxNrofZP-CSI-RS-ResourceSets-1 INTEGER : := 15
maxNrofZP-CSI-RS-ResourcesPerSet INTEGER : := 16
maxNrofZP-CSI-RS-ResourceSets INTEGER : := 16
maxNrofCSI-IM-Resources INTEGER : := 32 -- Maximum number of CSI-IM resources
maxNrofCSI-IM-Resources-1 INTEGER : := 31 -- Maximum number of CSI-IM resources minus 1
maxNrofCSI-IM-ResourcesPerSet INTEGER : := 8 -- Maximum number of CSI-IM resources per set
maxNrofCSI-IM-ResourceSets INTEGER : := 64 -- Maximum number of NZP CSI-IM resource sets per cell
maxNrofCSI-IM-ResourceSets-1 INTEGER : := 63 -- Maximum number of NZP CSI-IM resource sets per
cell minus 1
maxNrofCSI-IM-ResourceSetsPerConfig INTEGER ::= 16 -- Maximum number of CSI IM resource sets per
resource configuration
maxNrofCSI-SSB-ResourcePerSet INTEGER : := 64 -- Maximum number of SSB resources in a resource set
maxNrofCSI-SSB-ResourceSets INTEGER : := 64 -- Maximum number of CSI SSB resource sets per cell
maxNrofCSI-SSB-ResourceSets-1 INTEGER : := 63 -- Maximum number of CSI SSB resource sets per cell
minus 1
maxNrofCSI-SSB-ResourceSetsPerConfig INTEGER : : = 1 -- Maximum number of CSI SSB resource sets per
resource configuration
maxNrofCSI-SSB-ResourceSetsPerConfigExt INTEGER : : = 2 -- Maximum number of CSI SSB resource sets
per resource configuration
  -- extended
maxNrofFailureDetectionResources INTEGER : := 10 -- Maximum number of failure detection resources
maxNrofFailureDetectionResources-1 INTEGER : := 9 -- Maximum number of failure detection resources
minus 1
maxNrofFailureDetectionResources-1-r17 INTEGER : := 63 -- Maximum number of the enhanced failure
detection resources minus 1
maxNrofFreqSL-r16 INTEGER : : = 8 -- Maximum number of carrier frequency for NR sidelink
communication
maxNrofSL-BWPs-r16 INTEGER : : = 4 -- Maximum number of BWP for NR sidelink communication
maxFreqSL-EUTRA-r16 INTEGER : := 8 -- Maximum number of EUTRA anchor carrier frequency for NR
sidelink communication
maxNrofSL-MeasId-r16 INTEGER : := 64 -- Maximum number of sidelink measurement identity (RSRP) per
destination
maxNrofSL-ObjectId-r16 INTEGER : := 64 -- Maximum number of sidelink measurement objects (RSRP)
per destination
maxNrofSL-ReportConfigId-r16 INTEGER : := 64 -- Maximum number of sidelink measurement reporting
configuration (RSRP) per destination
maxNrofSL-PoolToMeasureNR-r16 INTEGER : : = 8 -- Maximum number of resource pool for NR sidelink
measurement to measure for
  -- each measurement object (for CBR)
maxFreqSL-NR-r16 INTEGER : := 8 -- Maximum number of NR anchor carrier frequency for NR sidelink
communication
maxNrofSL-QFIs-r16 INTEGER : := 2048 -- Maximum number of QoS flow for NR sidelink communication
per UE
maxNrofSL-QFIsPerDest-r16 INTEGER : := 64 -- Maximum number of QOS flow per destination for NR
sidelink communication
maxNrofObjectId INTEGER : := 64 -- Maximum number of measurement objects
maxNrofPageRec INTEGER : := 32 -- Maximum number of page records
maxNrofPCI-Ranges INTEGER : := 8 -- Maximum number of PCI ranges
maxPLMN INTEGER : := 12 -- Maximum number of PLMNs broadcast and reported by UE at establishment
maxTAC-r17 INTEGER : := 12 -- Maximum number of Tracking Area Codes to which a cell belongs to
maxNrofCSI-RS-ResourcesRRM INTEGER : := 96 -- Maximum number of CSI-RS resources per cell for an
RRM measurement object
maxNrofCSI-RS-ResourcesRRM-1 INTEGER : := 95 -- Maximum number of CSI-RS resources per cell for an
RRM measurement object
  -- minus 1.
maxNrofMeasId INTEGER : := 64 -- Maximum number of configured measurements
maxNrofQuantityConfig INTEGER : := 2 -- Maximum number of quantity configurations
maxNrofCSI-RS-CellsRRM INTEGER : := 96 -- Maximum number of cells with CSI-RS resources for an RRM
measurement object
maxNrofSL-Dest-r16 INTEGER : := 32 -- Maximum number of destination for NR sidelink communication
and discovery
maxNrofSL-Dest-1-r16 INTEGER : := 31 -- Highest index of destination for NR sidelink communication
and discovery
maxNrofSLRB-r16 INTEGER : := 512 -- Maximum number of radio bearer for NR sidelink communication
per UE
maxSL-LCID-r16 INTEGER : := 512 -- Maximum number of RLC bearer for NR sidelink communication per
UE
maxSL-SyncConfig-r16 INTEGER : := 16 -- Maximum number of sidelink Sync configurations
maxNrofRXPool-r16 INTEGER : : = 16 -- Maximum number of Rx resource pool for NR sidelink
communication and
  -- discovery
maxNrofTXPool-r16 INTEGER : : = 8 -- Maximum number of Tx resource pool for NR sidelink
communication and
  -- discovery
maxNrofPoolID-r16 INTEGER : := 16 -- Maximum index of resource pool for NR sidelink communication
and
  -- discovery
maxNrofSRS-PathlossReferenceRS-r16 INTEGER : := 64 -- Maximum number of RSs used as pathloss
maxNrofSRS-PathlossReferenceRS-1-r16 INTEGER : := 63 -- Maximum number of RSs used as pathloss
reference for SRS power control.
  -- minus 1.
maxNrofSRS-ResourceSets INTEGER : : = 16 -- Maximum number of SRS resource sets in a BWP.
maxNrofSRS-ResourceSets-1 INTEGER : := 15 -- Maximum number of SRS resource sets in a BWP minus 1.
maxNrofSRS-PosResourceSets-r16 INTEGER : := 16 -- Maximum number of SRS Positioning resource sets
in a BWP.
maxNrofSRS-PosResourceSets-1-r16 INTEGER : := 15 -- Maximum number of SRS Positioning resource
sets in a BWP minus 1.
maxNrofSRS-Resources INTEGER : := 64 -- Maximum number of SRS resources.
maxNrofSRS-Resources-1 INTEGER : := 63 -- Maximum number of SRS resources minus 1.
maxNrofSRS-PosResources-r16 INTEGER ::= 64 -- Maximum number of SRS Positioning resources.
maxNrofSRS-PosResources-1-r16 INTEGER : := 63 -- Maximum number of SRS Positioning resources minus
1.
maxNrofSRS-ResourcesPerSet INTEGER : : = 16 -- Maximum number of SRS resources in an SRS resource
set
maxNrofSRS-TriggerStates-1 INTEGER : : = 3 -- Maximum number of SRS trigger states minus 1, e.g.,
the largest code point.
maxNrofSRS-TriggerStates-2 INTEGER : : = 2 -- Maximum number of SRS trigger states minus 2.
maxRAT-CapabilityContainers INTEGER : : = 8 -- Maximum number of interworking RAT containers (incl
NR and MRDC)
maxSimultaneousBands INTEGER : := 32 -- Maximum number of simultaneously aggregated bands
maxULTxSwitchingBandPairs INTEGER : := 32 -- Maximum number of band pairs supporting dynamic UL Tx
switching in a band
  -- combination.
maxNrofSlotFormatCombinationsPerSet INTEGER : := 512 -- Maximum number of Slot Format Combinations
in a SF-Set.
maxNrofSlotFormatCombinationsPerSet-1 INTEGER : := 511 -- Maximum number of Slot Format
Combinations in a SF-Set minus 1.
maxNrofTrafficPattern-r16 INTEGER : := 8 -- Maximum number of Traffic Pattern for NR sidelink
communication.
maxNrofPUCCH-Resources INTEGER : : = 128
maxNrofPUCCH-Resources-1 INTEGER : := 127
maxNrofPUCCH-ResourceSets INTEGER : : = 4 -- Maximum number of PUCCH Resource Sets
maxNrofPUCCH-ResourceSets-1 INTEGER : := 3 -- Maximum number of PUCCH Resource Sets minus 1.
maxNrofPUCCH-ResourcesPerSet INTEGER : := 32 -- Maximum number of PUCCH Resources per PUCCH-
ResourceSet
maxNrofPUCCH-PO-PerSet INTEGER : := 8 -- Maximum number of PO-pucch present in a p0-pucch set
maxNrofPUCCH-PathlossReferenceRSs INTEGER : : = 4 -- Maximum number of RSs used as pathloss
reference for PUCCH power control.
maxNrofPUCCH-PathlossReferenceRSs-1 INTEGER : : = 3 -- Maximum number of RSs used as pathloss
reference for PUCCH power control
  -- minus 1.
maxNrofPUCCH-PathlossReferenceRSs-r16 INTEGER : : = 64 -- Maximum number of RSs used as pathloss
reference for PUCCH power control
  -- extended.
maxNrofPUCCH-PathlossReferenceRSs-1-r16 INTEGER : := 63 -- Maximum number of RSs used as pathloss
reference for PUCCH power control
  -- minus 1 extended.
maxNrofPUCCH-PathlossReferenceRSs-1-r17 INTEGER : := 7 -- Maximum number of RSs used as pathloss
reference for PUCCH power control
  -- minus 1.
maxNrofPUCCH-PathlossReferenceRSsDiff-r16 INTEGER : := 60 -- Difference between the extended
maximum and the non-extended maximum
maxNrofPUCCH-ResourceGroups-r16 INTEGER : : = 4 -- Maximum number of PUCCH resources groups.
maxNrofPUCCH-ResourcesPerGroup-r16 INTEGER : := 128 -- Maximum number of PUCCH resources in a
PUCCH group.
maxNrofPowerControlSetInfos-r17 INTEGER : := 8 -- Maximum number of PUCCH power control set infos
maxNrofMultiplePUSCHs-r16 INTEGER : : = 8 -- Maximum number of multiple PUSCHs in PUSCH TDRA list
maxNrofPO-PUSCH-AlphaSets INTEGER ::= 30 -- Maximum number of PO-pusch-alpha-sets (see TS 38.213
[13], clause 7.1)
maxNrofPO-PUSCH-AlphaSets-1 INTEGER : := 29 -- Maximum number of PO-pusch-alpha-sets minus 1 (see
TS 38.213 [13], clause 7.1)
maxNrofPUSCH-PathlossReferenceRSs INTEGER : := 4 -- Maximum number of RSs used as pathloss
reference for PUSCH power control.
maxNrofPUSCH-PathlossReferenceRSs-1 INTEGER : : = 3 -- Maximum number of RSs used as pathloss
reference for PUSCH power control
  -- minus 1.
maxNrofPUSCH-PathlossReferenceRSs-r16 INTEGER : := 64 -- Maximum number of RSs used as pathloss
reference for PUSCH power control
  -- extended
maxNrofPUSCH-PathlossReferenceRSs-1-r16 INTEGER : : = 63 -- Maximum number of RSs used as pathloss
reference for PUSCH power control
  -- extended minus 1
maxNrofPUSCH-PathlossReferenceRSsDiff-r16 INTEGER : := 60 -- Difference between maxNrofPUSCH-
PathlossReferenceRSs-r16 and
  -- maxNrofPUSCH-PathlossReferenceRSs
maxNrofPathlossReferenceRSs-r17 INTEGER : := 64 -- Maximum number of RSs used as pathloss
reference for PUSCH, PUCCH, SRS
  -- power control for unified TCI state operation
maxNrofPathlossReferenceRSs-1-r17 INTEGER : := 63 -- Maximum number of RSs used as pathloss
reference for PUSCH, PUCCH, SRS
  -- power control for unified TCI state operation minus 1
maxNrofNAICS-Entries INTEGER : := 8 -- Maximum number of supported NAICS capability set
maxBands INTEGER : := 1024 -- Maximum number of supported bands in UE capability.
maxBandsMRDC INTEGER : := 1280
maxBandsEUTRA INTEGER : := 256
maxCellReport INTEGER : := 8
maxDRB INTEGER : := 29 -- Maximum number of DRBs (that can be added in DRB-ToAddModList).
maxFreq INTEGER : := 8 -- Max number of frequencies.
maxFreqLayers INTEGER : := 4 -- Max number of frequency layers.
maxFreqPlus1 INTEGER : := 9 -- Max number of frequencies for Slicing.
maxFreqIDC-r16 INTEGER : := 128 -- Max number of frequencies for IDC indication.
maxCombIDC-r16 INTEGER : := 128 -- Max number of reported UL CA for IDC indication.
maxFreqIDC-MRDC INTEGER : := 32 -- Maximum number of candidate NR frequencies for MR-DC IDC
indication
maxNrofCandidateBeams INTEGER : := 16 -- Max number of PRACH-ResourceDedicatedBFR in BFR config.
maxNrofCandidateBeams-r16 INTEGER ::= 64 -- Max number of candidate beam resources in BFR config.
maxNrofCandidateBeamsExt-r16 INTEGER : : = 48 -- Max number of PRACH-ResourceDedicatedBFR in the
CandidateBeamRSListExt
maxNrofPCIsPerSMTC INTEGER : := 64 -- Maximum number of PCIs per SMTC.
maxNrofQFIs INTEGER : := 64
maxNrofResourceAvailabilityPerCombination-r16 INTEGER : := 256
maxNrOfSemiPersistentPUSCH-Triggers INTEGER : := 64 -- Maximum number of triggers for semi
persistent reporting on PUSCH
maxNrofSR-Resources INTEGER : := 8 -- Maximum number of SR resources per BWP in a cell.
maxNrofSlotFormatsPerCombination INTEGER : : = 256
maxNrofSpatialRelationInfos INTEGER : : = 8
maxNrofSpatialRelationInfos-plus-1 INTEGER : : = 9
maxNrofSpatialRelationInfos-r16 INTEGER : := 64
maxNrofSpatialRelationInfosDiff-r16 INTEGER : := 56 -- Difference between
maxNrofSpatialRelationInfos-r16 and maxNrofSpatialRelationInfos
maxNrofIndexesToReport INTEGER : : = 32
maxNrofIndexesToReport2 INTEGER : : = 64
maxNrofSSBs-r16 INTEGER : := 64 -- Maximum number of SSB resources in a resource set.
maxNrofSSBs-1 INTEGER : : = 63 --Maximum number of SSB resources in a resource set minus 1.
maxNrofS-NSSAI INTEGER : : = 8 --Maximum number of S-NSSAI.
maxNrofTCI-StatesPDCCH INTEGER : : = 64
maxNrofTCI-States INTEGER : := 128 -- Maximum number of TCI states.
maxNrofTCI-States-1 INTEGER : : = 127 -- Maximum number of TCI states minus 1.
maxUL-TCI-r17 INTEGER : := 64 -- Maximum number of TCI states.
maxUL-TCI-1-r17 INTEGER : := 63 -- Maximum number of TCI states minus 1.
maxNrofAdditionalPCI-r17 INTEGER : := 7 -- Maximum number of additional PCI
maxMPE-Resources-r17 INTEGER : := 64 -- Maximum number of pooled MPE resources
maxNrofUL-Allocations INTEGER : := 16 -- Maximum number of PUSCH time domain resource allocations.
maxQFI INTEGER : := 63
maxRA-CSIRS-Resources INTEGER : := 96
maxRA-OccasionsPerCSIRS INTEGER : := 64 -- Maximum number of RA occasions for one CSI-RS
maxRA-Occasions-1 INTEGER : := 511 -- Maximum number of RA occasions in the system
maxRA-SSB-Resources INTEGER : := 64
maxSCSs INTEGER : := 5
maxSecondaryCellGroups INTEGER : : = 3
maxNrofServingCellsEUTRA INTEGER : : = 32
maxMBSFN-Allocations INTEGER : := 8
maxNrofMultiBands INTEGER : := 8
maxCellSFTD INTEGER : := 3 -- Maximum number of cells for SFTD reporting
maxReportConfigId INTEGER : := 64
maxNrofCodebooks INTEGER : := 16 -- Maximum number of codebooks supported by the UE
maxNrofCSI-RS-ResourcesExt-r16 INTEGER ::= 16 -- Maximum number of codebook resources supported
by the UE for eType2/Codebook combo
maxNrofCSI-RS-ResourcesExt-r17 INTEGER : := 8 -- Maximum number of codebook resources for
fetype2R1 and fetype2R2
maxNrofCSI-RS-Resources INTEGER : : = 7 -- Maximum number of codebook resources supported by the UE
maxNrofCSI-RS-ResourcesAlt-r16 INTEGER : := 512 -- Maximum number of alternative codebook
resources supported by the UE
maxNrofCSI-RS-ResourcesAlt-1-r16 INTEGER : := 511 -- Maximum number of alternative codebook
resources supported by the UE minus 1
maxNrofSRI-PUSCH-Mappings INTEGER : : = 16
maxNrofSRI-PUSCH-Mappings-1 INTEGER : := 15
maxSIB INTEGER: := 32 -- Maximum number of SIBs
maxSI-Message INTEGER: := 32 -- Maximum number of SI messages
maxSIB-MessagePlus1-r17 INTEGER: := 33 -- Maximum number of SIB messages plus 1
maxPO-perPF INTEGER : := 4 -- Maximum number of paging occasion per paging frame
maxPEI-perPF-r17 INTEGER : : = 4 -- Maximum number of PEI occasion per paging frame
maxAccessCat-1 INTEGER : := 63 -- Maximum number of Access Categories minus 1
maxBarringInfoSet INTEGER : : = 8 -- Maximum number of access control parameter sets
maxCellEUTRA INTEGER : := 8 -- Maximum number of E-UTRA cells in SIB list
maxEUTRA-Carrier INTEGER : : = 8 -- Maximum number of E-UTRA carriers in SIB list
maxPLMNIdentities INTEGER : : = 8 -- Maximum number of PLMN identities in RAN area configurations
maxDownlinkFeatureSets INTEGER : := 1024 -- (for NR DL) Total number of FeatureSets (size of the
pool)
maxUplinkFeatureSets INTEGER : : = 1024 -- (for NR UL) Total number of FeatureSets (size of the
pool)
maxEUTRA-DL-FeatureSets INTEGER : : = 256 --
(for E-UTRA) Total number of FeatureSets (size of the
pool)
maxEUTRA-UL-FeatureSets INTEGER : : = 256 -- (for E-UTRA) Total number of FeatureSets (size of the
pool)
maxFeatureSetsPerBand INTEGER : : = 128 -- (for NR) The number of feature sets associated with one
band.
maxPerCC-FeatureSets INTEGER : := 1024 -- (for NR) Total number of CC-specific FeatureSets (size
of the pool)
maxFeatureSetCombinations INTEGER : := 1024 -- (for MR-DC/NR) Total number of Feature set
combinations (size of the pool)
maxInterRAT-RSTD-Freq INTEGER : : = 3
maxGIN-r17 INTEGER : := 24 -- Maximum number of broadcast GINs
maxHRNN-Len-r16 INTEGER ::= 48 -- Maximum length of HRNNs
maxNPN-r16 INTEGER : := 12 -- Maximum number of NPNs broadcast and reported by UE at establishment
maxNrOfMinSchedulingOffsetValues-r16 INTEGER : := 2 -- Maximum number of min. scheduling offset
(K0/K2) configurations
maxK0-SchedulingOffset-r16 INTEGER : := 16 -- Maximum number of slots configured as min.
scheduling offset (K0)
maxK2-SchedulingOffset-r16 INTEGER : := 16 -- Maximum number of slots configured as min.
scheduling offset (K2)
maxKO-SchedulingOffset-r17 INTEGER : := 64 -- Maximum number of slots configured as min.
scheduling offset (K0)
maxK2-SchedulingOffset-r17 INTEGER : := 64 -- Maximum number of slots configured as min.
scheduling offset (K2)
maxDCI-2-6-Size-r16 INTEGER : := 140 -- Maximum size of DCI format 2-6
maxDCI-2-7-Size-r17 INTEGER : := 43 -- Maximum size of DCI format 2-7
maxDCI-2-6-Size-1-r16 INTEGER : := 139 -- Maximum DCI format 2-6 size minus 1
maxNrofUL-Allocations-r16 INTEGER : : = 64 -- Maximum number of PUSCH time domain resource
allocations
maxNrofPO-PUSCH-Set-r16 INTEGER : := 2 -- Maximum number of PO PUSCH set (s)
maxOnDemandSIB-r16 INTEGER : := 8 -- Maximum number of SIB (s) that can be requested on-demand
maxOnDemandPosSIB-r16 INTEGER : : = 32 -- Maximum number of posSIB (s) that can be requested on-
demand
maxCI-DCI-PayloadSize-r16 INTEGER : := 126 -- Maximum number of the DCI size for CI
maxCI-DCI-PayloadSize-1-r16 INTEGER : := 125 -- Maximum number of the DCI size for CI minus 1
maxUu-RelayRLC-ChannelID-r17 INTEGER : := 32 -- Maximum value of Uu Relay RLC channel ID
maxWLAN-Id-Report-r16 INTEGER : := 32 -- Maximum number of WLAN IDs to report
maxWLAN-Name-r16 INTEGER : := 4 -- Maximum number of WLAN name
maxRAReport-r16 INTEGER : := 8 -- Maximum number of RA procedures information to be included in
the RA report
maxTxConfig-r16 INTEGER : := 64 -- Maximum number of sidelink transmission parameters
configurations
maxTxConfig-1-r16 INTEGER : := 63 -- Maximum number of sidelink transmission parameters
configurations minus 1
maxPSSCH-TxConfig-r16 INTEGER : := 16 -- Maximum number of PSSCH TX configurations
maxNrofCLI-RSSI-Resources-r16 INTEGER : := 64 -- Maximum number of CLI-RSSI resources for UE
maxNrofCLI-RSSI-Resources-1-r16 INTEGER : := 63 -- Maximum number of CLI-RSSI resources for UE
minus 1
maxNrofCLI-SRS-Resources-r16 INTEGER : := 32 -- Maximum number of SRS resources for CLI
measurement for UE
maxCLI-Report-r16 INTEGER : := 8
maxNrofCC-Group-r17 INTEGER : := 16 -- Maximum number of CC groups for DC location report
maxNrofConfiguredGrantConfig-r16 INTEGER : := 12 -- Maximum number of configured grant
configurations per BWP
maxNrofConfiguredGrantConfig-1-r16 INTEGER : : = 11 -- Maximum number of configured grant
configurations per BWP minus 1
maxNrofCG-Type2DeactivationState INTEGER : := 16 -- Maximum number of deactivation state for type
2 configured grants per BWP
maxNrofConfiguredGrantConfigMAC-1-r16 INTEGER : := 31 -- Maximum number of configured grant
configurations per MAC entity minus 1
maxNrofSPS-Config-r16 INTEGER : : = 8 --
Maximum number of SPS configurations per BWP
maxNrofSPS-Config-1-r16 INTEGER : := 7
Maximum number of SPS configurations per BWP minus 1
maxNrofSPS-DeactivationState INTEGER : := 16 -- Maximum number of deactivation state for SPS per
BWP
maxNrofPPW-Config-r17 INTEGER : = 4 --Maximum number of Preconfigured PRS processing windows per
DL BWP
maxNrofPPW-ID-1-r17 INTEGER : := 15 -- Maximum number of Preconfigured PRS processing windows
minus 1
maxNrOfTxTEGReport-r17 INTEGER : : = 256 -- Maximum number of UE Tx Timing Error Group Report
maxNrOfTxTEG-ID-1-r17 INTEGER : := 7 -- Maximum number of UE Tx Timing Error Group ID minus 1
maxNrofDormancyGroups INTEGER : := 5 --
maxNrofPagingSubgroups-r17 INTEGER : : = 8 -- Maximum number of paging subgroups per paging
occasion
maxNrofPUCCH-ResourceGroups-1-r16 INTEGER : : = 3 --
maxNrofReqComDC-Location-r17 INTEGER : : = 128 -- Maximum number of requested carriers/BWPs
combinations for DC location
  -- report
maxNrofServingCellsTCI-r16 INTEGER : := 32 -- Maximum number of serving cells in simultaneousTCI-
UpdateList
maxNrofTxDC-TwoCarrier-r16 INTEGER : : = 64 -- Maximum number of UL Tx DC locations reported by the
UE for 2CC uplink CA
maxNrofRB-SetGroups-r17 INTEGER : : = 8 -- Maximum number of RB set groups
maxNrofRB-Sets-r17 INTEGER : : = 8 -- Maximum number of RB sets
maxNrofEnhType3HARQ-ACK-r17 INTEGER : := 8 -- Maximum number of enhanced type 3 HARQ-ACK codebook
maxNrofEnhType3HARQ-ACK-1-r17 INTEGER : := 7 -- Maximum number of enhanced type 3 HARQ-ACK
codebook minus 1
maxNrofPRS-ResourcesPerSet-r17 INTEGER : := 64 -- Maximum number of PRS resources for one set
maxNrofPRS-ResourcesPerSet-1-r17 INTEGER : := 63 -- Maximum number of PRS resources for one set
minus 1
maxNrofPRS-ResourceOffsetValue-1-r17 INTEGER : : = 511
maxNrofGapId-r17 INTEGER : := 8 -- Maximum number of measurement gap ID is FFS
maxNrofPreConfigPosGapId-r17 INTEGER : := 16 -- Maximum number of preconfigured positioning
measurement gap
maxNrOfGapPri-r17 INTEGER : := 16 -- Maximum number of gap priority level
maxCEFReport-r17 INTEGER : : = 4 -- Maximum number of CEF reports by the UE
maxNrofMultiplePDSCHs-r17 INTEGER : := 8 -- Maximum number of PDSCHs in PDSCH TDRA list
maxSliceInfo-r17 INTEGER : := 8 -- Maximum number of NSAGs
maxCellSlice-r17 INTEGER : := 16 -- Maximum number of cells supporting the NSAG
maxNrofTRS-ResourceSets-r17 INTEGER : := 64 -- Maximum number of TRS resource sets
maxNrofSearchSpaceGroups-1-r17 INTEGER : := 2 -- Maximum number of search space groups minus 1
maxNrofRemoteUE-r17 INTEGER ::= 32 -- Maximum number of connected L2 U2N Remote UEs
maxDCI-4-2-Size-r17 INTEGER : := 140 -- Maximum size of DCI format 4-2
maxFreqMBS-r17 INTEGER : := 16 -- Maximum number of MBS frequencies reported in
MBSInterest Indication
maxNrofDRX-ConfigPTM-r17 INTEGER : : = 64 -- Max number of DRX configuration for PTM provided in
MBS broadcast in a
  -- cell
maxNrofDRX-ConfigPTM-1-r17 INTEGER : := 63 -- Max number of DRX configuration for PTM provided in
MBS broadcast in a
  -- cell minus 1
maxNrofMBS-ServiceListPerUE-r17 INTEGER : := 16 -- Maximum number of services which the UE can
include in the MBS interest
  -- indication
maxNrofMBS-Session-r17 INTEGER ::= 1024 -- Maximum number of MBS sessions provided in MBS
broadcast in a cell
maxNrofMTCH-SSB-MappingWindow-r17 INTEGER : := 16 -- Maximum number of MTCH to SSB beam mapping
pattern
maxNrofMTCH-SSB-MappingWindow-1-r17 INTEGER : : = 15 -- Maximum number of MTCH to SSB beam mapping
pattern minus 1
maxNrofMRB-Broadcast-r17 INTEGER : := 4 -- Maximum number of broadcast MRBs configured for one MBS
broadcast service
maxNrofPageGroup-r17 INTEGER : := 32 -- Maximum number of paging groups in a paging message
maxNrofPDSCH-ConfigPTM-r17 INTEGER : := 16 -- Maximum number of PDSCH configuration groups for PTM
maxNrofPDSCH-ConfigPTM-1-r17 INTEGER : := 15 -- Maximum number of PDSCH configuration groups for
PTM minus 1
maxG-RNTI-r17 INTEGER ::= 16 -- Maximum number of G-RNTI that can be configured for a UE.
maxG-RNTI-1-r17 INTEGER : := 15 -- Maximum number of G-RNTI that can be configured for a UE minus
1.
maxG-CS-RNTI-r17 INTEGER : := 8 -- Maximum number of G-CS-RNTI that can be configured for a UE.
maxG-CS-RNTI-1-r17 INTEGER : := 7 -- Maximum number of G-CS-RNTI that can be configured for a UE
minus 1.
maxMRB-r17 INTEGER : := 32 -- Maximum number of multicast MRBs (that can be added in MRB-
ToAddModLIst )
maxFSAI-MBS-r17 INTEGER : := 64 -- Maximum number of MBS frequency selection area identities
maxNeighCellMBS-r17 INTEGER : := 8 -- Maximum number of MBS broadcast neighbour cells
maxNrofPdcch-BlindDetectionMixed-1-r16 INTEGER : := 7 -- Maximum number of combinations of mixed
Rel-16 and Rel-15 PDCCH
  -- monitoring capabilities minus 1
maxNrofPdcch-BlindDetection-r17 INTEGER : := 16 -- Maximum number of combinations of PDCCH blind
detection monitoring
  --capabilities
maxNrofCellsLTM-r18 INTEGER : := 99999 -- Maximum number of LTM candidate cells
-- TAG-MULTIPLICITY-AND-TYPE-CONSTRAINT-DEFINITIONS-STOP
-- ASN1STOP
```

8.6. Timers

TABLE 8.6-1
Timers

| Timer | Start | Stop | At expiry |
|---|---|---|---|
| T300 | Upon transmission of | Upon reception of RRCSetup or | Perform the actions as specified |
| | RRCSetupRequest. | RRCReject message, cell re- | in [TS38331] § 5.3.3.7. |
| | | selection, relay reselection, and | |
| | | upon abortion of connection | |
| | | establishment by upper layers. | |
| T301 | Upon transmission of | Upon reception of | Go to RRC_IDLE |
| | RRCReestabilshmentRequest | RRCReestablishment or | |
| | | RRCSetup message as well as | |
| | | when the selected cell becomes | |
| | | unsuitable or the (re)selected L2 | |
| | | U2N Relay UE becomes | |
| | | unsuitable, upon reception of | |
| | | notificationMessageSidelink | |
| | | indicating relayUE-HO or | |
| | | relayUE-CellReselection. | |
| T302 | Upon reception of | Upon entering | Inform upper layers about |
| | RRCReject while | RRC_CONNECTED or | barring alleviation as specified in |
| | performing RRC | RRC_IDLE, upon cell re- | [TS38331] § 5.3.14.4 |
| | connection establishment | selection, upon cell change due | |
| | or resume, upon | to relay (re)selection, and upon | |
| | reception of RRCRelease | reception of RRCReject | |
| | with waitTime. | message. | |
| T304 | Upon reception of | Upon successful completion of | For T304 of MCG, in case of the |
| | RRCReconfiguration | random access on the | handover from NR or intra-NR |
| | message including | corresponding SpCell | handover, or path switch from a |
| | reconfigurationWithSync | For T304 of SCG, upon SCG | L2 U2N Relay UE to a NR cell, |
| | for the MCG which does | release | initiate the RRC re- |
| | not include sl- | | establishment procedure; In |
| | PathSwitchConfig, or | | case of handover to NR, perform |
| | upon reception of | | the actions defined in the |
| | RRCReconfiguration | | specifications applicable for the |
| | message including | | source RAT. If any DAPS bearer |
| | reconfigurationWithSync | | is configured and if there is no |
| | for the SCG not indicated | | RLF in source PCell, initiate the |
| | as deactivated in the NR | | failure information procedure. |
| | or E-UTRA message | | For T304 of SCG, inform |
| | containing the | | network about the |
| | RRCReconfiguration | | reconfiguration with sync failure |
| | message or upon | | by initiating the SCG failure |
| | conditional | | information procedure as |
| | reconfiguration execution | | specified in [TS38331] § 5.7.3. |
| | e.g., when applying a | | |
| | stored | | |
| | RRCReconfiguration | | |
| | message including | | |
| | reconfigurationWithSync. | | |
| T3xx | Upon execution of an | Upon successful completion of a | For Txxx of MCG, initiate the |
| | LTM cell switch | LTM cell switch procedure (FFS | RRC re-establishment |
| | procedure i.e., upon | how an LTM cell switch | procedure. |
| | Upon the indication by | procedure is considere as | For Txxx of SCG, inform the |
| | lower layers that an LTM | completed). | network about the LTM cell |
| | cell switch procedure is | | switch failure by initiating the |
| | triggered. | | SCG failure information |
| | | | procedure as specified in |
| | | | [TS38331] § 5.7.3. |
| T310 | Upon detecting physical | Upon receiving N311 | If the T310 is kept in MCG: If AS |
| | layer problems for the | consecutive in-sync indications | security is not activated: go to |
| | SpCell e.g., upon | from lower layers for the SpCell, | RRC_IDLE else: initiate the |
| | receiving N310 | upon receiving | MCG failure information |
| | consecutive out-of-sync | RRCReconfiguration with | procedure as specified in |
| | indications from lower | reconfiguration WithSync for that | [TS38331] § 5.7.3b or the |
| | layers. | cell group, upon reception of | connection re-establishment |
| | | MobilityFromNRCommand, | procedure as specified in |
| | | upon the reconfiguration of rlf- | [TS38331] § 5.3.7 or the |
| | | TimersAndConstant, upon | procedure as specified in |
| | | initiating the connection re- | [TS38331] § 5.3.10.3 if any |
| | | establishment procedure, upon | DAPS bearer is configured. |
| | | conditional reconfiguration | If the T310 is kept in SCG, |
| | | execution e.g., when applying a | Inform E-UTRAN/NR about the |
| | | stored RRCReconfiguration | SCG radio link failure by |
| | | message including | initiating the SCG failure |
| | | reconfiguration WithSync for that | information procedure as |
| | | cell group, and upon initiating | specified in [TS38331] § 5.7.3. |
| | | the MCG failure information | |
| | | procedure. | |
| | | Upon SCG release, if the T310 | |
| | | is kept in SCG. | |
| T311 | Upon initiating the RRC | Upon selection of a suitable NR | Enter RRC_IDLE |
| | connection re- | cell, or upon selection of a | |
| | establishment procedure | suitable L2 U2N Relay UE, or a | |
| | | cell using another RAT. | |
| T312 | If T312 is configured in | Upon receiving N311 | If the T312 is kept in MCG |
| | MCG: Upon triggering a | consecutive in-sync indications | initiate the MCG failure |
| | measurement report for a | from lower layers for the SpCell, | information procedure as |
| | measurement identity for | receiving RRCReconfiguration | specified in 5.7.3b or the |
| | which T312 has been | with reconfiguration WithSync for | connection re-establishment |
| | configured and useT312 | that cell group, upon reception | procedure. |
| | has been set to true, | of MobilityFromNRCommand, | If the T312 is kept in SCG, |
| | while T310 in PCell is | upon initiating the connection re- | Inform E-UTRAN/NR about the |
| | running. | establishment procedure, upon | SCG radio link failure by |
| | If T312 is configured in | the reconfiguration of rlf- | initiating the SCG failure |
| | SCG and useT312 has | TimersAndConstant, upon | information procedure.as |
| | been set to true: Upon | initiating the MCG failure | specified in 5.7.3 of [TS38331]. |
| | triggering a measurement | information procedure, upon | |
| | report for a measurement | conditional reconfiguration | |
| | identity for which T312 | execution e.g., when applying a | |
| | has been configured, | stored RRCReconfiguration | |
| | while T310 in PSCell is | message including | |
| | running. | reconfiguration WithSync for that | |
| | | cell group, and upon the expiry | |
| | | of T310 in corresponding | |
| | | SpCell. | |
| | | Upon SCG release, if the T312 | |
| | | is kept in SCG | |
| T316 | Upon transmission of the | Upon receiving RRCRelease, | Perform the actions as specified |
| | MCGFailureInformation | RRCReconfiguration with | in 5.7.3b.5 of [TS38331]. |
| | message | reconfigurationwithSync for the | |
| | | PCell, | |
| | | MobilityFromNRCommand, or | |
| | | upon initiating the re- | |
| | | establishment procedure | |
| T319 | Upon transmission of | Upon reception of RRCResume, | Perform the actions as specified |
| | RRCResumeRequest or | RRCSetup, RRCRelease, | in 5.3.13.5 of [TS38331]. |
| | RRCResumeRequest1 | RRCRelease with | |
| | when the resume | suspendConfig or RRCReject | |
| | procedure is not initiated | message, upon cell re-selection | |
| | for SDT. | or upon relay (re)selection. | |
| T319a | Upon transmission of | Upon reception of RRCResume, | Perform the actions as specified |
| | RRCResumeRequest or | RRCSetup, RRCRelease, | in 5.3.13.5 of [TS38331]. |
| | RRCResumeRequest1 | RRCReject message or upon | |
| | when the resume | failure to resume RRC | |
| | procedure is initiated for | connection for SDT as specified | |
| | SDT. | in 5.3.13.5 or upon cell | |
| | | reselection. | |
| T320 | Upon reception of t320 or | Upon entering | Discard the cell reselection |
| | upon cell (re)selection to | RRC_CONNECTED, upon | priority information provided by |
| | NR from another RAT | reception of RRCRelease, when | dedicated signalling. |
| | with validity time | PLMN selection or SNPN | |
| | configured for dedicated | selection is performed on | |
| | priorities (in which case | request by NAS, when the UE | |
| | the remaining validity | enters RRC_IDLE from | |
| | time is applied). | RRC_INACTIVE, or upon cell | |
| | | (re)selection to another RAT (in | |
| | | which case the timer is carried | |
| | | on to the other RAT). | |
| T321 | Upon receiving | Upon acquiring the information | Initiate the measurement |
| | measConfig including a | needed to set all fields of cgi- | reporting procedure, stop |
| | reportConfig with the | info, upon receiving measConfig | performing the related |
| | reportType set to | that includes removal of the | measurements. |
| | reportCGI | reportConfig with the reportType | |
| | | set to reportCGI and upon | |
| | | detecting that a cell is not | |
| | | broadcasting SIB1. | |
| T322 | Upon receiving | Upon acquiring the SFTD | Initiate the measurement |
| | measConfig including | measurement results, upon | reporting procedure, stop |
| | reportConfigNR with the | receiving measConfig that | performing the related |
| | report Type set to | includes removal of the | measurements. |
| | reportSFTD and drx- | reportConfig with the reportType | |
| | SFTD-NeighMeas is set | set to reportSFTD. | |
| | to true. | | |
| T325 | Upon reception of | | Stop deprioritisation of all |
| | RRCRelease message | | frequencies or NR signalled by |
| | with deprioritisation Timer. | | RRCRelease. |
| T330 | Upon receiving | Upon log volume exceeding the | Perform the actions specified in |
| | LoggedMeasurementCon | suitable UE memory, upon | 5.5a.1.4 of [TS38331]. |
| | figuration message | initiating the release of | |
| | | LoggedMeasurementConfigurati | |
| | | on procedure | |
| T331 | Upon receiving | Upon receiving RRCSetup, | Perform the actions as specified |
| | RRCRelease message | RRCResume, RRCRelease with | in 5.7.8.3 of [TS38331]. |
| | with measidleDuration | idle/inactive measurement | |
| | | configuration, upon cell | |
| | | selection/reselection to a cell | |
| | | that does not belong to the | |
| | | validityArea (if configured), or | |
| | | upon cell re-selection to another | |
| | | RAT. | |
| T342 | Upon transmitting | Upon releasing | No action. |
| | UEAssistanceInformation | delayBudgetReportingConfig | |
| | message with | during the connection re- | |
| | DelayBudgetReport. | establishment/resume | |
| | | procedures, and upon receiving | |
| | | delayBudgetReportingConfig set | |
| | | to release. | |
| T345 | Upon transmitting | Upon releasing | No action. |
| | UEAssistanceInformation | overheatingAssistanceConfig | |
| | message with | during the connection re- | |
| | overheatingAssistance | establishment procedure, upon | |
| | | initiating the connection | |
| | | resumption procedure, and upon | |
| | | receiving | |
| | | overheatingAssistanceConfig | |
| | | set to release. | |
| T346a | Upon transmitting | Upon releasing drx- | No action. |
| (The UE | UEAssistanceInformation | PreferenceConfig during the | |
| maintains | message with drx- | connection re- | |
| one | Preference. | establishment/resume | |
| instance of | | procedures, upon receiving drx- | |
| this timer | | PreferenceConfig set to release, | |
| per cell | | or upon performing MR-DC | |
| group) | | release. | |
| T346b | Upon transmitting | Upon releasing maxBW- | No action. |
| (The UE | UEAssistanceInformation | PreferenceConfig during the | |
| maintains | message with maxBW- | connection re- | |
| one | Preference. | establishment/resume | |
| instance of | | procedures, upon receiving | |
| this timer | | maxBW-PreferenceConfig set to | |
| per cel | | release, or upon performing MR- | |
| group) | | DC release. | |
| T346c | Upon transmitting | Upon releasing maxCC- | No action. |
| (The UE | UEAssistanceInformation | PreferenceConfig during the | |
| maintains | message with maxCC- | connection re- | |
| one | Preference. | establishment/resume | |
| instance of | | procedures, upon receiving | |
| this timer | | maxCC-PreferenceConfig set to | |
| per cell | | release, or upon performing MR- | |
| group) | | DC release. | |
| T346d | Upon transmitting | Upon releasing maxMIMO- | No action. |
| (The UE | UEAssistanceInformation | LayerPreferenceConfig during | |
| maintains | message with maxMIMO- | the connection re- | |
| one | LayerPreference. | establishment/resume | |
| instance of | | procedures, upon receiving | |
| this timer | | maxMIMO- | |
| per cell | | LayerPreferenceConfig set to | |
| group) | | release, or upon performing MR- | |
| | | DC release. | |
| T346e | Upon transmitting | Upon releasing | No action. |
| (The UE | UEAssistanceInformation | minSchedulingOffsetPreference | |
| maintains | message with | Config during the connection re- | |
| one | minSchedulingOffset- | establishment/resume | |
| instance of | Preference. | procedures, upon receiving | |
| this timer | | minSchedulingOffsetPreference | |
| per cell | | Config set to release, or upon | |
| group) | | performing MR-DC release. | |
| T346f | Upon transmitting | Upon releasing | No action. |
| | UEAssistanceInformation | releasePreferenceConfig during | |
| | message with | the connection re- | |
| | releasePreference. | establishment/resume | |
| | | procedures, or upon receiving | |
| | | releasePreferenceConfig set to | |
| | | release. | |
| T346g | Upon transmitting | Upon receiving RRCRelease, or | Perform the actions as specified |
| | UEAssistanceInformation | upon receiving musim- | in 5.3.8.6 of [TS38331]. |
| | message with musim- | LeaveAssistanceConfig set to | |
| | PreferredRRC-State. | release. | |
| T346h | Upon transmitting | Upon releasing musim- | No action. |
| | UEAssistanceInformation | GapAssistanceConfig during the | |
| | message with musim- | connection re- | |
| | GapPreferenceList | establishment/resume | |
| | Information. | procedures, or upon receiving | |
| | | musim-GapAssistanceConfig set | |
| | | to release. | |
| T346i | Upon transmitting | Upon releasing scg- | No action. |
| | UEAssistanceInformation | DeactivationPreferenceConfig | |
| | message with scg- | during RRC connection re- | |
| | DeactivationPreference | establishment/resume or upon | |
| | | receiving scg- | |
| | | DeactivationPreferenceConfig | |
| | | set to release. | |
| T346j (The | Upon transmitting | Upon releasing rlm- | No action. |
| UE | UEAssistanceInformation | Relaxation ReportingConfig | |
| maintains | message with rlm- | during the connection re- | |
| one | Relaxation ReportingConfig. | establishment/resume | |
| instance of | | procedures, upon receiving rlm- | |
| this timer | | RelaxationReportingConfig set | |
| per cell | | to release, or upon performing | |
| group) | | MR-DC release. | |
| T346k | Upon transmitting | Upon releasing bfd- | No action. |
| (The UE | UEAssistanceInformation | Relaxation ReportingConfig | |
| maintains | message with bfd- | during the connection re- | |
| one | RelaxationReportingConfig. | establishment/resume | |
| instance of | | procedures, upon receiving bfd- | |
| this timer | | Relaxation ReportingConfig set | |
| per cell | | to release, or upon performing | |
| group) | | MR-DC release. | |
| T350 | Upon transmitting | Upon acquiring the requested | No action |
| | DedicatedSIBRequest | SIB(s) or posSIB(s), upon | |
| | message with | releasing onDemandSIB- | |
| | requestedSIB-List and/or | Request during the connection | |
| | requestedPosSIB-List. | re-establishment procedures, | |
| | | upon receiving onDemandSIB- | |
| | | Request set to release, upon | |
| | | reception of RRCRelease or | |
| | | upon successful change of PCell | |
| | | while in RRC_CONNECTED. | |
| T380 | Upon reception of t380 in | Upon reception of RRCResume, | Perform the actions as specified |
| | RRCRelease. | RRCSetup or RRCRelease. | in 5.3.13. |
| T390 | When access attempt is | Upon cell (re)selection, upon | Perform the actions as specified |
| | barred at access barring | relay (re)selection, upon | in 5.3.14.4 of [TS38331]. |
| | check for an Access | entering RRC_CONNECTED, | |
| | Category. The UE | upon reception of | |
| | maintains one instance of | RRCReconfiguration including | |
| | this timer per Access | reconfiguration WithSync, upon | |
| | Category. | change of PCell while in | |
| | | RRC_CONNECTED, upon | |
| | | reception of | |
| | | MobilityFromNRCommand, or | |
| | | upon reception of RRCRelease. | |
| T400 | Upon transmission of | Upon reception of | Perform the Sidelink radio link |
| | RRCReconfigurationSide- | RRCReconfigurationFailureSidelink | failure related actions as |
| | link | or | specified in 5.8.9.3 of |
| | | RRCReconfigurationCompleteSidelink | [TS38331]. |
| T420 | Upon reception of the | Upon successfully sending | Perform the RRC re- |
| | RRCReconfiguration | RRCReconfigurationComplete | establishment procedure as |
| | message including sl- | message (i.e., PC5 RLC | specified in 5.3.7 of [TS38331]. |
| | PathSwitchConfig | acknowledgement is received | |
| | | from target L2 U2N Relay UE) | |
| T430 | Start or restart from the | Stop T430, if it is running, for the | Perform the actions as specified |
| | subframe indicated by | source cell upon reception of | in 5.2.2.6 of [TS38331]. |
| | epoch Time upon | RRCReconfiguration message | |
| | reception of SIB19, or | including | |
| | upon reception of | reconfigurationWithSync, or | |
| | RRCReconfiguration | upon conditional reconfiguration | |
| | message for the target | execution e.g., when applying a | |
| | cell including | stored RRCReconfiguration | |
| | reconfigurationWithSync, | message including | |
| | or upon conditional | reconfiguration WithSync. | |
| | reconfiguration execution | | |
| | e.g., when applying a | | |
| | stored | | |
| | RRCReconfiguration | | |
| | message for the target | | |
| | cell including | | |
| | reconfigurationWithSync. | | |

8.7. UE Variables

To facilitate the specification of the UE behavioural requirements, UE variables are represented using ASN.1. Unless explicitly specified otherwise, it is however up to UE implementation how to store the variables. The optionality of the IEs in ASN.1 is used only to indicate that the values may not always be available

8.7.1. VarConditionalReconfig

The UE variable VarConditionalReconfig includes the accumulated configuration of the conditional handover, conditional PSCell addition or conditional PSCell change configurations including the pointers to conditional handover, conditional PSCell addition or conditional PSCell change execution condition (associated measId(s)), the stored target candidate SpCell RRCReconfiguration, and the stored reference configuration. An example VarConditionalReconfig is shown and described by table 8.7.1-1.

TABLE 8.7.1-1
VarConditionalReconfig UE variable

```
-- ASN1START
-- TAG-VARCONDITIONALRECONFIG-START
VarConditionalReconfig : := SEQUENCE {
  condReconfigList CondReconfigToAddModList-r16 OPTIONAL.
  scpac-ReferenceConfiguration-r18 OCTET STRING (CONTAINING
  RRCReconfiguration) OPTIONAL
}
-- TAG-VARCONDITIONALRECONFIG-STOP
--ASN1STOP
```

8.7.2. VarConditionalReconfig-Complete

The UE variable VarConditionalReconfig-Complete includes the generated complete configuration of the SCPAC configurations. An example VarConditionalReconfig-Complete is shown and described by table 8.7.2-1.

TABLE 8.7.2-1
VarConditionalReconfig-Complete UE variable

```
-- ASN1START
-- TAG-VARCONDITIONALRECONFIG-START
VarConditionalReconfig-Complete : := SEQUENCE {
  condReconfigCompleteList CondReconfigCompleteList-r18
}
CondReconfigCompleteList-r18 : := SEQUENCE (SIZE
(1. . maxNrofCondCells-r16) ) OF CondReconfigId-r16
CondReconfigCompleteList-r18 : := SEQUENCE {
  condReconfigId-r16 CondReconfigId-r16,
condReconfig-Complete-r18 OCTET STRING (CONTAINING
RRCReconfiguration)
}
-- TAG-VARCONDITIONALRECONFIG-STOP
-- ASN1STOP
```

8.7.3. VarLTM-Config

The IE VarLTM-Config is used to store the reference configuration and the LTM candidate cell configurations. An example VarConditionalReconfig-Complete is shown and described by table 8.7.3-1.

TABLE 8.7.3-1
VarLTM-Config UE variable

```
-- ASN1START
-- TAG-VARLTM-CONFIG-START
VarLTM-Config-r18-IEs : := SEQUENCE {
  ltm-ReferenceConfiguration-r18 OCTET STRING (CONTAINING
  RRCReconfiguration) ,
  ltm-CandidateList-r18 LTM-CandidateList-r18
}
LTM-CandidateList-r18 ::= SEQUENCE (SIZE
(1..maxNrofCellsLTM-r18) ) OF LTM-Candidate-r18
-- TAG-VARLTM-CONFIG-STOP
-- ASN1STOP
```

8.7.4. VarLTM-UE-Config

The IE VarLTM-UE-Config is used to store the generated UE configuration related to the received LTM candidate cell configurations. An example VarConditionalReconfig-Complete is shown and described by table 8.7.4-1.

TABLE 8.7.4-1
VarLTM-UE-Config UE variable

```
-- ASN1START
-- TAG-VARLTM-CONFIG-START
VarLTM-UE-Config-r18-IEs : := SEQUENCE {
  ue-ltm-ConfigCandidateList-r18 UE-LTM-ConfigCandidateList-r18
}
UE-LTM-ConfigCandidateList-r18 ::= SEQUENCE (SIZE
(1. . maxNrofCellsLTM-r18) ) OF UE-LTM-Candidate-r18
UE-LTM-Candidate-r18 : := SEQUENCE {
  ltm-CandidateId-r18 LTM-CandidateId-r18,
  ue-LTM-Config-r18 OCTET STRING,
}
-- TAG-VARLTM-CONFIG-STOP
-- ASN1STOP
```

8.8. Message Definitions

8.8.1. CG-ConfigInfo

The CG-ConfigInfo message is used by master eNB or gNB to request the SgNB or SeNB to perform certain actions e.g. to establish, modify or release an SCG. The message may include additional information e.g. to assist the SgNB or SeNB to set the SCG configuration. It can also be used by a CU to request a DU to perform certain actions, e.g. to establish, or modify an MCG or SCG. Direction: Master eNB or gNB to secondary gNB or eNB, alternatively CU to DU. In some examples, it is FFS on which node initially generates the reference configuration. An example CG-ConfigInfo message is shown and described by tables 8.8.1-1, 8.8.1-2, and 8.8.1-3.

TABLE 8.8.1-1
CG-ConfigInfo message

```
-- ASN1START
-- TAG-CG-CONFIG-INFO-START
CG-ConfigInfo : := SEQUENCE {
  criticalExtensions CHOICE {
  c1 CHOICE{
  cg-ConfigInfo CG-ConfigInfo-IEs,
  spare3 NULL, spare2 NULL, spare1 NULL
  },
  criticalExtensionsFuture SEQUENCE { }
  }
}
CG-ConfigInfo-IEs : := SEQUENCE {
  ue-CapabilityInfo OCTET STRING (CONTAINING UE-CapabilityRAT-ContainerList) OPTIONAL, -- Cond SN-
AddMod
  candidateCellInfoListMN MeasResultList2NR OPTIONAL,
  candidateCellInfoListSN OCTET STRING (CONTAINING MeasResultList2NR) OPTIONAL,
  measResultCellListSFTD-NR MeasResultCellListSFTD-NR OPTIONAL,
  scgFailureInfo SEQUENCE {
  failureType ENUMERATED { t310-Expiry, randomAccessProblem,
  rlc-MaxNumRetx, synchReconfigFailure-SCG,
  scg-reconfigFailure,
  srb3-IntegrityFailure},
  measResultSCG OCTET STRING (CONTAINING MeasResultSCG-Failure)
  } OPTIONAL,
  configRestrictInfo ConfigRestrictInfoSCG OPTIONAL,
  drx-InfoMCG DRX-Info OPTIONAL,
  measConfigMN MeasConfigMN OPTIONAL,
  sourceConfigSCG OCTET STRING (CONTAINING RRCReconfiguration) OPTIONAL,
  scg-RB-Config OCTET STRING (CONTAINING RadioBearerConfig) OPTIONAL,
  mcg-RB-Config OCTET STRING (CONTAINING RadioBearerConfig) OPTIONAL,
  mrdc-AssistanceInfo MRDC-AssistanceInfo OPTIONAL,
  nonCriticalExtension CG-ConfigInfo-v1540-IEs OPTIONAL
}
CG-ConfigInfo-v1540-IEs : := SEQUENCE {
  ph-InfoMCG PH-TypeListMCG OPTIONAL,
  measResultReportCGI SEQUENCE {
  ssbFrequency ARFCN-ValueNR,
  cellForWhichToReportCGI PhysCellId,
  cgi-Info CGI-InfoNR
  } OPTIONAL,
  nonCriticalExtension CG-ConfigInfo-v1560-IEs OPTIONAL
}
CG-ConfigInfo-v1560-IEs : := SEQUENCE {
  candidateCellInfoListMN-EUTRA OCTET STRING OPTIONAL,
  candidateCellInfoListSN-EUTRA OCTET STRING OPTIONAL,
  sourceConfigSCG-EUTRA OCTET STRING OPTIONAL,
  scgFailureInfoEUTRA SEQUENCE {
  failureTypeEUTRA ENUMERATED { t313-Expiry, randomAccessProblem,
  rlc-MaxNumRetx, scg-ChangeFailure},
  measResultSCG-EUTRA OCTET STRING
  } OPTIONAL,
  drx-ConfigMCG DRX-Config OPTIONAL,
  measResultReportCGI-EUTRA SEQUENCE {
  eutraFrequency ARFCN-ValueEUTRA,
  cellForWhichToReportCGI-EUTRA EUTRA-PhysCellId,
  cgi-InfoEUTRA CGI-InfoEUTRA
  } OPTIONAL,
  measResultCellList SFTD-EUTRA MeasResultCellList SFTD-EUTRA OPTIONAL,
  fr-InfoListMCG FR-InfoList OPTIONAL,
  nonCriticalExtension CG-ConfigInfo-v1570-IEs OPTIONAL
}
CG-ConfigInfo-v1570-IEs : := SEQUENCE {
  sftdFrequencyList-NR SFTD-FrequencyList-NR OPTIONAL,
  sftdFrequencyList-EUTRA SFTD-FrequencyList-EUTRA OPTIONAL,
  nonCriticalExtension CG-ConfigInfo-v1590-IEs OPTIONAL
}
CG-ConfigInfo-v1590-IEs : := SEQUENCE {
  servFrequenciesMN-NR SEQUENCE (SIZE (1..maxNrofServingCells-1) ) OF ARFCN-ValueNR OPTIONAL,
  nonCriticalExtension CG-ConfigInfo-v1610-IEs OPTIONAL
}
CG-ConfigInfo-v1610-IEs : := SEQUENCE {
  drx-InfoMCG2 DRX-Info2 OPTIONAL,
  alignedDRX-Indication ENUMERATED {true} OPTIONAL,
  scgFailureInfo-r16 SEQUENCE {
  failureType-r16 ENUMERATED { scg-lbtFailure-r16, beamFailureRecoveryFailure-r16,
  t312-Expiry-r16, bh-RLF-r16,
  beamFailure-r17, spare3, spare2, spare1},
  measResultSCG-r16 OCTET STRING (CONTAINING MeasResultSCG-Failure)
  } OPTIONAL,
  dummy1 SEQUENCE {
  failureTypeEUTRA-r16 ENUMERATED { scg-lbtFailure-r16, beamFailureRecoveryFailure-r16,
  t312-Expiry-r16, spare5,
  spare4, spare3, spare2, spare1},
  measResultSCG-EUTRA-r16 OCTET STRING
  } OPTIONAL,
  sidelinkUEInformationNR-r16 OCTET STRING (CONTAINING SidelinkUEInformationNR-r16) OPTIONAL,
  sidelinkUEInformationEUTRA-r16 OCTET STRING OPTIONAL,
  nonCriticalExtension CG-ConfigInfo-v1620-IEs OPTIONAL
}
CG-ConfigInfo-v1620-IEs : := SEQUENCE {
  ueAssistanceInformationSourceSCG-r16 OCTET STRING (CONTAINING UEAssistanceInformation) OPTIONAL,
  nonCriticalExtension CG-ConfigInfo-v1640-IEs OPTIONAL
}
CG-ConfigInfo-v1640-IEs : := SEQUENCE {
  servCellInfoListMCG-NR-r16 ServCellInfoListMCG-NR-r16 OPTIONAL,
  servCellInfoListMCG-EUTRA-r16 ServCellInfoListMCG-EUTRA-r16 OPTIONAL,
  nonCriticalExtension CG-ConfigInfo-v1700-IEs OPTIONAL
}
CG-ConfigInfo-v1700-IEs : := SEQUENCE {
  candidateCellListCPC-r17 CandidateCellListCPC-r17 OPTIONAL,
  twoPHRModeMCG-r17 ENUMERATED {enabled} OPTIONAL,
  lowMobilityEvaluationConnectedInPCell-r17 ENUMERATED {enabled} OPTIONAL,
  nonCriticalExtension CG-ConfigInfo-v1730-IEs OPTIONAL
}
CG-ConfigInfo-v1730-IEs : := SEQUENCE {
  fr1-Carriers-MCG-r17 INTEGER (1..32) OPTIONAL,
  fr2-Carriers-MCG-r17 INTEGER (1..32) OPTIONAL,
  nonCriticalExtension CG-ConfigInfo-v1800-IEs OPTIONAL
}
CG-ConfigInfo-v1800-IEs : := SEQUENCE {
    scpac-ReferenceConfiguration-r18 OCTET STRING (CONTAINING RRCReconfiguration) OPTIONAL,
    nonCriticalExtension SEQUENCE [ ] OPTIONAL
}
ServCellInfoListMCG-NR-r16 ::= SEQUENCE (SIZE (1..maxNrofServingCells) ) OF ServCellInfoXCG-NR-
r16
ServCellInfoListMCG-EUTRA-r16 : := SEQUENCE (SIZE (1..maxNrofServingCellsEUTRA) ) OF
ServCellInfoXCG-EUTRA-r16
SFTD-FrequencyList-NR : := SEQUENCE (SIZE (1. . maxCellSFTD) ) OF ARFCN-ValueNR
SFTD-FrequencyList-EUTRA : := SEQUENCE (SIZE (1. . maxCellSFTD) ) OF ARFCN-ValueEUTRA
ConfigRestrictInfoSCG : := SEQUENCE {
  allowedBC-ListMRDC BandCombinationInfoList OPTIONAL,
  powerCoordination-FR1 SEQUENCE {
  p-maxNR-FR1 P-Max OPTIONAL,
  p-maxEUTRA P-Max OPTIONAL,
  p-maxUE-FR1 P-Max OPTIONAL
  } OPTIONAL,
  servCellIndexRangeSCG SEQUENCE {
  lowBound ServCellIndex,
  upBound ServCellIndex
  } OPTIONAL, -- Cond SN-AddMod
  maxMeasFreqsSCG INTEGER (1. . maxMeasFreqsMN) OPTIONAL,
  dummy INTEGER (1 . . maxMeasIdentitiesMN) OPTIONAL,
  . . . ,
  [[
  selectedBandEntriesMNList SEQUENCE (SIZE (1. . maxBandComb) ) OF SelectedBandEntriesMN OPTIONAL,
  pdcch-BlindDetectionSCG INTEGER (1..15) OPTIONAL,
  maxNumberROHC-ContextSessionsSN INTEGER (0..16384) OPTIONAL
  ]],
  [[
  maxIntraFreqMeasIdentitiesSCG INTEGER (1. . maxMeasIdentitiesMN) OPTIONAL,
  max InterFreqMeasIdentitiesSCG INTEGER (1. . maxMeas IdentitiesMN) OPTIONAL
  ]],
  [[
  p-maxNR-FR1-MCG-r16 P-Max OPTIONAL,
  powerCoordination-FR2-r16 SEQUENCE {
  p-maxNR-FR2-MCG-r16 P-Max OPTIONAL,
  p-maxNR-FR2-SCG-r16 P-Max OPTIONAL,
  p-maxUE-FR2-r16 P-Max OPTIONAL
  } OPTIONAL,
  nrdc-PC-mode-FR1-r16 ENUMERATED {semi-static-model, semi-static-mode2, dynamic} OPTIONAL,
  nrdc-PC-mode-FR2-r16 ENUMERATED {semi-static-model, semi-static-mode2, dynamic} OPTIONAL,
  maxMeasSRS-ResourceSCG-r16 INTEGER (0. . maxNrofCLI-SRS-Resources-r16) OPTIONAL,
  maxMeasCLI-ResourceSCG-r16 INTEGER (0. . maxNrofCLI-RSSI-Resources-r16) OPTIONAL,
  maxNumberEHC-ContextsSN-r16 INTEGER (0..65536) OPTIONAL,
  allowedReducedConfigForOverheating-r16 OverheatingAssistance OPTIONAL,
  maxToffset-r16 T-Offset-r16 OPTIONAL
  ]],
  [[
  allowedReducedConfigForOverheating-r17 OverheatingAssistance-r17 OPTIONAL,
  maxNumberUDC-DRB-r17 INTEGER (0..2) OPTIONAL,
  maxNumberCPCCandidates-r17 INTEGER (0. . maxNrofCondCells-1-r17) OPTIONAL
  ]]
}
SelectedBandEntriesMN : := SEQUENCE (SIZE (1. . maxSimultaneousBands) ) OF BandEntryIndex
BandEntryIndex : := INTEGER (0. . maxNrofServingCells)
PH-TypeListMCG : := SEQUENCE (SIZE (1. . maxNrofServingCells) ) OF PH-InfoMCG
PH-InfoMCG : := SEQUENCE {
  servCellIndex ServCellIndex,
  ph-Uplink PH-UplinkCarrierMCG,
  ph-SupplementaryUplink PH-UplinkCarrierMCG OPTIONAL,
  . . . ,
  [[
  twoSRS-PUSCH-Repetition-r17 ENUMERATED {enabled} OPTIONAL
  ]]
}
PH-UplinkCarrierMCG : := SEQUENCE {
  ph-Typelor3 ENUMERATED {type1, type3},
  . . .
}
BandCombinationInfoList : := SEQUENCE (SIZE (1. . maxBandComb) ) OF BandCombinationInfo
BandCombinationInfo : := SEQUENCE {
  bandCombinationIndex BandCombinationIndex,
  allowedFeatureSetsList SEQUENCE (SIZE (1. . maxFeatureSetsPerBand) ) OF FeatureSetEntryIndex
}
FeatureSetEntryIndex : := INTEGER (1. . maxFeatureSetsPerBand)
DRX-Info : := SEQUENCE {
  drx-LongCycleStartOffset CHOICE {
  ms10 INTEGER (0..9),
  ms20 INTEGER (0..19),
  ms32 INTEGER (0..31),
  ms40 INTEGER (0..39),
  ms60 INTEGER (0..59),
  ms64 INTEGER (0..63),
  ms70 INTEGER (0..69),
  ms80 INTEGER (0..79),
  ms128 INTEGER (0..127),
  ms160 INTEGER (0..159),
  ms256 INTEGER (0..255),
  ms320 INTEGER (0..319),
  ms512 INTEGER (0..511),
  ms640 INTEGER (0..639),
  ms1024 INTEGER (0..1023),
  ms1280 INTEGER (0..1279),
  ms2048 INTEGER (0..2047),
  ms2560 INTEGER (0..2559),
  ms5120 INTEGER (0..5119),
  ms10240 INTEGER (0..10239)
  },
  shortDRX SEQUENCE {
  drx-ShortCycle ENUMERATED {
  ms2, ms3, ms4, ms5, ms6, ms7, ms8, ms10, ms14, ms16, ms20, ms30, ms32,
  ms35, ms40, ms64, ms80, ms128, ms160, ms256, ms320, ms512, ms640, spare9,
  spare8, spare7, spare6, spare5, spare4, spare3, spare2, spare1 },
  drx-ShortCycleTimer INTEGER (1..16)
  } OPTIONAL
}
DRX-Info2 : := SEQUENCE {
  drx-onDurationTimer CHOICE {
  subMilliSeconds INTEGER (1..31),
  milliSeconds ENUMERATED {
  ms1, ms2, ms3, ms4, ms5, ms6, ms8, ms10, ms20, ms30, ms40, ms50, ms60,
  ms80, ms100, ms200, ms300, ms400, ms500, ms600, ms800, ms1000, ms1200,
  ms1600, spare8, spare7, spare6, spare5, spare4, spare3, spare2, spare1 }
  }
}
MeasConfigMN : := SEQUENCE {
  measuredFrequenciesMN SEQUENCE (SIZE (1. . maxMeasFreqsMN) ) OF NR-FreqInfo OPTIONAL,
  measGapConfig SetupRelease { GapConfig } OPTIONAL,
  gapPurpose ENUMERATED {perUE, perFR1} OPTIONAL,
  . . . ,
  [[
  measGapConfigFR2 SetupRelease { GapConfig } OPTIONAL
  ]],
  [[
  interFreqNoGap-r16 ENUMERATED {true} OPTIONAL
  ]]
}
MRDC-AssistanceInfo : := SEQUENCE {
  affectedCarrierFreqCombInfoListMRDC SEQUENCE (SIZE (1. . maxNrofCombIDC) ) OF
AffectedCarrierFreqCombInfoMRDC,
  . . . ,
  [[
  overheatingAssistanceSCG-r16 OCTET STRING (CONTAINING OverheatingAssistance) OPTIONAL
  ]],
  [[
  overheatingAssistanceSCG-FR2-2-r17 OCTET STRING (CONTAINING OverheatingAssistance-r17) OPTIONAL
  ]]
}
AffectedCarrierFreqCombInfoMRDC : : = SEQUENCE {
  victimSystemType VictimSystemType,
  interferenceDirectionMRDC ENUMERATED {eutra-nr, nr, other, utra-nr-other, nr-other, spare3,
spare2, spare1},
  affectedCarrierFreqCombMRDC SEQUENCE {
  affectedCarrierFreqCombEUTRA AffectedCarrierFreqCombEUTRA OPTIONAL,
  affectedCarrierFreqCombNR AffectedCarrierFreqCombNR
  } OPTIONAL
}
VictimSystemType : := SEQUENCE {
  gps ENUMERATED {true} OPTIONAL,
  glonass ENUMERATED {true} OPTIONAL,
  bds ENUMERATED {true} OPTIONAL,
  galileo ENUMERATED {true} OPTIONAL,
  wlan ENUMERATED {true} OPTIONAL,
  bluetooth ENUMERATED {true} OPTIONAL
}
AffectedCarrierFreqCombEUTRA : := SEQUENCE (SIZE (1. . maxNrofServingCellsEUTRA) ) OF ARFCN-
ValueEUTRA
AffectedCarrierFreqCombNR : := SEQUENCE (SIZE (1. . maxNrofServingCells) ) OF ARFCN-ValueNR
CandidateCellListCPC-r17 : := SEQUENCE (SIZE (1..maxFreq) ) OF CandidateCellCPC-r17
CandidateCellCPC-r17 : := SEQUENCE {
  ssbFrequency-r17 ARFCN-ValueNR,
  candidateCellList-r17 SEQUENCE (SIZE (1. . maxNrofCondCells-r16) ) OF PhysCellId
}
-- TAG-CG-CONFIG-INFO-STOP
-- ASN1STOP
```

TABLE 8.8.1-2
CG-ConfigInfo field descriptions
alignedDRX-Indication
This field is signalled upon MN triggered CGI reporting by the UE that requires aligned DRX configurations
between the MCG and the SCG (e.g., same DRX cycle and on-duration configured by MN completely contains
on-duration configured by SN).
allowedBC-ListMRDC
A list of indices referring to band combinations in MR-DC capabilities from which SN is allowed to select the
SCG band combination. Each entry refers to:
- a band combination numbered according to supportedBandCombinationList and
supportedBandCombinationList-UplinkTxSwitch in the UE-MRDC-Capability (in case of (NG)EN-DC), or
according to supportedBandCombinationList and supportedBandCombinationListNEDC-Only in the UE-MRDC-
Capability (in case of NE-DC), or according to supportedBandCombinationList in the UE-NR-Capability (in case
of NR-DC),
- and the Feature Sets allowed for each band entry. All MR-DC band combinations indicated by this field
comprise the MCG band combination, which is a superset of the MCG band(s) selected by MN.
allowedReducedConfigForOverheating
Indicates the reduced configuration that the SCG is allowed to configure.
reducedMaxCCs in allowedReducedConfigForOverheating indicates the maximum number of downlink/uplink
PSCell/SCells that the SCG is allowed to configure. This field is used in (NG)EN-DC and NR-DC.
reducedMaxBW-FR1 and reducedMaxBW-FR2 in allowedReducedConfigForOverheating indicates the
maximum aggregated bandwidth across all downlink/uplink carriers of FR1 and FR2-1, respectively that the
SCG is allowed to configure. reducedMaxBW-FR2-2 in allowedReducedConfigForOverheating-r17 indicates
the maximum aggregated bandwidth across all downlink/uplink carriers of FR2-2 that the SCG is allowed to
configure. This field is only used in NR-DC.
reducedMaxMIMO-LayersFR1 and reducedMaxMIMO-LayersFR2 in allowedReducedConfigForOverheating
indicates the maximum number of downlink/uplink MIMO layers of each serving cell operating on FR1 and
FR2-1, respectively that the SCG is allowed to configure. reducedMaxMIMO-LayersFR2-2 in
allowedReducedConfigForOverheating-r17 indicates the maximum number of downlink/uplink MIMO layers of
each serving cell operating on FR2-2 that the SCG is allowed to configure. This field is only used in NR-DC.
candidateCellInfoListMN, candidateCellInfoListSN
Contains information regarding cells that the master node or the source node suggests the target gNB or DU to
consider configuring. In case of MN initiated CPA or CPC, the field candidateCellInfoListMN contains
information regarding cells that the MN suggests the candidate target secondary node to consider configuring
for MN initiated CPA or CPC.
For (NG)EN-DC, including CSI-RS measurement results in candidateCellInfoListMN is not supported in this
version of the specification. For NR-DC, including SSB and/or CSI-RS measurement results in
candidateCellInfoListMN is supported.
candidateCellInfoListMN-EUTRA, candidateCellInfoListSN-EUTRA
Includes the MeasResultList3EUTRA as specified in [TS36331]. Contains information regarding cells that the
master node or the source node suggests the target secondary eNB to consider configuring. These fields are
only used in NE-DC.
candidateCellListCPC
Contains information regarding cells that the source secondary node suggests the candidate target secondary
node to consider configuring for SN initiated Conditional PSCell Change (CPC).
configRestrictInfo
Includes fields for which SgNB is explicitly indicated to observe a configuration restriction.
scpac-ReferenceConfiguration
Includes the reference configuration for Subsequent CPAC candidates.
drx-ConfigMCG
This field contains the complete DRX configuration of the MCG. This field is only used in NR-DC.
drx-InfoMCG
This field contains the DRX long and short cycle configuration of the MCG. This field is used in (NG)EN-DC and
NE-DC.
drx-InfoMCG2
This field contains the drx-onDuration Timer configuration of the MCG. This field is only used in (NG)EN-DC.
dummy, dummy1
These fields are not used in the specification and SN ignores the received value(s).
fr-InfoListMCG
Contains information of FR information of serving cells that include PCell and SCell(s) configured in MCG.
fr1-Carriers-MCG, fr2-Carriers-MCG
Indicates the number of FR1 or FR2 serving cells configured in MCG.
interFreqNoGap
Indicates that the field interFrequencyConfig-NoGap-r16 has been included within the MeasConfig IE
generated by the MN.
lowMobilityEvaluationConnectedInPCell
Indicates if low mobility criterion has been configured in NR PCell.
maxInterFreqMeasIdentitiesSCG
Indicates the maximum number of allowed measurement identities that the SCG is allowed to configure for
inter-frequency measurement. The maximum value for this field is 10. If the field is absent, the SCG is allowed
to configure inter-frequency measurements up to the maximum value. This field is only used in NR-DC.
maxIntraFreqMeasIdentitiesSCG
Indicates the maximum number of allowed measurement identities that the SCG is allowed to configure for
intra-frequency measurement on each serving frequency. The maximum value for this field is 9 (in case of
(NG)EN-DC or NR-DC) or 10 (in case of NE-DC). If the field is absent, the SCG is allowed to configure intra-
frequency measurements up to the maximum value on each serving frequency.
maxMeasCLI-ResourceSCG
Indicates the maximum number of CLI RSSI resources that the SCG is allowed to configure.
maxMeasFreqsSCG
Indicates the maximum number of NR inter-frequency carriers the SN is allowed to configure with PSCell for
measurements.
maxMeasSRS-ResourceSCG
Indicates the maximum number of SRS resources that the SCG is allowed to configure for CLI measurement.
maxNumberCPCCandidates
Indicates the maximum numbers of conditional reconfigurations the SN is allowed to configure for SN initiated
CPC. Value 0 indicates that the SN is not allowed to configure SN initiated CPC. If the field is absent, the SN is
allowed to configure up to maxNrofCondCells-r16 conditional reconfigurations for SN-initiated CPC.
maxNumberROHC-ContextSessionsSN
Indicates the maximum number of ROHC context sessions allowed to SN terminated bearer, excluding context
sessions that leave all headers uncompressed.
maxNumberEHC-ContextsSN
Indicates the maximum number of EHC contexts allowed to the SN terminated bearer. The field indicates the
number of contexts in addition to CID = ″all zeros″, as specified in [TS38323].
maxNumberUDC-DRB
Indicates the maximum number of UDC DRBs allowed to SN terminated bearer. This field is used in NGEN-
DC, NR-DC and NE-DC.
maxToffset
Indicates the maximum Toffset value the SN is allowed to use for scheduling SCG transmissions (see TS
38.213 [13]). This field is used in NR-DC only when the fields nrdc-PC-mode-FR1-r16 or nrdc-PC-mode-FR2-
r16 are set to dynamic. Value ms0dot5 corresponds to 0.5 ms, value ms0dot75 corresponds to 0.75 ms, value
ms1 corresponds to 1 ms and so on.
measuredFrequenciesMIN
Used by MN to indicate a list of frequencies measured by the UE.
measGapConfig
Indicates the FR1 and perUE measurement gap configuration configured by MN.
measGapConfigFR2
Indicates the FR2 measurement gap configuration configured by MN.
mcg-RB-Config
Contains all of the fields in the IE RadioBearerConfig used in MN, used by the SN to support delta configuration
to UE (e.g., when MN does not use full configuration option), for bearer type change between MN terminated
bearer with NR PDCP to SN terminated bearer. It is also used to indicate the PDCP duplication related
information for MN terminated split bearer (whether duplication is configured and if so, whether it is initially
activated) in SN Addition/Modification procedure. Otherwise, this field is absent.
measResultReportCGI, measResultReportCGI-EUTRA
Used by MN to provide SN with CGI-Info for the cell as per SN's request. In this version of the specification, the
measResultReportCGI is used for (NG)EN-DC and NR-DC and the measResultReportCGI-EUTRA is used only
for NE-DC.
measResultSCG-EUTRA
This field includes the MeasResultSCG-FailureMRDC IE as specified in [TS36331]. This field is only used in
NE-DC.
measResultSFTD-EUTRA
SFTD measurement results between the PCell and the E-UTRA PScell in NE-DC. This field is only used in NE-
DC.
mrdc-AssistanceInfo
Contains the IDC assistance information for MR-DC reported by the UE (see [TS36331]).
nrdc-PC-mode-FR1
Indicates the uplink power sharing mode that the UE uses in NR-DC FR1 (see TS 38.213 [13], clause 7.6).
nrdc-PC-mode-FR2
Indicates the uplink power sharing mode that the UE uses in NR-DC FR2 (see TS 38.213 [13], clause 7.6).
overheatingAssistanceSCG
Contains the UE's preference on reduced configuration for NR SCG to address overheating. This field is only
used in (NG)EN-DC.
overheatingAssistanceSCG-FR2-2
Contains the UE's preference on reduced configuration for NR SCG on FR2-2 to address overheating. This
field is only used in (NG)EN-DC.
p-maxEUTRA
Indicates the maximum total transmit power to be used by the UE in the E-UTRA cell group (see TS 36.104
[33]). This field is used in (NG)EN-DC and NE-DC.
p-maxNR-FR1
For (NG)EN-DC and NE-DC, the field indicates the maximum total transmit power to be used by the UE in the
NR cell group across all serving cells in frequency range 1 (FR1) (see TS 38.104 [12]). For NR-DC, it indicates
the maximum total transmit power to be used by the UE in the NR cell group across all serving cells in
frequency range 1 (FR1) (see TS 38.104 [12]) the UE can use in NR SCG.
p-maxUE-FR1
Indicates the maximum total transmit power to be used by the UE across all serving cells in frequency range 1
(FR1)
p-maxNR-FR1-MCG
Indicates the maximum total transmit power to be used by the UE in the NR cell group across all serving cells
in frequency range 1 (FR1) (see TS 38.104 [12]) the UE can use in NR MCG. This field is only used in NR-DC.
p-maxNR-FR2-SCG
Indicates the maximum total transmit power to be used by the UE in the NR cell group across all serving cells
in frequency range 2 (FR2) (see TS 38.104 [12]) the UE can use in NR SCG.
p-maxUE-FR2
Indicates the maximum total transmit power to be used by the UE across all serving cells in frequency range 2
(FR2).
p-maxNR-FR2-MCG
Indicates the maximum total transmit power to be used by the UE in the NR cell group across all serving cells
in frequency range 2 (FR2) (see TS 38.104 [12]) the UE can use in NR MCG.
pdcch-BlindDetectionSCG
Indicates the maximum value of the reference number of cells for PDCCH blind detection allowed to be
configured for the SCG.
ph-InfoMCG
Power headroom information in MCG that is needed in the reception of PHR MAC CE in SCG.
ph-SupplementaryUplink
Power headroom information for supplementary uplink. For UE in (NG)EN-DC, this field is absent.
ph-Type1or3
Type of power headroom for a serving cell in MCG (PCell and activated SCells). type1 refers to type 1 power
headroom, type3 refers to type 3 power headroom (see e.g., [TS38321]).
ph-Uplink
Power headroom information for uplink.
powerCoordination-FR1
Indicates the maximum power that the UE can use in FR1.
powerCoordination-FR2
Indicates the maximum power that the UE can use in frequency range 2 (FR2). This field is only used in NR-
DC.
scgFailureInfo
Contains SCG failure type and measurement results. In case the sender has no measurement results
available, the sender may include one empty entry (e.g., without any optional fields present) in
measResultPerMOList. This field is used in (NG)EN-DC and NR-DC.
scg-RB-Config
Contains all of the fields in the IE RadioBearerConfig used in SN, used to allow the target SN to use delta
configuration to the UE, e.g. during SN change. The field is signalled upon change of SN unless MN uses full
configuration option. Otherwise, the field is absent.
selectedBandEntriesMNList
A list of indices referring to the position of a band entry selected by the MN, in each band combination entry in
allowedBC-ListMRDC IE. BandEntryIndex 0 identifies the first band in the bandList of the BandCombination,
BandEntryIndex 1 identifies the second band in the bandList of the BandCombination, and so on. This
selectedBandEntriesMNList includes the same number of entries, and listed in the same order as in
allowedBC-ListMRDC. The SN uses this information to determine which bands out of the NR band
combinations in allowedBC-ListMRDC it can configure in SCG in NR-DC. The SN can use this information to
determine for which band pair(s) it should check SimultaneousRxTxPerBandPair.
servCellIndexRangeSCG
Range of serving cell indices that SN is allowed to configure for SCG serving cells.
servCellInfoListMCG-EUTRA
Indicates the carrier frequency and the transmission bandwidth of the serving cell(s) in the MCG in intra-band
(NG)EN-DC. The field is needed when MN and SN operate serving cells in the same band for either contiguous
or non-contiguous intra-band band combination or LTE NR inter-band band combinations where the frequency
range of the E-UTRA band is a subset of the frequency range of the NR band (as specified in Table 5.5B.4.1-1
of TS 38.101-3 [34]) in (NG)EN-DC.
servCellInfoListMCG-NR
Indicates the frequency band indicator, carrier center frequency, UE specific channel bandwidth and SCS of the
serving cell(s) in the MCG in intra-band NE-DC. The field is needed when MN and SN operate serving cells in
the same band for either contiguous or non-contiguous intra-band band combination or LTE NR inter-band
band combinations where the frequency range of the E-UTRA band is a subset of the frequency range of the
NR band (as specified in Table 5.5B.4.1-1 of TS 38.101-3 [34]) in NE-DC.
servFrequenciesMN-NR
Indicates the frequency of all serving cells that include PCell and SCell(s) with SSB configured in MCG. This
field is only used in NR-DC. servFrequenciesMN-NR indicates absoluteFrequencySSB.
sftdFrequencyList-NR
Includes a list of SSB frequencies. Each entry identifies the SSB frequency of a PSCell, which corresponds to
one MeasResultCellSFTD-NR entry in the MeasResultCellListSFTD-NR.
sftdFrequencyList-EUTRA
Includes a list of E-UTRA frequencies. Each entry identifies the carrier frequency of a PSCell, which
corresponds to one MeasResultSFTD-EUTRA entry in the MeasResultCellListSFTD-EUTRA.
sidelinkUEInformationEUTRA
This field contains the E-UTRA SidelinkUEInformation message as specified in [TS36331].
sidelinkUEInformationNR
This field contains the NR SidelinkUEInformationNR message.
sourceConfigSCG
Includes all of the current SCG configurations used by the target SN to build delta configuration to be sent to
UE, e.g. during SN change. The field contains the RRCReconfiguration message, e.g. including
secondaryCellGroup and measConfig. The field is signalled upon change of SN, unless MN uses full
configuration option. Otherwise, the field is absent.
sourceConfigSCG-EUTRA
Includes the E-UTRA RRCConnectionReconfiguration message as specified in [TS36331]. In this version of the
specification, the E-UTRA RRC message can only include the field scg-Configuration. In this version of the
specification, this field is absent when master gNB uses full configuration option. This field is only used in NE-
DC.
twoPHRModeMCG
Indicates if the power headroom for MCG shall be reported as two PHRs (each PHR associated with a SRS
resource set) is enabled or not.
twoSRS-PUSCH-Repetition
Indicates whether the indicated serving cell is configured for PUSCH repetition corresponding to two SRS
resource sets configured in either srs-ResourceSetToAddModList or srs-ResourceSetToAddModListDCI-0-2
with usage ′codebook′ or ′noncodebook′.
ueAssistanceInformationSourceSCG
Includes for each UE assistance feature associated with the SCG, the information last reported by the UE in
the NR UEAssistanceInformation message for the source SCG, if any.
ue-CapabilityInfo
Contains the IE UE-CapabilityRAT-ContainerList supported by the UE (see NOTE 3). A gNB that retrieves
MRDC related capability containers ensures that the set of included MRDC containers is consistent w.r.t. the
feature set related information.
BandCombinationInfo field descriptions
allowedFeatureSetsList
Defines a subset of the entries in a FeatureSetCombination. Each index identifies a position in the
FeatureSetCombination, which corresponds to one FeatureSetUplink/Downlink for each band entry in the
associated band combination.
bandCombinationIndex
In case of NR-DC, this field indicates the position of a band combination in the supportedBandCombinationList.
In case of NE-DC, this field indicates the position of a band combination in the supportedBandCombinationList
and/or supportedBandCombinationListNEDC-Only. In case of (NG)EN-DC, this field indicates the position of a
band combination in the supportedBandCombinationList and/or supportedBandCombinationList-
UplinkTxSwitch. Band combination entries in supportedBandCombinationList are referred by an index which
corresponds to the position of a band combination in the supportedBandCombinationList. Band combination
entries in supportedBandCombinationListNEDC-Only are referred by an index which corresponds to the
position of a band combination in the supportedBandCombinationListNEDC-Only increased by the number of
entries in supportedBandCombinationList. Band combination entries in supportedBandCombinationList-
UplinkTxSwitch are referred by an index which corresponds to the position of a band combination in the
supportedBandCombinationList-UplinkTxSwitch increased by the number of entries in
supportedBandCombinationList.

TABLE 8.8.1-3

| Conditional Presence | Explanation |
|---|---|
| SN-AddMod | The field is mandatory present upon SN addition and SN change. It is optionally |
| | present upon SN modification and inter-MN handover without SN change. |
| | Otherwise, the field is absent. |

In some examples, table 8.8.1-4 indicates per MN RAT and SN RAT whether RAT capabilities are included or not in ue-CapabilityInfo.

TABLE 8.8.1-4

| MN RAT | SN RAT | NR capabilities | E-UTRA capabilities | MR-DC capabilities |
|---|---|---|---|---|
| E-UTRA | NR | Need not be included if the | Not included | Need not be included if |
| | | UE Radio Capability ID as | | the UE Radio Capability |
| | | specified in [TS23502] is | | ID as specified in |
| | | used. Included otherwise | | [TS23502] is used. |
| | | | | Included otherwise |
| NR | E-UTRA | Not included | Need not be included if the | Need not be included if |
| | | | UE Radio Capability ID as | the UE Radio Capability |
| | | | specified in [TS23502] is | ID as specified in |
| | | | used. Included otherwise | [TS23502] is used. |
| | | | | Included otherwise |
| NR | NR | Need not be included if the | Not included | Not included |
| | | UE Radio Capability ID as | | |
| | | specified in [TS23502] is | | |
| | | used. Included otherwise | | |

### 9. NETWORK, SYSTEM, AND DEVICE CONFIGURATIONS AND ARRANGEMENTS

FIG. 54 depicts an example network architecture 5400. The network 5400 may operate in a manner consistent with 3GPP technical specifications for LTE or 5G/NR systems. However, the example embodiments are not limited in this regard and the described examples may apply to other networks that benefit from the principles described herein, such as future 3GPP systems, or the like.

The network 5400 includes a UE 5402, which is any mobile or non-mobile computing device designed to communicate with a RAN 5404 via an over-the-air connection. The UE 5402 is communicatively coupled with the RAN 5404 by a Uu interface, which may be applicable to both LTE and NR systems. Examples of the UE 5402 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein. The UE 5402 may be the same or similar to any of the other UEs discussed herein such as, for example, UE 5502, hardware resources 5600, and/or any other UE discussed herein.

The network 5400 may include a set of UEs 5402 coupled directly with one another via a device-to-device (D2D), proximity services (ProSe), PCS, and/or sidelink (SL) interface, and/or any other suitable interface such as any of those discussed herein. These UEs 5402 may be M2M, D2D, MTC, and/or IoT devices, and/or V2X systems that communicate using physical sidelink channels such as, but not limited to, PSBCH, PSDCH, PSSCH, PSCCH, PSFCH, and the like. The UE 5402 may perform blind decoding attempts of SL channels/links according to the various examples herein.

In some examples, the UE 5402 may additionally communicate with an AP 5406 via an over-the-air (OTA) connection. The AP 5406 manages a WLAN connection, which may serve to offload some/all network traffic from the RAN 5404. The connection between the UE 5402 and the AP 5406 may be consistent with any IEEE 802.11 protocol. Additionally, the UE 5402, RAN 5404, and AP 5406 may utilize cellular-WLAN aggregation/integration (e.g., LWA/LWIP). Cellular-WLAN aggregation may involve the UE 5402 being configured by the RAN 5404 to utilize both cellular radio resources and WLAN resources.

The RAN 5404 includes one or more network access nodes (NANs) 5414 (also referred to as “RAN nodes 5414”). The NANs 5414 terminate air-interface(s) for the UE 5402 by providing access stratum protocols including RRC, PDCP, RLC, MAC, and PHY/L1 protocols. In this manner, the NAN 5414 enables data/voice connectivity between a core network (CN) 5440 and the UE 5402. The NANs 5414 may be a macrocell base station or a low power base station for providing femtocells, picocells or other like cells having smaller coverage areas, smaller user capacity, or higher bandwidth compared to macrocells; or some combination thereof. In these implementations, a NAN 5414 may be referred to as a base station (BS), next generation nodeB (gNB), RAN node, eNodeB (eNB), next generation (ng)-eNB, NodeB, RSU, TRP, and/or the like.

One example implementation is a “CU/DU split” architecture where the NANs 5414 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The NANs 5414 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The set of NANs 5414 are coupled with one another via respective X2 interfaces if the RAN 5404 is an LTE RAN or Evolved Universal Terrestrial Radio Access Network (E-UTRAN), or respective Xn interfaces if the RAN 5404 is a NG-RAN 5404. The X2/Xn interfaces, which may be separated into control/user plane interfaces in some examples, may allow the ANs to communicate information related to handovers, data/context transfers, mobility, load management, interference coordination, and the like.

The NANs 5414 of the RAN 5404 may each manage one or more cells, cell groups, component carriers, and the like to provide the UE 5402 with an air interface for network access. The UE 5402 may be simultaneously connected with a set of cells provided by the same or different NANs 5414 of the RAN 5404. For example, the UE 5402 and RAN 5404 may use carrier aggregation (CA) to allow the UE 5402 to connect with a set of component carriers, each corresponding to a Pcell or Scell. In dual connectivity scenarios, a first NAN 5414 may be a master node that provides an MCG and a second NAN 5414 may be secondary node that provides an SCG. The first/second NANs 5414 may be any combination of eNB, gNB, ng-eNB, and the like.

The RAN 5404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

Additionally or alternatively, individual UEs 5402 provide radio information to one or more NANs 5414 and/or one or more edge compute nodes (e.g., edge servers/hosts, and the like). The radio information may be in the form of one or more measurement reports, and/or may include, for example, signal strength measurements, signal quality measurements, and/or the like. Each measurement report is tagged with a timestamp and the location of the measurement (e.g., the UEs 5402 current location). As examples, the measurements collected by the UEs 5402 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (a/NO), energy per chip to interference power density ratio (Ec/I0), energy per chip to noise power density ratio (Ec/N0), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP 5406 or RAN node 5414 reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v17.0.0 (2022-03-31), 3GPP TS 38.215 v17.3.0 (2023 Mar. 30) (“[TS38215]”), 3GPP TS 38.314 v17.3.0 (2023 Jun. 30), and/or [IEEE80211], the contents of each of which are hereby incorporated by reference in their entireties. Additionally or alternatively, any of the aforementioned measurements (or combination of measurements) may be collected by one or more NANs 5414 and provided to the edge compute node(s).

Additionally or alternatively, the measurements can include one or more of the following measurements: measurements related to Data Radio Bearer (DRB) (e.g., number of DRBs attempted to setup, number of DRBs successfully setup, number of released active DRBs, in-session activity time for DRB, number of DRBs attempted to be resumed, number of DRBs successfully resumed, and the like); measurements related to RRC (e.g., mean number of RRC connections, maximum number of RRC connections, mean number of stored inactive RRC connections, maximum number of stored inactive RRC connections, number of attempted, successful, and/or failed RRC connection establishments, and the like); measurements related to UE Context (UECNTX); measurements related to Radio Resource Utilization (RRU) (e.g., DL total PRB usage, UL total PRB usage, distribution of DL total PRB usage, distribution of UL total PRB usage, DL PRB used for data traffic, UL PRB used for data traffic, DL total available PRBs, UL total available PRBs, and the like); measurements related to Registration Management (RM); measurements related to Session Management (SM) (e.g., number of PDU sessions requested to setup; number of PDU sessions successfully setup; number of PDU sessions failed to setup, and the like); measurements related to GTP Management (GTP); measurements related to IP Management (IP); measurements related to Policy Association (PA); measurements related to Mobility Management (MM) (e.g., for inter-RAT, intra-RAT, and/or Intra/Inter-frequency handovers and/or conditional handovers: number of requested, successful, and/or failed handover preparations; number of requested, successful, and/or failed handover resource allocations; number of requested, successful, and/or failed handover executions; mean and/or maximum time of requested handover executions; number of successful and/or failed handover executions per beam pair, and the like); measurements related to Virtualized Resource(s) (VR); measurements related to Carrier (CARR); measurements related to QoS Flows (QF) (e.g., number of released active QoS flows, number of QoS flows attempted to release, in-session activity time for QoS flow, in-session activity time for a UE 5402, number of QoS flows attempted to setup, number of QoS flows successfully established, number of QoS flows failed to setup, number of initial QoS flows attempted to setup, number of initial QoS flows successfully established, number of initial QoS flows failed to setup, number of QoS flows attempted to modify, number of QoS flows successfully modified, number of QoS flows failed to modify, and the like); measurements related to Application Triggering (AT); measurements related to Short Message Service (SMS); measurements related to Power, Energy and Environment (PEE); measurements related to NF service (NFS); measurements related to Packet Flow Description (PFD); measurements related to Random Access Channel (RACH); measurements related to Measurement Report (MR); measurements related to Layer 1 Measurement (LIM); measurements related to Network Slice Selection (NSS); measurements related to Paging (PAG); measurements related to Non-IP Data Delivery (NIDD); measurements related to external parameter provisioning (EPP); measurements related to traffic influence (TI); measurements related to Connection Establishment (CE); measurements related to Service Parameter Provisioning (SPP); measurements related to Background Data Transfer Policy (BDTP); measurements related to Data Management (DM); and/or any other performance measurements such as those discussed in 3GPP TS 28.552 v18.3.0 (2023 Jun. 27) and 3GPP TS 32.425 v17.1.0 (2021 Jun. 24), the contents of each of which are hereby incorporated by reference in their entireties.

The radio information may be reported in response to a trigger event and/or on a periodic basis. Additionally or alternatively, individual UEs 5402 report radio information either at a low periodicity or a high periodicity depending on a data transfer that is to take place, and/or other information about the data transfer. Additionally or alternatively, the edge compute node(s) may request the measurements from the NANs 5414 at low or high periodicity, or the NANs 5414 may provide the measurements to the edge compute node(s) at low or high periodicity. Additionally or alternatively, the edge compute node(s) may obtain other relevant data from other edge compute node(s), core network functions (NFs), application functions (AFs), and/or other UEs 5402 such as Key Performance Indicators (KPIs), with the measurement reports or separately from the measurement reports.

Additionally or alternatively, in cases where is discrepancy in the observation data from one or more UEs, one or more RAN nodes, and/or core network NFs (e.g., missing reports, erroneous data, and the like) simple imputations may be performed to supplement the obtained observation data such as, for example, substituting values from previous reports and/or historical data, apply an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g., the value exceeds an acceptable range/bounds, or the like), such values may be dropped for the current learning/training episode or epoch. For example, on packet delivery delay bounds may be defined or configured, and packets determined to have been received after the packet delivery delay bound may be dropped.

The UE 5402 can also perform determine reference signal (RS) measurement and reporting procedures to provide the network with information about the quality of one or more wireless channels and/or the communication media in general, and this information can be used to optimize various aspects of the communication system. As examples, the measurement and reporting procedures performed by the UE 5402 can include those discussed in 3GPP TS 38.211 v17.5.0 (2023 Jun. 26), 3GPP TS 38.212 v17.5.0 (2023 Mar. 30) (“[TS38212]”), 3GPP TS 38.213 v17.6.0 (2023 Jun. 26) (“[TS38213]”), 3GPP TS 38.214 v17.6.0 (2023 Jun. 26) (“[TS38214]”), [TS38215], 3GPP TS 38.101-1 v18.2.0 (2023 Jun. 30), 3GPP TS 38.104 v18.2.0 (2023 Jun. 30), 3GPP TS 38.133 v18.2.0 (2023 Jun. 30), and [TS38331], the contents of each of which are incorporated by reference in their entireties. The physical signals and/or reference signals can include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), and sounding reference signal (SRS).

In any of the examples discussed herein, any suitable data collection and/or measurement mechanism(s) may be used to collect the observation data. For example, data marking (e.g., sequence numbering, and the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various software parameters (e.g., OS type and version, and the like). Various configurations may be used to define any of the aforementioned data collection parameters. Such configurations may be defined by suitable specifications/standards, such as 3GPP (e.g., [3GPPEdge]), ETSI (e.g., [MEC]), [O-RAN], Intel® Smart Edge Open (formerly OpenNESS) (e.g., [ISEO]), IETF (e.g., [MAMS]), IEEE/WiFi (e.g., [IEEE80211], and the like), and/or any other like standards such as those discussed herein.

In some examples, the RAN 5404 is an E-UTRAN with one or more eNBs, and provides an LTE air interface (Uu) with the parameters and characteristics at least as discussed in 3GPP TS 36.300 v17.2.0 (2022 Sep. 30) (“[TS36300]”), the contents of which are hereby incorporated by reference in its entirety. In some examples, the RAN 5404 is an next generation (NG)-RAN 5404 with a set of RAN nodes 5414 (including gNBs 5414a and ng-eNBs 5414b). Each gNB 5414a connects with 5G-enabled UEs 5402 using a 5G-NR Uu interface with parameters and characteristics as discussed in [TS38300], among many other 3GPP standards, including any of those discussed herein. Where the NG-RAN 5404 includes a set of ng-eNBs 5414b, the one or more ng-eNBs 5414b connect with a UE 5402 via the 5G Uu and/or LTE Uu interface. The gNBs 5414a and the ng-eNBs 5414b connect with the 5GC 5440 through respective NG interfaces, which include an N2 interface, an N3 interface, and/or other interfaces. The gNBs 5414a and the ng-eNBs 5414b are connected with each other over an Xn interface. Additionally, individual gNBs 5414a are connected to one another via respective Xn interfaces, and individual ng-eNBs 5414b are connected to one another via respective Xn interfaces. In some examples, the NG interface may be split into two parts, an NG user plane (NG-U) interface, which carries traffic data between the nodes of the NG-RAN 5404 and a UPF 5448 (e.g., N3 interface), and an NG control plane (NG-C) interface, which is a signaling interface between the nodes of the NG-RAN 5404 and an AMF 5444 (e.g., N2 interface).

The NG-RAN 5404 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a DL resource grid that includes PSS/SSS/PBCH.

The 5G-NR air interface may utilize BWPs for various purposes. For example, BWP can be used for dynamic adaptation of the SCS. For example, the UE 5402 can be configured with multiple BWPs where each BWP configuration has a different SCS. When a BWP change is indicated to the UE 5402, the SCS of the transmission is changed as well. Another use case example of BWP is related to power saving. In particular, multiple BWPs can be configured for the UE 5402 with different amount of frequency resources (e.g., PRBs) to support data transmission under different traffic loading scenarios. A BWP containing a smaller number of PRBs can be used for data transmission with small traffic load while allowing power saving at the UE 5402 and in some cases at the gNB 5414a. A BWP containing a larger number of PRBs can be used for scenarios with higher traffic load.

In some implementations, individual gNBs 5414a can include a gNB-CU (e.g., CU 5732) and a set of gNB-DUs (e.g., DUs 5731). Additionally or alternatively, gNBs 5414a can include one or more RUs. In these implementations, the gNB-CU may be connected to each gNB-DU via respective F1 interfaces. In case of network sharing with multiple cell ID broadcast(s), each cell identity associated with a subset of PLMNs corresponds to a gNB-DU and the gNB-CU it is connected to, share the same physical layer cell resources. For resiliency, a gNB-DU may be connected to multiple gNB-CUs by appropriate implementation. Additionally, a gNB-CU can be separated into gNB-CU control plane (gNB-CU-CP) and gNB-CU user plane (gNB-CU-UP) functions. The gNB-CU-CP 5732c is connected to a gNB-DU through an F1 control plane interface (F1-C), the gNB-CU-UP 5732u is connected to the gNB-DU through an F1 user plane interface (F1-U), and the gNB-CU-UP 5732u is connected to the gNB-CU-CP 5732c through an El interface. In some implementations, one gNB-DU is connected to only one gNB-CU-CP 5732c, and one gNB-CU-UP 5732u is connected to only one gNB-CU-CP 5732c. For resiliency, a gNB-DU and/or a gNB-CU-UP 5732u may be connected to multiple gNB-CU-CPs by appropriate implementation. One gNB-DU can be connected to multiple gNB-CU-UPs under the control of the same gNB-CU-CP 5732c, and one gNB-CU-UP 5732u can be connected to multiple DUs under the control of the same gNB-CU-CP 5732c. Data forwarding between gNB-CU-UPs during intra-gNB-CU-CP 5732c handover within a gNB may be supported by Xn-U. Similarly, individual ng-eNBs 5414b can include an ng-eNB-CU and a set of ng-eNB-DUs. In these implementations, the ng-eNB-CU and each ng-eNB-DU are connected to one another via respective W1 interface. An ng-eNB can include an ng-eNB-CU-CP 5732c, one or more ng-eNB-CU-UP(s), and one or more ng-eNB-DU(s). An ng-eNB-CU-CP 5732c and an ng-eNB-CU-UP 5732u is connected via the E1 interface. An ng-eNB-DU is connected to an ng-eNB-CU-CP 5732c via the W1-C interface, and to an ng-eNB-CU-UP 5732u via the W1-U interface. The general principle described herein w.r.t gNB aspects also applies to ng-eNB aspects and corresponding E1 and W1 interfaces, if not explicitly specified otherwise.

The node hosting user plane part of the PDCP protocol layer (e.g., gNB-CU, gNB-CU-UP 5732u, and for EN-DC, MeNB or SgNB depending on the bearer split) performs user inactivity monitoring and further informs its inactivity or (re)activation to the node having control plane connection towards the core network (e.g., over E1, X2, or the like). The node hosting the RLC protocol layer (e.g., gNB-DU) may perform user inactivity monitoring and further inform its inactivity or (re)activation to the node hosting the control plane (e.g., gNB-CU or gNB-CU-CP).

In these implementations, the NG-RAN 5404, is layered into a Radio Network Layer (RNL) and a Transport Network Layer (TNL). The NG-RAN 5404 architecture (e.g., the NG-RAN logical nodes and interfaces between them) is part of the RNL. For each NG-RAN interface (e.g., NG, Xn, F1, and the like) the related TNL protocol and the functionality are specified. The TNL provides services for user plane transport and/or signaling transport. In NG-Flex configurations, each NG-RAN node is connected to all AMFs 5444 of AMF sets within an AMF region supporting at least one slice also supported by the NG-RAN node. The AMF Set and the AMF Region are defined in [TS23501].

The RAN 5404 is communicatively coupled to CN 5440 that includes network elements and/or network functions (NFs) to provide various functions to support data and telecommunications services to customers/subscribers (e.g., UE 5402). The components of the CN 5440 may be implemented in one physical node or separate physical nodes. In some examples, NFV may be utilized to virtualize any or all of the functions provided by the network elements of the CN 5440 onto physical compute/storage resources in servers, switches, and the like. A logical instantiation of the CN 5440 may be referred to as a network slice, and a logical instantiation of a portion of the CN 5440 may be referred to as a network sub-slice.

In the example of FIG. 54, the CN 5440 is a 5GC 5440 including an Authentication Server Function (AUSF) 5442, Access and Mobility Management Function (AMF) 5444, Session Management Function (SMF) 5446, User Plane Function (UPF) 5448, Network Slice Selection Function (NSSF) 5450, Network Exposure Function (NEF) 5452, Network Repository Function (NRF) 5454, Policy Control Function (PCF) 5456, Unified Data Management (UDM) 5458, Unified Data Repository (UDR), Application Function (AF) 5460, and Network Data Analytics Function (NWDAF) 5462 coupled with one another over various interfaces as shown. The NFs in the 5GC 5440 are briefly introduced as follows.

The NWDAF 5462 includes one or more of the following functionalities: support data collection from NFs and AFs 5460; support data collection from OAM; NWDAF service registration and metadata exposure to NFs and AFs 5460; support analytics information provisioning to NFs and AFs 5460; support machine learning (ML) model training and provisioning to NWDAF(s) 5462 (e.g., those containing analytics logical function). Some or all of the NWDAF functionalities can be supported in a single instance of an NWDAF 5462. The NWDAF 5462 also includes an analytics reporting capability, which comprises means that allow discovery of the type of analytics that can be consumed by an external party and/or the request for consumption of analytics information generated by the NWDAF 5462.

The NWDAF 5462 interacts with different entities for different purposes, such as one or more of the following: data collection based on subscription to events provided by AMF 5444, SMF 5446, PCF 5456, UDM 5458, NSACF, AF 5460 (directly or via NEF 5452) and OAM (not shown); analytics and data collection using the Data Collection Coordination Function (DCCF); retrieval of information from data repositories (e.g., UDR via UDM 5458 for subscriber-related information); data collection of location information from LCS system; storage and retrieval of information from an Analytics Data Repository Function (ADRF); analytics and data collection from a Messaging Framework Adaptor Function (MFAF); retrieval of information about NFs (e.g., from NRF 5454 for NF-related information); on-demand provision of analytics to consumers, as specified in clause 6 of [TS23288]; and/or provision of bulked data related to analytics ID(s). NWDAF discovery and selection procedures are discussed in clause 6.3.13 in [TS23501] and clause 5.2 of [TS23288]. Additional aspects of NWDAF 5462 functionality are defined in 3GPP TS 23.288 v18.2.0 (2023 Jun. 21) (“[TS23288]”).

The AUSF 5442 stores data for authentication of UE 5402 and handle authentication-related functionality. The AUSF 5442 may facilitate a common authentication framework for various access types.

The AMF 5444 allows other functions of the 5GC 5440 to communicate with the UE 5402 and the RAN 5404 and to subscribe to notifications about mobility events w.r.t the UE 5402. The AMF 5444 is also responsible for registration management (e.g., for registering UE 5402), connection management, reachability management, mobility management, lawful interception of AMF-related events, and access authentication and authorization. The AMF 5444 provides transport for SM messages between the UE 5402 and the SMF 5446, and acts as a transparent proxy for routing SM messages. AMF 5444 also provides transport for SMS messages between UE 5402 and an SMSF. AMF 5444 interacts with the AUSF 5442 and the UE 5402 to perform various security anchor and context management functions. Furthermore, AMF 5444 is a termination point of a RAN-CP interface, which includes the N2 reference point between the RAN 5404 and the AMF 5444. The AMF 5444 is also a termination point of NAS (N1) signaling, and performs NAS ciphering and integrity protection.

The AMF 5444 also supports NAS signaling with the UE 5402 over an N3IWF interface. The N3IWF provides access to untrusted entities. N3IWF may be a termination point for the N2 interface between the (R)AN 5404 and the AMF 5444 for the control plane, and may be a termination point for the N3 reference point between the (R)AN 5404 and the 5448 for the user plane. As such, the AMF 5444 handles N2 signaling from the SMF 5446 and the AMF 5444 for PDU sessions and QoS, encapsulate/de-encapsulate packets for IPSec and N3 tunneling, marks N3 user-plane packets in the UL, and enforces QoS corresponding to N3 packet marking taking into account QoS requirements associated with such marking received over N2. N3IWF may also relay UL and DL control-plane NAS signaling between the UE 5402 and AMF 5444 via an N1 reference point between the UE 5402 and the AMF 5444, and relay UL and DL user-plane packets between the UE 5402 and UPF 5448. The N3IWF also provides mechanisms for IPsec tunnel establishment with the UE 5402. The AMF 5444 may exhibit an Namf service-based interface, and may be a termination point for an N14 reference point between two AMFs 5444 and an N17 reference point between the AMF 5444 and a 5G-EIR (not shown by FIG. 54). In addition to the functionality of the AMF 5444 described herein, the AMF 5444 may provide support for Network Slice restriction and Network Slice instance restriction based on NWDAF analytics.

The SMF 5446 is responsible for SM (e.g., session establishment, tunnel management between UPF 5448 and RAN node 5414); UE IP address allocation and management (including optional authorization); selection and control of UP function; configuring traffic steering at UPF 5448 to route traffic to proper destination; termination of interfaces toward policy control functions; controlling part of policy enforcement, charging, and QoS; lawful intercept (for SM events and interface to LI system); termination of SM parts of NAS messages; DL data notification; initiating AN specific SM information, sent via AMF 5444 over N2 to RAN node 5414; and determining SSC mode of a session. SM refers to management of a PDU session, and a PDU session or “session” refers to a PDU connectivity service that provides or enables the exchange of PDUs between the UE 5402 and the DN 5436. The SMF 5446 may also include the following functionalities to support edge computing enhancements (see e.g., [TS23548]): selection of EASDF 5461 and provision of its address to the UE as the DNS server for the PDU session; usage of EASDF 5461 services as defined in [TS23548]; and for supporting the application layer architecture defined in [TS23558], provision and updates of ECS address configuration information to the UE. Discovery and selection procedures for EASDFs 5461 is discussed in [TS23501] § 6.3.23.

The UPF 5448 acts as an anchor point for intra-RAT and inter-RAT mobility, an external PDU session point of interconnect to data network 5436, and a branching point to support multi-homed PDU session. The UPF 5448 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs UL traffic verification (e.g., SDF-to-QoS flow mapping), transport level packet marking in the UL and DL, and performs DL packet buffering and DL data notification triggering. UPF 5448 may include an UL classifier to support routing traffic flows to a data network.

The NSSF 5450 selects a set of network slice instances serving the UE 5402. The NSSF 5450 also determines allowed NSSAI and the mapping to the subscribed S-NSSAIs, if needed. The NSSF 5450 also determines an AMF set to be used to serve the UE 5402, or a list of candidate AMFs 5444 based on a suitable configuration and possibly by querying the NRF 5454. The selection of a set of network slice instances for the UE 5402 may be triggered by the AMF 5444 with which the UE 5402 is registered by interacting with the NSSF 5450; this may lead to a change of AMF 5444. The NSSF 5450 interacts with the AMF 5444 via an N22 reference point; and may communicate with another NSSF in a visited network via an N31 reference point (not shown).

The NEF 5452 securely exposes services and capabilities provided by 3GPP NFs for third party, internal exposure/re-exposure, AFs 5460, edge computing networks/frameworks, and the like. In such examples, the NEF 5452 may authenticate, authorize, or throttle the AFs 5460. The NEF 5452 stores/retrieves information as structured data using the Nudr interface to a Unified Data Repository (UDR). The NEF 5452 also translates information exchanged with the AF 5460 and information exchanged with internal NFs. For example, the NEF 5452 may translate between an AF-Service-Identifier and an internal 5GC information, such as DNN, S-NSSAI, as described in clause 5.6.7 of [TS23501]. In particular, the NEF 5452 handles masking of network and user sensitive information to external AF's 5460 according to the network policy. The NEF 5452 also receives information from other NFs based on exposed capabilities of other NFs. This information may be stored at the NEF 5452 as structured data, or at a data storage NF using standardized interfaces. The stored information can then be re-exposed by the NEF 5452 to other NFs and AFs, or used for other purposes such as analytics.

The NRF 5454 supports service discovery functions, receives NF discovery requests from NF instances, and provides information of the discovered NF instances to the requesting NF instances. The NRF 5454 also maintains NF profiles of available NF instances and their supported services. The contents of individual NF profiles of individual NF instances maintained in the NRF 5454 3GPP TS 23.256; among many others discussed in [TS23501]. In some examples, service authorization information provided by an OAM system is also included in the NF profile in the case that, for example, an NF instance has an exceptional service authorization information.

The PCF 5456 provides policy rules to control plane functions to enforce them, and may also support unified policy framework to govern network behavior. The PCF 5456 may also implement a front end to access subscription information relevant for policy decisions in a UDR 5459 of the UDM 5458. In addition to communicating with functions over reference points as shown, the PCF 5456 exhibit an Npcf service-based interface.

The UDM 5458 handles subscription-related information to support the network entities' handling of communication sessions, and stores subscription data of UE 5402. For example, subscription data may be communicated via an N8 reference point between the UDM 5458 and the AMF 5444. The UDM 5458 may include two parts, an application front end and a UDR. The UDR may store subscription data and policy data for the UDM 5458 and the PCF 5456, and/or structured data for exposure and application data (including PFDs for application detection, application request information for multiple UEs 5402) for the NEF 5452. The Nudr service-based interface may be exhibited by the UDR to allow the UDM 5458, PCF 5456, and NEF 5452 to access a particular set of the stored data, as well as to read, update (e.g., add, modify), delete, and subscribe to notification of relevant data changes in the UDR. The UDM 5458 may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 5458 may exhibit the Nudm service-based interface.

Edge Application Server Discovery Function (EASDF) 5461 exhibits an Neasdf service-based interface, and is connected to the SMF 5446 via an N88 interface. One or multiple EASDF instances may be deployed within a PLMN, and interactions between 5GC NF(s) and the EASDF 5461 take place within a PLMN. The EASDF 5461 includes one or more of the following functionalities: registering to NRF 5454 for EASDF 5461 discovery and selection; handling the DNS messages according to the instruction from the SMF 5446; and/or terminating DNS security, if used. Handling the DNS messages according to the instruction from the SMF 5446 includes one or more of the following functionalities: receiving DNS message handling rules and/or BaselineDNSPattern from the SMF 5446; exchanging DNS messages from/with the UE 5402; forwarding DNS messages to C-DNS or L-DNS for DNS query; adding EDNS client subnet (ECS) option into DNS query for an FQDN; reporting to the SMF 5446 the information related to the received DNS messages; and/or buffering/discarding DNS messages from the UE 5402 or DNS Server. The EASDF has direct user plane connectivity (e.g., without any NAT) with the PSA UPF over N6 for the transmission of DNS signaling exchanged with the UE. The deployment of a NAT between EASDF 5461 and PSA UPF 5448 may or may not be supported. Additional aspects of the EASDF 5461 are discussed in [TS23548].

AF 5460 provides application influence on traffic routing, provide access to NEF 5452, and interact with the policy framework for policy control. The AF 5460 may influence UPF 5448 (re)selection and traffic routing. Based on operator deployment, when AF 5460 is considered to be a trusted entity, the network operator may permit AF 5460 to interact directly with relevant NFs. In some implementations, the AF 5460 is used for edge computing implementations.

The 5GC 5440 may enable edge computing by selecting operator/3rd party services to be geographically close to a point that the UE 5402 is attached to the network. This may reduce latency and load on the network. In edge computing implementations, the 5GC 5440 may select a UPF 5448 close to the UE 5402 and execute traffic steering from the UPF 5448 to DN 5436 via the N6 interface. This may be based on the UE subscription data, UE location, and information provided by the AF 5460, which allows the AF 5460 to influence UPF (re)selection and traffic routing.

The data network (DN) 5436 may represent various network operator services, Internet access, or third party services that may be provided by one or more servers including, for example, application (app)/content server 5438. The DN 5436 may be an operator external public, a private PDN, or an intra-operator packet data network, for example, for provision of IMS services. In this example, the app server 5438 can be coupled to an IMS via an S-CSCF or the I-CSCF. In some implementations, the DN 5436 may represent one or more local area DNs (LADNs), which are DNs 5436 (or DN names (DNNs)) that is/are accessible by a UE 5402 in one or more specific areas. Outside of these specific areas, the UE 5402 is not able to access the LADN/DN 5436.

Additionally or alternatively, the DN 5436 may be an edge DN 5436, which is a (local) DN that supports the architecture for enabling edge applications. In these examples, the app server 5438 may represent the physical hardware systems/devices providing app server functionality and/or the application software resident in the cloud or at an edge compute node that performs server function(s). In some examples, the app/content server 5438 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RANs 5404 or RAN nodes 5414. For example, the edge compute nodes can provide a connection between the RAN 5404 and UPF 5448 in the 5GC 5440. The edge compute nodes can use one or more NFV instances instantiated on virtualization infrastructure within the edge compute nodes to process wireless connections to and from the RAN 5414 and UPF 5448.

In some implementations, the edge compute nodes provide a distributed computing environment for application and service hosting, and also provide storage and processing resources so that data and/or content can be processed in close proximity to subscribers (e.g., users of UEs 5402) for faster response times. The edge compute nodes also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge compute nodes from the UEs 5402, CN 5440, DN 5436, and/or server(s) 5438, or vice versa. For example, a device application or client application operating in a UE 5402 may offload application tasks or workloads to one or more edge compute nodes. In another example, an edge compute node may offload application tasks or workloads to a set of UEs 5402 (e.g., for distributed machine learning computation and/or the like).

The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. The edge servers are physical computer systems that may include an edge platform and/or virtualization infrastructure, and provide compute, storage, and network resources to edge computing applications. Each of the edge servers are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 5402. The VI of the edge compute nodes provide virtualized environments and virtualized resources for the edge hosts, and the edge computing applications may run as VMs and/or application containers on top of the VI.

In one example implementation, the ECT is and/or operates according to the multi-access edge computing (MEC) framework (“[MEC]”) as discussed in, for example, ETSI GS MEC 003 V3.1.1 (2022 March) and/or the like. In another example implementation, the ECT is and/or operates according to the Open RAN alliance (“[O-RAN]”) framework as described in O-RAN Working Group 1 (Use Cases and Overall Architecture): O-RAN Architecture Description, O-RAN ALLIANCE WG1, O-RAN Architecture Description v08.00, Release R003 (March 2023) and the like. In another example implementation, the ECT is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/(“[ISE0]”). In another example implementation, the ECT operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020) (“[MAMS]”). In another example implementation, the ECT is and/or operates according to the 3rd Generation Partnership Project (3GPP) System Aspects Working Group 6 (SA6) Architecture for enabling Edge Applications as discussed in 3GPP TS 23.558 v18.3.0 (2023 Jun. 21) (“[TS23558]”), 3GPP TS 23.501 v18.2.1 (2023 Jun. 29) (“[TS23501]”), 3GPP TS 23.502 v18.2.0 (2023 Jun. 29) (“[TS23502]”), 3GPP TS 23.548 v18.2.0 (2023 Jun. 22) (“[TS23548]”), 3GPP TS 28.538 v18.3.0 (2023 Jun. 22), 3GPP TR 23.700-98 v18.1.0 (2023 Mar. 31), 3GPP TS 23.222 v18.2.0 (2023 Jun. 21), 3GPP TS 33.122 v18.0.0 (2023-06-22), 3GPP TS 29.222 v18.2.0 (2023 Jun. 26), 3GPP TS 29.522 v18.2.0 (2023 Jun. 27), 3GPP TS 29.122 v18.2.0 (2023 Jun. 26), 3GPP TS 23.682 v18.0.0 (2023 Mar. 31), 3GPP TS 23.434 v18.5.0 (2023 Jun. 21), and 3GPP TS 23.401 v18.2.0 (2023 Jun. 21) (collectively referred to as “[3GPPEdge]”), the contents of each of which are hereby incorporated by reference in their entireties and for all purposes. In any of the aforementioned example implementations (and/or in any other example implementation discussed herein), the edge compute nodes may include NFV and/or other like virtualization technologies and/or service orchestration and automation platforms.

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure. Examples of such edge computing/networking technologies include [MEC]; [O-RAN]; [ISEO]; [3GPPEdge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

The interfaces of the 5GC 5440 include reference points and service-based interfaces. The reference points include: N1 (between the UE 5402 and the AMF 5444), N2 (between RAN 5414 and AMF 5444), N3 (between RAN 5414 and UPF 5448), N4 (between the SMF 5446 and UPF 5448), N5 (between PCF 5456 and AF 5460), N6 (between UPF 5448 and DN 5436), N7 (between SMF 5446 and PCF 5456), N8 (between UDM 5458 and AMF 5444), N9 (between two UPFs 5448), N10 (between the UDM 5458 and the SMF 5446), N11 (between the AMF 5444 and the SMF 5446), N12 (between AUSF 5442 and AMF 5444), N13 (between AUSF 5442 and UDM 5458), N14 (between two AMFs 5444; not shown), N15 (between PCF 5456 and AMF 5444 in case of a non-roaming scenario, or between the PCF 5456 in a visited network and AMF 5444 in case of a roaming scenario), N16 (between two SMFs 5446; not shown), and N22 (between AMF 5444 and NSSF 5450). Other reference point representations not shown in FIG. 54 can also be used. The service-based representation of FIG. 54 represents NFs within the control plane that enable other authorized NFs to access their services. The service-based interfaces (SBIs) include: Namf (SBI exhibited by AMF 5444), Nsmf (SBI exhibited by SMF 5446), Nnef (SBI exhibited by NEF 5452), Npcf (SBI exhibited by PCF 5456), Nudm (SBI exhibited by the UDM 5458), Naf (SBI exhibited by AF 5460), Nnrf (SBI exhibited by NRF 5454), Nnssf (SBI exhibited by NSSF 5450), Nausf (SBI exhibited by AUSF 5442). Other service-based interfaces (e.g., Nudr, N5g-eir, and Nudsf) not shown in FIG. 54 can also be used. In some examples, the NEF 5452 can provide an interface to edge compute nodes, which can be used to process wireless connections with the RAN 5414.

Although not shown by FIG. 54, the system 5400 may also include NFs that are not shown such as, for example, UDR, Unstructured Data Storage Function (UDSF), Network Slice Admission Control Function (NSACF), Network Slice-specific and Stand-alone Non-Public Network (SNPN) Authentication and Authorization Function (NSSAAF), UE radio Capability Management Function (UCMF), 5G-Equipment Identity Register (5G-EIR), CHarging Function (CHF), Time Sensitive Networking (TSN) AF 5460, Time Sensitive Communication and Time Synchronization Function (TSCTSF), DCCF, Analytics Data Repository Function (ADRF), Messaging Framework Adaptor Function (MFAF), Binding Support Function (BSF), Non-Seamless WLAN Offload Function (NSWOF), Service Communication Proxy (SCP), Security Edge Protection Proxy (SEPP), Non-3GPP InterWorking Function (N3IWF), Trusted Non-3GPP Gateway Function (TNGF), Wireline Access Gateway Function (W-AGF), and/or Trusted WLAN Interworking Function (TWIF) as discussed in [TS23501].

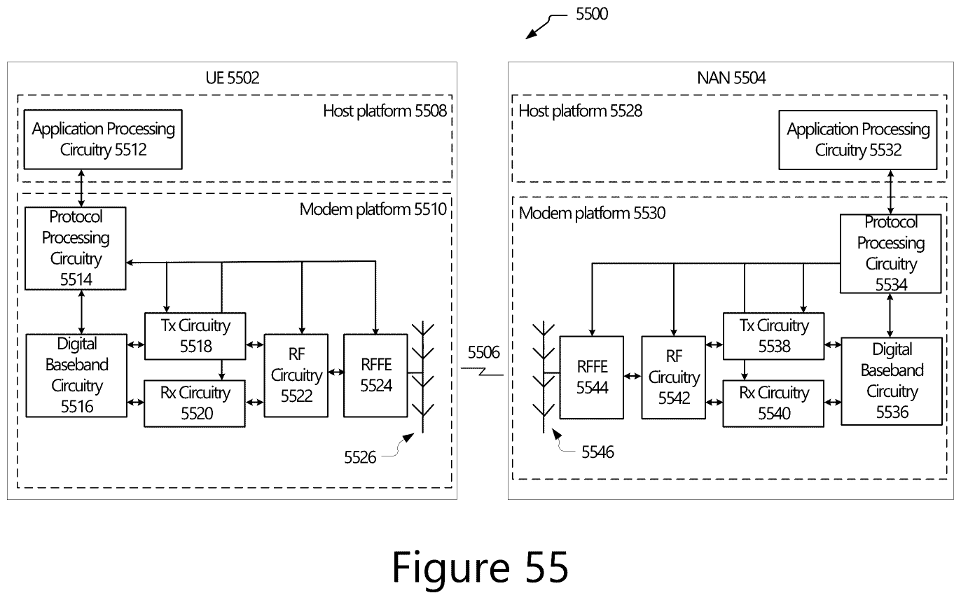

FIG. 55 illustrates a wireless network 5500, which includes a UE 5502 in wireless communication with a NAN 5504. The UE 5502 may be the same or similar to, and substantially interchangeable with any of the of the UEs discussed herein such as, for example, UE 5402, hardware resources 5600, and/or any other UE discussed herein. The NAN 5504 may be the same or similar to, and substantially interchangeable with any of the of the ANs (network access nodes (NANs)) discussed herein such as, for example, AP 5406, NANs 5414, RAN 5404, hardware resources 5600, and/or any other AN/NAN discussed herein.

The UE 5502 may be communicatively coupled with the NAN 5504 via connection 5506. The connection 5506 is illustrated as an air interface to enable communicative coupling, and can be consistent with cellular communications protocols such as an LTE protocol or a 5G NR protocol operating at mmWave or sub-6 GHz frequencies.

The UE 5502 includes a host platform 5508 coupled with a modem platform 5510. The host platform 5508 includes application processing circuitry 5512, which may be coupled with protocol processing circuitry 5514 of the modem platform 5510. The application processing circuitry 5512 may run various applications for the UE 5502 that source/sink application data. The application processing circuitry 5512 may further implement one or more layer operations to transmit/receive application data to/from a data network. These layer operations includes transport (for example UDP) and Internet (e.g., IP) operations

The protocol processing circuitry 5514 may implement one or more of layer operations to facilitate transmission or reception of data over the connection 5506. The layer operations implemented by the protocol processing circuitry 5514 includes, for example, MAC, RLC, PDCP, RRC and NAS operations.

The modem platform 5510 may further include digital baseband circuitry 5516 that may implement one or more layer operations that are “below” layer operations performed by the protocol processing circuitry 5514 in a network protocol stack. These operations includes, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and other related functions.

The modem platform 5510 may further include transmit circuitry 5518, receive circuitry 5520, RF circuitry 5522, and RF front end (RFFE) 5524, which includes or connect to one or more antenna panels 5526. Briefly, the transmit circuitry 5518 includes a digital-to-analog converter, mixer, intermediate frequency (IF) components, and/or the like; the receive circuitry 5520 includes an analog-to-digital converter, mixer, IF components, and/or the like; the RF circuitry 5522 includes a low-noise amplifier, a power amplifier, power tracking components, and/or the like; RFFE 5524 includes filters (e.g., surface/bulk acoustic wave filters), switches, antenna tuners, beamforming components (e.g., phase-array antenna components), etc. The selection and arrangement of the components of the transmit circuitry 5518, receive circuitry 5520, RF circuitry 5522, RFFE 5524, and antenna panels 5526 (referred generically as “transmit/receive components” or “Tx/Rx components”) may be specific to details of a specific implementation such as, for example, whether communication is TDM or FDM, in mmWave or sub-6 gHz frequencies, etc. In some examples, the transmit/receive components may be arranged in multiple parallel transmit/receive chains, may be disposed in the same or different chips/modules, etc.

In some examples, the protocol processing circuitry 5514 includes one or more instances of control circuitry (not shown) to provide control functions for the transmit/receive components.

A UE reception may be established by and via the antenna panels 5526, RFFE 5524, RF circuitry 5522, receive circuitry 5520, digital baseband circuitry 5516, and protocol processing circuitry 5514. In some examples, the antenna panels 5526 may receive a transmission from the NAN 5504 by receive-beamforming signals received by a set of antennas/antenna elements of the one or more antenna panels 5526.

A UE transmission may be established by and via the protocol processing circuitry 5514, digital baseband circuitry 5516, transmit circuitry 5518, RF circuitry 5522, RFFE 5524, and antenna panels 5526. In some examples, the transmit components of the UE 5504 may apply a spatial filter to the data to be transmitted to form a transmit beam emitted by the antenna elements of the antenna panels 5526.

Similar to the UE 5502, the NAN 5504 includes a host platform 5528 coupled with a modem platform 5530. The host platform 5528 includes application processing circuitry 5532 coupled with protocol processing circuitry 5534 of the modem platform 5530. The modem platform may further include digital baseband circuitry 5536, transmit circuitry 5538, receive circuitry 5540, RF circuitry 5542, RFFE circuitry 5544, and antenna panels 5546. The components of the NAN 5504 may be similar to and substantially interchangeable with like-named components of the UE 5502. In addition to performing data transmission/reception as described above, the components of the NAN 5508 may perform various logical functions that include, for example, RNC functions such as radio bearer management, UL and DL dynamic radio resource management, and data packet scheduling.

Examples of the antenna elements of the antenna panels 5526 and/or the antenna elements of the antenna panels 5546 include planar inverted-F antennas (PIFAs), monopole antennas, dipole antennas, loop antennas, patch antennas, Yagi antennas, parabolic dish antennas, omni-directional antennas, and/or the like.

FIG. 56 illustrates components capable of reading instructions from a machine-readable or computer-readable medium (e.g., a non-transitory machine-readable storage medium) and perform any one or more of the methodologies discussed herein. Specifically, FIG. 56 shows a diagrammatic representation of hardware resources 5600 including one or more processors (or processor cores) 5610, one or more memory/storage devices 5620, and one or more communication resources 5630, each of which may be communicatively coupled via a bus 5640 or other interface circuitry. For examples where node virtualization (e.g., NFV) is utilized, a hypervisor 5602 may be executed to provide an execution environment for one or more network slices/sub-slices to utilize the hardware resources 5600.

The processors 5610 may include, for example, a processor 5612 and a processor 5614. The processors 5610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 5620 may include main memory, disk storage, or any suitable combination thereof. The memory/storage devices 5620 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 5630 may include interconnection or network interface controllers, components, or other suitable devices to communicate with one or more peripheral devices 5604 or one or more databases 5606 or other network elements via a network 5608. For example, the communication resources 5630 may include wired communication components (e.g., for coupling via USB, Ethernet, etc.), cellular communication components, NFC components, Bluetooth® (or Bluetooth® Low Energy) components, Wi-Fi® components, and other communication components.

Instructions 5650 may comprise software, a program, an application, an applet, an app, or other executable code for causing at least any of the processors 5610 to perform any one or more of the methodologies discussed herein. The instructions 5650 may reside, completely or partially, within at least one of the processors 5610 (e.g., within the processor's cache memory), the memory/storage devices 5620, or any suitable combination thereof. Furthermore, any portion of the instructions 5650 may be transferred to the hardware resources 5600 from any combination of the peripheral devices 5604 or the databases 5606. Accordingly, the memory of processors 5610, the memory/storage devices 5620, the peripheral devices 5604, and the databases 5606 are examples of computer-readable and machine-readable media.

FIG. 57 shows example network deployments including an example next generation fronthaul (NGF) deployment 5700a where a user equipment (UE) 5702 is connected to an RU 5730 (also referred to as a “remote radio unit 5730”, “a remote radio head 5730”, or “RRH 5730”) via an air interface, the RU 5730 is connected to a Digital Unit (DU) 5731 via a NGF interface (NGFI)-I, the DU 5731 is connected to a Central Unit (CU) 5732 via an NGFI-II, and the CU 5732 is connected to a core network (CN) 5742 via a backhaul interface. In 3GPP NG-RAN implementations (see e.g., [TS38401]), the DU 5731 may be a distributed unit (for purposes of the present disclosure, the term “DU” may refer to a digital unit and/or a distributed unit unless the context dictates otherwise). The UEs 5702 may be the same or similar to, and/or share one or more features with UE 5402, UE 5502, hardware resources 5600, and/or any other UE described herein.

In some implementations, the NGF deployment 5700a may be arranged in a distributed RAN (D-RAN) architecture where the CU 5732, DU 5731, and RU 5730 reside at a cell site and the CN 5742 is located at a centralized site. Alternatively, the NGF deployment 5700a may be arranged in a centralized RAN (C-RAN) architecture with centralized processing of one or more baseband units (BBUs) at the centralized site. In C-RAN architectures, the radio components are split into discrete components, which can be located in different locations. In one example C-RAN implementation, only the RU 5730 is disposed at the cell site, and the DU 5731, the CU 5732, and the CN 5742 are centralized or disposed at a central location. In another example C-RAN implementation, the RU 5730 and the DU 5731 are located at the cell site, and the CU 5732 and the CN 5742 are at the centralized site. In another example C-RAN implementation, only the RU 5730 is disposed at the cell site, the DU 5731 and the CU 5732 are located a RAN hub site, and the CN 5742 is at the centralized site.

The CU 5732 is a central controller that can serve or otherwise connect to one or multiple DUs 5731 and/or multiple RUs 5730. The CU 5732 is network (logical) nodes hosting higher/upper layers of a network protocol functional split. For example, in the 3GPP NG-RAN and/or O-RAN architectures, a CU 5732 hosts the radio resource control (RRC), Service Data Adaptation Protocol (SDAP), and/or Packet Data Convergence Protocol (PDCP) layers of a next generation NodeB (gNB), or hosts the RRC and PDCP protocol layers when included in or operating as an E-UTRA-NR gNB (en-gNB). The SDAP sublayer performs mapping between QoS flows and a data radio bearers (DRBs) and marking QoS flow IDs (QFI) in both DL and UL packets. The PDCP sublayer performs transfers user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery. In various implementations, a CU 5732 terminates respective F1 interfaces connected with corresponding DUs 5731 (see e.g., [TS38401]).

A CU 5732 may include a CU-control plane (CP) entity (referred to herein as “CU-CP 5732c”) and a CU-user plane (UP) entity (referred to herein as “CU-UP 5732u”). The CU-CP 5732c is a logical node hosting the RRC layer and the control plane part of the PDCP protocol layer of the CU 5732 (e.g., a gNB-CU for an en-gNB or a gNB). The CU-CP terminates an El interface connected with the CU-UP 5732u and the F1-C interface connected with a DU 5731. The CU-UP 5732u is a logical node hosting the user plane part of the PDCP protocol layer (e.g., for a gNB-CU 5732 of an en-gNB), and the user plane part of the PDCP protocol layer and the SDAP protocol layer (e.g., for the gNB-CU 5732 of a gNB). The CU-UP 5732u terminates the E1 interface connected with the CU-CP 5732c and the F1-U interface connected with a DU 5731.

The DU 5731 controls radio resources, such as time and frequency bands, locally in real time, and allocates resources to one or more UEs. The DUs 5731 are network (logical) nodes hosting middle and/or lower layers of the network protocol functional split. For example, in the 3GPP NG-RAN and/or O-RAN architectures, a DU 5731 hosts the radio link control (RLC), medium access control (MAC), and high-physical (PHY) layers of the gNB or en-gNB, and its operation is at least partly controlled by the CU 5732. The RLC sublayer operates in one or more of a Transparent Mode (TM), Unacknowledged Mode (UM), and Acknowledged Mode (AM). The RLC sublayer performs transfer of upper layer PDUs; sequence numbering independent of the one in PDCP (UM and AM); error Correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; and/or protocol error detection (AM only). The MAC sublayer performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding. In some implementations, a DU 5731 can host a Backhaul Adaptation Protocol (BAP) layer (see e.g., 3GPP TS 38.340 v16.5.0 (2021 Jul. 7)) and/or a F1 application protocol (F1AP) (see e.g., 3GPP TS 38.470 v16.5.0 (2021 Jul. 1)), such as when the DU 5731 is operating as an Integrated Access and Backhaul (IAB) node. One DU 5731 supports one or multiple cells, and one cell is supported by only one DU 5731. A DU 5731 terminates the F1 interface connected with a CU 5732. Additionally or alternatively, the DU 5731 may be connected to one or more RRHs/RUs 5730.

The RU 5730 is a transmission/reception point (TRP) or other physical node that handles radiofrequency (RF) processing functions. The RU 5730 is a network (logical) node hosting lower layers based on a lower layer functional split. For example, in 3GPP NG-RAN and/or O-RAN architectures, the RU 5730 hosts low-PHY layer functions and RF processing of the radio interface based on a lower layer functional split. The RU 5730 may be similar to 3GPP's transmission/reception point (TRP) or RRH, but specifically includes the Low-PHY layer. Examples of the low-PHY functions include fast Fourier transform (FFT), inverse FFT (iFFT), physical random access channel (PRACH) extraction, and the like

Each of the CUs 5732, DUs 5731, and RUs 5730 are connected through respective links, which may be any suitable wireless and/or wired (e.g., fiber, copper, and the like) links. In some implementations, various combinations of the CU 5732, DU 5731, and RU 5730 may correspond to one or more of the RAN 5404, AN 5408, AP 5406, and/or any other NAN, such as any of those discussed herein. Additional aspects of CUs 5732, DUs 5731, and RUs 5730 are discussed in [O-RAN], [TS38401], [TS38410], and [TS38300], the contents of each of which are hereby incorporated by reference in their entireties.

In some implementations, a fronthaul gateway function (FHGW) may be disposed between the DU 5731 and the RU/RRU 5730 (not shown by FIG. 57), where the interface between the DU 5731 and the FHGW is an Open Fronthaul (e.g., Option 7-2×) interface, the interface between FHGW function and the RU/RRU 5730 is an Open Fronthaul (e.g., Option 7-2×) interface or any other suitable interface (e.g., option 7, option 8, or the like) including those that do not support Open Fronthaul (e.g., Option 7-2×). The FHGW may be packaged with one or more other functions (e.g., Ethernet switching and/or the like) in a physical device or appliance. In some implementations, a RAN controller may be communicatively coupled with the CU 5732 and/or the DU 5731.

The NGFI (also referred to as “xHaul” or the like) is a two-level fronthaul architecture that separates the traditional RRU 5730 to BBU connectivity in the C-RAN architecture into two levels, namely levels I and II. Level I connects the RU 5730 via the NGFI-I to the DU 5731, and level II connects the DU 5731 via the NGFI-II to the CU 5732 as shown by deployment 5700a in FIG. 57. The NGFI-I and NGFI-II connections may be wired connections or wireless connections, which may utilize any suitable RAT such as any of those discussed herein. The purpose of the two-level architecture is to distribute (split) the RAN node protocol functions between CU 5732 and DU 5731 such that latencies are relaxed, giving more deployment flexibilities. In general, the NGFI-I interfaces with the lower layers of the function split which have stringent delay and data rate requirements, whereas NGFI-II interfaces with higher layers of the function split relative to the layers of the NGFI-I, relaxing the requirements for the fronthaul link. Examples of the NGFI fronthaul interfaces and functional split architectures include O-RAN 7.2× fronthaul (see e.g., O-RAN Open Transport Working Group 9 Xhaul Packet Switched Architectures and Solutions, v03.00, Release R003 (March 2023) (“[ORAN.XPSAAS]”) and O-RAN Working Group 4 (Open Fronthaul Interfaces WG) Control, User and Synchronization Plane Specification, v11.00, Release R003 (March 2023) (“[ORAN.CUS]”)), Enhanced Common Radio Interface (CPRI) based C-RAN fronthaul (see e.g., Common Public Radio Interface: eCPRI Interface Specification, eCPRI Specification v2.0 (2019 May 10), Common Public Radio Interface: Requirements for the eCPRI Transport Network, eCPRI Transport Network v1.2 (2018 Jun. 25), and [ORAN.CUS]), Radio over Ethernet (RoE) based C-RAN fronthaul (see e.g., IEEE Standard for Radio over Ethernet Encapsulations and Mappings, IEEE Standards Association, IEEE 1914.3-2018 (5 Oct. 2018) (“[IEEE1914.3]”)), and/or the like. Additional aspects of NGFI are also discussed in [ORAN.XPSAAS], [ORAN.CUS], IEEE Standard for Packet-based Fronthaul Transport Networks, IEEE Standards Association, IEEE 1914.1-2019 (21 Apr. 2020), [IEEE1914.3], and Nasrallah et al., Ultra-Low Latency (ULL) Networks: A Comprehensive Survey Covering the IEEE TSN Standard and Related ULL Research, arXiv:1803.07673v1 [cs.NI] (20 Mar. 2018), the contents of each of which are hereby incorporated by reference in their entireties.

In one example, the deployment 5700a may implement a low level split (LLS) (also referred to as a “Lower Layer Functional Split 7-2×” or “Split Option 7-2x”) that runs between the RU 5730 (e.g., an O-RU in O-RAN architectures) and the DU 5731 (e.g., an O-DU in O-RAN architectures) (see e.g., O-RAN WG7 Hardware Reference Design Specification for Indoor Picocell (FR1) with Split Architecture Option 7-2 v03.00, 0-RAN ALLIANCE WG7 (October 2021) (“[IPC-Opt7-2]”), O-RAN White Box Hardware Working Group Hardware Reference Design Specification for Outdoor Macrocell with Split Architecture Option 7.2, v02.00, Release R003 (March 2023) (“[OMAC-HRD]”), and/or the like). In this example implementation, the NGFI-I is the Open Fronthaul interface described in the O-RAN Open Fronthaul Specification (see e.g., [ORAN.CUS]). Other LLS options may be used such as the relevant interfaces described in other standards or specifications such as, for example, the 3GPP NG-RAN functional split (see e.g., [TS38401] and 3GPP TR 38.801 v14.0.0 (2017 Apr. 3)), the Small Cell Forum for Split Option 6 (see e.g., 5G small cell architecture and product definitions: Configurations and Specifications for companies deploying small cells 2020-2025, Small Cell Forum, document 238.10.01 (5 Jul. 2020), 5G NR FR1 Reference Design: The case for a common, modular architecture for 5G NR FR1 small cell distributed radio units, Small Cell Forum, document 251.10.01 (15 Dec. 2021), and O-RAN White Box Hardware Working Group Hardware Reference Design Specification for Indoor Pico Cell with Fronthaul Split Option 6 v02.00, 0-RAN ALLIANCE WG7 (October 2021) (“[IPC-Opt6]”), the contents of each of which are hereby incorporated by reference in their entireties), and/or in O-RAN white-box hardware Split Option 8 (e.g., O-RAN WG7 Hardware Reference Design Specification for Indoor Picocell (FR1) with Split Architecture Option 8 v03.00 (October 2021) (“[IPC-Opt8]”)).

Additionally or alternatively, the CUs 5732, DUs 5731, and/or RUs 5730 may be JAB nodes. JAB enables wireless relaying in an NG-RAN where a relaying node (referred to as an “JAB-node”) supports access and backhauling via 3GPP 5G/new radio (NR) links/interfaces. The terminating node of NR backhauling on the network side is referred to as an “JAB-donor”, which represents a RAN node (e.g., a gNB) with additional functionality to support JAB. Backhauling can occur via a single or via multiple hops. All IAB-nodes that are connected to an JAB-donor via one or multiple hops form a directed acyclic graph (DAG) topology with the JAB-donor as its root. The JAB-donor performs centralized resource, topology and route management for the JAB topology. The JAB architecture is shown and described in [TS38300].

Although the NGF deployment 5700a shows the CU 5732, DU 5731, RRH 5730, and CN 5742 as separate entities, in other implementations some or all of these network nodes can be bundled, combined, or otherwise integrated with one another into a single device or element, including collapsing some internal interfaces (e.g., F1-C, F1-U, E1, E2, and the like). At least the following implementations are possible: (i) integrating the CU 5732 and the DU 5731 (e.g., a CU-DU), which is connected to the RRH 5730 via the NGFI-I; (ii) integrating the DU 5731 and the RRH 5730 integrated (e.g., CU-DU), which is connected to the CU 5732 via NGFI-II; (iii) integrating a RAN controller and the CU 5732, which is connected to the DU 5731 via NGFI-II; (iv) integrating the CU 5732, the DU 5731, and the RU 5730, which is connected to the CN 5742 via backhaul interface; and (v) integrating the network controller (or intelligent controller), the CU 5732, the DU 5731, and the RU 5730. Any of the aforementioned example implementations involving the CU 5732 may also include integrating the CU-CP 5732c and CP-UP 5732u.

In any of the implementations discussed herein, the lower layers of the RAN protocol stack can be characterized by real-time (RT) functions and relatively complex signal processing algorithms, and the higher layers of the RAN protocol stack can be characterized by non-RT functions. In these implementations, the RT functions and signal processing algorithms can be implemented in DUs 5731 and/or RRHs 5730 either using purpose-built network elements or in COTS hardware augmented with purpose-built HW accelerators.

FIG. 57 also shows various functional split options 5700b, for both DL and UL directions. The traditional RAN is an integrated network architecture based on a distributed RAN (D-RAN) model, where D-RAN integrates all RAN functions (RANFs) into a few network elements. As alluded to previously, the disaggregated RAN architecture provides flexible function split options to overcome various drawbacks of the D-RAN model. The disaggregated RAN breaks up the integrated network system into several function components that can then be individually re-located as needed without hindering their ability to work together to provide a holistic network services. The split options 5700b are mostly split between the CU 5732 and the DU 5731, but can include a split between the CU 5732, DU 5731, and RU 5730. For each option 5700b, protocol entities on the left side of the figure are included in the RANF implementing the CU 5732 and the protocol entities on the right side of the figure are included in the RANF implementing the DU 5731. For example, the Option 2 function split includes splitting non-RT processing (e.g., RRC and PDCP layers) from RT processing (e.g., RLC, MAC, and PHY layers), where the RANF implementing the CU 5732 performs network functions of the RRC and PDCP layers, and the RANF implementing the DU 5731 performs the baseband processing functions of the RLC (including high-RLC and low-RLC), MAC (including high-MAC and low-MAC), and PHY layers. In some implementations, the PHY layer is further split between the DU 5731 and the RU 5730, where the RANF implementing the DU 5731 performs the high-PHY layer functions and the RU 5730 handles the low-PHY layer functions. In some implementations, the Low-PHY entity may be operated by the RU 5730 regardless of the selected functional split option. Under the Option 2 split, the RANF implementing the CU 5732 can connect to multiple DU 5731 (e.g., the CU 5732 is centralized), which allows RRC and PDCP anchor change to be eliminated during a handover across DUs 5731 and allows the centralized CU 5732 to pool resources across several DUs 5731. In these ways, the option 2 function split can improve resource efficiencies. The particular function split option used may vary depending on the service requirements and network deployment scenarios, and may be implementation specific. It should also be noted that in some implementations, all of the function split options can be selected where each protocol stack entity is operated by a respective RANF (e.g., a first RANF operates the RRC layer, a second RANF operates the PDCP layer, a third RANF operates the high-RLC layer, and so forth until an eighth RANF operates the low-PHY layer). Other split options are possible such as those discussed in [IPC-Opt6], [IPC-Opt7-2], [IPC-Opt8], [OMAC-HRD], and O-RAN White Box Hardware Working Group Hardware Reference Design Specification for Outdoor Micro Cell with Split Architecture Option 7.2 v03.00, 0-RAN ALLIANCE WG7 (October 2022).

9.1. Multi-Radio Dual Connectivity (MR-DC) Aspects

NG-RAN supports multi-radio DC (MR-DC) operation where a UE 5402 in RRC_CONNECTED is configured to utilize radio resources provided by two distinct schedulers, located in at least two different NG-RAN nodes 5414 connected via a non-ideal backhaul, one NG-RAN node 5414 providing NR access and the other NG-RAN node 5414 providing either E-UTRA or NR access. One node acts as a master node (MN) and the other as a secondary node (SN), and the MN and SN are connected via a network interface and at least the MN is connected to the core network (e.g., CN 5440). In some implementations, the MN and/or the SN can be operated with shared spectrum channel access.

E-UTRAN supports MR-DC via E-UTRA-NR DC (EN-DC), in which a UE 5402 is connected to one eNB that acts as an MN and one en-gNB that acts as a SN, or vice versa. The eNB is connected to a EUTRAN core network (EPC) via an S1 interface and to an en-gNB via an X2 interface. The en-gNB might also be connected to the EPC via an S1-U interface and other en-gNB s via the X2-U interface.

The NG-RAN 5404 supports NG-RAN E-UTRA-NR Dual Connectivity (NGEN-DC), in which a UE 5402 is connected to one ng-eNB 5414b that acts as an MN and one gNB 5414a that acts as an SN. The NG-RAN 5404 supports NR-E-UTRA Dual Connectivity (NE-DC), in which a UE is connected to one gNB that acts as a MN and one ng-eNB that acts as a SN. The NG-RAN 5404 supports NR-NR Dual Connectivity (NR-DC), in which a UE is connected to one gNB that acts as a MN and another gNB that acts as a SN. In addition, NR-DC can also be used when a UE is connected to a single gNB, acting both as a MN and as a SN, and configuring both MCG and SCG.

Further details of MR-DC operation, including conditional PSCell addition (CPA) and conditional PSCell change (CPC), can be found in [TS36300], [TS38300], and 3GPP TS 37.340 v17.5.0 (2023 Jun. 30) (“[TS37340]”), the contents of each of which are hereby incorporated by reference in their entireties and for all purposes.

### 10. EXAMPLE IMPLEMENTATIONS

Additional examples of the presently described methods, devices, systems, and networks discussed herein include the following, non-limiting example implementations. Each of the following non-limiting examples may stand on its own or may be combined in any permutation or combination with any one or more of the other examples provided below or throughout the present disclosure. For one or more embodiments, at least one of the components set forth in one or more of FIGS. 1-57 may be configured to perform one or more operations, techniques, processes, and/or methods as set forth in the example section below. For example, processor circuitry as described above in connection with one or more of the preceding figures may be configured to operate in accordance with one or more of the examples set forth below. For another example, circuitry associated with a UE, base station, network element, and/or other element/entity as described herein may be configured to operate in accordance with one or more of the following examples.
Example A01 includes a method for layer 1 (L1) and/or layer 2 (L2) based inter-cell mobility.
Example A02.0 include the method of example A01 and/or some other example(s) herein, wherein candidate target primary cells (PCells) are pre-configured, and a handover (HO) is triggered by L1/L2 signaling from network or based on L1/L2 measurement results at UE side.
Example A02.1 include the method of example A01 and/or some other example(s) herein, wherein candidate target PCells are pre-configured, and a HO is triggered by L1 and/or L2 signaling from network or based on L1 measurement results performed or collected by a UE.
Example A02.2 include the method of example A01 and/or some other example(s) herein, wherein candidate target PCells are pre-configured, and a HO is triggered by L1 and/or L2 signaling from network or based on L2 measurement results performed or collected by a UE.
Example A03 includes the method of examples A02.0-A02.2 and/or some other example(s) herein, wherein the UE reports L2 measurement results or trigger a handover towards a candidate cell when at least one of following conditions is met: the number of good beams is better than a threshold X in consecutive N times, or for N times within a period of time; a candidate cell's good beams are offset more than that of current serving cell in consecutive N times, or for N times within a period of time; and/or whether a candidate cell's quality is offset better than that of current serving cell cell in consecutive N times, or for N times within a period of time.
Example A04 includes the method of example A03 and/or some other example(s) herein, wherein the beams whose beam quality is better than this threshold Z1 is considered as a good/qualified beam.
Example A05 includes the method of examples A01-A04 and/or some other example(s) herein, wherein a UE sends a MAC CE to indicate the handover is complete.
Example A06 includes the method of example A05 and/or some other example(s) herein, wherein configured by network or specified as UE behavior, the UE maintains at least one of the following items during MAC reset: logical channel related UE variables; HARQ NDI state and buffer; and/or a triggered BSR procedure.
Example A07 includes a method of a user equipment (UE) comprising: determining, for a candidate cell, a number of beams meeting or exceeding a predetermined threshold for a predetermined consecutive number of times, a predetermined non-consecutive number of times, and/or a predetermined number of times within a time period; and encoding a measurement reporting message for transmission to a radio access network (RAN) node that includes information associated with the determined number of beams.
Example A08 includes the method of example A07 and/or some other example(s) herein, wherein the predetermined threshold and predetermined consecutive number of times are configured to the UE by a network.
Example A09 includes the method of examples A07-A08 and/and/or some other example(s) herein, wherein the predetermined number of times and the time period are configured to the UE by a network.
Example A10 includes the method of example A07-A09 and/or some other example(s) herein, wherein the beams meeting or exceeding a predetermined threshold for the candidate cell are offset more than that of current serving cell in the predetermined consecutive number of times, a predetermined non-consecutive number of times, and/or a predetermined number of times within a time period.
Example A11 includes the method of example A07-A10 and/or some other example(s) herein, wherein the method includes: determining a number of times that a candidate cell's quality is offset better than a current serving cell.
Example A12 includes the method of example All and/or some other example(s) herein, wherein the method includes: encoding a medium access control (MAC) control element (CE) message for transmission to the RAN node that includes a cell identifier of the candidate cell or a cell index of the candidate cell.
Example A13 includes the method of example A07-A12 and/or some other example(s) herein, wherein the method includes: performing a handover procedure between a current serving cell to a candidate cell based on the determined number of beams.
Example A14 includes the method of example A13 and/or some other example(s) herein, wherein the current serving cell and candidate shell share a common centralized unit (CU).
Example A15 includes the method of example A13-A14 and/or some other example(s) herein, wherein the current serving cell and candidate cell share a common CU and distributed unit (DU).
Example A16 includes the method of example A13-A15 and/or some other example(s) herein, wherein the handover procedure is triggered in response to L1/L2 signaling from a network.
Example A17 includes the method of example A13-A16 and/or some other example(s) herein, wherein the handover procedure is triggered in response to L1/L2/L3 measurement results by the UE.
Example A18 includes the method of examples A07-A17 and/or some other example(s) herein, wherein the RAN node is a next-generation NodeB (gNB), a next-generation eNodeB (ng-eNB), a CU, a DU, an RU, and/or some other network element, such as any of those discussed herein.
Example A19 includes the method of examples A01-A18 and/or some other example(s) herein, wherein the method includes: performing the method of any one of examples B01-B18, C01-C14, D01-D25, E01-E15, F01-F30, G01-G15, and/or H01-H27.
Example B01 includes a method of secondary cell group (SCG) selective activation, the method comprising: performing an SCG activation/deactivation procedure.
Example B02 includes the method of example B01 and/or some other example(s) herein, wherein the method includes: when a user equipment (UE) is configured by a network (or RAN node) with one or more SCGs with or without a PCell change, performing measurement(s) and following SCG activation or deactivation when one or more conditions is/are met.
Example B03.1 includes the method of examples B01-B02 and/or some other example(s) herein, wherein the method includes: activating or deactivating an SCG based on a configured condition.
Example B03.2 includes the method of example B03.1 and/or some other example(s) herein, wherein the condition is based on radio link quality, an event, and/or CHO.
Example B04 includes the method of examples B01-B03.2 and/or some other example(s) herein, wherein an SCG configuration contains an activate/deactivate state or a configured only state.
Example B05 includes the method of examples B01-B04 and/or some other example(s) herein, wherein, for inter-CU SCG change, PDCP establishment is needed, different SK counter is provided in pre-configuration of target SCG to derive new key.
Example B06.1 includes the method of examples B01-B05 and/or some other example(s) herein, wherein the method includes: indicating a new SK counter
Example B06.2 includes the method of examples B01-B06.1 and/or some other example(s) herein, wherein the method includes: indicating support for intra-CU case and/or inter-CU case via RRC
Example B06.3 includes the method of examples B01-B06.2 and/or some other example(s) herein, wherein the method includes: indicating support for only intra-CU case.
Example B06.4 includes the method of examples B01-B06.3 and/or some other example(s) herein, wherein the method includes: receiving an indication of a new SK counter.
Example B06.5 includes the method of examples B01-B06.4 and/or some other example(s) herein, wherein the method includes: receiving an indication of support for intra-CU and/or inter-CU case.
Example B06.6 includes the method of examples B01-B06.4 and/or some other example(s) herein, wherein the method includes: receiving an indication of support for only intra-CU case.
Example B06.7 includes the method of examples B01-B06.6 and/or some other example(s) herein, wherein the indications are communicated via RRC signaling.
Example B07 includes the method of examples B01-B06.6 and/or some other example(s) herein, wherein the method includes: indicating support of SCG state, a number of activated/deactivated/pre-configured SCG in UE capability.
Example B08 includes the method of examples B01-B07 and/or some other example(s) herein, wherein the method includes: indicating a number of activated/deactivated/pre-configured SCG per band combination.
Example B09.1 includes the method of examples B01-B08 and/or some other example(s) herein, wherein the method includes: when the UE reaches a maximum number of activated/deactivated SCGs and a new (pre-)configured SCG is triggered to be activated, releasing a low priority SCG.
Example B09.2 includes the method of examples B01-B08 and/or some other example(s) herein, wherein the method includes: when the UE reaches maximum number of activated/deactivated SCG and a new pre-configured SCG is triggered to be activated, releasing an SCG according to a network indication or configuration.
Example B09.3 includes the method of examples B01-B08 and/or some other example(s) herein, wherein the method includes: when the UE reaches maximum number of activated/deactivated SCG and a new pre-configured SCG is triggered to be activated, releasing a UE-selected SCG, wherein the UE-selected SGC is selected based on UE implementation.
Example B10 includes the method of examples B01-B09.3 and/or some other example(s) herein, wherein the method includes: activating an SCG from a pre-configured cell based on UE preference and/or priority configured by network.
Example B11 includes the method of examples B01-B10 and/or some other example(s) herein, wherein the method includes: performing an SCG change with handover may contain a list of SCell per PCell in a configuration.
Example B12.0 includes the method of examples B01-B11 and/or some other example(s) herein, wherein an SCG configuration is based on MN and/or other cell indicated in the configuration or UE preference.
Example B12.1 includes the method of examples B12.0 and/or some other example(s) herein, wherein the SCG configuration is a complete SCG configuration generated from application of a delta (difference) SCG configuration received from the MN applied to a reference SGC configuration.
Example B12.2 includes the method of examples B12.0-B12.1 and/or some other example(s) herein, wherein the reference SGC configuration is managed separately from the delta (difference) SCG configuration.
Example B13 includes the method of examples B01-B12.2 and/or some other example(s) herein, wherein support of subsequent SCG change after conditional PSCell addition (CPA) and/or conditional PSCell change (CPC), network indicates conExecutionCondSubsequentCPC in the configuration of the SCG or subsequentCPC in the configuration add mod list.
Example B14.0 includes the method of examples B01-B13 and/or some other example(s) herein, wherein when network configured subsequent SCG change after CPA/CPC, the method includes: performing the CPA execution and candidate SCGs can be considered for subsequent CPC when all conditions met.
Example B14.1 includes the method of example B14.0 and/or some other example(s) herein, wherein a CPA/CPC conditional configuration is used for CPA/CPC but with different triggering conditions.
Example B15 includes the method of examples B01-B14.1, wherein the method includes: receiving a configuration of a secondary cell group (SCG); determining one or more activation conditions to trigger activation of a secondary cell of the secondary cell group; and activating the secondary cell based on the determination, wherein the secondary cell is activated without changing a primary cell.
Example B16 includes the method of example B15 and/or some other example(s) herein, wherein the activation of the secondary cell transitions the UE from single connectivity to dual connectivity.
Example B17 includes the method of examples B15-B16 and/or some other example(s) herein, wherein the configuration of the SCG include: a CellGroupConfig; an indication of a cell, a state of which the configuration is based; an indication of the one or more activation conditions; an indication of one or more deactivation conditions; and/or a SCG or SCell state.
Example B18 includes the method of examples B01-B17 and/or some other example(s) herein, wherein selective activation/deactivation of SCGs corresponds to support of a subsequent CPAC after a cell group change (normal or conditional).
Example B19 includes the method of examples B01-B18 and/or some other example(s) herein, wherein the SCG activation/deactivation is based on a delta (difference) configuration applied to a reference configuration.
Example B20 includes the method of example B19 and/or some other example(s) herein, wherein the method includes: storing the reference configuration as a separate configuration than the delta (difference) configuration.
Example B21 includes the method of examples B19-B20 and/or some other example(s) herein, wherein the method includes: managing the reference configuration separately from management of the delta (difference) configuration.
Example B22 includes the method of examples B01-B21 and/or some other example(s) herein, wherein performing an SCG activation/deactivation procedure includes: when an execution condition of a CPAC candidate cell is met, performing execution of CPAC towards the CPAC candidate cell.
Example B23 includes the method of example B22 and/or some other example(s) herein, wherein the method includes: after completion of the CPAC, not releasing a conditional configuration of other CPAC candidate cells for subsequent CPAC (SCPAC), and continuing evaluating execution conditions of the other CPAC candidate cells.
Example B24 includes the method of example B23 and/or some other example(s) herein, wherein the method includes: when an execution condition of the another CPAC candidate cell of the other CPAC candidate cells is met, performing execution of CPAC towards the another CPAC candidate cell.
Example B25 includes the method of examples B23-B24 and/or some other example(s) herein, wherein the CPAC candidate cell is a PSCell or SpCell, and the other CPAC candidate cells are PSCells or SpCells.
Example B26 includes the method of examples B01-B25 and/or some other example(s) herein, wherein the SCG selective activation is an SN initiated intra-SN SCG selective activation, an MN-initiated inter-SN SCG selective activation, an SN-initiated inter-SN SCG selective activation, or an inter-MN SCG selective activation.
Example B27 includes the method of example B26 and/or some other example(s) herein, wherein the method includes: releasing a CPAC configuration after a PCell change takes place when the SCG selective activation is the inter-MN SCG selective activation.
Example B28 includes the method of examples B01-B26 and/or some other example(s) herein, wherein the method includes: releasing a CPAC configuration after a PCell change takes place.
Example B29 includes the method of example B26 and/or some other example(s) herein, wherein the method includes: for inter-SN CPC, the MN provides a reference configuration to a set of candidate target SNs (T-SNs) in order to generate a T-SN candidate configuration.
Example B30 includes the method of example B29 and/or some other example(s) herein, wherein each T-SN of the set of candidate T-SNs includes an indication in an SN Addition Request acknowledge (Ack) message for each candidate target PSCell of a set of candidate target PSCells, wherein the indication denotes whether an associated SCG configuration is a delta (difference) SCG configuration with respect to a reference SCG configuration.
Example B31 includes the method of examples B01-B30 and/or some other example(s) herein, wherein a reference configuration for SCG selective activation follows a similar design as LTM reference configuration discussed herein.
Example B32 includes the method of examples B01-B31 and/or some other example(s) herein, wherein when the SCG selective activation is an inter-SN SCG selective activation, an RRC reconfiguration message containing CPAC configurations provided to the UE is in an MN format.
Example B33 includes the method of examples B01-B32 and/or some other example(s) herein, wherein the method includes: generating a set of execution conditions for an initial CPAC or a set of execution conditions for one or more SCPACs.
Example B34 includes the method of example B33 and/or some other example(s) herein, wherein when the SCG selective activation is an MN-initiated inter-SN SCG selective activation, a source MN generates the set of execution conditions for the initial CPAC.
Example B35 includes the method of examples B33-B34 and/or some other example(s) herein, wherein a source MN generates the set of execution conditions for all of the one or more SCPCs.
Example B36 includes the method of example B33 and/or some other example(s) herein, wherein a candidate SN generates and/or modifies the set of execution conditions for some or all of the one or more SCPCs.
Example B37 includes the method of examples B33-B36 and/or some other example(s) herein, wherein when the SCG selective activation is an SN-initiated SCG selective activation, a candidate SN generates the set of execution conditions for some or all of the one or more SCPCs.
Example B38 includes the method of examples B33-B37 and/or some other example(s) herein, wherein when the SCG selective activation is an MN-initiated CPAC, a candidate SN generates the set of execution conditions for some or all of the one or more SCPCs.
Example B39 includes the method of examples B33-B38 and/or some other example(s) herein, wherein when the SCG selective activation is an SN-initiated inter-SN SCG selective activation, a source SN generates the set of execution conditions for the initial CPAC.
Example B40 includes the method of examples B33-B39 and/or some other example(s) herein, wherein a candidate SN generates and/or modifies the set of execution conditions for some or all of the one or more SCPCs.
Example B41 includes the method of examples B33-B40 and/or some other example(s) herein, wherein the set of execution conditions for the initial CPAC and the set of execution conditions for SCPACs are associated with a set of candidate target cells.
Example B42 includes the method of example B41 and/or some other example(s) herein, wherein when the SCG selective activation is an MN-initiated procedure or an SN-initiated procedure, the set of execution conditions for the initial CPAC are based on measurement report triggering event A3 (neighbor becomes offset better than SpCell), measurement report triggering event A4 (neighbor becomes better than threshold), and/or measurement report triggering event A5 (SpCell becomes worse than threshold1 and neighbor becomes better than threshold2) (see e.g., [TS38331]).
Example B43 includes the method of example B41 and/or some other example(s) herein, wherein when the SCG selective activation is an MN-initiated procedure or an SN-initiated procedure, the set of execution conditions for the for one or more SCPACs are based on measurement report triggering event A3 (neighbor becomes offset better than SpCell), measurement report triggering event A4 (neighbor becomes better than threshold), and/or measurement report triggering event A5 (SpCell becomes worse than threshold1 and neighbor becomes better than threshold2) (see e.g., [TS38331]).
Example B44 includes the method of examples B01-B43 and/or some other example(s) herein, wherein an initial RRC reconfiguration message containing a set of CPAC configurations includes at least one of the following configurations: a reference SCG configuration, an LTM reference configuration, an MCG configuration, an RRC model for the SCG reference configuration, an RRC model for the LTM reference configuration, an initial list of candidate target cells with associated target SCG configurations, and/or MCG configurations associated with the target SCG configurations are included.
Example B45 includes the method of example B44 and/or some other example(s) herein, wherein the candidate target cells are PSCells and/or candidate target SpCells.
Example B46 includes the method of examples B44-B45 and/or some other example(s) herein, wherein the method includes: keeping or maintaining the set of CPAC configurations after CPAC execution.
Example B47 includes the method of examples B44-B46 and/or some other example(s) herein, wherein the method includes: releasing an individual CPAC candidate cell based on explicit signaling via RRC reconfiguration procedure or MAC CE.
Example B48 includes the method of examples B01-B47 and/or some other example(s) herein, wherein the method includes: skipping performing condition evaluation for a candidate that is a current PSCell or SpCell.
Example B49 includes the method of examples B01-B48 and/or some other example(s) herein, wherein the method includes: providing, during an MN-initiated procedure or an SN-initiated procedure, a reference configuration to all candidate cells involved in preparation.
Example B50 includes the method of examples B01-B50 and/or some other example(s) herein, wherein the method includes: performing the method of any one of examples A01-A18, C01-C14, D01-D25, E01-E12, F01-F30, G01-G15, and/or H01-H27.
Example C01 includes a method comprising: upon L1/L2 based switching, PHY layer providing in-sync and out-sync information to RRC layer by using RLM-RS configured for cell B although the serving cell is still cell A; with this option, RLM can be autonomously updated to cell B and RLF could be avoided.
Example C02 includes the method of example C01 and/or some other example(s) herein, wherein when L1/L2 mobility is triggered, it also indicates to higher layer (RRC).
Example C03 includes the method of examples C01-C02 and/or some other example(s) herein, wherein the reconfigure serving cell to cell B; serving cell pre-configured RRC and PDCP is sent to the UE in advance; and UE applies when serving cell change is triggered.
Example C04.1 includes the method of examples C01-C03 and/or some other example(s) herein, wherein reconfigured RLM to include cell B, in this option, either UE uses cell A and cell B for RLM purpose when L1/L2 signal the switch.
Example C04.2 includes the method of examples C01-C03 and/or some other example(s) herein, wherein the UE RLM procedure can be modified such that the UE use both cell for RLM purposes.
Example C04.3 includes the method of example C04.2 and/or some other example(s) herein, wherein both cells need to have out of sync for some time before RLF is triggered, and when only one cell out of sync is detected, the UE does not trigger any RLF related timer.
Example C05 includes the method of examples C01-004.3 and/or some other example(s) herein, wherein the UE performs hard HO to non-serving cell (cell B) when out of sync is detected without declaring RLF.
Example C06.1 includes the method of examples C01-005 and/or some other example(s) herein, wherein the method includes autonomous switching of MO.
Example C06.2 includes the method of example C06.1 and/or some other example(s) herein, wherein the autonomous switching of MO includes network configures TRP specific MO, and the UE switches the MO to corresponding TRP upon receiving L1/L2 switching indication from the lower layer.
Example C07 includes the method of examples C01-006.2 and/or some other example(s) herein, wherein if cell A and cell B are intra-DU (meaning they share the same RRC, PDCP, RLC, MAC, and PHY), When a UE is in location A, a list of candidate cells can be configured to UE; and for each candidate cell, at least the PCI, RS, obj ID, TCI, cell specific parameters, C-RNTI configurations can be provided.
Example C08.1 includes the method of examples C01-007 and/or some other example(s) herein, wherein trigger may happen after higher layer receive out-of-sync indicator.
Example C08.2 includes the method of example C08.1 and/or some other example(s) herein, wherein the trigger can be in a form of a new timer similar to T310 or a new timer, and at expiry of new timer, triggers new UE procedure.
Example C09 includes the method of examples C01-008.2 and/or some other example(s) herein, wherein the trigger may happen when L1/L2 mobility happen.
Example C10 includes the method of examples C01-009 and/or some other example(s) herein, wherein trigger may be based on new event in L1/2 or L3
Example C11 includes a method to be performed by a user equipment (UE), one or more elements of a UE, and/or one or more electronic devices that includes or implement one or more elements of a UE, wherein the method comprises: identifying that the UE is communicatively coupled with a transmit/reception point (TRP) of a serving cell and a TRP of a non-serving cell; identifying a radio link monitoring reference signal (RLM-RS) related to the non-service cell; providing in-sync or out-of-sync information based on the RLM-RS; and updating RLM to the non-serving cell.
Example C12 includes the method of example C11 and/or some other example(s) herein, wherein the method includes: providing the in-sync or out-of-sync information to a radio resource control (RRC) entity of the serving cell or non-serving cell.
Example C13 includes the method of examples C01-C12 and/or some other example(s) herein, wherein the serving cell and non-serving cell are in the same centralized unit (CU) of a base station.
Example C14 includes the method of examples C01-C13 and/or some other example(s) herein, wherein the method includes: performing the method of any one of examples A01-A18, B01-B50, D01-D25, E01-E15, F01-F30, G01-G15, and/or H01-H27.
Example D01 includes a method to support L1/L2 based intra-DU mobility for latency reduction in a split NG-RAN architecture involving a CU-CP, CU-UP, and DU, the method comprising: when the CU-CP decides intra-DU L1/L2 mobility and which candidate cells to configure, following a legacy intra-DU handover (HO) principle, the CU-UP retrieves new UL TNL per DRB from CU-UP; in terms of preparing multiple candidate cell configurations with a candidate DU over an F1 interface, performing parallel preparation signalling each for each candidate cell via the UE Context Modification procedure is used, wherein the DU is able to accept/reject the request for each candidate cell basis and also able to provide lower-layer configuration separately for each candidate cell.
Example D02 includes the method of example D01 and/or some other example(s) herein, wherein the method includes: after preparing multiple candidate cell configurations with DU over F1 interface, the DU is allowed to request cancellation of configured candidate cells toward CU.
Example D03 includes the method of examples D01-D02 and/or some other example(s) herein, wherein the method includes: when preparing multiple candidate cell configurations with the DU over the F1 interface, the CU-CP provides a new UL TEID, which was retrieved from the CU-UP by CU-CP, for each DRB so that the DU can meet the legacy intra-DU HO principle and use it when intra-DU L1/L2 mobility is executed.
Example D04 includes the method of example D03 and/or some other example(s) herein, wherein the method includes: the DU provides the corresponding new DL TEID for each DRB so that CU-CP can obtain new DL TEID for each DRB that has been successfully prepared with the DU, which later can be delivered to CU-UP to meet the legacy intra-DU HO principle and use it when intra-DU L1/L2 mobility is executed.
Example D05 includes the method of examples D01-D04 and/or some other example(s) herein, wherein the method includes: when the DU decides which cell to move the UE based on L1 measurements and receives successful acknowledgement (ACK) for L1/2 HO command (CMD) sent to the UE, then to minimize latency, continuing a mobility procedure before random access channel (RACH) or RRC Reconfiguration Complete.
Example D06 includes the method of example D05 and/or some other example(s) herein, wherein legacy DDDS signallings and ACCESS SUCCESS message are used to continue the mobility procedure toward the CU-UP and the CU-CP, respectively.
Example D07 includes the method of example D06 and/or some other example(s) herein, wherein the DU sends two DDDS to the CU-UP and ACCESS SUCCESS message to the CU-CP as soon as the DU confirms which cell the UE is going to access, wherein a first DDDS is sent to the CU-UP to inform not successfully transmitted/delivered PDUs using the legacy F1-U interface, and a second DDDS (which is an initial DDDS) is sent to CU-UP to inform the UE's successful access using new F1-U with DL TEID corresponding to the chosen cell by DU and new UL TEID provided by CU-CP, and the ACCESS SUCCESS message informs the cell the UE is going to access to CU-CP.
Example D08 includes the method of examples D01-D07 and/or some other example(s) herein, wherein the method includes: the CU-CP triggers the E1AP Bearer Context Modification procedure to provide to the CU-UP with DN TEIDs for new F1-Us, updated SDAP/PDCP configurations (if needed), and updated security key (if needed).
Example D09 includes the method of examples D01-D08 and/or some other example(s) herein, wherein the method includes: for subsequent HO executions, same network signalling design as for initial HO execution is used, with a difference that the DU toggles between old UL TEIDs and new UL TEIDs for initial DDDS by the DU to let the CU-UP use the UL TEID of the initial DDDS sent from the DU for subsequent DL delivery, in order to meet the legacy intra-DU principle of the special F1-U UL/DL TEID handling (as specified in [TS38401] § 8.2.1.2.).
Example D10 includes the method of examples D01-D09 and/or some other example(s) herein, wherein a list of UL TEIDs per each candidate cell can be allocated by CU-UP in advance, for which the DU and the CU-UP use the UL TEID and DL TEID corresponding to the cell that the UE is handed over for initial DDDS and subsequent UL/DL delivery over F1-U.
Example D11 includes the method of examples D01-D10 and/or some other example(s) herein, wherein a list of UL TEIDs and DL TEIDs can be allocated by CU-UP and DU in advance, for which the DU and the CU-UP use the UL TEID and DL TEID in the order of each list for UL/DL delivery over F1-U whenever the UE handover is executed.
Example D12 includes a method to support L1/L2 based inter-DU mobility for latency reduction in a split NG-RAN architecture involving a CU-CP, CU-UP, and DU, the method comprising: when the CU-CP decides inter-DU L1/L2 mobility and which candidate cells to configure, following the legacy intra-DU HO principle, the CU-UP retrieves new UL TNL per DRB from the CU-UP; and in terms of preparing multiple candidate cell configurations with a candidate DU over F1 interface, parallel preparation signalling each for each candidate cell via the UE Context Setup procedure is used, wherein the DU is able to accept/reject the request for each candidate cell basis and also able to provide lower-layer configuration separately for each candidate cell.
Example D13 includes the method of example D12 and/or some other example(s) herein, wherein the method includes: after preparing multiple candidate cell configurations with the DU over the F1 interface, the DU and the CU-CP is/are allowed to request cancellation of configured candidate cells.
Example D14 includes the method of examples D12-D13 and/or some other example(s) herein, wherein the method includes: when preparing multiple candidate cell configurations with a candidate DU over F1 interface, the CU-CP provides two UL TNLs for each DRB so that the DU can meet the legacy intra-DU HO principle and use it when intra-DU L1/L2 mobility is executed in case HO within a candidate DU (e.g., intra-DU) may happen, wherein a first UL TNL of the two UL TNLs is an old UL TEID that has been used with a source DU and a second UL TNL of the two UL TNLs is a new UL TEID that is retrieved from the CU-UP by the CU-CP.
Example D15 includes the method of examples D12-D14 and/or some other example(s) herein, wherein the method includes: after preparing multiple candidate cell configurations with a candidate DU over the F1 interface, the CU-CP provides the candidate cells to the candidate DU that have been prepared with other DU(s).
Example D16 includes the method of examples D12-D15 and/or some other example(s) herein, wherein the method includes: after preparing multiple candidate cell configurations with a candidate DU over F1 interface, the CU-CP provides the candidate cells to the source DU that have been prepared with other DU(s).
Example D17 includes the method of examples D12-D16 and/or some other example(s) herein, wherein the method includes: when the DU decides which cell to move the UE based on L1 measurements and receives successful ACK for L1/2 HO CMD sent to the UE, then to minimize latency, continuing a mobility procedure before RACH (optional) or RRC Reconfiguration Complete.
Example D18 includes the method of examples D12-D17 and/or some other example(s) herein, wherein the method includes: the DU who executed HO and confirms further propagates HO execution to the CU-UP and the target DU when it confirms so that the CU-UP can be ready with the target DU and the target DU can be ready to trigger initial DDDS to the CU-UP as early as possible.
Example D19 includes the method of example D18 and/or some other example(s) herein, wherein a DU-initiated class-1 procedure is used to propagate the HO execution to the CU-CP and the target DU when it confirms.
Example D20 includes the method of examples D18-D19 and/or some other example(s) herein, wherein the legacy DU-initiated class-1 procedure could be re-used/extended or a new dedicated procedure or a dedicated IE could be defined.
Example D21 includes the method of examples D19-D20 and/or some other example(s) herein, wherein when the CU-CP receives the propagation of the HO execution from the DU, the CU-CP further propagates the HO execution to the target DU.
Example D22 includes the method of examples D19-D21 and/or some other example(s) herein, wherein the successful ACK replied from the CU-CP is to cause the DU to trigger DDDS to inform not successfully transmitted/delivered PDUs to CU-UP.
Example D23 includes the method of examples D12-D22 and/or some other example(s) herein, wherein for inter-DU L1/L2 handover execution, in case of intra-DU HO execution, same network signalling is re-used as for intra-DU L1/L2 handover execution.
Example D24 includes the method of examples D12-D22 and/or some other example(s) herein, wherein for inter-DU L1/L2 handover execution, in case of intra-DU HO execution, different signalling is defined for intra-DU HO execution in case of L1/L2 based inter-DU mobility procedure.
Example D25 includes the method of examples D01-D24 and/or some other example(s) herein, wherein the method includes: performing the method of any one of examples A01-A18, B01-B50, C01-C14, E01-E15, F01-F30, G01-G15, and/or H01-H27.
Example E01 includes a method comprising: determining or identifying a list of sk-counter values for sequential use when CPC happens.
Example E02 includes the method of example E01 and/or some other example(s) herein, wherein the method includes: a network providing a UE with the list of sk-counter, wherein the list is incremental or not incremental, and wherein the UE uses a next available sk-counter for the next activated cell.
Example E03 includes the method of examples E01 to E02 and/or some other example(s) herein, wherein the method includes: when all the sk-counter is used in the list, the network sends a new list to the UE; and/or no more SCG can be activated which require new sk-counter, and wherein the UE falls back to a legacy procedure.
Example E04 includes the method of example E03 and/or some other example(s) herein, wherein the method includes: the sk-counter may or may not be reused, wherein for the reuse case, the UE can remember which sk-counter is used for the deactivated cell, and if a newly activated cell (never activated from pre-configuration), the UE will use a new sk-counter from the list.
Example E05 includes a method comprising: determining or identifying one assigned sk-counter for each candidate PSCell, wherein each candidate PSCell is associated with a pre-configured sk-counter, and a UE will use the associated sk-counter accordingly.
Example E06 includes the method of example E05 and/or some other example(s) herein, wherein the sk-counter assigned to a candidate PSCell is reused.
Example E07 includes the method of examples E05 to E06 and/or some other example(s) herein, wherein if sk-counter can be reuse for deactivated PSCell, the UE uses a stored sk-counter.
Example E08 includes the method of example E05 and/or some other example(s) herein, wherein the sk-counter is not allowed to be reused, and the network assigns a new sk-counter to a deactivated cell.
Example E09 includes the method of example E05 and/or some other example(s) herein, wherein the sk-counter is not allowed to be reused, and the UE sends a request for a new sk-counter from network; otherwise, the cell will be released.
Example E10 includes a method to be performed by a user equipment (UE), comprising: receiving, from radio access network (RAN) node, a list of secondary key (SK) counter values; and determining a security key for accessing a network cell based on the list of SK counter values.
Example E11 includes the method of example E10 and/or some other example(s) herein, wherein the UE performs the method of any one or more of examples E01-E09 and E12-E14.
Example E12 includes a method to be performed by a user equipment (UE), comprising: storing, in a memory, a master key and a cell group configuration (CPC), wherein the CPC indicates a configured set of secondary nodes (SNs).
Example E13 includes the method of example E12 and/or some other example(s) herein, wherein the method includes: receiving, from a master node (MN), respective SN counter values for corresponding SNs in the set of SNs; and storing the respective SN counter values along with the CPC.
Example E14 includes the method of example E13 and/or some other example(s) herein, wherein the method includes: deriving respective SN security keys for each SN in the set of SNs using the master key together with an unused ones of the respective SN counter values
Example E15 includes the method of examples E01-E14 and/or some other example(s) herein, wherein the method includes: performing the method of any one of examples A01-A18, B01-B50, C01-C14, D01-D25, F01-F30, G01-G15, and/or H01-H27.
Example F01 includes a method for early TA acquisition before cell switch execution.
Example F02 includes the method of example F01 and/or some other example(s) herein, wherein the candidate target cell allocates preamble resources for early TA acquisition.
Example F03 includes the method of example F02 and/or some other example(s) herein, wherein the source cell indicates to UE which preamble resource is used for transmission, and source cell receives TA value.
Example F04 includes the method of example F03 and/or some other example(s) herein, wherein the source cell receives TA value from the candidate target cell.
Example F05 includes the method of examples F03 to F04 and/or some other example(s) herein, wherein the source cell sends the UE ID to the candidate target cell.
Example F06 includes the method of examples F01 to F05 and/or some other example(s) herein, wherein a gap is configured by source cell to UE, during which UE transmits preamble towards a candidate cell.
Example F07 includes the method of example F06 and/or some other example(s) herein, wherein the gap can take effect periodically which has the same periodicity with that of preamble resource.
Example F08 includes a method to be performed by a user equipment (UE), one or more elements of a UE, and/or an electronic device that includes and/or implements a UE, wherein the method comprises: identifying, from a source cell of a cellular network, a physical downlink control channel (PDCCH) transmission related to timing advance (TA) acquisition; transmitting, based on the PDCCH transmission, a random access channel (RACH) transmission to a target cell; and identifying, based on the RACH transmission, an indication of a TA value.
Example F09 includes the method of example F08 and/or some other example(s) herein, wherein the method includes communicatively coupling with the target cell based on the TA value.
Example F10 includes the method of examples F08-F09 and/or some other example(s) herein, wherein the method includes: identifying an indication of a gap received from the source cell; and transmitting the RACH transmission based on the gap.
Example F11 includes the method of examples F08-F10 and/or some other example(s) herein, wherein the indication of the TA value is received from the source cell.
Example F12 includes the method of examples F08-F10 and/or some other example(s) herein, wherein the indication of the TA value is received from the target cell.
Example F13 includes a method to be performed by a source cell, one or more elements of a source cell, and/or an electronic device that includes or implements a source cell, wherein the method comprises: identifying that early timing advance (TA) acquisition of a candidate cell by a user equipment (UE) is to occur; and transmitting, to the UE, a physical downlink control channel (PDCCH) transmission related to the early TA acquisition.
Example F14 includes the method of example F13 and/or some other example(s) herein, wherein the method includes: identifying, from the candidate cell, an indication of a TA value related to the early TA acquisition; and transmitting, to the UE, an indication of the TA value.
Example F15 includes the method of examples F13-F14 and/or some other example(s) herein, wherein the method includes: identifying, from the candidate cell, an indication of a preamble resource; and transmitting, to the UE in the PDCCH transmission, an indication of the preamble resource, wherein the UE is to use the preamble resource to transmit a random access channel (RACH) transmission related to the early TA acquisition.
Example F16 includes the method of example F15 and/or some other example(s) herein, wherein the indication of the preamble resource is based on transmission, to the candidate cell, of an indication of a UE identifier (ID).
Example F17 includes a method to be performed by a candidate cell, one or more elements of a candidate cell, and/or an electronic device that includes or implements a candidate cell, wherein the method comprises: identifying an indication related to a request for a timing advance (TA) value related to a user equipment (UE) that is to communicatively couple with the candidate cell; and transmitting the indication.
Example F18 includes the method of example F17 and/or some other example(s) herein, wherein the method includes: transmitting the indication to a source cell to which the UE is communicatively coupled.
Example F19 includes the method of example F17 and/or some other example(s) herein, wherein the method includes: transmitting the indication to the UE.
Example F20 includes the method of any of examples F17-F19 and/or some other example(s) herein, wherein the request is a random access channel (RACH) transmission received from the UE.
Example F21 includes the method of any of examples F17-F19 and/or some other example(s) herein, wherein the request is received from a source cell to which the UE is communicatively coupled.
Example F22 includes a method comprising: receiving a physical downlink control channel (PDCCH) order including information that identifies an allocated Contention Free Random Access (CFRA) resource to enable shared preamble resource among multiple UEs.
Example F23 includes the method of any of example F22 and/or some other example herein, wherein CFRA resource includes an SS/PBCH index, random access channel (RACH) occasion, and random access preamble index.
Example F24 includes a method comprising: signaling an RRC RACH configuration for early timing advance (TA) acquisition separately from a candidate cell configuration.
Example F25 includes the method of any of example F24 and/or some other example herein, wherein the RRC RACH configuration for early TA acquisition is specific per target cell.
Example F26 includes the method of any of examples F24-F25 and/or some other example herein, wherein the RRC RACH configuration for early TA acquisition indicates whether a random access response (RAR) needs to be received.
Example F26 includes the method of any of examples F24-F25 and/or some other example herein, wherein the separate signaling includes indicating the RRC RACH configuration for early TA acquisition in a separate information element (IE) than an IE used for the candidate cell configuration.
Example F27 includes the method of any of examples F24-F26 and/or some other example herein, wherein the candidate cell configuration indicates a part that is to be applied at a cell switch.
Example F27 includes the method of any of examples F24-F26 and/or some other example herein, wherein for PDCCH ordered early TA acquisition without RAR, there is no need for a UE to maintain a TA timer for candidate cell.
Example F28 includes the method of any of example F27 and/or some other example herein, wherein the TA is given in a cell switch medium access control (MAC) control element (CE).
Example F29 includes the method of any of examples F27-F28 and/or some other example herein, wherein without RAR and/or without UE maintaining TA, the UE is to perform RACH for link recovery and/or for conditional PSCell change (CPC)/Conditional PSCell addition (CPA).
Example F30 includes the method of any of examples F27-F29 and/or some other example herein, wherein the UE determines to trigger RACH-less cell switch in MAC layer, if the LTM cell switch MAC CE provides a TA value with or without a RAR.
Example F31 includes the method of examples F01-F30 and/or some other example(s) herein, wherein the method includes: performing the method of any one of examples A01-A18, B01-B50, C01-C14, D01-D25, E01-E15, G01-G15, and/or H01-H27.
Example G01 includes a method of supporting conditional handover (CHO) with or without secondary cell group (SCG) configurations for a UE in a network system.
Example G02 includes the method of example G01 and/or some other example(s) herein, wherein the network system comprises a source master node (S-MN), a target master node (T-MN), and a set of target secondary nodes (T-SNs) inter-connected by respective Xn interfaces.
Example G03 includes the method of example G02 and/or some other example(s) herein, wherein a source secondary node (S-SN) is connected with the S-MN by an Xn interface, and both are serving the UE in dual connectivity.
Example G04 includes the method of example G03 and/or some other example(s) herein, wherein the S-MN informs the S-SN of the prepared CHO with or without SCG configurations for the UE.
Example G05.0 includes the method of example G04 and/or some other example(s) herein, wherein the S-SN informs the S-SM of its intra-S-SN RRC reconfiguration update with the UE.
Example G05.1 includes the method of example G05.0 and/or some other example(s) herein, wherein the S-SN informs the S-SM of its intra-S-SN RRC reconfiguration update with the UE regardless of whether system information block 3 (SRB3) was used.
Example G05.2 includes the method of examples G05.0-G05.1 and/or some other example(s) herein, wherein the S-SN informs the S-SM of its intra-S-SN RRC reconfiguration update with the UE regardless of whether intra-S-SN RRC reconfiguration was already performed.
Example G05.3 includes the method of examples G05.0-G05.2 and/or some other example(s) herein, wherein system information block 1 (SRB1) is to be used for intra-S-SN RRC reconfiguration toward the UE.
Example G06 includes the method of examples G02-G05.3 and/or some other example(s) herein, wherein the T-MN, during CHO preparation phase, provides the information on full RRC configuration status of the prepared CHO with or without SCG configurations to S-MN.
Example G07 includes the method of example G06 and/or some other example(s) herein, wherein the information includes whether full RRC configuration was applied entirely and/or whether full RRC configuration was applied only on SN part of RRC configurations.
Example G08 includes the method of examples G06-G07 and/or some other example(s) herein, wherein the information includes which T-SN may apply full configuration.
Example G09 includes the method of examples G06-G08 and/or some other example(s) herein, wherein S-MN, based on the received information, may decide to trigger CHO modification signalling toward T-MN upon RRC reconfiguration happens in S-MN.
Example G10.0 includes the method of exampleS G05.0-G06 and/or some other example(s) herein, wherein the S-MN, based on the received information, decides to trigger CHO modification signalling toward T-MN upon RRC reconfiguration happens in the S-SN.
Example G10.1 includes the method of exampleS G05.0-G09 and/or some other example(s) herein, wherein the S-MN, based on the received information, decides to trigger CHO modification signalling toward T-MN upon RRC reconfiguration happens in the S-SN.
Example G11 includes the method of examples G02-G10.1 and/or some other example(s) herein, wherein the S-MN provides the information on the executed source RRC reconfiguration status with the UE to T-MN when triggering the update of the prepared CHO with or without SCG configurations to T-MN.
Example G12 includes the method of example G11 and/or some other example(s) herein, wherein the information may include whether the executed RRC reconfiguration was only for intra-S-MN RRC reconfiguration.
Example G13 includes the method of examples G05.0-G11 and/or some other example(s) herein, wherein the information may include whether the executed RRC reconfiguration was only for intra-S-SN RRC reconfiguration.
Example G14 includes the method of examples G11-G13 and/or some other example(s) herein, wherein the T-MN, based on the received information from the S-MN and/or the full RRC configuration information from the associated set of T-SNs for the prepared CHO with SCG configurations, decides to trigger SN modification toward at least a subset of the set of T-SNs.
Example G15 includes the method of examples G01-G14 and/or some other example(s) herein, wherein the method includes: performing the method of any one of examples A01-A18, B01-B50, C01-C14, D01-D25, E01-E15, F01-F30, and/or H01-H27.
Example H01 includes a method, comprising: storing a reference configuration; storing a candidate cell configuration separate from the reference configuration; and generating a complete configuration by application of the candidate cell configuration to (or on top of) the reference configuration.
Example H02 includes the method of example H01 and/or some other example(s) herein, wherein the reference configuration is a configuration provided to the UE that is common to an entire set of configured candidate cells
Example H03 includes the method of examples H01-H02 and/or some other example(s) herein, wherein the candidate cell configuration is a configuration associated with at least one candidate cell.
Example H04 includes the method of examples H01-H03 and/or some other example(s) herein, wherein the method includes: upon generating the complete configuration by applying the candidate cell configuration on top of the reference configuration, considering the configuration in the reference configuration as the complete configuration.
Example H05 includes the method of example H04 and/or some other example(s) herein, wherein the method includes: for each field present in the candidate cell configuration that releases an element on or in a list of elements to release, deleting a corresponding element from the complete configuration, if present.
Example H06 includes the method of examples H04-H05 and/or some other example(s) herein, wherein the method includes: for each field present in the candidate cell configuration that adds or modifies an element on or in a list of elements to add or modify, when a corresponding element is already present in the complete configuration, modifying the corresponding element in the complete configuration with the one received in the candidate cell configuration.
Example H07 includes the method of examples H04-H06 and/or some other example(s) herein, wherein the method includes: for each field present in the candidate cell configuration that adds or modifies an element on or in a list of elements to add or modify, when a corresponding element is not already present in the complete configuration, adding the corresponding element in the complete configuration according to the corresponding element in the candidate cell configuration.
Example H08 includes the method of examples H04-H07 and/or some other example(s) herein, wherein the method includes: for each field present in the candidate cell configuration that that do not release, add, or modify an element of a list, when a corresponding field is present in the complete configuration, modifying the corresponding field in the complete configuration with the corresponding field in the received candidate cell configuration.
Example H09 includes the method of examples H04-H08 and/or some other example(s) herein, wherein the method includes: for each field present in the candidate cell configuration that that do not release, add, or modify an element of a list, when the corresponding field is not present in the complete configuration, adding the corresponding field in the received candidate cell configuration in the complete configuration.
Example H10 includes the method of examples H04-H09 and/or some other example(s) herein, wherein the method includes: for each field that is present in the reference configuration that does not have a corresponding field in the candidate cell configuration, removing the corresponding field from the complete configuration.
Example H11 includes the method of examples H01-H10 and/or some other example(s) herein, wherein the candidate cell configuration includes a candidate-to-release list, and the method includes: for each candidate identifier (ID) in the candidate-to-release list, when the reference configuration includes a candidate cell with a corresponding candidate ID, removing the entry related to the candidate cell with the corresponding candidate ID from the complete configuration.
Example H12 includes the method of examples H01-H11 and/or some other example(s) herein, wherein the candidate cell configuration is associated with a master cell group (MCG).
Example H13 includes the method of examples H01-H11 and/or some other example(s) herein, wherein the candidate cell configuration is associated with a secondary cell group (SCG),
Example H14 includes the method of example H13 and/or some other example(s) herein, wherein the method includes: receiving or obtaining the candidate cell configuration from a radio resource control (RRC) reconfiguration message received via system information block three (SIB 3).
Example H15 includes the method of examples H12-H13 and/or some other example(s) herein, wherein the method includes: receiving or obtaining the candidate cell configuration from an RRC reconfiguration message received via system information block one (SIB1).
Example H16 includes the method of examples H01-H15 and/or some other example(s) herein, wherein the method includes: generating the complete configuration in response to receipt of an indication of a cell switch from a lower layer entity.
Example H17 includes the method of example H16 and/or some other example(s) herein, wherein the indication of the cell switch is based on a handover (HO), a condition HO (CHO), a conditional primary SCG cell (PSCell) addition (CPA), a conditional PSCell Change (CPC), or a conditional PSCell addition or change (CPAC).
Example H18 includes the method of example H16 and/or some other example(s) herein, wherein the reference configuration is a layer 1 (L1)/layer 2 (L2) triggered mobility (LTM) reference configuration, the candidate cell configuration is an LTM candidate cell configuration, the complete configuration is a complete LTM candidate cell configuration, and the indication of the cell switch is an LTM cell switch indication.
Example H19 includes the method of example H18 and/or some other example(s) herein, wherein the method includes: initiating an LTM cell switch procedure in response to receipt of the LTM cell switch indication.
Example H20 includes the method of example H19 and/or some other example(s) herein, wherein the method includes: performing the LTM cell switch procedure including: when a received cell group configuration contains LTM cell switch information: applying, as a cell radio network temporary identifier (C-RNTI) for this cell group, a value included in a new UE identity information element (IE) within the LTM cell switch information of the LTM candidate cell configuration indicated by the lower layers; configuring the lower layers in accordance with a received special cell (SpCell) common configuration within the LTM cell switch information of the LTM candidate cell configuration indicated by the lower layers; and configuring the lower layers in accordance with a received random access channel (RACH) configuration within the LTM cell switch information of the LTM candidate cell configuration indicated by the lower layers.
Example H21 includes the method of examples H19-H20 and/or some other example(s) herein, wherein the method includes: starting an LTM timer upon execution of the LTM cell switch procedure; and stopping the LTM timer upon successful completion of the LTM cell switch procedure.
Example H22 includes the method of examples H01-H17 and/or some other example(s) herein, wherein the reference configuration is a subsequent CPAC (SCPAC) reference configuration, the candidate cell configuration is an conditional reconfiguration candidate cell configuration or a cell group configuration (CGC), and the complete configuration is a complete conditional configuration.
Example H23 includes the method of example H22 and/or some other example(s) herein, wherein the CGC includes a list of candidate master nodes (MNs) and/or a list of candidate secondary nodes (SNs).
Example H24 includes the method of examples H01-H23 and/or some other example(s) herein, wherein the method includes: receiving an RRC message including the candidate cell configuration and the reference configuration in separate information elements (IEs).
Example H25 includes the method of examples H01-H24 and/or some other example(s) herein, wherein the candidate cell configuration is a complete configuration.
Example H26 includes the method of examples H01-H24 and/or some other example(s) herein, wherein the candidate cell configuration is a delta (difference) configuration with respect to the reference configuration.
Example H27 includes the method of examples H01-H26 and/or some other example(s) herein, wherein the method includes: performing the method of any one of examples A01-A18, B01-B50, C01-C14, D01-D25, E01-E15, F01-F30, and/or G01-G15.
Example H28 includes the method of examples A01-A18, B01-B50, C01-C14, D01-D25, E01-E15, F01-F30, G01-G15, H01-H27 and/or some other example(s) herein, wherein the method is performed by a user equipment (UE) or an integrated circuit disposed in a UE.
Example Z01 includes an apparatus comprising means to perform one or more elements of a method described in or related to any of examples A01-A18, B01-B50, C01-C14, D01-D25, E01-E15, F01-F30, G01-G15, H01-H27, or any other method(s), process(es), procedure(s), and/or example(s) described herein. Example Z02 includes one or more non-transitory computer-readable media comprising instructions to cause an electronic device, upon execution of the instructions by one or more processors of the electronic device, to perform one or more elements of a method described in or related to any of examples A01-A18, B01-B50, C01-C14, D01-D25, E01-E15, F01-F30, G01-G15, H01-H27, or any other method(s), process(es), procedure(s), and/or example(s) described herein. Example Z03 includes an apparatus comprising logic, modules, or circuitry to perform one or more elements of a method described in or related to any of examples A01-A18, B01-B50, C01-C14, D01-D25, E01-E15, F01-F30, G01-G15, H01-H27, or any other method(s), process(es), procedure(s), and/or example(s) described herein. Example Z04 includes a method, technique, or process as described in or related to any of examples A01-A18, B01-B50, C01-C14, D01-D25, E01-E15, F01-F30, G01-G15, H01-H27, or portions or parts thereof. Example Z05 includes an apparatus comprising: one or more processors and one or more computer-readable media comprising instructions that, when executed by the one or more processors, cause the one or more processors to perform the method, techniques, or process as described in or related to any of examples A01-A18, B01-B50, C01-C14, D01-D25, E01-E15, F01-F30, G01-G15, H01-H27, or portions thereof. Example Z06 includes a signal as described in or related to any of examples A01-A18, B01-B50, C01-C14, D01-D25, E01-E15, F01-F30, G01-G15, H01-H27, or portions or parts thereof. Example Z07 includes a datagram, packet, frame, segment, protocol data unit (PDU), or message as described in or related to any of examples A01-A18, B01-B50, C01-C14, D01-D25, E01-E15, F01-F30, G01-G15, H01-H27, or portions or parts thereof, or otherwise described in the present disclosure. Example Z08 includes a signal encoded with data as described in or related to any of examples A01-A18, B01-B50, C01-C14, D01-D25, E01-E15, F01-F30, G01-G15, H01-H27, or portions or parts thereof, or otherwise described in the present disclosure. Example Z09 includes a signal encoded with a datagram, packet, frame, segment, protocol data unit (PDU), or message as described in or related to any of examples A01-A18, B01-B50, C01-C14, D01-D25, E01-E15, F01-F30, G01-G15, H01-H27, or portions or parts thereof, or otherwise described in the present disclosure. Example Z10 includes an electromagnetic signal carrying computer-readable instructions, wherein execution of the computer-readable instructions by one or more processors is to cause the one or more processors to perform the method, techniques, or process as described in or related to any of examples A01-A18, B01-B50, C01-C14, D01-D25, E01-E15, F01-F30, G01-G15, H01-H27, or portions thereof. Example Z11 includes a computer program comprising instructions, wherein execution of the program by a processing element is to cause the processing element to carry out the method, techniques, or process as described in or related to any of examples A01-A18, B01-B50, C01-C14, D01-D25, E01-E15, F01-F30, G01-G15, H01-H27, or portions thereof. Example Z12 includes a signal in a wireless network as shown and described herein. Example Z13 includes a method of communicating in a wireless network as shown and described herein. Example Z14 includes a system for providing wireless communication as shown and described herein. Example Z15 includes a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### 11. TERMINOLOGY

For the purposes of the present document, the following terms and definitions are applicable to the examples and embodiments discussed herein. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “performer”, “agent”, “standby”, “consumer”, “peripheral”, “follower”, “server”, “child”, “helper”, “worker”, “node”, and/or the like.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, engines, components, and so forth, or combinations thereof. The term “entity” at least in some examples refers to a distinct element of a component, architecture, platform, device, and/or system. Additionally or alternatively, the term “entity” at least in some examples refers to information transferred as a payload.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing. The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The terms “ego” (as in, e.g., “ego device”) and “subject” (as in, e.g., “data subject”) at least in some examples refers to an entity, element, device, system, and the like, that is under consideration or being considered. The terms “neighbor” and “proximate” (as in, e.g., “proximate device”) at least in some examples refers to an entity, element, device, system, and the like, other than an ego device or subject device.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database. The term “application identifier”, “application ID”, or “app ID” at least in some examples refers to an identifier that can be mapped to a specific application, application instance, or application instance. In the context of 3GPP 5G/NR, an “application identifier” at least in some examples refers to an identifier that can be mapped to a specific application traffic detection rule.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), single-board computer (SBC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” includes, but is not limited to, memory, portable or fixed storage devices, optical storage devices, and various other mediums capable of storing, containing or carrying instructions or data.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “infrastructure processing unit” or “IPU” at least in some examples refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in hardware by the IPU.

The term “device” at least in some examples refers to a physical entity embedded inside, or attached to, another physical entity in its vicinity, with capabilities to convey digital information from or to that physical entity. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “terminal” at least in some examples refers to point at which a conductor from a component, device, or network comes to an end. Additionally or alternatively, the term “terminal” at least in some examples refers to an electrical connector acting as an interface to a conductor and creating a point where external circuits can be connected. In some examples, terminals may include electrical leads, electrical connectors, electrical connectors, solder cups or buckets, and/or the like.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. For purposes of the present disclosure, the term “node” at least in some examples refers to and/or is interchangeable with the terms “device”, “component”, “sub-system”, and/or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers includes an operating system (OS) that provides executable program instructions for the general administration and operation of the individual server computer devices, and includes a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some examples refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “architecture” at least in some examples refers to a computer architecture or a network architecture. The term “computer architecture” at least in some examples refers to a physical and logical design or arrangement of software and/or hardware elements in a computing system or platform including technology standards for interacts therebetween. The term “network architecture” at least in some examples refers to a physical and logical design or arrangement of software and/or hardware elements in a network including communication protocols, interfaces, and media transmission.

The term “appliance,” “computer appliance,” and the like, at least in some examples refers to a computer device or computer system with program code (e.g., software or firmware) that is specifically designed to provide a specific computing resource. The term “virtual appliance” at least in some examples refers to a virtual machine image to be implemented by a hypervisor-equipped device that virtualizes or emulates a computer appliance or otherwise is dedicated to provide a specific computing resource. The term “security appliance”, “firewall”, and the like at least in some examples refers to a computer appliance designed to protect computer networks from unwanted traffic and/or malicious attacks. The term “policy appliance” at least in some examples refers to technical control and logging mechanisms to enforce or reconcile policy rules (information use rules) and to ensure accountability in information systems. The term “gateway” at least in some examples refers to a network appliance that allows data to flow from one network to another network, or a computing system or application configured to perform such tasks. Examples of gateways include IP gateways, Internet-to-Orbit (I2O) gateways, IoT gateways, cloud storage gateways, and/or the like.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” includes any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices. The term “station” or “STA” at least in some examples refers to a logical entity that is a singly addressable instance of a medium access control (MAC) and physical layer (PHY) interface to the wireless medium (WM). The term “wireless medium” or WM″ at least in some examples refers to the medium used to implement the transfer of protocol data units (PDUs) between peer physical layer (PHY) entities of a wireless local area network (LAN).

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like. The term “network controller” at least in some examples refers to a functional block that centralizes some or all of the control and management functionality of a network domain and may provide an abstract view of the network domain to other functional blocks via an interface. The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” includes specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware. The term “access point” or “AP” at least in some examples refers to an entity that contains one station (STA) and provides access to the distribution services, via the wireless medium (WM) for associated STAs. An AP comprises a STA and a distribution system access function (DSAF).

The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN. The term “camped on a cell” at least in some examples refers to a UE in idle mode that has completed a cell selection/reselection process and has chosen a cell; in some examples, the UE monitors system information and (in most cases) paging information.

The term “serving cell” at least in some examples refers to a primary cell (PCell) for a UE in a connected mode or state (e.g., RRC_CONNECTED) and not configured with carrier aggregation (CA) and/or dual connectivity (DC). Additionally or alternatively, the term “serving cell” at least in some examples refers to a set of cells comprising zero or more special cells and one or more secondary cells for a UE in a connected mode or state (e.g., RRC_CONNECTED) and configured with CA.

The term “serving cell” at least in some examples refers to a primary cell for a UE in RRC_CONNECTED not configured with CA/DC there is only one serving cell comprising of the primary cell. Additionally or alternatively, the term “serving cell” or “serving cells” at least in some examples refers to a set of cells comprising special cell(s) (SpCell(s)) and one or more secondary cells for a UE in RRC_CONNECTED configured with CA. The term “active serving cell” at least in some examples refers to a PCell, a PSCell, and one or more activated SCells.

The term “primary cell” or “PCell” at least in some examples refers to a master cell group (MCG) cell, operating on a primary frequency, in which a UE either performs an initial connection establishment procedure or initiates a connection re-establishment procedure.

The term “primary SCG cell” at least in some examples refers to a secondary cell group (SCG) cell in which a UE performs random access when performing a reconfiguration with Sync procedure for DC operation.

The term “primary secondary cell” or “PSCell” at least in some examples refers to a primary cell of a secondary cell group (SCG). The term “conditional PSCell addition” or “CPA” at least in some examples refers to a PSCell addition procedure that is executed only when PSCell addition execution condition is met. The term “conditional PSCell change” or “CPC” at least in some examples refers to a PSCell change procedure that is executed only when PSCell change execution condition is met. The term “conditional PSCell addition or change” or “CPAC” at least in some examples refers to a CPA and/or a CPC.

The term “secondary cell” or “SCell” at least in some examples refers to a cell providing additional radio resources on top of a special cell (SpCell) for a UE configured with carrier aggregation (CA).

The term “special cell” or “SpCell” at least in some examples refers to a PCell for non-DC operation or refers to a PCell of an MCG or a PSCell of an SCG for DC operation. In some examples, the terms “PCell” and “PSCell” are collectively referred to as a “special cell”, “spCell”, or “SpCell”.

The term “master cell group” or “MCG” at least in some examples refers to a group of serving cells associated with a “Master Node” comprising a SpCell (PCell) and zero or more SCells.

The term “secondary cell group” or “SCG” at least in some examples refers to a subset of serving cells comprising at least one primary SCell (PSCell) and zero or more SCells for a UE configured with dual connectivity (DC).

The term “handover” or “HO” at least in some examples refers to the transfer of a user's connection from one radio channel to another (can be the same or different cell). Additionally or alternatively, the term “handover” or “HO” at least in some examples refers to the process in which a radio access network changes the radio transmitters, radio access mode, and/or radio system used to provide the bearer services, while maintaining a defined bearer service QoS.

The term “Master Node” or “MN” at least in some examples refers to a NAN that provides control plane connection to a core network.

The term “Secondary Node” or “SN” at least in some examples refers to a NAN providing resources to the UE in addition to the resources provided by an MN and/or a NAN with no control plane connection to a core network.

The term “E-UTEAN NodeB”, “eNodeB”, or “eNB” at least in some examples refers to a RAN node providing E-UTRA user plane (e.g., PDCP, RLC, MAC, PHY) and control plane (e.g., RRC) protocol terminations towards a UE, and connected via an S1 interface to the Evolved Packet Core (EPC). Two or more eNBs are interconnected with each other (and/or with one or more en-gNBs) by means of an X2 interface.

The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface.

The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface.

The term “E-UTRA-NR gNB” or “en-gNB” at least in some examples refers to a RAN node providing NR user plane and control plane protocol terminations towards a UE, and acting as a secondary node in E-UTRA-NR Dual Connectivity (EN-DC) scenarios (see e.g., [TS37340]). Two or more en-gNBs are interconnected with each other (and/or with one or more eNBs) by means of an X2 interface.

The term “Next Generation RAN node” or “NG-RAN node” at least in some examples refers to either a gNB or an ng-eNB.

The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g., a gNB) that provides network access to UEs via a network of backhaul and access links.

The term “Transmission Reception Point”, “TRxP”, or “TRP” at least in some examples refers to an antenna array with one or more antenna elements available to a network located at a specific geographical location for a specific area.

The term “Central Unit” or “CU” at least in some examples refers to a logical node hosting radio resource control (RRC), Service Data Adaptation Protocol (SDAP), and/or Packet Data Convergence Protocol (PDCP) protocols/layers of an NG-RAN node, or RRC and PDCP protocols of the en-gNB that controls the operation of one or more DUs; a CU terminates an F1 interface connected with a DU and may be connected with multiple DUs. The term “Distributed Unit” or “DU” at least in some examples refers to a logical node hosting Backhaul Adaptation Protocol (BAP), F1 application protocol (F1AP), radio link control (RLC), medium access control (MAC), and physical (PHY) layers of the NG-RAN node or en-gNB, and its operation is partly controlled by a CU; one DU supports one or multiple cells, and one cell is supported by only one DU; and a DU terminates the F1 interface connected with a CU. The term “Radio Unit” or “RU” at least in some examples refers to a logical node hosting PHY layer or Low-PHY layer and radiofrequency (RF) processing based on a lower layer functional split. The term “split architecture” at least in some examples refers to an architecture in which at least one CU, a set of DUs, and/or a set of RUs are physically or virtually separate from one another. Additionally or alternatively, the term “split architecture” at least in some examples refers to a split RAN architecture, such as those discussed in 3GPP TS 38.401 v17.5.0 (2023 Jun. 29) (“[TS38401]”), 3GPP TS 38.410 v 17.1.0 (2022 Jun. 23), and 3GPP TS 38.473 v17.5.0 (2023 Jun. 29) (“[TS38473]”), the contents of each of which are hereby incorporated by reference in their entireties and for all purposes. The term “integrated architecture” at least in some examples refers to an architecture in which an RU and DU are implemented on one platform, and/or an architecture in which a DU and a CU are implemented on one platform.

The term “Residential Gateway” or “RG” at least in some examples refers to a device providing, for example, voice, data, broadcast video, video on demand, to other devices in customer premises. The term “Wireline 5G Access Network” or “W-5GAN” at least in some examples refers to a wireline AN that connects to a 5GC via N2 and N3 reference points. The W-5GAN can be either a W-5GBAN or W-5GCAN. The term “Wireline 5G Cable Access Network” or “W-5GCAN” at least in some examples refers to an Access Network defined in/by CableLabs. The term “Wireline BBF Access Network” or “W-5GBAN” at least in some examples refers to an Access Network defined in/by the Broadband Forum (BBF). The term “Wireline Access Gateway Function” or “W-AGF” at least in some examples refers to a Network function in W-5GAN that provides connectivity to a 3GPP 5G Core network (5GC) to 5G-RG and/or FN-RG. The term “5G-RG” at least in some examples refers to an RG capable of connecting to a 5GC playing the role of a user equipment with regard to the 5GC; it supports secure element and exchanges N1 signaling with 5GC. The 5G-RG can be either a 5G-BRG or 5G-CRG.

The term “edge computing” at least in some examples refers to an implementation or arrangement of distributed computing elements that move processing activities and resources (e.g., compute, storage, acceleration, and/or network resources) towards the “edge” of the network in an effort to reduce latency and increase throughput for endpoint users (client devices, user equipment, and the like). Additionally or alternatively, term “edge computing” at least in some examples refers to a set of services hosted relatively close to a client/UE's access point of attachment to a network to achieve relatively efficient service delivery through reduced end-to-end latency and/or load on the transport network. In some examples, edge computing implementations involve the offering of services and/or resources in a cloud-like systems, functions, applications, and subsystems, from one or multiple locations accessible via wireless networks. Additionally or alternatively, term “edge computing” at least in some examples refers to the concept, as described in [TS23501], that enables operator and 3rd party services to be hosted close to a UE's access point of attachment, to achieve an efficient service delivery through the reduced end-to-end latency and load on the transport network. The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. however, references to an “edge computing system” generally refer to a distributed architecture, organization, or collection of multiple nodes and devices, and which is organized to accomplish or offer some aspect of services or resources in an edge computing setting. The term “edge computing platform” or “edge platform” at least in some examples refers to a collection of functionality that is used to instantiate, execute, or run edge applications on a specific edge compute node (e.g., virtualization infrastructure and/or the like), enable such edge applications to provide and/or consume edge services, and/or otherwise provide one or more edge services. The term “edge application” or “edge app” at least in some examples refers to an application that can be instantiated on, or executed by, an edge compute node within an edge computing network, system, or framework, and can potentially provide and/or consume edge computing services. The term “edge service” at least in some examples refers to a service provided via an edge compute node and/or edge platform, either by the edge platform itself and/or by an edge application.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “network function” or “NF” at least in some examples refers to a functional block within a network infrastructure that has one or more external interfaces and a defined functional behavior. The term “network instance” at least in some examples refers to information identifying a domain; in some examples, a network instance is used by a UPF for traffic detection and routing. The term “network service” or “NS” at least in some examples refers to a composition or collection of NF(s) and/or network service(s), defined by its functional and behavioral specification(s). The term “NF service instance” at least in some examples refers to an identifiable instance of the NF service. The term “NF instance” at least in some examples refers to an identifiable instance of an NF. The term “NF service” at least in some examples refers to functionality exposed by an NF through a service-based interface and consumed by other authorized NFs. The term “NF service operation” at least in some examples refers to an elementary unit that an NF service is composed of. The term “NF service set” at least in some examples refers to a group of interchangeable NF service instances of the same service type within an NF instance; in some examples, the NF service instances in the same NF service set have access to the same context data. The term “NF set” at least in some examples refers to a group of interchangeable NF instances of the same type, supporting the same services and the same network slice(s); in some examples, the NF instances in the same NF Set may be geographically distributed but have access to the same context data.

The term “RAN function” or “RANF” at least in some examples refers to a functional block within a RAN architecture that has one or more external interfaces and a defined behavior related to the operation of a RAN or RAN node. Additionally or alternatively, the term “RAN function” or “RANF” at least in some examples refers to a set of functions and/or NFs that are part of a RAN. The term “Application Function” or “AF” at least in some examples refers to an element or entity that interacts with a 3GPP core network in order to provide services. Additionally or alternatively, the term “Application Function” or “AF” at least in some examples refers to an edge compute node or ECT framework from the perspective of a 5G core network. The term “management function” at least in some examples refers to a logical entity playing the roles of a service consumer and/or a service producer. The term “management service” at least in some examples refers to a set of offered management capabilities. The term “network function virtualization” or “NFV” at least in some examples refers to the principle of separating network functions from the hardware they run on by using virtualization techniques and/or virtualization technologies. The term “virtualized network function” or “VNF” at least in some examples refers to an implementation of an NF that can be deployed on a Network Function Virtualization Infrastructure (NFVI). The term “Network Functions Virtualization Infrastructure Manager” or “NFVI” at least in some examples refers to a totality of all hardware and software components that build up the environment in which VNFs are deployed. The term “Virtualized Infrastructure Manager” or “VIM” at least in some examples refers to a functional block that is responsible for controlling and managing the NFVI compute, storage and network resources, usually within one operator's infrastructure domain. The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings. The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “Data Network” or “DN” at least in some examples refers to a network hosting data-centric services such as, for example, operator services, the internet, third-party services, or enterprise networks. Additionally or alternatively, a DN at least in some examples refers to service networks that belong to an operator or third party, which are offered as a service to a client or user equipment (UE). DNs are sometimes referred to as “Packet Data Networks” or “PDNs”. The term “Local Area Data Network” or “LADN” at least in some examples refers to a DN that is accessible by the UE only in specific locations, that provides connectivity to a specific DNN, and whose availability is provided to the UE.

The term “Internet of Things” or “IoT” at least in some examples refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure. The term “standard protocol” at least in some examples refers to a protocol whose specification is published and known to the public and is controlled by a standards body. The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities. Additionally or alternatively, the term “protocol” at least in some examples refers to a formal set of procedures that are adopted to ensure communication between two or more functions within the within the same layer of a hierarchy of functions.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and includes identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT (MQ Telemetry Transport), Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), SBMV Protocol, Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (μTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signalling Radio Bearers (SRBs) and Data Radio Bearers (DRBs); mobility functions/services; QoS management; and some sidelink specific services and functions over the Uu interface (see e.g., 3GPP TS 36.331 v17.5.0 (2023 Jul. 4) (“[TS36331]”) and/or 3GPP TS 38.331 v17.5.0 (2023 Jul. 1) (“[TS38331]”), the contents of each of which are hereby incorporated by reference in their entireties and for all purposes).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324 v17.0.0 (2022 Apr. 13) (“[TS37324]”), the contents of which is hereby incorporated by reference in its entirety and for all purposes).

The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 v17.2.0 (2023 Jan. 13) and/or 3GPP TS 38.323 v17.5.0 (2023 Jun. 30) (“[TS38323]”), the contents of each of which are hereby incorporated by reference in their entireties and for all purposes).

The term “radio link control layer”, “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 36.322 v17.0.0 (2022 Apr. 15) and 3GPP TS 38.322 v17.3.0 (2023 Jun. 30) (“[TS38322]”), the contents of each of which are hereby incorporated by reference in their entireties and for all purposes).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA) and related HARQ processes; priority handling between UEs by means of dynamic scheduling; priority handling between logical channels of one UE by means of logical channel prioritization; priority handling between overlapping resources of one UE; padding; and/or sidelink processes (see e.g., 3GPP TS 36.321 v17.5.0 (2023 Jun. 30), and 3GPP TS 38.321 v17.5.0 (2023 Jun. 30) (“[TS38321]”), the contents of each of which are hereby incorporated by reference in their entireties and for all purposes).

The term “physical layer”, “PHY layer”, or “PHY” at least in some examples refers to a protocol layer or sublayer that includes capabilities to transmit and receive modulated signals for communicating in a communications network (see e.g., 3GPP TS 36.201 v17.0.0 (2022 Mar. 31), and 3GPP TS 38.201 v17.0.0 (2022 Jan. 5), the contents of each of which are hereby incorporated by reference in their entireties and for all purposes).

The term “access technology” at least in some examples refers to the technology used for the underlying physical connection to a communication network. The term “radio access technology” or “RAT” at least in some examples refers to the technology used for the underlying physical connection to a radio based communication network. The term “radio technology” at least in some examples refers to technology for wireless transmission and/or reception of electromagnetic radiation for information transfer. The term “RAT type” at least in some examples may identify a transmission technology and/or communication protocol used in an access network. Examples of access technologies include wireless access technologies/RATs, wireline, wireline-cable, wireline broadband forum (wireline-BBF), Ethernet (see e.g., IEEE Standard for Ethernet, IEEE Std 802.3-2018 (31 Aug. 2018)) and variants thereof, fiber optics networks (e.g., ITU-T G.651, ITU-T G.652, Optical Transport Network (OTN), Synchronous optical networking (SONET) and synchronous digital hierarchy (SDH), and the like), digital subscriber line (DSL) and variants thereof, Data Over Cable Service Interface Specification (DOCSIS) technologies, hybrid fiber-coaxial (HFC) technologies, and/or the like. Examples of RATs (or RAT types) and/or communications protocols include Advanced Mobile Phone System (AMPS) technologies (e.g., Digital AMPS (D-AMPS), Total Access Communication System (TACS) and variants thereof, such as Extended TACS (ETACS), and the like); Global System for Mobile Communications (GSM) technologies (e.g., Circuit Switched Data (CSD), High-Speed CSD (HSCSD), General Packet Radio Service (GPRS), and Enhanced Data Rates for GSM Evolution (EDGE)); Third Generation Partnership Project (3GPP) technologies (e.g., Universal Mobile Telecommunications System (UMTS) and variants thereof (e.g., UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) and variants thereof (e.g., HSPA Plus (HSPA+)), Long Term Evolution (LTE) and variants thereof (e.g., LTE-Advanced (LTE-A), Evolved UTRA (E-UTRA), LTE Extra, LTE-A Pro, LTE LAA, MuLTEfire, and the like), Fifth Generation (5G) or New Radio (NR), narrowband IoT (NB-IOT), 3GPP Proximity Services (ProSe), and/or the like); ETSI RATs (e.g., High Performance Radio Metropolitan Area Network (HiperMAN), Intelligent Transport Systems (ITS) (e.g., ITS-G5, ITS-G5B, ITS-G5C, and the like), and the like); Institute of Electrical and Electronics Engineers (IEEE) technologies and/or WiFi (e.g., IEEE Standard for Local and Metropolitan Area Networks: Overview and Architecture, IEEE Std 802-2014, pp. 1-74 (30 Jun. 2014), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), IEEE 802.15 technologies (e.g., IEEE Standard for Low-Rate Wireless Networks, IEEE Std 802.15.4-2020, pp. 1-800 (23 Jul. 2020) and variants thereof (e.g., ZigBee, WirelessHART, MiWi, ISA100.11a, Thread, IPv6 over Low power WPAN (6LoWPAN), and the like), IEEE Standard for Local and metropolitan area networks—Part 15.6: Wireless Body Area Networks, IEEE Std 802.15.6-2012, pp. 1-271 (29 Feb. 2012), and the like), WLAN V2X RATs (e.g., [IEEE80211], IEEE Guide for Wireless Access in Vehicular Environments (WAVE) Architecture, IEEE STANDARDS ASSOCIATION, IEEE 1609.0-2019 (10 Apr. 2019) (“[IEEE16090]”), IEEE 802.11bd, Dedicated Short Range Communications (DSRC), and/or the like), Worldwide Interoperability for Microwave Access (WiMAX) (e.g., IEEE Standard for Air Interface for Broadband Wireless Access Systems, IEEE Std 802.16-2017, pp. 1-2726 (2 Mar. 2018), IEEE Standard for a Precision Clock Synchronization Protocol for Networked Measurement and Control Systems, IEEE Std 1588-2019 (16 Jun. 2020) and IEEE Standard for Local and Metropolitan Area Networks—Timing and Synchronization for Time-Sensitive Applications, IEEE Std 802.1AS™-2020 (19 Jun. 2020)), Mobile Broadband Wireless Access (MBWA)/iBurst (e.g., IEEE 802.20 and variants thereof), Wireless Gigabit Alliance (WiGig) standards (e.g., IEEE 802.11ad, IEEE 802.11ay, and the like), and so forth); Integrated Digital Enhanced Network (iDEN) and variants thereof (e.g., Wideband Integrated Digital Enhanced Network (WiDEN)); millimeter wave (mmWave) technologies/standards (e.g., wireless systems operating at 10-300 GHz and above 3GPP 5G); short-range and/or wireless personal area network (WPAN) technologies/standards (e.g., IEEE 802.15 technologies (e.g., as mentioned previously); Bluetooth and variants thereof (e.g., Bluetooth 5.3, Bluetooth Low Energy (BLE), and the like), WiFi-direct, Miracast, ANT/ANT+, Z-Wave, Universal Plug and Play (UPnP), low power Wide Area Networks (LPWANs), Long Range Wide Area Network (LoRA or LoRaWAN™), and the like); optical and/or visible light communication (VLC) technologies/standards (e.g., IEEE Standard for Local and metropolitan area networks—Part 15.7: Short-Range Optical Wireless Communications, IEEE Std 802.15.7-2018, pp. 1-407 (23 Apr. 2019), and the like); Sigfox; Mobitex; 3GPP2 technologies (e.g., cdmaOne (2G), Code Division Multiple Access 2000 (CDMA 2000), and Evolution-Data Optimized or Evolution-Data Only (EV-DO); Push-to-talk (PTT), Mobile Telephone System (MTS) and variants thereof (e.g., Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) and variants thereof (e.g., DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “carrier” at least in some examples refers to a modulated waveform conveying one or more physical channels (e.g., physical channels of 5G/NR, E-UTRA/LTE, UTRA, GSM/EDGE, and/or the like). The term “carrier frequency” at least in some examples refers to the center frequency of a cell.

The term “bearer” at least in some examples refers to an information transmission path of defined capacity, delay, bit error rate, and/or the like. The term “radio bearer” at least in some examples refers to the service provided by Layer 2 (L2) for transfer of user data between user equipment (UE) and a radio access network (RAN). The term “radio access bearer” at least in some examples refers to the service that the access stratum provides to the non-access stratum for transfer of user data between a UE and a CN.

The terms “beamforming” and “beam steering” at least in some examples refer to a spatial filtering mechanism used at a transmitter (Tx) to improve the received signal power, signal-to-noise ratio (SNR), or some other signaling metric at an intended receiver (Rx). The term “beamformer” at least in some examples refers to a STA that transmits a physical layer PDU (PPDU) using a beamforming steering matrix. The term “beamforming steering matrix” at least in some examples refers to a matrix determined using knowledge of the channel between a Tx and an intended Rx that maps from space-time streams to transmit antennas with the goal of improving the signal power, SNR, and/or some other signaling metric at the intended Rx.

The term “subframe” at least in some examples at least in some examples refers to a time interval during which a signal is signaled. In some implementations, a subframe is equal to 1 millisecond (ms). The term “time slot” at least in some examples at least in some examples refers to an integer multiple of consecutive subframes. The term “superframe” at least in some examples at least in some examples refers to a time interval comprising two time slots.

The term “channel coding” at least in some examples refers to processes and/or techniques to add redundancy to messages or packets in order to make those messages or packets more robust against noise, channel interference, limited channel bandwidth, and/or other errors. For purposes of the present disclosure, the term “channel coding” can be used interchangeably with the terms “forward error correction” or “FEC”; “error correction coding”, “error correction code”, or “ECC”; and/or “network coding” or “NC”. The term “network coding” at least in some examples refers to processes and/or techniques in which transmitted data is encoded and decoded to improve network performance. The term “code rate” at least in some examples refers to the proportion of a data stream or flow that is useful or non-redundant (e.g., for a code rate of k/n, for every k bits of useful information, the (en)coder generates a total of n bits of data, of which n−k are redundant). The term “systematic code” at least in some examples refers to any error correction code in which the input data is embedded in the encoded output. The term “non-systematic code” at least in some examples refers to any error correction code in which the input data is not embedded in the encoded output. The term “interleaving” at least in some examples refers to a process to rearrange code symbols so as to spread bursts of errors over multiple codewords that can be corrected by ECCs. The term “code word” or “codeword” at least in some examples refers to an element of a code or protocol, which is assembled in accordance with specific rules of the code or protocol.

The term “network address” at least in some examples refers to an identifier for a node or host in a computer network, and may be a unique identifier across a network and/or may be unique to a locally administered portion of the network. Examples of identifiers and/or network addresses can include am application identifier, Bluetooth hardware device address (BD_ADDR), a cellular network address (e.g., Access Point Name (APN), AMF name and/or AMF identifier (ID), AF-Service-Identifier, Closed Access Group Identifier (CAG-ID), Edge Application Server (EAS) ID, Data Network Access Identifier (DNAI), Data Network Name (DNN), EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, gNB Identifier (gNB ID), Global gNB ID, International Mobile Equipment Identity (IMEI), IMEI Type Allocation Code (IMEA/TAC), International Mobile Subscriber Identity (IMSI), IMSI software version (IMSISV), permanent equipment identifier (PEI), Local Area Data Network (LADN) DNN, Local NG-RAN Node Identifier, Mobile Subscriber Identification Number (MSIN), Mobile Subscriber/Station ISDN Number (MSISDN), Network identifier (NID), NR Cell Global Identifier (NCGI), Network Slice Instance (NSI) ID, Network Slice AS Group (NSAG), Permanent Equipment Identifier (PEI), Public Land Mobile Network (PLMN) ID, Physical Cell Identifier (PCI), QoS Flow ID (QFI) and/or 5G QoS Identifier (5QI), RAN ID, Routing Indicator, Radio Network Temporary Identifier (RNTI) and variants thereof (e.g., any of those discussed in clause 8 of [TS38300]), SMS Function (SMSF) ID, Stand-alone Non-Public Network (SNPN) ID, Single Network Slice Selection Assistance information (S-NSSAI), sidelink identities (e.g., Source Layer-2 ID, Destination Layer-2 ID, PC5 Link Identifier, and the like), Subscription Concealed Identifier (SUCI), Subscription Permanent Identifier (SUPI), Temporary Mobile Subscriber Identity (TMSI) and variants thereof, Tracking Area identity (TAI), UE Access Category and Identity, and/or other cellular network related identifiers), CAG-ID, drivers license number, Global Trade Item Number (GTIN) (e.g., Australian Product Number (APN), EPC, European Article Number (EAN), Universal Product Code (UPC), and the like), email address, Enterprise Application Server (EAS) ID, an endpoint address, an Electronic Product Code (EPC) as defined by the EPCglobal Tag Data Standard, Fully Qualified Domain Name (FQDN), flow ID and/or flow hash, hash value, index, internet protocol (IP) address in an IP network (e.g., IP version 4 (IPv4), IP version 6 (IPv6), and the like), an internet packet exchange (IPX) address, LAN ID, a MAC address, personal area network (PAN) ID, port number (e.g., TCP port number, UDP port number, and the like), price lookup code (PLC), product key, QUIC connection ID, RFID tag, sequence number, service set identifier (SSID) and variants thereof, screen name, serial number, stock keeping unit (SKU), socket address, social security number (SSN), telephone number (e.g., in a public switched telephone network (PTSN)), unique identifier (UID) (e.g., including globally UID, universally unique identifier (UUID) (e.g., as specified in ISO/IEC 11578:1996), and the like), a Universal Resource Locator (URL) and/or Universal Resource Identifier (URI), user name (e.g., ID for logging into a service provider platform, such as a social network and/or some other service), vehicle identification number (VIN), Virtual LAN (VLAN) ID, X.21 address, an X.25 address, Zigbee® ID, Zigbee® Device Network ID, and/or any other suitable network address and components thereof.

The term “global cell identity” or “global cell ID” at least in some examples refers to an identity to uniquely identifying an NR cell. In some examples, a “global cell identity” or “global cell ID” includes a cellIdentity and plmn-Identity of the first PLMN-Identity in plmn-IdentityList in SIB1.

The term “endpoint address” at least in some examples refers to an address used to determine the host/authority part of a target network address (e.g., URI and/or any other network address(es), such as those discussed herein), where the target network address (e.g., URI and/or any other network address(es), such as those discussed herein) is used to access an NF service (e.g., to invoke service operations) of an NF service producer or for notifications to an NF service consumer. The term “port” in the context of computer networks, at least in some examples refers to a communication endpoint, a virtual data connection between two or more entities, and/or a virtual point where network connections start and end. Additionally or alternatively, a “port” at least in some examples is associated with a specific process or service. Additionally or alternatively, the term “port” at least in some examples refers to a particular interface of the specified equipment (apparatus) with an electromagnetic environment (e.g., any connection point on an equipment intended for connection of cables to or from that equipment is considered as a port).

The term “delay” at least in some examples refers to a time interval between two events. Additionally or alternatively, the term “delay” at least in some examples refers to a time interval between the propagation of a signal and its reception. The term “delay bound” at least in some examples refers to a predetermined or configured amount of acceptable delay. The term “per-packet delay bound” at least in some examples refers to a predetermined or configured amount of acceptable packet delay where packets that are not processed and/or transmitted within the delay bound are considered to be delivery failures and are discarded or dropped. The term “goodput” at least in some examples refers to a number of useful information bits delivered by the network to a certain destination per unit of time. The term “jitter” at least in some examples refers to a deviation from a predefined (“true”) periodicity of a presumably periodic signal in relation to a reference clock signal. The term “latency” at least in some examples refers to the amount of time it takes to transfer a first/initial data unit in a data burst from one point to another. Additionally or alternatively, the term “latency” at least in some examples refers to the delay experienced by a data unit (e.g., frame) in the course of its propagation between two points in a network, measured from the time that a known reference point in the frame passes the first point to the time that the reference point in the data unit passes the second point. The term “network delay” at least in some examples refers to the delay of an a data unit within a network (e.g., an IP packet within an IP network). The term “packet delay” at least in some examples refers to the time it takes to transfer any packet from one point to another. Additionally or alternatively, the term “packet delay” or “per packet delay” at least in some examples refers to the difference between a packet reception time and packet transmission time. Additionally or alternatively, the “packet delay” or “per packet delay” can be measured by subtracting the packet sending time from the packet receiving time where the transmitter and receiver are at least somewhat synchronized. The term “packet drop rate” at least in some examples refers to a share of packets that were not sent to the target due to high traffic load or traffic management and should be seen as a part of the packet loss rate. The term “packet loss rate” at least in some examples refers to a share of packets that could not be received by the target, including packets dropped, packets lost in transmission and packets received in wrong format. The term “performance indicator” at least in some examples refers to performance data aggregated over a group of network functions (NFs), which is derived from performance measurements collected at the NFs that belong to the group, according to the aggregation method identified in a Performance Indicator definition. The term “physical rate” or “PHY rate” at least in some examples refers to a speed at which one or more bits are actually sent over a transmission medium. Additionally or alternatively, the term “physical rate” or “PHY rate” at least in some examples refers to a speed at which data can move across a wireless link between a transmitter and a receiver. The term “processing delay” at least in some examples refers to an amount of time taken to process a packet in a network node. The term “propagation delay” at least in some examples refers to amount of time it takes a signal's header to travel from a sender to a receiver. The term “queuing delay” at least in some examples refers to an amount of time a job waits in a queue until that job can be executed. Additionally or alternatively, the term “queuing delay” at least in some examples refers to an amount of time a packet waits in a queue until it can be processed and/or transmitted. The term “throughput” or “network throughput” at least in some examples refers to a rate of production or the rate at which something is processed. Additionally or alternatively, the term “throughput” or “network throughput” at least in some examples refers to a rate of successful message (date) delivery over a communication channel. The term “transmission delay” at least in some examples refers to an amount of time needed (or necessary) to push a packet (or all bits of a packet) into a transmission medium.

The term “application” or “app” at least in some examples refers to a computer program designed to carry out a specific task other than one relating to the operation of the computer itself. Additionally or alternatively, term “application” or “app” at least in some examples refers to a complete and deployable package, environment to achieve a certain function in an operational environment. The term “process” at least in some examples refers to an instance of a computer program that is being executed by one or more threads. In some implementations, a process may be made up of multiple threads of execution that execute instructions concurrently. The term “algorithm” at least in some examples refers to an unambiguous specification of how to solve a problem or a class of problems by performing calculations, input/output operations, data processing, automated reasoning tasks, and/or the like.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, operating system, database system, computer hardware, software library, and/or the like.

The terms “instantiate,” “instantiation,” and the like at least in some examples refers to the creation of an instance. In some examples, the term “instance” at least in some examples refers to a concrete occurrence of an object, which may occur, for example, during execution of program code.

The term “reference point” at least in some examples refers to a conceptual point at the conjunction of two non-overlapping functional groups, elements, or entities. The term “service based interface” at least in some examples refers to a representation how a set of services is provided and/or exposed by a particular NF.

The term “use case” at least in some examples refers to a description of a system from a user's perspective. Use cases sometimes treat a system as a black box, and the interactions with the system, including system responses, are perceived as from outside the system. Use cases typically avoid technical jargon, preferring instead the language of the end user or domain expert.

The term “user” at least in some examples refers to an abstract representation of any entity issuing commands, requests, and/or data to a compute node or system, and/or otherwise consumes or uses services. Additionally or alternatively, the term “user” at least in some examples refers to an entity, not part of the 3GPP System, which uses 3GPP System services (e.g., a person using a 3GPP system mobile station as a portable telephone). The term “user profile” at least in some examples refers to a set of information to provide a user with a consistent, personalized service environment, irrespective of the user's location or the terminal used (within the limitations of the terminal and the serving network).

The term “service consumer” or “consumer” at least in some examples refers to an entity that consumes one or more services. The term “service producer” or “producer” at least in some examples refers to an entity that offers, serves, or otherwise provides one or more services. The term “service provider” or “provider” at least in some examples refers to an organization or entity that provides one or more services to at least one service consumer. For purposes of the present disclosure, the terms “service provider” and “service producer” may be used interchangeably even though these terms may refer to difference concepts. Examples of service providers include cloud service provider (CSP), network service provider (NSP), application service provider (ASP) (e.g., Application software service provider in a service-oriented architecture (ASSP)), internet service provider (ISP), telecommunications service provider (TSP), online service provider (OSP), payment service provider (PSP), managed service provider (MSP), storage service providers (SSPs), SAML service provider, and/or the like.

The terms “configuration”, “policy”, “ruleset”, and/or “operational parameters”, at least in some examples refer to a machine-readable information object and/or data structure that contains instructions, conditions, parameters, criteria, data, metadata, and/or any other information that is/are relevant to a component, device, system, network, service producer, service consumer, and/or other element/entity.

The term “SMTC” at least in some examples refers to an Synchronization Signal Block (SSB)-based measurement timing configuration configured by SSB-MeasurementTimingConfiguration. The term “SSB” at least in some examples refers to a synchronization signal block or an synchronization signal (SS)/PBCH block.

The term “complete L1/L2 triggered mobility candidate cell configuration” or “complete LTM candidate cell configuration” at least in some examples refers to a configuration that contains all the necessary fields needed to perform an LTM cell switch procedure. This configuration can be an LTM candidate cell configuration itself or be generated by applying an LTM candidate cell configuration on top of an LTM reference configuration.

The term “L1/L2 triggered mobility candidate cell configuration” or “LTM candidate cell configuration” at least in some examples refers to a configuration associated with an LTM candidate cell. An LTM candidate cell configuration can be a complete LTM candidate cell configuration or a delta (difference) configuration with respect to an LTM reference configuration.

The term “L1/L2 triggered mobility reference configuration” or “LTM reference configuration” at least in some examples refers to a configuration provided by the network to the UE that is common to all the configured LTM candidate cells. It is used by the UE to generate a complete LTM candidate cell configuration (e.g., by applying an LTM candidate cell configuration on top of an LTM reference configuration).

The term “datagram” at least in some examples at least in some examples refers to a basic transfer unit associated with a packet-switched network; a datagram may be structured to have header and payload sections. The term “datagram” at least in some examples may be synonymous with any of the following terms, even though they may refer to different aspects: “data unit”, a “protocol data unit” or “PDU”, a “service data unit” or “SDU”, “frame”, “packet”, a “network packet”, “segment”, “block”, “cell”, “chunk”, “Type Length Value” or “TLV”, and/or the like. Examples of datagrams, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a IEEE 802 protocol/standard (e.g., [IEEE80211] and/or the like), Type Length Value (TLV), and/or other like data structures. The term “packet” at least in some examples refers to an information unit identified by a label at layer 3 of the OSI reference model. In some examples, a “packet” may also be referred to as a “network protocol data unit” or “NPDU”. The term “protocol data unit” at least in some examples refers to a unit of data specified in an (N)-protocol layer and includes (N)-protocol control information and possibly (N)-user data.

The term “information element” or “IE” at least in some examples refers to a structural element containing one or more fields. Additionally or alternatively, the term “information element” or “IE” at least in some examples refers to a field or set of fields defined in a standard or specification that is used to convey data and/or protocol information. The term “field” at least in some examples refers to individual contents of an information element, or a data element that contains content. The term “data frame”, “data field”, or “DF” at least in some examples refers to a data type that contains more than one data element in a predefined order. The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some examples refers to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, and the like), object instances, and/or other data elements. An “attribute” at least in some examples refers to a markup construct including a name—value pair that exists within a start tag or empty element tag. Attributes contain data related to its element and/or control the element's behavior.

The term “reference” at least in some examples refers to data useable to locate other data and may be implemented a variety of ways (e.g., a pointer, an index, a handle, a key, an identifier, a hyperlink, and/or the like).

The term “data set” or “dataset” at least in some examples refers to a collection of data; a “data set” or “dataset” may be formed or arranged in any type of data structure. In some examples, one or more characteristics can define or influence the structure and/or properties of a dataset such as the number and types of attributes and/or variables, and various statistical measures (e.g., standard deviation, kurtosis, and/or the like). The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set (or dataset), multiset or bag, stack, queue, graph (e.g., tree, heap, and the like), and/or the like), routing table, symbol table, quad-edge, blockchain, purely-functional data structures (e.g., stack, queue, (multi)set, random access list, hash consing, zipper data structure, and/or the like).

The term “clock” at least in some examples refers to a physical device that is capable of providing a measurement of the passage of time since a defined epoch.

The term “timing standard” or “time standard” at least in some examples refers to a specification for measuring time, which includes the rate at which time passes, points in time, or both. Additionally or alternatively, the term “timing standard” or “time standard” at least in some examples refers to a standard time source and/or provides time that is traceable to the international standards laboratories maintaining clocks. Examples of timing standards or time standards include Geocentric Coordinate Time (TCG), International Atomic Time (TAI), Universal Time (UT1), Coordinated Universal Time (UTC), GPS time (GPST), and Barycentric Coordinate Time (TCB). Examples of standard time sources are National Institute of Standards and Technology (NIST) timeservers and global navigation satellite systems (GNSSs).

The term “authorization” at least in some examples refers to a prescription that a particular behavior shall not be prevented. The term “authentication” at least in some embodiments refers to a process of proving or verifying an identity. Additionally or alternatively, the term “authentication” at least in some embodiments refers to a mechanism by which a computer system checks or verifies that a user or entity is really the user or entity being claimed. Examples of the authentication and/or authorization techniques include using API keys, basic access authentication (“Basic Auth”), Open Authorization (OAuth), hash-based message authentication codes (HMAC), Kerberos protocol, OpenID, WebID, and/or other authentication and/or authorization techniques. The term “consistency check” at least in some examples refers to a test or assessment performed to determine if data has any internal conflicts, conflicts with other data, and/or whether any contradictions exist. In some examples, a “consistency check” may operate according to a “consistency model”, which at least in some examples refers to a set of operations for performing a consistency check and/or rules or policies used to determine if data is consistent (or predictable) or not. The term “integrity” at least in some examples refers to a mechanism that assures that data has not been altered in an unapproved way. Examples of cryptographic mechanisms that can be used for integrity protection include digital signatures, message authentication codes (MAC), and secure hashes. The term “verification” at least in some examples refers to a process, method, function, or any other means of establishing the correctness of information or data.

The term “certificate” or “digital certificate” at least in some examples refers to an information object (e.g., an electronic document or other data structure) used to prove the validity of a piece of data such as a public key in a public key infrastructure (PKI) system. Examples of the digital certificates include the X.509 format and/or some other suitable format, and may be signed using any suitable cryptographic mechanisms such as Elliptic Curve cryptography Digital Signature Algorithm (ECDSA) or some other suitable algorithm such as any of those discussed herein. Additionally or alternatively, the digital certificates discussed herein can include various certificates issued by the an issuer, a verification body, a notified body, certificate authority (CA) (e.g., a root CA or the like), an enrollment authority (EA), an authorization authority (AA), and/or other entity as delineated by relevant Certificate Authority Security Council (CASC) standards, Common Computing Security Standards Forum (CCSF) standards, CA/Browser Forum standards, GSMA standards, ETSI standards, GlobalPlatform standards, and/or some other suitable standard. The term “certificate revocation list” or “CRL” at least in some examples refers to a signed list indicating a set of certificates that are no longer considered valid by the certificate issuer. The term “signature” or “digital signature” at least in some examples refers to a mathematical scheme, process, or method for verifying the authenticity of a digital message or information object (e.g., an electronic document or other data structure).

The term “confidential data” at least in some examples refers to any form of information that a person or entity is obligated, by law or contract, to protect from unauthorized access, use, disclosure, modification, or destruction. Additionally or alternatively, “confidential data” at least in some examples refers to any data owned or licensed by a person or entity that is not intentionally shared with the general public or that is classified by the person or entity with a designation that precludes sharing with the general public.

The term “cryptographic mechanism” at least in some examples refers to any cryptographic protocol and/or cryptographic algorithm. Examples of cryptographic mechanisms include a cryptographic hash algorithm, such as a function in the Secure Hash Algorithm (SHA) 2 set of cryptographic hash algorithms (e.g., SHA-226, SHA-256, SHA-512, and the like), SHA 3, and so forth, or any type of keyed or unkeyed cryptographic hash function and/or any other function discussed herein; an elliptic curve cryptographic (ECC) algorithm (e.g., Elliptic Curve cryptography Key Agreement algorithm (ECKA) algorithm, Elliptic Curve cryptography Digital Signature Algorithm (ECDSA), Lenstra elliptic-curve factorization or elliptic-curve factorization method (ECM), Menezes—Qu—Vanstone (MQV) or elliptic curve MQV (ECMQV), Elliptic Curve Diffie—Hellman (ECDH) key agreement, Elliptic Curve Integrated Encryption Scheme (ECIES) or Elliptic Curve Augmented Encryption Scheme, Edwards-curve Digital Signature Algorithm (EdDSA), and/or the like); Rivest-Shamir-Adleman (RSA) cryptography; Merkle signature scheme, advanced encryption system (AES) algorithm; a triple data encryption algorithm (3DES); Quantum cryptography algorithms; and/or the like. Additionally or alternatively, the term “cryptographic protocol” at least in some examples refers to a sequence of steps precisely specifying the actions required of two or more entities to achieve specific security objectives (e.g., cryptographic protocol for key agreement). Additionally or alternatively, the term “cryptographic algorithm” at least in some examples refers to an algorithm specifying the steps followed by a single entity to achieve specific security objectives (e.g., cryptographic algorithm for symmetric key encryption). The term “public-key cryptography” or “asymmetric cryptography” at least in some examples refers to a cryptographic system that use pairs of related keys including, for example, a public key used for generating ciphertext, and a corresponding private key to decrypt the ciphertext to obtain the original message (e.g., plaintext); in some examples, these key pairs are generated with cryptographic algorithms based on one-way functions

The term “cryptographic hash function”, “hash function”, or “hash”) at least in some examples refers to a mathematical algorithm that maps data of arbitrary size (sometimes referred to as a “message”) to a bit array of a fixed size (sometimes referred to as a “hash value”, “hash”, or “message digest”). A cryptographic hash function is usually a one-way function, which is a function that is practically infeasible to invert.

The term “cryptographic key” or “key” at least in some examples refers to a piece of information, usually a string of numbers or letters that are stored in a file, which, when processed through a cryptographic algorithm can encode or decode cryptographic data. The term “symmetric-key algorithm” at least in some examples refers to a cryptographic algorithm that uses the same cryptographic key for both the encryption of plaintext and the decryption of ciphertext; the keys may be identical, or there may be a simple transformation to go between the two keys. The term “anchor key” at least in some examples refers to a cryptographic key that is used to generate other keys. In some examples, an “anchor key” is used in key management systems to create and distribute keys to users. In some examples, an “anchor key” is stored in a secure location and is not used directly to encrypt or decrypt data. Examples of anchor keys include, master keys, subkeys, and session keys.

The term “encryption” at least in some examples refers to a process of encoding information wherein the original representation of information (referred to as “plaintext”) into an alternative form (referred to as “ciphertext”). In some examples, an encryption scheme includes use of a pseudo-random encryption key generated by a cryptographic mechanism or some other algorithm to generate an encryption key, which can be used to encrypt and/or decrypt the plaintext.

The term “one-time credential” at least in some examples refers to a type of authentication that is only valid for a single use. In some examples, a one-time credential is used for two-factor authentication (2FA), which is a security measure that requires two different forms of authentication to access an account. Examples of one-time credentials include time-based one-time passwords (TOTPs) (e.g., a one-time credential generated by a time-based algorithm that is valid for a short period of time (e.g., 30 seconds or the like; in some examples, a TOTP is generated by mobile apps or hardware tokens) and out-of-band (OOB) one-time passwords (OTPs) (e.g., a one-time credential that is sent to a user's phone (via SMS message), email address, or the like; In some examples, an OOB OTP is valid for a single use and can only be used once).

The term “data breach” at least in some examples refers to a breach of security leading to the accidental or unlawful destruction, loss, alteration, unauthorized disclosure of, or access to, data (including personal, sensitive, and/or confidential data) transmitted, stored or otherwise processed.

The term “information security” or “InfoSec” at least in some examples refers to any practice, technique, and technology for protecting information by mitigating information risks and typically involves preventing or reducing the probability of unauthorized/inappropriate access to data, or the unlawful use, disclosure, disruption, deletion, corruption, modification, inspection, recording, or devaluation of information; and the information to be protected may take any form including electronic information, physical or tangible (e.g., computer-readable media storing information, paperwork, and the like), or intangible (e.g., knowledge, intellectual property assets, and the like).

The term “artificial intelligence” or “AI” at least in some examples refers to any intelligence demonstrated by machines, in contrast to the natural intelligence displayed by humans and other animals. Additionally or alternatively, the term “artificial intelligence” or “AI” at least in some examples refers to the study of “intelligent agents” and/or any device that perceives its environment and takes actions that maximize its chance of successfully achieving a goal.

The terms “artificial neural network”, “neural network”, or “NN” refer to an ML technique comprising a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), and the like), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), and the like), Linear Dynamical System (LDS), Switching LDS (SLDS), Optical NNs (ONNs), an NN for reinforcement learning (RL) and/or deep RL (DRL), and/or the like.

The term “mathematical model” at least in some examples refer to a system of postulates, data, and inferences presented as a mathematical description of an entity or state of affairs including governing equations, assumptions, and constraints. The term “statistical model” at least in some examples refers to a mathematical model that embodies a set of statistical assumptions concerning the generation of sample data and/or similar data from a population; in some examples, a “statistical model” represents a data-generating process.

The term “machine learning” or “ML” at least in some examples refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build ML model(s) (also referred to as “models”) in order to make predictions or decisions based on sample data (e.g., training data).

The term “machine learning model” or “ML model” at least in some examples refers to an application, program, process, algorithm, and/or function that is capable of making predictions, inferences, or decisions based on an input data set and/or is capable of detecting patterns based on an input data set. In some examples, a “machine learning model” or “ML model” is trained on a training data to detect patterns and/or make predictions, inferences, and/or decisions. In some examples, a “machine learning model” or “ML model” is based on a mathematical and/or statistical model. For purposes of the present disclosure, the terms “ML model”, “AI model”, “AI/ML model”, and the like may be used interchangeably. For purposes of the present disclosure, the term “ML model” may be used interchangeably with the terms “AI/ML model” and “model”.

The term “machine learning algorithm” or “ML algorithm” at least in some examples refers to an application, program, process, algorithm, and/or function that builds or estimates an ML model based on sample data or training data. Additionally or alternatively, the term “machine learning algorithm” or “ML algorithm” at least in some examples refers to a program, process, algorithm, and/or function that learns from experience w.r.t some task(s) and some performance measure(s)/metric(s), and an ML model is an object or data structure created after an ML algorithm is trained with training data. For purposes of the present disclosure, the terms “ML algorithm”, “AI algorithm”, “AI/ML algorithm”, and the like may be used interchangeably. Additionally, although the term “ML algorithm” may refer to different concepts than the term “ML model,” these terms may be used interchangeably for the purposes of the present disclosure.

The term “machine learning application” or “ML application” at least in some examples refers to an application, program, process, algorithm, and/or function that contains some AI/ML model(s) and application-level descriptions. Additionally or alternatively, the term “machine learning application” or “ML application” at least in some examples refers to a complete and deployable application and/or package that includes at least one ML model and/or other data capable of achieving a certain function and/or performing a set of actions or tasks in an operational environment. For purposes of the present disclosure, the terms “ML application”, “AI application”, “AI/ML application”, and the like may be used interchangeably.

The terms “model parameter” and/or “parameter” in the context of ML, at least in some examples refer to values, characteristics, and/or properties that are learnt during training. Additionally or alternatively, “model parameter” and/or “parameter” in the context of ML, at least in some examples refer to a configuration variable that is internal to the model and whose value can be estimated from the given data. Model parameters are usually required by a model when making predictions, and their values define the skill of the model on a particular problem. Examples of such model parameters/parameters include weights (e.g., in an ANN); constraints; support vectors in a support vector machine (SVM); coefficients in a linear regression and/or logistic regression; word frequency, sentence length, noun or verb distribution per sentence, the number of specific character n-grams per word, lexical diversity, and the like, for natural language processing (NLP) and/or natural language understanding (NLU); and/or the like. The term “hyperparameter” at least in some examples refers to characteristics, properties, and/or parameters for an ML process that cannot be learnt during a training process. Hyperparameter are usually set before training takes place, and may be used in processes to help estimate model parameters. Examples of hyperparameters include model size (e.g., in terms of memory space, bytes, number of layers, and the like); training data shuffling (e.g., whether to do so and by how much); number of evaluation instances, iterations, epochs (e.g., a number of iterations or passes over the training data), or episodes; number of passes over training data; regularization; learning rate (e.g., the speed at which the algorithm reaches (converges to) optimal weights); learning rate decay (or weight decay); momentum; number of hidden layers; size of individual hidden layers; weight initialization scheme; dropout and gradient clipping thresholds; the C value and sigma value for SVMs; the k in k-nearest neighbors; number of branches in a decision tree; number of clusters in a clustering algorithm; vector size; word vector size for NLP and NLU; and/or the like.

Although many of the previous examples are provided with use of specific cellular/mobile network terminology, including with the use of 4G/5G 3GPP network components (or expected terahertz-based 6G/6G+ technologies), it will be understood these examples may be applied to many other deployments of wide area and local wireless networks, as well as the integration of wired networks (including optical networks and associated fibers, transceivers, and/or the like). Furthermore, various standards (e.g., 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

What is claimed is:

1. A non-transitory computer-readable medium comprising instructions operable, upon execution by a processor of a computer, to cause the computer to:
generate, based at least on a 3D model of a primary workpiece and a cut solution for the primary workpiece, a virtual model of a predicted flitch to be cut from the primary workpiece according to the cut solution, wherein the primary workpiece is a cant or a log, and the 3D model of the primary workpiece is based on a detected geometric profile of the primary workpiece,
compare a virtual model of an actual flitch to the virtual model of the predicted flitch, wherein the virtual model of the actual flitch is based on a detected geometric profile of the actual flitch and the geometric profile of the actual flitch is detected after the actual flitch is cut from the primary workpiece, and
based on the comparison, identify the primary workpiece as a source of the actual flitch,
determine a difference between the actual flitch and the predicted flitch, and
send instructions to a controller to cause the controller to adjust a cutting device a cutting member, a workpiece positioning or handling device, or a workpiece transport based at least in part on said difference.

2. The non-transitory computer-readable medium of claim 1, wherein said virtual models are 3D virtual models, and the instructions are further operable, upon execution by the processor, to cause the computer to:
determine, based at least on the 3D model of the predicted flitch, a first group of data points that represent an outer contour of the predicted flitch at a first elevation relative to a first face of the predicted flitch, and
determine, based at least on the 3D model of the actual flitch, a second group of data points that represent an outer contour of the actual flitch at said first elevation relative to a corresponding first face of the actual flitch, and
compare the data points of the first group to the corresponding data points of the second group to thereby compare the virtual model of the actual flitch to the virtual model of the predicted flitch.

3. The non-transitory computer-readable medium of claim 2, wherein the first elevation is an elevation equidistant between the first face and an opposite second face of one of said flitches.

4. The non-transitory computer-readable medium of claim 1, the instruction further operable, upon execution by the processor, to cause the computer to:
generate, based at least on a 3D virtual model of a second primary workpiece and a cut solution for the second primary workpiece, a second virtual model of a second predicted flitch,
compare the virtual model of the actual flitch to the second virtual model of the second predicted flitch, and
based on the comparison, eliminate the second primary workpiece as the source of the actual flitch.

5. The non-transitory computer-readable medium of claim 2, wherein the primary workpiece is a log.

6. The non-transitory computer-readable medium of claim 2, wherein the primary workpiece is a cant.

7. A system for identifying a primary workpiece as the source of a flitch, the system comprising:
a first scanner optimizer system including a plurality of first sensors operatively coupled with a first computer system, wherein the first sensors are collectively positioned to scan a primary workpiece as the primary workpiece is transported along a first path of flow and operable to measure a geometric profile of the primary workpiece, and the first computer system is configured to generate a virtual model of the primary workpiece and a cut solution for the primary workpiece based at least on data from the first sensors, wherein the primary workpiece is a cant or a log;
a second scanner optimizer system including a plurality of second sensors operatively coupled with a second computer system, wherein the second sensors are collectively positioned to scan an actual flitch as the actual flitch is transported along a second path of flow and operable to measure a geometric profile of the actual flitch, and the second computer system is configured to generate a virtual model of the actual flitch based at least on data from the second sensors; and
a third computer system operatively coupled with the first and second computer systems and programmed with instructions operable, upon execution, to;
generate, based at least on the virtual model of the primary workpiece and the cut solution, a virtual model of a predicted flitch to be cut from the primary work piece according to the cut solution,
compare the virtual model of the actual flitch to the virtual model of the predicted flitch,
based on the comparison, identify the primary workpieces as source of the flitch,
determine a difference between the actual flitch and the predicted flitch, and
send instructions to a controller or a display based at least in part on the difference, wherein the instructions are configured to
cause the controller to adjust a cutting device, a cutting member, a workpiece positioning or handling device, or a workpiece transport, or
cause the display to display a result of the comparison or a recommendation to adjust the cutting device, perform maintenance or repair on the cutting device, or adjust a speed of the transport.

8. The system of claim 7, wherein the virtual model of the predicted flitch and the virtual model of the flitch are 3D models, and the instructions are further operable, upon execution, to;
determine a first group of data points that represent the outer contour of the predicted flitch at a first elevation relative to a first face of the predicted flitch,
determine a second group of data points that represent the outer contour of the flitch at the first elevation relative to a corresponding first face of the flitch, and
compare the virtual model of the flitch to the virtual model of the predicted flitch by comparing the first group of data points to the second group of data points.

9. A method of matching a flitch to a source log, the method comprising:
receiving, from a first plurality of sensors or a first computer system, a virtual model of a predicted flitch to be cut from a primary workpiece according to a cut solution, wherein the primary workpiece is a log or a cant;
receiving, from one or more second sensors or a second computer system, a virtual model of an actual flitch:
comparing the virtual model of the predicted flitch to the virtual model of the actual flitch;
based on the comparison, identifying the primary workpiece as a source of the actual flitch;
determining a difference between the actual flitch and the predicted flitch, and and
sending instructions to a controller based at least in part on the difference, wherein the instructions are configured to cause the controller to adjust a cutting device, a cutting member, a workpiece positioning or handling device, or a workpiece transport.

10. The method of claim 9, wherein comparing the virtual model of the predicted flitch to the virtual model of the actual flitch includes determining a first outer contour of the predicted flitch at a first elevation relative to a first face of the predicted flitch, determining a second outer contour of the actual flitch at said first elevation relative to a corresponding first face of the actual flitch, and comparing the first outer contour to the second outer contour.

11. The method of claim 10, wherein the first outer contour is represented by a group of first coordinates at intervals along a length of the predicted flitch, and the second outer contour is represented by a group of second coordinates at intervals along a length of the actual flitch, and wherein comparing the first outer contour to the second outer contour includes comparing the first coordinates to corresponding ones of the second coordinates.

12. The method of claim 9, further comprising identifying a zone within the primary workpiece as the zone from which the actual flitch was cut, based at least in part on the cut solution.

13. The method of claim 12, further comprising identifying, based at least on the identified zone or the cut solution, a saw that was used to cut the actual flitch from the primary workpiece.

14. The method of claim 13, further comprising:
determining one or more geometric differences between the predicted flitch and the actual flitch, and
adjusting a position of said saw based at least on the one or more geometric differences.

15. A method of modifying a log processing system, wherein the log processing system includes a first scanner optimizer and a second scanner optimizer, the method comprising:
operatively coupling a computer system with the first and second scanner optimizers, wherein the computer system is programmed with instructions operable, upon execution by one or more processors of the computer system, to cause the computer system to:
receive a virtual model of a primary workpiece and a cut solution for the primary workpiece from the first scanner optimizer, wherein the primary workpiece is a log or a cant;
generate a virtual model of a predicted flitch based at least on the virtual model of the primary workpiece and the cut solution;
receive a virtual model of an actual flitch from the second scanner optimizer;
compare the virtual model of the predicted flitch to the virtual model of the actual flitch;
identify the primary workpiece as a source of the actual flitch based at least on the comparison;
determine a difference between the actual flitch and the predicted flitch; and
send instructions to a controller, based at least in part on said difference, to cause the controller to adjust a cutting device, a cutting member, a work-piece positioning or handling device, or a workpiece transport.

16. The method of claim 15, wherein comparing the virtual model of the predicted flitch to virtual model of the actual flitch includes comparing an outer contour of the predicted flitch at a first elevation relative to a first face of the predicted flitch to an outer contour of the actual flitch at a corresponding elevation relative to a corresponding face of the actual flitch.

17. The method of claim 16, wherein each of the contours is represented by a plurality of coordinates that lie within a plane at said first elevation, and wherein comparing the contours includes comparing the coordinates of each contour at respective locations along a longitudinal axis of the contours.

18. The method of claim 17, wherein the first elevation does not coincide with the first face or an opposite second face of the predicted flitch or the actual flitch.

19. The method of claim 16, further including identifying a saw used to cut the actual flitch, based at least on the cut pattern.

20. The method of claim 17, further including:
determining a first geometric difference between the actual flitch and the predicted flitch, and
based on the first geometric difference, adjusting a position of the saw.

21. The method of claim 15, wherein the instructions are further operable, upon execution, to:
compare a virtual model of a second predicted flitch to the virtual model of the actual flitch; and
identify the virtual model of the second predicted flitch as a potential match to the virtual model of the actual flitch based on the comparison.
